(19) United States
(12) Patent Application Publication
(10) Pub. No.: US 2006/0265732 A1
(43) Pub. Date: Nov. 23, 2006

(54) Adapter, cartridge, computer system and entertainment system

(75) Inventors: Yoshiaki Nakanishi, Shiga (JP); Kunihiro Tanaka, Shiga (JP); Shinji Nakajima, Japan (JP)

Correspondence Address: OSHA LIANG L.L.P., 1221 MCKINNEY STREET, SUITE 2800, HOUSTON, TX, 77010, US

(73) Assignee: SSD Company Limited, Shiga (JP)

(21) Appl. No.: 10/554,681

(22) PCT Filed: Dec. 22, 2004
(86) PCT No.: PCT/JP04/19687

§ 371 Date: Oct. 26, 2005

(30) Foreign Application Priority Data
Jan. 8, 2004 (JP) 2004-002664
Jun. 18, 2004 (JP) 2004-181098

(51) Int. Cl. H04N 7/16; H04N 7/173; H04N 5/44

(52) U.S. Cl. 725/136; 348/725; 725/140; 725/133

(57) ABSTRACT

An adapter is provided which can be used to adapt a television receiver for a variety of purposes by connecting the television receiver to a computer. A cartridge comprises a memory storing a program and data, and a high speed processor capable of generating a video signal and an audio signal in such signal formats that the television receiver receives the video and audio signals, and displays an image and outputs a sound corresponding to the signals. The cartridge is installed into the adapter to which the video signal and the audio signal are input from the high speed processor. The adapter outputs the video and audio signals as input from the high speed processor to the television receiver.

### TECHNICAL FIELD

The present invention relates to an adapter, a cartridge connectable to the adapter and the techniques related thereto.

### BACKGROUND ART

A game console and a game cartridge are described in FIG. 1 and FIG. 5 of Japanese Utility Model Published Application No. Sho60-52885 (referred to herein as Patent document 1) as explained below. A printed circuit board is installed in the inside of the game cartridge. A single LSI (large scale integrated circuit) chip is mounted on this printed circuit board. This LSI chip incorporates a memory for storing a game program and a CPU (central processing unit) for performing various types of processing. Also, this LSI chip is provided with I/O ports for inputting and outputting addresses and data, the operations of switches (a manipulation lever, push buttons and the like), VDG (video display generator) control signals, audio signals and so forth.

On the other hand, the game console is connected to the antenna terminal of the television receiver. An arched handle is formed on the upper surface of the game console near the left side. A push button is provided on the upper surface of this handle. This push button can be used as a game start button, a game mode select button, a firing button and other switches. The player can manipulate this push button while gripping the handle by the left hand.

Also, on the upper surface in the right hand side of the game console, there are provided a manipulation lever near the front side and a cartridge insert slot near the back side respectively. The manipulation lever can pivot from front to back and from side to side. A push button is provided on the left side of the lever handle of the manipulation lever. The player can manipulate this push button while gripping the lever handle by the right hand. This push button of the lever handle has switching functions differing from the functions of the push button of the arched handle. The cartridge insertion slot comprises a rectangular insert opening, and a pair of cover plates which are resiliently supported and can be opened by pushing with the edge of the game cartridge.

Furthermore, on the upper surface of the game console, there are a power supply switch, a pause button, and a lamp between the handle and the manipulation lever.

Next, the circuit configuration of the game console will be explained. Besides the memories and the CPU, there are several built-in functional devices in the game console. Specifically, this game console is provided with a decoder, a video RAM (random access memory), a mode select latch, a VDG, an address latch, an address driver, a bus transceiver, a sound modulator, a video modulator, a lowpass filter, a high frequency oscillator and various keys.

The decoder is used to take control of accessing the video RAM and operating the mode select latch. The video RAM stores data transmitted from the memory of the game cartridge, and transfers the data to the VDG. The mode select latch is used to select the operation mode of the VDG and latch the selected mode in accordance with the information from the decoder. The address latch is a latch for separating address information from data.

The address driver is controlled when reading and writing an address for accessing the video RAM. The bus transceiver takes control of transmitting and receiving data by read and write signals, and control of the timing of accessing the video RAM in synchronization with the clock. The VDG generates video signals on the basis of the data from the video RAM in accordance with the display mode as set.

This display mode can be selected from among a variety of graphics modes such as a semi-graphics mode of 64×32 dots with eight colors, a graphics mode of 64×64 dots with four colors, and a graphics mode of 128×64 dots with two colors. The setting of the display mode is performed by the CPU of the game cartridge.

The sound modulator synthesizes and modulates the signals from CPU to output 4.5 MHz television audio signals by frequency modulation. The video modulator performs the RF amplitude modulation of the signal of the VDG with a high frequency oscillator to generate television signals (NTSC) of CH1 or CH2, which are then passed through a lowpass filter and supplied to television.

In the circuit configuration as described above, a desired context of game can be implemented by the game program stored in the memory of the game cartridge, while the VDG is controlled by the CPU of the game cartridge to set the number of colors and the picture quality (the number of dots as displayed) of the images displayed on a television screen.

However, as has been discussed above, the CPU of the game cartridge does not have an ability of displaying images while the VDG having an ability of displaying images is implemented within the game console. In other words, the CPU of the game cartridge cannot generate video signals.

As has been discussed above, since the game cartridge incorporates the memory and CPU in the case of the prior art technique of Patent document 1, it is possible for the respective implementations of the game cartridge to change not only the game context but also other display characteristics such as the number of dots and the number of colors in the display screen. Also, since the memory and the CPU can be manufactured in a single chip which is suitable for mass production, it contributes to the reduction of the total costs of the game cartridge and the game console.

However, the technique of the game cartridge with a built-in CPU and a built-in memory as described in Patent document 1 becomes obsolete nowadays. The details are as follows. Up to the present date from the date the technique as described in Patent document 1 was proposed, there have been substantial resources being put into the development of highly functional hardware and software in the television game industry in the same manner as in the computer industry. Particularly, in the television game industry, efforts are aiming at improving the graphics capability of displaying realistic three dimensional images on a television monitor. Because of this, while all the hardware of expanded circuitry is incorporated within a television game console as well as the CPU, enlarged game programs, pixel data and the like are stored in CD-ROMs (compact disc-read only memory) for distribution. In addition to this, in the current television game industry, there is a trend to endow a game machine with the functionality of an electric home appliance (particularly, as an audio-visual product) such as the functionality of playing a DVD (digital versatile disc), recording a TV program and so forth.

Accordingly, in the context of the actual situation on the television game industry, the technique of Patent document 1 relating to a cartridge incorporating both the CPU and the memory provides no information on which those skilled in the art advance development.

So far, Patent document 1 is used to explain the actual situation on the television game industry. Next, a technique of the personal computer industry will be explained. A portable personal processor module is described in FIG. 1 and FIG. 3 of Japanese Patent Published Application No. Hei06-289953 (referred to herein as Patent document 2) as explained below. This personal processor module comprises a processor, a memory and a hard disk. And, this personal processor module is connected to a docking station. Then, peripheral devices such as a monitor and a keyboard are connected to the docking station. In this way, a personal computer is configured by the personal processor module, the docking station and the peripheral devices such as a monitor in combination.

One feature of the personal computer industry differ from the television game industry is that versatility (usability for any intended purpose of the user) is required of a personal computer while such versatility is not required of television game consoles. However, common to both industries, there is a trend to endow the system with the functionality of an electric home appliance (particularly, as an audio-visual product).

### DISCLOSURE OF INVENTION

Meanwhile, television game consoles and personal computers have won the admiration of many consumers. However, if it is possible to provide a product having a different concept than the above, it is very likely for enterprises to gain large economic benefits.

It is therefore an object of the present invention to provide an adapter and the techniques related thereto for making it possible to serve a variety of purposes by connecting a computer to a television receiver.

Also, it is another object of the present invention to provide a cartridge and the techniques related thereto for making it possible to use a television receiver such a manner as to serve a particular purpose simply by connecting the cartridge to an adapter, which in turn serves a variety of purposes with the television receiver by changing the cartridge connected thereto.

The adapter in accordance with the first aspect of the present invention is an adapter connectable to a television receiver and a cartridge which contains a memory storing a program and data, and a computer capable of performing an arithmetic operation by the use of said program with said data, generating a video signal in such a signal format that said television receiver receives said video signal and displays an image corresponding to said video signal and generating an audio signal in such a signal format that television receiver receives said audio signal and outputs a sound corresponding to said audio signal, said adapter comprising: a first video signal input terminal through which said video signal is received from said computer; a first audio signal input terminal through which said audio signal is received from said computer; a video signal output terminal through which said video signal input from said computer is output to said television receiver; an audio signal output terminal through which said audio signal is output from said computer to said television receiver; a first inner circuit operable to receive said video signal from said first video signal input terminal and output said video signal to said video signal output terminal; a second inner circuit operable to receive said audio signal from said first audio signal input terminal and output said audio signal to said audio signal output terminal.

In accordance with this adapter, it is possible to transmit a video signal and an audio signal generated by the computer to the television receiver simply by connecting the video signal output terminal and audio signal output terminal of said adapter respectively to the video signal input terminal and audio signal input terminal of the television receiver and installing the cartridge into said adapter. Accordingly, the television receiver can display an image corresponding to the video signal generated by the computer and output a sound corresponding to the audio signal generated by the computer.

As thus described, the computer can easily be connected to the television receiver by the use of said adapter. Accordingly, the television receiver can be easily adapted for the purpose of the program stored in the memory inside of the cartridge. In addition to this, the television receiver can be easily adapted for a variety of purposes simply by changing the cartridge inserted into the adapter.

Also, by the use of the adapter, the computer can be easily connected to the television receiver which is widely distributed and used by any person, and therefore it is possible to alleviate the economic burden on the user while the user can use the computer without circumstance.

Incidentally, since a personal computer cannot be used alone without peripherals such as a monitor, the user has to provide a set of a personal computer with all the necessary peripherals, and therefore a computer can not necessarily be used without circumstance even with the recent price plummet of personal computers. Also, while it is troublesome to use a monitor connected to a personal computer by installing an exclusive device driver, which is usually indispensable for operating the monitor, such troublesome installation can be dispensed with by the use of the above adapter since the adapter is connected to the television receiver without installing a device driver to improve the convenience of the user. Furthermore, in the usual case, a variety of functions are installed in a personal computer to have the versatility with many unnecessary functions which are burdensome for the user and boost the price. Contrary to this, the user of the present system possessing this adapter can adapt the television receiver for his purpose only by purchasing the corresponding cartridge, while few unnecessary function for the user is installed to remove botheration.

Furthermore, since the computer outputs a video signal and an audio signal in such signal formats that the television receiver receives the video and audio signals, displays an image and outputs a sound respectively corresponding to the video and audio signals, the user can continue using the adapter without extension or modification even when the functionality of the computer is upgraded or modified. In other words, even when the functionality of the computer is upgraded or modified, the user can continue using the existing adapter in the way as it is without awareness of the extension and modification of hardware and software simply by inserting into the adapter the cartridge equipped with the built-in computer which is upgraded or modified. As a result, it is possible to improve user-friendliness and alleviate the economic burden on the user, and therefore to promote the spread of the cartridges.

Incidentally, in the case of the game machine disclosed in Patent document 1, the VDG having an ability of generating video signals is implemented within the game console itself, and therefore, when the CPU in a game cartridge is upgraded or modified, the game console must be upgraded or modified in functionality corresponding to the upgrade or modification of the game cartridge. As a result, in the case of the game machine of Patent document 1, the user has to purchase a new game cartridge together with a new game console so that a substantial economic burden is imposed on and botheration is caused to the user while the specification and operation procedure of the game console may be changed. This is true for the personal computer disclosed in Patent document 2. The reason is because the display control circuit for generating video signals is implemented within a docking station.

Also, since this adapter is designed to receive video signals and audio signals in such signal formats that the television receiver can receive the video and audio signals, display an image corresponding to the video signal, and output a sound corresponding to the audio signal, the computer can be employed for use in combination with the adapter as long as it is capable of outputting such signals, and therefore the developer of the cartridge can be freely and arbitrarily design the hardware and software configuration of the computer in accordance with a variety of purposes. As has been discussed above, unlike the existing personal computers and the game machines, the restraints on hardware and software by the platform can be removed, as much as possible, when designing the cartridge.

By the way, in the case of the existing personal computers, an application program must be designed for each of different platforms to be supported (for example, different operating systems) to increase the development cost. Also, in the case of the existing game machines, a game program must be designed for each of different platforms to be supported (for example, different game consoles).

Furthermore, this adapter is used with the cartridge in which a program is installed for a particular purpose. Because of this, unlike the personal processor module of Patent document 2 requiring the versatility, there is no need for a hard disk and it is possible to reduce the performance required of the computer. As a result, it is possible to reduce the cost of the cartridge to be inserted into the adapter as compared with the personal processor module having the versatility.

Preferably, the adapter further comprises: an internal power supply voltage generation circuit operable to generate an internal power supply voltage on the basis of an external power supply voltage as supplied from an external source; and a power supply voltage output terminal through which the computer is supplied with said inner power supply voltage as generated by said internal power supply voltage generation circuit.

In accordance with this adapter, the power supply voltages required for operating the computer and peripheral circuits inside of the cartridge can be supplied from the adapter so that there is no need for a power supply circuit in the cartridge. Therefore, the cost of the cartridge can be reduce. On the other hand, while the cost of the adapter tends to increase in this configuration, it is outweighed by the economic effect of the cost reduction of the cartridges which are frequently purchased in accordance with different purposes since the adapter can be commonly used for the cartridges.

Furthermore, preferably, said internal power supply voltage generation circuit generates a plurality of power supply voltages having different output levels respectively as said internal power supply voltage; and wherein a plurality of output terminals are provided respectively as said power supply output terminal for supplying said plurality of internal power supply voltages having different output levels respectively to said computer.

In accordance with this adapter, since the cartridges can be designed to operate with various power supply voltages, the design freedom can be increased.

Furthermore, preferably, the adapter further comprises: a second video signal input terminal through which a video signal is externally received; a second audio signal input terminal through which an audio signal is externally received; a first switching circuit having a first contact, a second contact and a third contact; a second switching circuit having a fourth contact, a fifth contact, and a sixth contact; and a third switching circuit having a seventh contact, an eighth contact, and a ninth contact, wherein said first contact is connected to said video signal output terminal; said fourth contact is connected to said audio signal output terminal; and said seventh contact is connected to a first line through which said external power supply voltage is supplied, and wherein said second contact is connected to a second line which is connected to said first video signal input terminal; said fifth contact is connected to a third line which is connected to said first audio signal input terminal; and said eighth contact is connected to a fourth line which is connected to said internal power supply voltage generation circuit, and wherein said third contact is connected to said second video signal input terminal; said sixth contact is connected to said second audio signal input terminal; and said ninth contact is in a high impedance state, and wherein when said seventh contact is connected to said eighth contact, then said first contact is connected to said second contact, and said fourth contact is connected to said fifth contact, and wherein when said seventh contact is connected to said ninth contact, then said first contact is connected to said third contact, and said fourth contact is connected to said sixth contact.

In accordance with this adapter, when it is not needed to supply a power supply voltage to the cartridge, i.e., when the cartridge is not used, the seventh contact and the ninth contact of the third switching circuit are connected to each other so that the first line for supplying the external power supply voltage assumes a high impedance state. On the other hand, the first contact and third contact of the first switching circuit are connected to each other so that the video signal output terminal is connected to the second video signal input terminal, while the fourth contact and sixth contact of the second switching circuit are connected to each other so that the audio signal output terminal is connected to the second audio signal input terminal. Accordingly, when the cartridge is not used, it is possible to output the video signals and the audio signals as input from the external device to the television receiver. Therefore, the adapter can be applied for wider purposes. Also, while there may be users who have the adapter always connected to the television receiver, a shortage of the input terminals of the television receiver can be avoided by this configuration. In other words, since the adapter is provided with the second video signal input terminal and the second audio signal input terminal, the number of available input terminals is not decreased even if the adapter is connected to the input terminal of the television receiver.

The adapter may further comprises a rod-like member, wherein said first switching circuit, said second switching circuit and said third switching circuit are combined to form a switch unit, and wherein said switch unit is opened and closed by abutting said rod-like member against said switch unit.

In accordance with this adapter, since the wiring configuration can be simplified, it is possible to reduce the manufacture cost and improve the reliability. The details are as follows. Taking into consideration the user's convenience and the external appearance, it seems reasonable that the power supply button which is manipulated by the user is located in the front face of the adapter while the respective terminals are located in the back face of the adapter. Then, the switch unit serves not only to turn on and off the power supply but also connect and disconnect the respective terminals therebetween. Accordingly, if the switch unit is located in the front face side of the adapter, many wirings must be arranged from the back face side of the adapter to the front face side of the adapter. However, while the switch unit is located in the back face of the adapter, it is possible to control the opening and closing of the switch unit in the front face side by making the rod-like member come in contact with the switch unit from the front face side. Therefore, complicated wirings can be dispensed with. Eventually, it is possible to inhibit noise or the like from affecting the system.

Preferably, the adapter further comprises an AC/DC converter operable to convert an AC power supply voltage into a DC power supply voltage, and outputs the DC power supply voltage to said internal power supply voltage generation circuit.

In accordance with this adapter, since an AC power supply voltage is internally converted to a DC power supply voltage in accordance with this adapter, unlike in the case where an AC power supply voltage is supplied from an external AC adapter, it is avoided that the user connects an inappropriate AC adapter having a different specification with the adapter by oversight, and therefore the reliability can be improved.

Furthermore, preferably, the adapter further comprises: a clock oscillator circuit operable to generate a clock signal at a predetermined frequency; and a clock signal output terminal through which said clock signal is supplied to said computer.

In accordance with this adapter, the adapter serves to supply a clock signal which is required for operating the computer and other circuitry implemented within the cartridge connected to the adapter, and therefore a clock oscillator circuit need not be provided in the cartridge. Accordingly, the cost of the cartridge can be reduced. On the other hand, while the cost of the adapter tends to increase in this configuration, it is outweighed by the economic effect of the cost reduction of the cartridges which are frequently purchased in accordance with different purposes since the adapter can be commonly used for the cartridges.

More preferably, the adapter further comprises: an internal power supply voltage generation circuit operable to generate a plurality of internal power supply voltages having different output levels on the basis of an external power supply voltage as supplied from an external source; a clock oscillator circuit operable to generate a clock signal at a predetermined frequency; and a clock signal output terminal through which said clock signal is supplied to said computer, wherein said internal power supply voltage generation circuit supplies said clock oscillator circuit with an inner power supply voltage having a maximum output level from among said plurality of internal power supply voltages having different output levels.

In accordance with this adapter, since the clock signal is generated from the internal power supply voltage which has the maximum level, the cartridge can be designed to operate with a clock signal having a large amplitude so that the design freedom can be increased. On the other hand, the cartridge can be designed to operate with a clock signal having a smaller amplitude by providing a circuit for changing the amplitude of the clock signal.

The second inner circuit may be provided with a frequency characteristic adjustment circuit operable to adjust or modify the frequency characteristics of said audio signal as input from said computer and outputs said audio signal as adjusted to said audio signal output terminal.

In accordance with this adapter, the frequency characteristics are improved so that it is possible to output high quality audio signals to the television receiver. In addition to this, the frequency characteristic adjustment functionality need not be provided in the cartridge, so that the cost of the cartridge can be reduced. On the other hand, while the cost of the adapter tends to increase in this configuration, it is outweighed by the economic effect of the cost reduction of the cartridges which are frequently purchased in accordance with different purposes since the adapter can be commonly used for the cartridges.

Preferably, the adapter further comprises: an infrared signal receiver circuit operable to externally receive an infrared signal and convert the infrared signal into an electrical signal; and a terminal through which the electrical signal from said infrared signal receiver circuit to said computer.

In accordance with this adapter, the infrared signals received by the adapter can be transferred to the cartridge. Accordingly, the program stored in the cartridge can be designed in order to use the information of infrared signals so that a wider variety of applications can be implemented in the cartridge.

Furthermore, preferably, the adapter further comprises a doughnut-shaped optical lens, wherein said lens is located to face a light receiving section of said infrared signal receiver circuit.

In accordance with this adapter, it is possible to focus infrared rays incident from a wider range of directions by the use of the doughnut-shaped optical lens to expand the light receiving range of the infrared sensor.

More preferably, this lens is integrally formed with an infrared filter which is located on a light path toward said light receiving section of said infrared signal receiver circuit.

In accordance with this adapter, the setting of the lens can be performed by installing the infrared filter, and therefore it is possible to reduce the number of steps of the manufacturing process.

Preferably, the adapter further comprises: a predetermined number of switching circuits; a parallel/serial conversion circuit operable to convert on/off signals as input in parallel from said predetermined number of switching circuits to serial signals, wherein the number of the input terminals of said parallel/serial conversion circuit is more than said predetermined number.

In accordance with this adapter, since the remaining input terminals other than the input terminals for use in the parallel/serial conversion can be used, it is possible to provide additional inputs, and therefore the extensibility is improved.

The cartridge in accordance with the second aspect of the present invention is a cartridge connectable to the adapter in accordance with the first aspect as described above, comprises: a memory storing a program and data; and a computer capable of performing an arithmetic operation by the use of said program with said data in order to generate a video signal in such a signal format that said television receiver receives said video signal and displays an image corresponding to said video signal and generate an audio signal in such a signal format that television receiver receives said audio signal and outputs a sound corresponding to said audio signal.

This cartridge has similar advantages as the adapter in accordance with the first aspect.

Preferably, the cartridge further comprises an imaging unit operable to take an image of an object and output the video signal as taken to said computer.

In accordance with this cartridge, while the memory thereof can be used to store a program handling the image of the object as taken, a wider variety of applications can be implemented in the cartridge.

The cartridge in accordance with the third aspect of the present invention comprises: a memory storing a program and data; a computer capable of performing an arithmetic operation by the use of said program with said data in order to generate a video signal in such a signal format that said television receiver receives said video signal and displays an image corresponding to said video signal and generate an audio signal in such a signal format that the television receiver receives said audio signal and outputs a sound corresponding to said audio signal; and a clock amplitude changing circuit operable to change the amplitude of said clock signal as output from said clock oscillator circuit.

This cartridge can be operated even with the clock signal as input from the adapter which is different from that required of the inside of the cartridge.

The computer system in accordance with the fourth aspect of the present invention comprises: a cartridge which contains a memory storing a program and data, and a computer capable of performing an arithmetic operation by the use of said program with said data, generating a video signal in such a signal format that said television receiver receives said video signal and displays an image corresponding to said video signal and generating an audio signal in such a signal format that television receiver receives said audio signal and outputs a sound corresponding to said audio signal; and an adapter into which said cartridge can be installed and which can be connected to said television receiver, and said adapter comprises: a video signal input terminal through which said video signal is received from said computer; an audio signal input terminal through which said audio signal is received from said computer; a video signal output terminal through which said video signal input from said computer is output to said television receiver; an audio signal output terminal through which said audio signal input from said computer is output to said television receiver; and an inner circuit operable to receive said video signal from said video signal input terminal and output said video signal to said video signal output terminal, and receive said audio signal from said audio signal input terminal and output said audio signal to said audio signal output terminal.

This computer system has similar advantages as the adapter in accordance with the first aspect.

The adapter in accordance with the fifth aspect of the present invention comprises: a cartridge installation interface provided with a connector section which is composed of a plurality of connection terminals including a first connection terminal and a second connection terminal, and connectable to a cartridge which serves a predetermined function and has a connector designed in a predetermined configuration; a first and a second signal output terminal each of which can be connected to a plug designed in a predetermined configuration; a first inner circuit by which said first connection terminal and said first signal output terminal are connected to each other; and a second inner circuit by which said second connection terminal and said second signal output terminal are connected to each other, wherein signals as input from said cartridge through said connector and said connector section are output to an external device through said first connection terminal and said first signal output terminal and through said second connection terminal and said second signal output terminal.

The transmission of signals from the cartridge to an external device can be relayed through the first and second connection terminals of the connector section and the first and second signal output terminals. In this simple configuration, the signals from the cartridge can be transmitted for any purpose to an external device, so that the destination of the processing result of the cartridge can be easily changed.

Preferably, the cartridge installation interface includes: a cartridge support member operable to stably support the cartridge; and an urging mechanism operable to urge said cartridge support member in a predetermined direction and restrict the amount of the movement of said cartridge support member in the direction opposed to said predetermined direction; said connector section is located in a position such that it can be connected to the connector of said cartridge when said cartridge support member supporting the cartridge is pushed in the direction opposed to said predetermined direction to a position in which the movement of said cartridge support member is restricted by said urging mechanism.

The cartridge is supported by the cartridge support member, pushed in the predetermined direction, and stopped in the position in which the connector of the cartridge can be inserted into the connector of the adapter while the cartridge is restrained against further moving. Accordingly, the cartridge can be easily inserted into the adapter.

Furthermore, preferably, the cartridge support member includes a plate-like member in a predetermined shape.

Since the plate-like member in a predetermined shape is used to form a cartridge support member, the cartridge in the form of a plate can be stably supported by the cartridge support member. Also, the handling of the cartridge and the operation of pushing the cartridge in the predetermined directional are easy, so that the cartridge can be easily inserted.

More preferably, the connector of said cartridge is connected to said connector section of said cartridge installation interface by sliding the cartridge supported by said cartridge support member toward said connector section after said cartridge support member is pushed to a position in which the movement is restricted by said urging mechanism.

The cartridge can be connected to the connector of the adapter only by simple steps of placing the cartridge on the cartridge support member, pushing down the cartridge and then sliding the cartridge placed on the cartridge support member toward the connector of the adapter.

In an embodiment, the adapter is provided with a housing in the form of a flat rectangular parallelepiped having an upper surface, a bottom surface, left and right side surfaces, a front surface, and a back surface, wherein an opening is formed on said upper surface for receiving said cartridge, and wherein said cartridge installation interface is located in said opening of said upper surface.

After placing the cartridge on the upper surface of the housing of the adapter, the cartridge can be inserted into the adapter by placing on the decoration plate, pushing down and then sliding it. The pushing down operation of the cartridge can be performed in a stable and reliable manner as compared with the manipulation of pushing in the lateral direction. For this reason, it is possible to stably and surely perform the insertion operation of the cartridge. Also, in the case where the cartridge is inserted into the installation interface simply by sliding the cartridge in the longitudinal direction, generally speaking, a certain type of mechanism must be provided for disconnecting the cartridge. However, when the cartridge is slid after pushing down in such a manner, such a disconnecting mechanism is not needed. Also, in the configuration that the cartridge is pushed inwardly from the upper surface of the adapter, the upper surface of the cartridge being used is exposed to the upper surface of the adapter during operation. Accordingly, it is possible to provide a variety of accessories such as an image sensor or the connector for connecting an additional cartridge on the upper surface of the cartridge. As a result, there are a wider variety of applications which are feasible with this cartridge.

Preferably, the cartridge installation interface includes: a top plate located in said opening of said upper surface and having a principal surface on which the cartridge is placed; and an urging mechanism operable to support said top plate in order that said principal surface of said top plate is approximately flush with said upper surface of said housing while urging said top plate in the upward direction and restricting the amount of the movement of said top plate in the downward direction, wherein said connector section is located in a position such that it can be connected to the connector of said cartridge by pushing down the cartridge placed with said connector oriented in the predetermined direction toward said bottom surface to a position in which the movement of said cartridge support member is restricted by said urging mechanism, and sliding the cartridge in said predetermined direction.

The top plate is usually supported by the urging mechanism in order to be flush with the upper surface of the adapter, so that the external design of the adapter becomes neat from the aesthetic viewpoint. Also, since the top plate is urged by the urging mechanism in the upward direction, the cartridge is automatically elevated together with the decoration plate after the cartridge is slid in order to disconnect the cartridge. The cartridge can be easily removed.

More preferably, said predetermined direction is the direction toward said front surface of said housing.

The user is usually considered to insert the cartridge before the front face of the adapter, so that he can easily confirm the correct direction of the cartridge by placing the cartridge in order that the connector thereof faces forward. There is a small possibility that the cartridge is placed in a wrong direction.

More preferably, the cartridge is provided with a housing in the form of a flat rectangular parallelepiped which can be installed into said opening of said adapter and provided with an upper surface, a lower surface, opposite side surfaces, a front surface, and a back surface, wherein an indent section in a predetermined shape is formed on at least one of said opposite side surfaces. The adapter further comprises: an engagement member which can enter into said indent section of the predetermined shape and fix said cartridge by fitting into said indent section; and an engagement member support mechanism operable to support said engagement member in said adapter in order that, when said top plate of said cartridge installation interface is located in a position in which the movement thereof is restricted by said urging mechanism said engagement member is protruded into said opening of said housing of said adapter, and when said top plate of said cartridge installation interface is located in elsewhere than the position said engagement member moves out of said opening, wherein said indent section is formed in such a geometry that said engagement member does not interfere with any other member of said cartridge during sliding said cartridge in the front-back direction when said cartridge is installed into said cartridge installation interface of said adapter.

When the cartridge is installed, i.e., when the top plate of the cartridge installation interface is located in a position where it is restrained by the urging mechanism, the engagement member enters the indent section of the side surface of the cartridge by the engagement member support mechanism. The cartridge is restrained against vertical movement by the engagement member. Because of this, the cartridge is prevented from being pushed up by the bias force of the urging mechanism to lower the risk that the cartridge is disconnected from the adapter when not desired. Also, the indent section is formed in a shape such that the engagement member do not hinder the motion of the cartridge when the cartridge is horizontally slid. Accordingly, there is no obstacle for intentionally inserting and pulling the cartridge.

The indent section may be formed in both the opposite sides of said cartridge while said engagement member comprises a plurality of members which can enter into said indent sections of the respective opposite sides of said cartridge.

The cartridge can be prevented from moving in the vertical direction of the cartridge by the indent sections and the engagement member. The cartridge can be securely fixed to the adapter.

Preferably, said urging mechanism includes: a plurality of urging members each of which has a first and a second end portion; and a support member having a plurality of connection sections to which said first end portions of said plurality of the urging members are respectively connected for supporting said top plate from the bottom. The bias force of the plurality of the urging members is exerted on the top plate through the support member. Therefore, it is possible to urge the top plate in the upward direction while the top plate is stably supported allowing the movement in the upward and downward directions.

More preferably, a plurality of bottom connection sections, to which said second end portions of said plurality of the urging members are respectively connected, are formed on the bottom surface of said housing of said adapter.

The second end portions of the urging members can be attached to the bottom connection sections formed on the bottom surface of the housing of the adapter. It is possible to attach the urging mechanism to the predetermined locations of the bottom surface of the housing of the adapter, and therefore to stably support the top plate by the urging mechanism.

Furthermore, preferably, each of said plurality of the urging members includes: a pivotable member which is pivotally attached to one of said plurality of the connection sections at said first end portion on the axis in parallel with the upper surface of said top plate, and pivotally attached to one of said plurality of the bottom connection sections at said second end portion on the axis in parallel with the above axis on which said pivotable member is pivotally attached at said first end portion; and a resilient member operable to urge said pivotable member in the upward direction at said second end portion. The resilient member may include a spring fitted onto the pivotable axis of said second end portion of said pivotable member in order to urge said pivotable member in the direction that it moves away from said bottom surface of said housing of said adapter.

The first end portion of each of the pivotable members as a constituent member of the plurality of the urging members is pivotally attached to the connection section of the support member on the axis in parallel with the upper surface of said top plate. Also, the second end portion is attached to the bottom connection section on the axis in parallel with the above axis. The pivotable member is urged by the resilient member such as a spring in the direction that it moves away from said bottom surface of the housing of said adapter. When the top plate is pushed down, the pivotable member pivots against the resilient force of the resilient member to move close to the bottom surface of the housing. As a result, the height of the support member is lowered toward the bottom surface of the housing, and when the pivotable member comes in contact with the bottom surface of the housing the support member no longer moves in the downward direction. When there is no force in the downward direction, the first end portion of the pivotable member moves depart from the bottom surface, i.e., in the upward direction by the resilient force of the resilient member to urge the support member in the upward direction. In this manner, the top plate is stably supported with a bias force exerted in the upward direction, and when pulled down in the downward direction while being stably supported, the top plate is restrained against movement in a predetermined position.

Preferably, said connector section comprises: a connector unit in the form of an approximately rectangular parallelepiped having an indented engagement section opened toward the front face of said rectangular parallelepiped in order to fit onto a protruding section formed on said cartridge; a shield member fixed to said connector unit in order to cover at least part of the upper surface of said connector unit; and a plurality of said connection terminals located in said indented engagement section, wherein said cartridge is provided with a protruded engagement section which can be fitted into said indented engagement section with a plurality of connection terminals to be in electric contact with the plurality of the connection terminals of said connector section, and a conductive shield member provided to cover the inner circuit of said cartridge while part of said shield member of said cartridge is attached to the inner upper surface of said indented engagement section of said cartridge, and wherein said shield member of said connector section is configured to come in contact with said shield member of said cartridge when said cartridge is installed into said connector section.

Furthermore, when the connector of the cartridge is connected to the connector section of the adapter, the contact members of the shield member fixed to the upper surface of the connector unit of the adapter are in contact with the shield member covering the inner circuitry of the cartridge at the portion located on the inner upper surface of the indented engagement section so that the connection therebetween is established over a wide area. By this connection, it is possible to stabilize the electric connection between the adapter and the cartridge and avoid trouble in the transmission and reception of signals. Also, in the case where the connection is made only by lines, a differential potential may be generated between the ground potential of the cartridge and the ground potential of the adapter (which is relatively stable) so that the ground potential of the cartridge is not stable. If the ground potential of the cartridge is not stable, there is the possibility that the transmission and reception of signals becomes unstable between the cartridge and the adapter. Also, there is the possibility that the potential of the shield member itself fluctuates during the operation of the inner circuit of the cartridge to radiate electromagnetic waves. By virtue of the connection established over a wide area between the cartridge and the connector of the adapter, it is possible to maximally reduce the differential potential between the ground potential of the cartridge and the ground potential of the adapter, i.e., to stabilize the ground potential of the cartridge.

More preferably, the back portion of said upper surface of said connector unit is formed lower than the front portion of said upper surface, wherein said shield member of said connector unit is provided with an opening in order to form a contact member having one end fixed to said front portion of said upper surface and the other end located in said lower portion of said upper surface of said connector unit.

The shield member of the connector is urged in the downward direction by coming in contact with the shield member of the cartridge at the portion located on the inner upper surface of the indented engagement section. The shield member of the connector can move in the downward direction above the lower portion of the upper surface of the connector unit and is prevented from coming in strong contact with the shield member of the cartridge and suffering from physical failure which would be caused by the strong contact.

Furthermore, preferably, said contact member is formed to have a predetermined point which is remotest from the upper surface of said connector unit between said one end and said the other end.

In this configuration, the shield member of the connector section can surely be in contact with the shield member of the cartridge at the contact members. Also, while a portion of the shield member of the connector section extending over the contact member moves in the downward direction, physical failure of the shield member of the connector is avoided also in this case because a portion of the upper surface of the connector unit is formed lower.

The cartridge in accordance with the sixth aspect of the present invention comprises: a memory storing a program and data; a computer capable of performing an arithmetic operation by the use of said program with said data, generating a video signal in such a signal format that said television receiver receives said video signal and displays an image corresponding to said video signal and generating an audio signal in such a signal format that television receiver receives said audio signal and outputs a sound corresponding to said audio signal; and a connector that is connected to said computer and operable to supply an external device with said video signal and audio signal as output from said computer; and a housing containing said memory and said computer and said connector attached thereto in order that a contact portion of said connector is located in a surface of said housing.

In accordance with this cartridge, it is possible to supply the external device, through the connector, with video signals and audio signals as generated by the computer in accordance with the data and program stored in the inner memory. The result of the program running in the cartridge can be used by transferring signals generated by the cartridge having no display device to an external device, such as the television receiver or an intermediary device. The memory is installed, as well as a program, in the cartridge which outputs video signals and audio signals in such signal formats that the television receiver can display an image and output a sound respectively corresponding to the video and audio signals, so that the cartridge can be used irrespective of the actual configuration of the television receiver. Furthermore, in the case where an intermediary device is used, since the memory and the computer are installed in the cartridge, the same intermediary device can be used to implement substantially different functions. Still further, when the performance of the computer in the cartridge is improved, the functionality of the improved computer can be fully available irrespective of the configuration of the intermediary device.

Preferably, the cartridge further comprises a dust entry prevention member located in an opening in which connection terminals are provided and operable to prevent external dust from entering the inside of said cartridge through said opening.

This dust entry prevention member serves to prevent external dust from entering the inside of the cartridge through the connector. The cartridge includes several components such as the memory and the computer which are relatively susceptible to external dust, and therefore this member is effective to lower the risk of causing failure due to external dust.

Furthermore, preferably, said housing comprises: a housing main body having an inside space with an opening in one side thereof; a top plate that is formed in such a shape as to cover the most part of said opening of said housing, and can be temporarily fixed to a position to cover said opening a fixation member having a claw portion protruded in order that it is fixedly hooked to a predetermined inner portion of said housing through a portion of said opening of said housing which is not covered by said top plate for securely fixing said temporarily fixed top plate to said housing main body.

Without the use of screws and the like which spoil the appearance of the cartridge, the top plate is fixed to the housing by hooking the top plate to predetermined sections inside of the housing over the top plate. Furthermore, since the fixation member is fixed to the housing by hooking the claw portion, this fixation member can be easily removed and therefore the top plate can be also easily removed so that the maintenance of the cartridge is facilitated.

Preferably, said housing main body is provided with an opening through which a tool can be inserted in order to detach said claw portion from said predetermined portion after said claw portion of said fixation member is fixedly hooked to the predetermined inner portion of said housing.

The fixation member and the top plate can be easily removed from the housing by inserting a pointed member into the opening to unhook the claw portion from the edge of the upper housing.

More preferably, fixation sections are provided on the inside of said housing in a plurality of positions in order that any one of constituent elements, which are functionally corresponding to each other but have different sizes, can be installed by selecting one or more of said fixation sections.

For example, there may be a plurality of types of boards, shield members and the like respectively having different sizes to be installed in the cartridge. By forming the fixation sections to receive any one of a plurality of different sizes in advance, it is possible to use the same housings for manufacturing a variety of products with boards, shield members and the like respectively having different size. As a result, it is possible to simplify the manufacturing process and quickly launch the production without need for redesigning the housing for the respective products.

In an embodiment, a first locking groove is formed on each of the opposite side surfaces of said housing in a position displaced toward the back face of said housing from the center of said each of the opposite side surfaces in order that part of a locking member for use in fixing said cartridge in a predetermined position is inserted into said first locking groove. This first locking groove may comprise a first groove in the form of a rectangle having a predetermined height and a predetermined width respectively larger than the height and width of said part of the locking member, and a second groove in the form of a rectangle adjoining said first groove and having a height slightly larger than the height of said part of the locking member and smaller than said predetermined height of said first groove and a predetermined width.

If the cartridge is placed in the correct direction when the cartridge is inserted into the adapter and the like, the cartridges can be surely restrained against movement in the vertical direction by, after part of the locking member enters the first locking groove from the right and left sides, sliding the cartridge toward the front face in order that said part of the locking member enters the inside of the second grooves.

A second locking groove is formed on each of the opposite side surfaces of the housing in a position opposite the first locking groove symmetrically with respect to the center line perpendicular to the opposite sides in order that part of a locking member for use in fixing the cartridge in a predetermined position is inserted into the second locking groove, and wherein the second locking groove has a height and a width which are selected in order that the part of the locking member is inserted into the second locking even if the cartridge is placed backwards in the predetermined position.

In the above configuration, even if the cartridge is inserted backwards into the adapter, it is avoided that the engagement member holds the cartridge in the location apart from the locking groove, and that the cartridge can no longer be pulled out from the adapter.

The height and width of the first locking groove and the height and width of the second locking groove are selected respectively in order that the part of the locking member is inserted into the first locking groove or the second locking groove even if the cartridge is placed upside down in the predetermined position.

In the above configuration, even if the cartridge is inserted backwards and also upside down into the adapter, it is avoided that the cartridge can no longer be pulled out from the adapter.

The input device in accordance with the seventh aspect of the present invention is a bowling ball type input device for an electric game machine comprising: a housing in the form of a bowling ball; and an input device installed in the housing, wherein a plurality of finger holes are formed in positions arranged appropriate for fitting a predetermined size of hands while an additional finger hole to be used in place of one of the plurality of finger holes is formed in a position arranged appropriate for fitting a size of hands which is smaller than the predetermined size.

Since a plurality of the finger holes are formed to fit hands of a predetermined size, it is possible for the user having hands of an average size to easily gesture a throwing motion of the bowling ball by the use of the finger holes. On the other hand, for the user having smaller hands than the average, for example, for a child, it is possible to easily gesture a throwing motion of the bowling ball by the use of the finger holes and the additional finger hole. Therefore, the user can enjoy the bowling game by selecting appropriate finger holes for his hand size.

The input device in accordance with the seventh aspect of the present invention is a bowling ball type input device for an electric game machine comprising: a first outer shell housing which is hollow and provided with indent sections serving as finger holes; a second outer shell housing which is hollow and provided with protruding sections for fixation whose distal ends are located in order to come in contact with the indent sections when joined with the first outer shell housing; a first inner shell housing which is hollow and provided with openings corresponding to the indent sections of the first outer shell housing; and a second inner shell housing which is hollow, provided with openings corresponding to the protruding sections for fixation of the first outer shell housing, and can be fixed to the first inner shell housing by a predetermined number of fastening members, wherein the first and second inner shell housings are fixed to each other by the predetermined number of fastening members in order to form an inner shell, wherein the inner shell is covered by the first outer shell housing in order that the indent sections of the first outer shell housing are inserted through the openings formed in the first inner shell housing of the inner shell, wherein the inner shell is covered by the second outer shell housing in order that the protruding sections for fixation of the second outer shell housing are inserted through the openings formed in the second inner shell housing of the inner shell, and wherein the indent sections of the first outer shell housing are fixed to the protruding sections for fixation of the second outer shell housing by predetermined fastening members.

The outer shell of the bowling ball type input device is formed with the inner shell held inside thereof by fixing the finger holes of the first outer shell housing to the protruding sections for fixation of the second outer shell housing. The fastening members are located in the bottom portion of the finger holes and therefore cannot be viewed from the outside. Besides them, any other such member is not used at least for fixing the outer shell. Because of this, a smart design of the bowling ball type input device can be provided.

Preferably, both the first and second outer shell housings are formed transparent.

By making transparent the outer shell housing, it is possible to externally use optical members provided on the inner shell housing by external light. On the other hand, the input device looks interesting in design since the inner shell housing appears through the outer shell.

Furthermore, preferably, a retroreflective member is attached to the outside of the inner shell housing.

With the retroreflective member attached to the inner shell housing, it is possible for an external device to obtain the position, velocity and acceleration of the input device by the light reflected from this member and make use of the information for the game. Also, there is no need for particular electric circuits in the bowling ball type input device itself so that the configuration can be simplified.

The input device in accordance with the ninth aspect of the present invention is an input device operable to detect acceleration and input predetermined information about the acceleration to a predetermined device, the input device comprising: a housing; an acceleration sensor attached to the housing; an acceleration sensor circuit operable to output a signal which varies in voltage level in correlation to the acceleration as detected by the acceleration sensor on the basis of an external signal having a predetermined voltage waveform and the output of the acceleration sensor; a circuit operable to output the predetermined information on the basis of the signal as output from the acceleration sensor circuit; a judgment circuit operable to judge whether or not the acceleration sensor circuit detects acceleration and output a judgment signal; and a signal supply control circuit operable to start or stop supplying the external signal having the predetermined voltage waveform to the acceleration sensor circuit in accordance with the judgment signal as output from the judgment circuit.

When acceleration is not detected, the signal supply control circuit shuts off supply of signals to the acceleration sensor circuit, and once acceleration is detected, signal supply is started so that it is possible to output the information about acceleration. It is therefore possible to provide the input device of which the power consumption is saved when not operated while, once operated, the system is activated.

The input device in accordance with the tenth aspect of the present invention is a bat type input device for an electric game machine comprising: a head assembly; and a grip section having a threaded portion which can be threaded with a threaded portion formed on the head assembly in order to fix the grip section to the head assembly by the threaded portions, wherein the head assembly comprising: a first member which is hollow; a second member which is fixed to the first member by a plurality of fastening members; and electric circuitry operable to generate control signals which is output to the electric game machine, wherein the first member and the second member are combined with a control unit containing the electric circuitry inside thereof, the head assembly further comprising: a cap fitted onto the control unit in order to cover at least part of the control unit and hide the plurality of fastening members.

The plurality of fastening members used in assembling the control unit become invisible by fitting the cap onto the control unit. Also, the grip section is fixed to the head assembly by the threaded portions and which are also invisible externally. Accordingly, it is possible to provide the bat type input device which is so good from the aesthetic viewpoint without externally visible fastening members such as screws.

The pixel data acquiring method in accordance with the eleventh aspect of the present invention is a method of acquiring pixel data which is pixel data corresponding to one frame in accordance with a frame status flag signal indicative of starting the acquisition of the pixel data corresponding to one frame and a pixel strobe signal indicative of starting the acquisition of ach pixel data, and storing the pixel data to an address designated by an X coordinate and a Y coordinate of a predetermined storage device. The pixel strobe signal is issued also when the start of acquiring the pixel data corresponding to one line is indicated. This method comprises: a step of initializing the value of the Y coordinate to a predetermined initial value; a step of waiting for the frame status flag signal to take a predetermined value; and a step of acquiring pixel data corresponding to one frame in response to the frame status flag signal of the predetermined value. The step of successively acquiring pixel data corresponding to one frame includes a step of successively acquiring pixel data corresponding to one frame as designated by each Y coordinate while incrementing the Y coordinate by a predetermined amount from a predetermined initial value to a predetermined maximum value. The step of successively acquiring pixel data comprising: a step of waiting for said pixel strobe signal to take a predetermined value; a step of initializing the value of the X coordinate to a predetermined initial value in response to said pixel strobe signal of said predetermined value; a step of acquiring pixel data each time it is judged that said pixel strobe signal takes said predetermined value while incrementing the value of the X coordinate by a predetermined amount to a predetermined maximum value, and successively storing the pixel data in the address designated by the value of the X coordinate and the value of the Y coordinate; a step of incrementing the value of the Y coordinate by said predetermined amount in response to the completion of the step of successively storing the pixel data; a step of judging whether or not said value of the Y coordinate reaches said maximum value; and a step of completing the step of successively acquiring pixel data in response to the judgment that said value of the Y coordinate reaches said maximum value.

When the frame status flag signal takes the predetermined value, the pixel data corresponding to one frame is acquired. In this step, while incrementing the Y coordinate from a predetermined initial value to a maximum value by a predetermined amount, the pixel data for one line designated by each Y coordinate is acquired in succession. The step of successively acquiring pixel data waits for the pixel strobe signal to take the predetermined value, the value of the X coordinate is initialized in response to the pixel strobe signal of the predetermined value. At this time, the pixel data is not stored yet. Thereafter, the pixel data is acquired while incrementing the X coordinate to the maximum value. When completing the acquisition of the pixel data for one line, the value of the Y coordinate is incremented by the predetermined amount. As a result, if the value of the Y coordinate reaches the maximum value, the step of sequentially acquiring is completed. When the pixel strobe signal takes the predetermined value for the first time, there is no effective pixel data so that this pixel strobe signal is skipped. Namely, while pixel data is not acquired when the pixel strobe signal takes the predetermined value for the first time, the actual acquisition of pixel data is started in the next time the pixel strobe signal takes the predetermined value. In the repeating process subsequent thereto for actually storing pixel data, the pixel data can be successively stored without initialization of the X coordinate since the value of the X coordinate has already been initialized. In the prior art technique, the X coordinate is initialized after the pixel data for one line is acquired and before the pixel strobe signal takes the predetermined value at the beginning of the next line. In the case of such a prior art technique, since a certain time is required for initializing the value of the X coordinate, when the pixel strobe signal takes the predetermined value at the beginning of the next line, this signal transition is sometimes missed. As a result, it often fails to acquire the first pixel data of each line. In accordance with the method of the present invention, the X coordinate is not initialized just after completing the acquisition of the pixel data for one line while waiting for the pixel strobe signal to take the predetermined value indicative of the start of the acquisition of the pixel data of the next line, and then the initialization of the value of the X coordinate is performed only just after the pixel strobe signal takes the predetermined value. Because of this, it is not missed when the pixel strobe signal takes the predetermined value, and therefore it rarely fails to acquire the pixel data.

The interactive entertainment system in accordance with twelfth aspect of the present invention comprises: a manipulation member that is manipulated by a user when the user is enjoying said interactive entertainment system; a cartridge including a memory that stores a program and data, and a signal processing unit that is connected to said memory and operable to run said program by the use of said data for generating signals indicative of images and sounds in accordance with the context of said interactive entertainment system; and an adapter that is to be placed in a position where said adapter faces the user when the user is enjoying said interactive entertainment system, provided with a wireless communication device for accepting input from the user in accordance with the action of the user by the use of said manipulation member, and connectable to a television receiver and said cartridge in order to receive said signals from said cartridge, and output video and audio signals to said television receiver for displaying said images and outputting said sounds in accordance with the context of said interactive entertainment system.

The video entertainment system in accordance with thirteenth aspect of the present invention comprises: a cartridge including a memory that stores a program and data and a signal processing unit that is connected to said memory and operable to run said program by the use of said data for generating analog video signals in accordance with the context of said video entertainment system; and an adapter connectable to a television receiver and said cartridge in order to receive said analog video signals from said cartridge and transfer said analog video signals to said television receiver for displaying images corresponding to said analog video signals on said television receiver in accordance with the context of said interactive entertainment system.

In accordance with an example of the video entertainment system, said adapter transfers said analog video signals to said television receiver without conversion.

In accordance with another example of the video entertainment system, said adapter transfers said analog video signals to said television receiver after encoding said analog video signals in accordance with the system of said television receiver.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a perspective external view showing an adapter and a cartridge in accordance with an embodiment of the present invention.

FIG. 2(a) is a front view showing the adapter of FIG. 1; FIG. 2(b) is a left side view showing the same; and FIG. 2(c) is a back side view showing the same.

FIG. 3(a) is a plan view showing the adapter of FIG. 1; and FIG. 3(b) is a bottom view showing the same.

FIG. 4 is an exploded perspective view showing the adapter of FIG. 1.

FIG. 5 is a perspective view showing the inside of the lower housing of FIG. 4.

FIG. 6 is a perspective view showing the inside of the upper housing of FIG. 4.

FIG. 7 is a cross sectional view along A-A line of FIG. 3(a).

FIG. 8 is a bottom view showing the adapter of FIG. 1 from which the lower housing is removed.

FIG. 9 is a plan view showing the adapter of FIG. 1 from which the upper housing and the decoration plate are removed.

FIG. 10 is a schematic diagram showing the elevator mechanism and the elevator board locking mechanism of FIG. 4.

FIG. 11(a) is a plan view showing the magnet holding member of FIG. 10; FIG. 11(b) is a left side view showing the same; FIG. 11(c) is a plan view showing the elevator board support member; FIG. 11(d) is a right side view showing the same; FIG. 11(e) is an explanatory view for showing the elevator board locking mechanism which is fully opened; and FIG. 11(f) is an explanatory view for showing the elevator board locking mechanism which is closed.

FIG. 12 is a perspective view showing the cartridge locking mechanism of FIG. 4.

FIG. 13(a) is an explanatory view for showing the cartridge locking mechanism of FIG. 4 as installed; and FIG. 13(b) is an explanatory view for showing the cartridge locking mechanism of FIG. 4 as installed.

FIG. 14 is a schematic diagram showing the push mechanism of FIG. 4.

FIG. 15(a) is a perspective view showing the infrared filter of FIG. 4; FIG. 15(b) is a plan view showing the inside of the infrared filter 19; and FIG. 15(c) is a cross sectional view along B-B line of FIG. 15(b).

FIG. 16(a) is a front view showing the connector of FIG. 4; FIG. 16(b) is a plan view showing the connector of FIG. 4; and FIG. 16(c) is a bottom view showing the connector of FIG. 4.

FIG. 17(a) is a perspective view showing a shield member of FIGS. 1(a) to (c); FIG. 17(b) is a perspective view showing a connector unit of FIGS. 16(a) to (c); and FIG. 17(c) is a perspective view showing the connector of FIGS. 16(a) to (c).

FIG. 18 is a cross sectional view along C-C line of FIG. 16(a).

FIG. 19(a) is an explanatory view for showing the elevator mechanism and the elevator board locking mechanism with the decoration plate of FIG. 7 on which the cartridge is not placed; FIG. 19(b) is an explanatory view for showing the elevator mechanism and the elevator board locking mechanism with the decoration plate on which the cartridge is placed; FIG. 19(c) is an explanatory view for showing the elevator mechanism and the elevator board locking mechanism with the decoration plate on which the cartridge is moved downward to the lowest position; and FIG. 19(d) is an explanatory view for showing the elevator mechanism and the elevator board locking mechanism with the decoration plate on which the cartridge is connected to the connector.

FIG. 20(a) is a view showing the engagement between the cartridge and the C-shaped member of the cartridge locking mechanism in the state of FIG. 19(b); FIG. 20(b) is a view showing the engagement between the cartridge and the C-shaped member of the cartridge locking mechanism in the state of FIG. 19(c); FIG. 20(c) is a right side view showing the state of FIG. 20(b); and FIG. 20(d) is a right side view showing the cartridge which is locked.

FIG. 21(a) is a plan view showing the cartridge of FIG. 1; FIG. 21(b) is a bottom view showing the cartridge; and FIG. 21(c) is a right side view showing the cartridge.

FIG. 22 is a cross sectional view along C-C line of FIG. 21(a).

FIG. 23 is an exploded perspective view showing the cartridge of FIG. 1.

FIG. 24(a) is a plan view showing the board of FIG. 23; and FIG. 24(b) is a right side view showing a connector section of the board.

FIG. 25 is a perspective view showing the dust entry prevention member of FIG. 23.

FIG. 26 is a view for explaining the use of the dust entry prevention member of FIG. 25.

FIG. 27 is a plan view showing the shield member of FIG. 23.

FIG. 28 is a plan view showing the inside of the lower housing of FIG. 23.

FIG. 29 is a perspective view showing the inside of the upper housing of FIG. 23.

FIG. 30 is a plan view showing the upper housing of FIG. 23.

FIG. 31 is a plan view showing the state that the top plate of FIG. 23 is fitted into the surface of the upper housing.

FIG. 32 is a perspective view showing the fixation member of FIG. 23.

FIG. 33 is a cross sectional view along D-D line of FIG. 21(a).

FIG. 34(a) is a plan view showing the board of FIG. 23; FIG. 34(b) is a plan view showing a medium size board which is lager in size than the board; FIG. 34(c) is a plan view showing a large size board which is lager in size than the medium size board; FIG. 34(d) is a plan view showing the shield member of FIG. 23; FIG. 34(e) is a plan view showing a medium size shield member which is lager in size than the shield member; and FIG. 34(f) is a plan view showing a large size shield member which is lager in size than the medium size shield member.

FIG. 35 is a perspective view showing an imaging unit equipped cartridge to be inserted into the adapter of FIG. 1.

FIG. 36(a) is a plan view showing the cartridge of FIG. 35; FIG. 36(b) is a bottom view showing the cartridge; and FIG. 36(c) is a right side view showing the cartridge.

FIG. 37 is a cross sectional view along E-E line of FIG. 36(a).

FIG. 38 is a cross sectional view along F-F line of FIG. 36(a) and showing only the imaging unit.

FIG. 39 is an exploded perspective view showing the imaging unit of FIG. 35.

FIG. 40 is a view for explaining the connection between the housing member and the base plate of FIG. 39.

FIG. 41 is an exploded perspective view showing the cartridge unit of FIG. 35.

FIG. 42 is a plan view showing the inside surface of the lower housing of FIG. 41.

FIG. 43 is a perspective view showing the inside of the upper housing of FIG. 41.

FIG. 44 is a view for explaining the procedure of attaching the top plate of FIG. 41 to the upper housing.

FIG. 45 is an explanatory view for showing an exemplary use 1 of the adapter of FIG. 1.

FIG. 46 is a plan view showing the racket type input device of FIG. 45.

FIG. 47 is an exploded perspective view showing the main body of the racket type input device of FIG. 46.

FIG. 48 is an exploded perspective view showing the grip portion of the racket type input device of FIG. 46.

FIG. 49 is a cross sectional view along G-G line of FIG. 46.

FIG. 50 is a perspective view showing the outer cap and the inner cap of FIG. 49 which are opened.

FIG. 51 is a plan view showing the outer cap and the inner cap of FIG. 49 which are closed.

FIG. 52 is a side view showing the outer cap and the inner cap of FIG. 49 which are opened and closed.

FIG. 53(a) is a plan view showing the bat type input device of FIG. 45; and FIG. 53(b) is a bottom view showing the bat type input device.

FIG. 54(a) is an explanatory views for showing the bat type input device of FIG. 45 after separation; FIG. 54(b) is an explanatory views for showing the bat type input device of FIG. 45 after separation; and FIG. 54(c) is an explanatory views for showing the bat type input device of FIG. 45 after separation.

FIG. 55 is a cross sectional view along H-H line of FIG. 53(b).

FIG. 56 is an expanded view showing area A of FIG. 55.

FIG. 57 is an expanded view showing area B of FIG. 55.

FIG. 58 is an expanded view showing area C of FIG. 55.

FIG. 59 is an explanatory view for showing the separation mechanism of the bat type input device of FIG. 45.

FIG. 60 is a perspective view showing the ball type input device of FIG. 45.

FIG. 61 is a plan view showing the ball type input device of FIG. 45.

FIG. 62 is a cross sectional view along I-I line of FIG. 61.

FIG. 63 is an explanatory view for showing an exemplary use 2 of the adapter of FIG. 1.

FIG. 64 is a perspective view showing the bowling ball type input device of FIG. 63.

FIG. 65 is a plan view showing the bowling ball type input device of FIG. 63.

FIG. 66 is a cross sectional view along J-J line of FIG. 65.

FIG. 67 is an exploded perspective view showing the bowling ball type input device of FIG. 63.

FIG. 68 is a perspective view showing the inside of the inner shell upper housing of FIG. 67.

FIG. 69 is a perspective view showing the inside of the inner shell lower housing of FIG. 67.

FIG. 70 is a plan view showing the inner shell upper housing and the inner shell lower housing as joined together.

FIG. 71 is a side view of the inner shell as viewed from arrow A of FIG. 70.

FIG. 72 is a side view of the inner shell as viewed from arrow B of FIG. 70.

FIG. 73 is a side view of the inner shell as viewed from arrow C of FIG. 70.

FIG. 74 is a bottom view showing the inner shell of FIG. 70.

FIG. 75 is a perspective view showing the inside of the outer shell upper housing of FIG. 67.

FIG. 76 is a schematic diagram showing the finger hole formation member of FIG. 67.

FIG. 77 is a perspective view showing the inside of the outer shell lower housing of FIG. 67.

FIG. 78 is a view showing the electric configuration of the adapter of FIG. 1.

FIG. 79 is a circuit diagram showing the power supply circuit and the power supply switch of FIG. 78.

FIG. 80 is a circuit diagram showing the internal power supply voltage generation circuit of FIG. 78.

FIG. 81 is a circuit diagram showing the audio amplifier of FIG. 78.

FIG. 82 is a circuit diagram showing the IR receiver circuit of FIG. 78.

FIG. 83 is a circuit diagram showing the key block of FIG. 78.

FIG. 84 is a circuit diagram showing the crystal oscillator circuit of FIG. 78.

FIG. 85 is a schematic diagram showing the electric configuration of the cartridge of FIG. 1.

FIG. 86 is a block diagram showing the high speed processor of FIG. 85.

FIG. 87 is a view showing the electric configuration of the cartridge of FIG. 35.

FIG. 88 is a view showing the electric configuration of the imaging unit of FIG. 87.

FIG. 89 is a timing diagram showing the operation of the high speed processor which receives pixel data from the image sensor of FIG. 88.

FIG. 90 is an expanded timing diagram showing part of FIG. 89.

FIG. 91 is a view showing the electric configuration of the racket type input device of FIG. 45.

FIG. 92(a) is a waveform diagram of the output signal from the output port of the MCU of FIG. 91; FIG. 92(b) is a waveform diagram of the input signal to the input port of the MCU; and FIG. 92(c) is an explanatory view for illustrating the input judgment by the MCU.

FIG. 93 is a flowchart showing the processing of the MCU of FIG. 91.

FIG. 94 is a flowchart showing the acceleration detection process in step S2 of FIG. 93.

FIG. 95 is a flowchart showing the code transmission process of step S5 of FIG. 93.

FIG. 96 is a flowchart showing the process flow of the virtual reality system for playing tennis by the use of the racket type input device of FIG. 45.

FIG. 97 is a flowchart showing the code reception process in step S109 of FIG. 96.

FIG. 98 is a flowchart showing the process flow of the virtual reality system for playing bowling by the use of the bowling ball type input device of FIG. 63.

FIG. 99 is a flowchart showing an example of the sensor initial setting process which is performed as a process of the initialization performed in step S201 of FIG. 98.

FIG. 100 is a flowchart showing one example of the command transmission process in step S231 of FIG. 99.

FIG. 101(a) is a timing diagram showing the register setting clock RCLK of FIG. 88; FIG. 101(b) is a timing diagram showing the register data of FIG. 88.

FIG. 102 is a flowchart showing one example of the register setting process in step S233 of FIG. 99.

FIG. 103 is a flowchart showing the imaging process of step S203 of FIG. 98.

FIG. 104 is a flowchart showing one example of the process of acquiring a set of pixel data in step S261 of FIG. 103.

FIG. 105 is a flowchart showing one example of the process of acquiring the pixel data shown in step S276 of FIG. 104.

FIG. 106 is a view showing an adapter 1000 in accordance with an exemplary modification of an embodiment of the present invention.

FIG. 107(a) is a side view showing the adapter 1000 shown in FIG. 106; FIG. 107(b) is a back side view thereof; and FIG. 167(c) is a bottom view thereof.

FIG. 108 is a perspective view showing the cartridge in accordance with an exemplary modification of an embodiment of the present invention.

FIG. 109 is a schematic diagram showing the power switch assembly inside of the adapter 1000.

FIG. 110 is a view showing the electric configuration of the adapter 1000.

FIG. 111 is a view showing the circuit configuration of the switching regulator 1058 shown in FIG. 110.

FIG. 112 is a circuit block diagram showing the circuit configurations of the expansion connector, extension connector peripheral circuit 1050 and key block 1052 shown in FIG. 110.

FIG. 113 shows the circuit configuration of the internal power supply voltage generation circuit 1056 as shown in FIG. 110.

FIG. 114 is an exploded view showing the bat type input device 1200 for use in an embodiment of the present invention.

FIG. 115 is an exploded view showing the head and the cap 1212 of the bat type input device 1200.

FIG. 116 is an inside plane view showing the button of the head of the bat type input device 1200.

FIG. 117 is a view showing the structure shown in FIG. 116 with the fastening member 1246 attached thereto.

FIG. 118(a) is a front view showing the button with which the head and the grip section of the bat type input device 1200 are assembled or disassembled; and FIG. 118(b) is a left side view thereof.

FIG. 119 is a cross sectional view showing the lower portions of the control unit 1210 of the head of the bat type input device 1200 with the cap 1212 fitted onto the control unit 1210.

FIG. 120 is a view showing the control unit 1210 of the head of the bat type input device 1200, onto which the cap 1212 is fitted, as viewed from the lower end direction of the head.

FIG. 121 is a perspective view showing the grip section 1214 of the bat type input device 1200.

FIG. 122 is a view showing the button 1222 of the head and the end portion of the grip section 1214 just before engagement.

FIG. 123 is a side view showing the grip section 1214 of which the end portion is engaged with the button 1222 of the head.

FIG. 124 is an internal plan view showing the control unit 1210 of the bat type input device 1200 as illustrated in FIG. 114 and FIG. 115.

### BEST MODE FOR CARRYING OUT THE INVENTION

In what follows, several embodiments of the present invention will be explained in conjunction with the accompanying drawings. Meanwhile, similar elements are given similar references throughout the respective drawings used for explaining the embodiments. Also, while various housings are used as follows, they are made of, for example, ABS (acrylonitrile butadiene styrene).

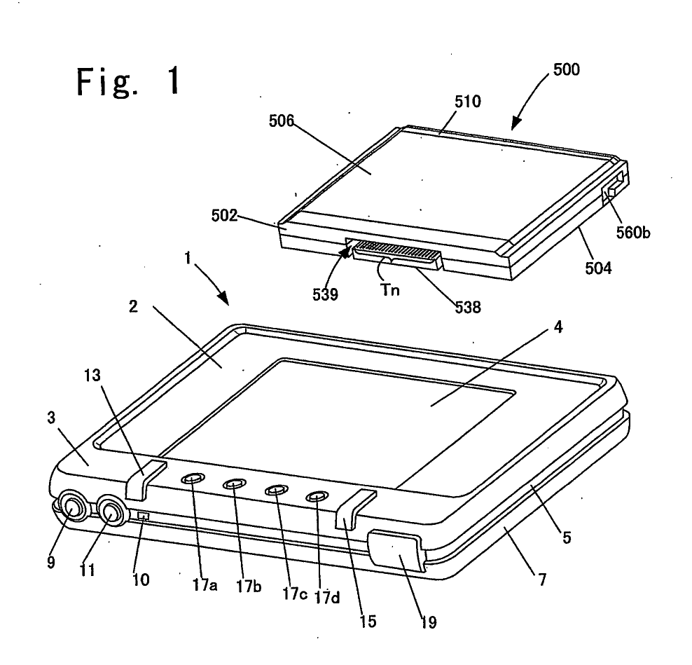

FIG. 1 is a perspective external view showing an adapter 1 and a cartridge 500 in accordance with an embodiment of the present invention. As shown in FIG. 1, the adapter 1 has a flat rectangular parallelepiped shape with an upper face, a lower face, a right and a left side face, a front and a back face. The adapter 1 is provided with a power supply switch 9, a reset switch 11 and a power lamp 10 on the front face in the left hand side, and an infrared filter 19 on the front face in the right hand side. This infrared filter 19 is a filter capable of cutting light rays except infrared rays and selectively transmitting infrared rays, and provided with an infrared sensor, to be described below, located behind of this infrared filter 19. In addition, arrow keys 17a to 17d are provided on the upper face of the adapter 1 in the vicinity of the front edge thereof. Furthermore, there are provided a cancel key 13 in the left hand side of the arrow key 17a and an enter key 15 in the right hand side of the arrow key 17d. Incidentally, the term “arrow key 17” is used to generally represent the arrow key 17a to 17d.

Furthermore, an opening is formed on the upper face in the middle position of the upper surface of the adapter 1 while a decoration plate 4 is disposed therein so that its upper face is approximately flush with the upper face of the adapter 1. Inside the adapter 1, there is an elevator mechanism which supports and urges upward the decoration plate 4 so that the upper face of the decoration plate 4 is located at the height as described above. The decoration plate 4 is supported to move up and down in the opening by this elevator mechanism. The cartridge 500 can be connected to a connector 69, to be described below, by placing and pushing down the cartridge 500 on this decoration plate 4, and sliding the cartridge 500 toward the front face. This cartridge 500 contains a high speed processor, a memory and the like to be described below. Also, needless to say, when the cartridge 500 is pushed down on the decoration plate 4, the downward movement distance of the decoration plate 4 is restricted by the elevator mechanism so that the cartridge 500 stops at a predetermined height.

(A) Structure of Adapter 1

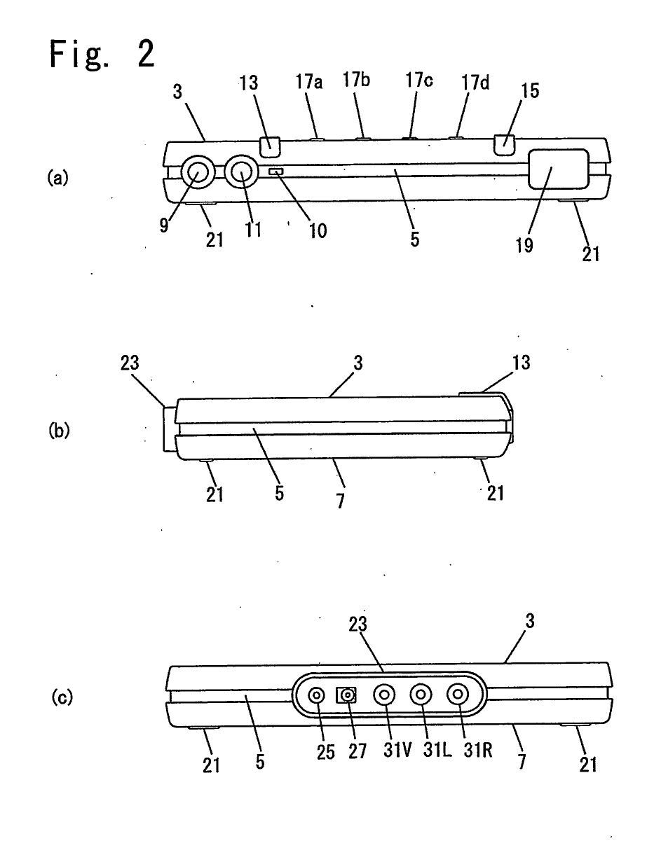

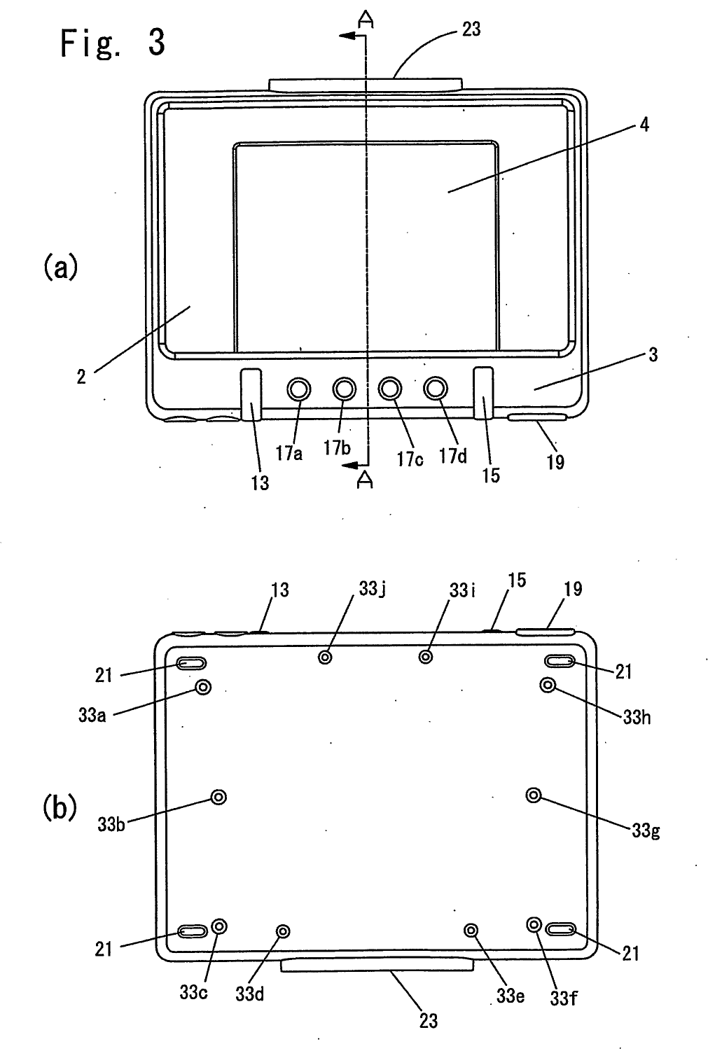

FIG. 2(a) is a front (foreside) view showing the adapter 1 of FIG. 1; FIG. 2(b) is a left side view showing the same; and FIG. 2(c) is a back side view showing the same. FIG. 3(a) is a plan view showing the adapter 1 of FIG. 1; and FIG. 3(b) is a bottom view showing the same.

As shown in FIG. 2(c), an AV jack 25, a power jack 27, a video jack 31 V, an L channel audio jack 31L and an R channel audio jack 31R are provided in the back face of the adapter 1. Incidentally, the term “AV jack 31” is used to generally represent the video jack 31 V, the L channel audio jack 31L and the R channel audio jack 31R. The AV jack 25 is an external output terminal, and connected to an external input terminal of the television receiver. On the other hand, the AV jack 31 is an input terminal which can be connected to the output terminal of a variety of external equipments (for example, DVD (digital versatile disc) player).

In addition, a jack guard 23 is provided in order to project from the back face of the adapter 1 (refer to FIG. 2(b)) and enclose the AV jacks 25 and 31 and the power jack 27 (refer to FIG. 2(c)). It is avoided by this jack guard 23 that an external force is directly applied to the plug portion of a cable connected to these jacks. Thus, the jack guard 23 serves to prevent a cable from coming out of a jack, and avoid damage of the plug portion of the cable, damage of a jack and so forth.

Furthermore, as shown in FIGS. 2(a) to (c) and FIG. 3(b), four nonslip pads 21 is provided in the bottom face of the adapter 1. In this configuration, it is possible to stably place the adapter 1.

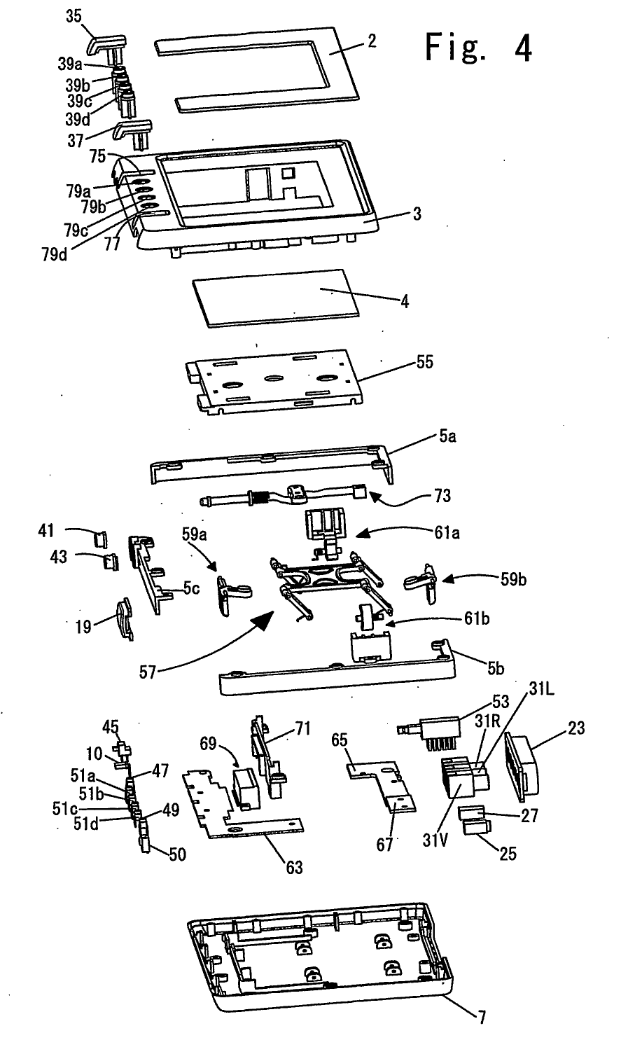

FIG. 4 is an exploded perspective view showing the adapter 1 of FIG. 1. As shown in FIG. 4, the adapter 1 includes a decoration plate 2, key tops 35, 37 and 39a to 39d, an upper housing 3, the decoration plate 4, an elevator board 55, frames 5a to 5c, key tops 41 and 43, the infrared filter 19, an elevator board locking mechanism 59a and 59b, an elevator mechanism 57, a cartridge locking mechanism 61a and 61b, a push mechanism 73, a reset switch unit 45, an LED (light emitting diode) as a power indicator 10, a cancel key unit 47, an enter key unit 49, an arrow key units 51a to 51d, boards 63, 65 and 67, a connector 69, a connector reinforcement member 71, a four pole single throw type power switch unit 53, the AV jack 25, the power jack 27, the video jack 31 V, the audio jacks 31L and 31R and a lower housing 7.

Incidentally, the terms “key top 39”, “frame 5”, “elevator board locking mechanism 59”, “cartridge locking mechanism 61” and “arrow key unit 51” are used respectively to generally represent the key tops 39a to 39d, the frames 5a to 5c, the elevator board locking mechanisms 59a and 59b, the cartridge locking mechanisms 61a and 61b and the arrow key units 51a to 51d.

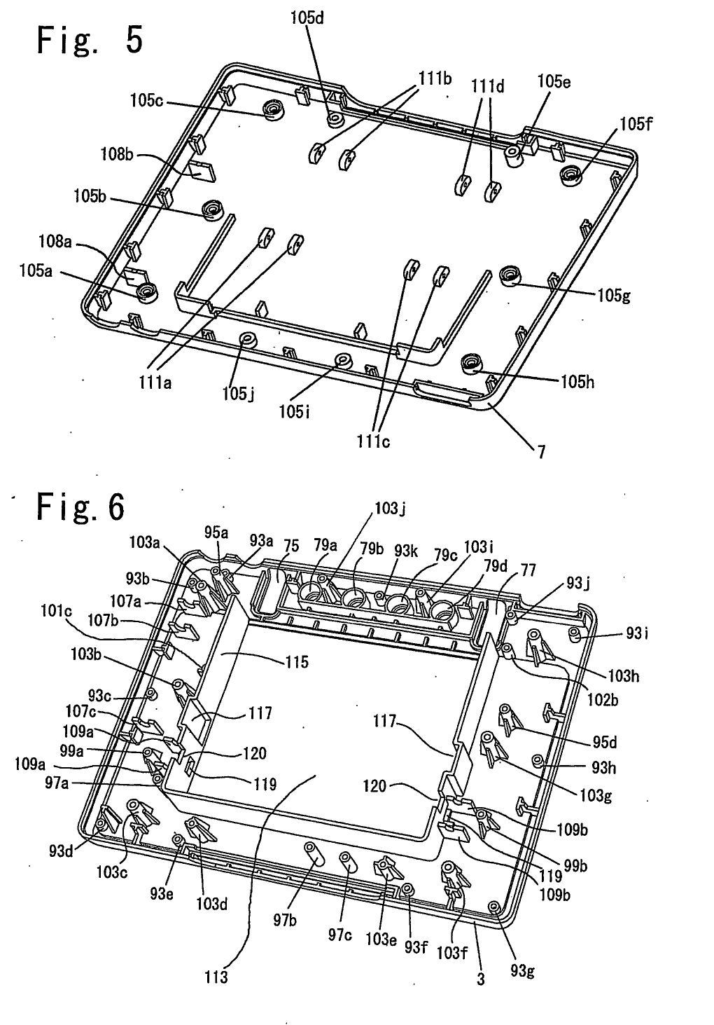

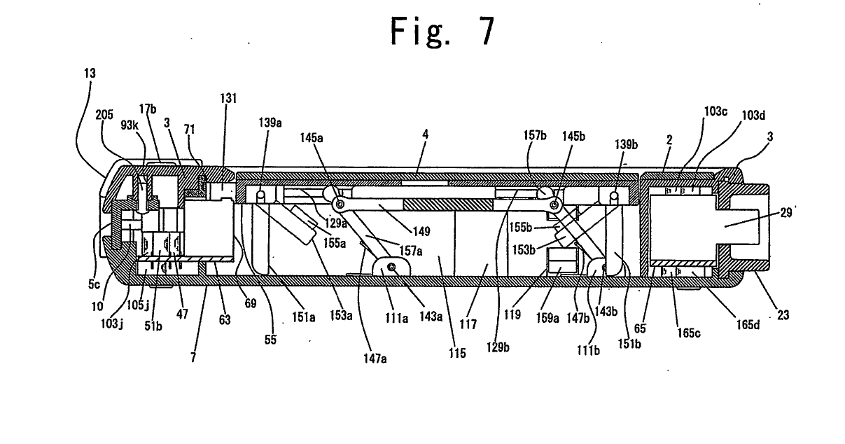

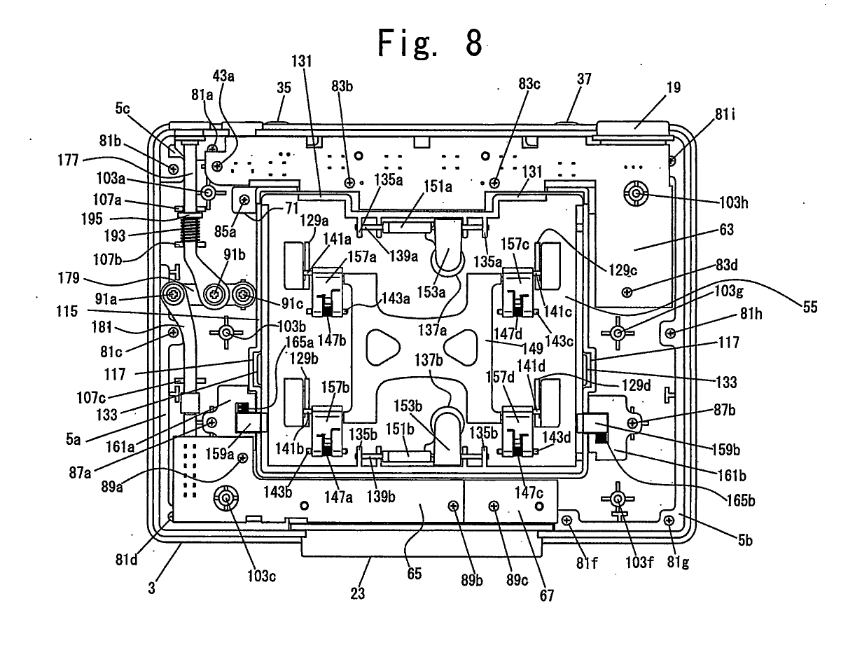

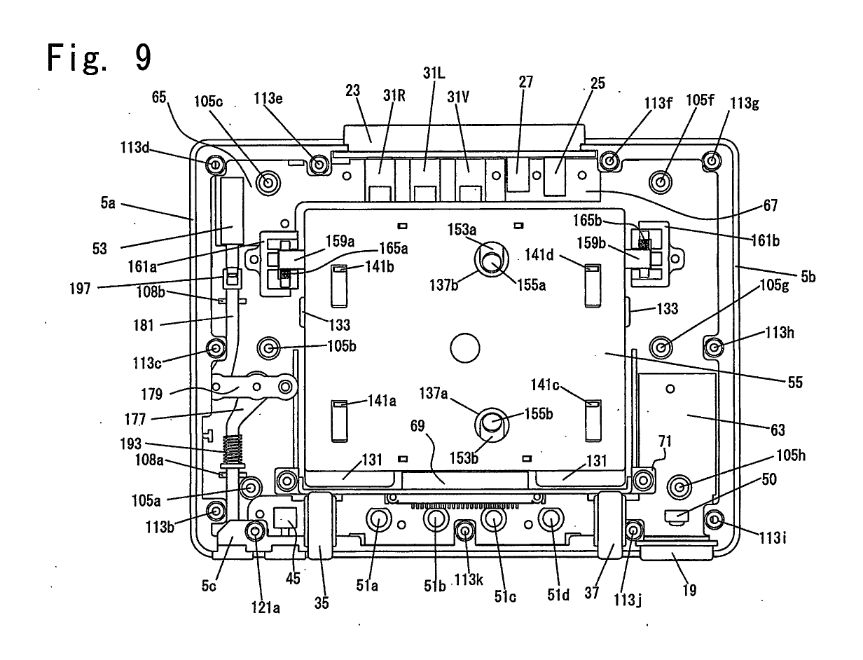

FIG. 5 is a perspective view showing the inside of the lower housing 7 of FIG. 4. FIG. 6 is a perspective view showing the inside of the upper housing 3 of FIG. 4. FIG. 7 is a cross sectional view along A-A line of FIG. 3(a). FIG. 8 is a bottom view showing the adapter 1 of FIG. 1 from which the lower housing 7 is removed. FIG. 9 is a plan view showing the adapter 1 of FIG. 1 from which the upper housing 3 and the decoration plates 2 and 4 are removed.

As shown in FIG. 5, in the inner surface of the lower housing 7, there are formed shaft supporting protrusions 111a to 111d which are protruding from the inner surface and have a shaft support hole respectively. Also, in the inner surface of the lower housing 7, there are formed cylindrical protrusions 105a to 105j along the outer edge thereof. A hole is formed in the center of each of the cylindrical protrusions 105a to 105j to penetrate through the bottom surface of the lower housing 7. One of the longer sides of the lower housing 7 (the back side of the adapter 1) is formed with a cutting section conforming to the profile of the jack guard 23. The other of the longer sides of the lower housing 7 (in the front side of the adapter 1) is formed with a cutting section conforming to the profile of the infrared filter 19. In the inner surface of the lower housing 7, there are formed supporting protrusions 108a and 108b along one of the shorter sides of the lower housing 7 (in the left side as viewed from the front of the adapter 1) for supporting the push mechanism 73 (refer to FIG. 9). Incidentally, the term “shaft supporting protrusion 111” is used to generally represent the shaft supporting protrusions 111a to 111d.

As shown in FIG. 6, a rectangular opening 113 is formed in the upper housing 3. In the upper housing 3, an opening 75, openings 79a to 79d and an opening 77 are formed corresponding to the cancel key 13, the arrow keys 17a to 17d and the enter key 15 as illustrated in FIG. 1. Also, one of the longer sides of the upper housing 3 (in the back side of the adapter 1) is formed with a cutting section conforming to the profile of the jack guard 23. The other of the longer sides of the upper housing 7 (in the front side of the adapter 1) is formed with a cutting section conforming to the profile of the infrared filter 19.

Along the perimeter of the opening 113 of the upper housing 3, there is an inner wall 115 except the front side of the adapter 1. The inner wall 115 is provided with two guide grooves 117 which are opposed to each other for guiding the vertical motion of the elevator mechanism 57. In addition, the inner wall 115 is provided with two openings 119 which are opposed to each other. In addition, the inner wall 115 is provided with cutting sections 120 paired respectively with the openings 119. The openings 119 and the cutting sections 120 are formed to support the cartridge locking mechanism 61 including a C-shaped member, to be described below, with one end which can protrude through the opening 119 into the inside of the opening 113 and the other end which can protrude through the cutting section 120 into the inside of the opening 113. In the inside surface of the upper housing 3, there are formed shaft supporting protrusions 109a and 109b respectively corresponding to the two sets of the opening 119 and the cutting section 120. The end portions of the shaft supporting protrusions 109a and 109b are formed respectively with semicircular notches for supporting the shafts of the C-shaped members. In the inner surface of the upper housing 3, there are formed supporting protrusions 107a to 107c along one of the shorter sides of the upper housing 3 (in the left side as viewed from the front of the adapter 1) for supporting the push mechanism 73 (refer to FIG. 8).

Also, in the inner surface of the upper housing 3, there are formed cylindrical protrusions 93a to 93k and cylindrical protrusions 103a to 103j along the outer edge thereof. Furthermore, in the inner surface of the upper housing 3, there are formed cylindrical protrusions 97a and 97b for supporting the board 65 and a cylindrical protrusion 97c for supporting the board 67. Still further, in the inner surface of the upper housing 3, there are formed cylindrical protrusions 95a and 95d for supporting the board 63. Still further, in the inner surface of the upper housing 3, there is formed a cylindrical protrusion 101c functioning as the pivot of the push mechanism 73. Still further, for supporting the connector reinforcement member 71 in the inner surface of the upper housing 3, there are formed a cylindrical protrusion 102a (not shown in the figure) and a cylindrical protrusion 102b.

(Elevator Unit)

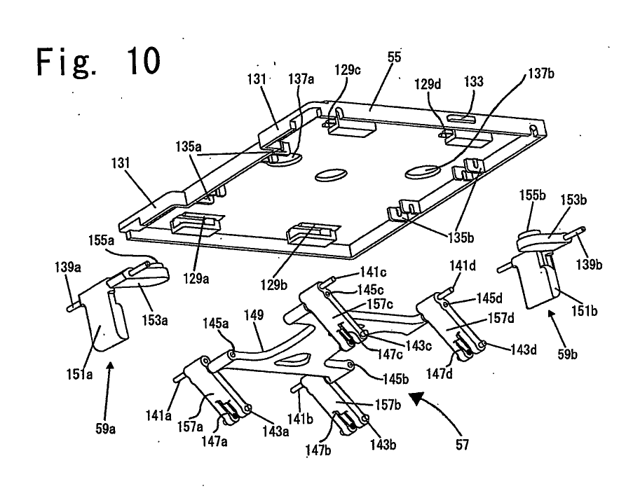

FIG. 10 is a schematic diagram showing the elevator mechanism 57 and the elevator board locking mechanisms 59a and 59b of FIG. 4. As shown in FIG. 10, the elevator mechanism 57 includes a shaft support member 149, pivotable members 157a to 157d, torsion springs 147a to 147d and shafts 141a to 141d, 145a to 145d and 143a to 143d. The elevator board locking mechanism 59a comprises a shaft 139a, a discoid magnet 155a, a magnet holding member 153a, and an elevator board support member 151a. The elevator board locking mechanism 59b has the same construction. Incidentally, the terms “pivotable member 157” and “shafts 141, 145 and 143” are used to generally represent the pivotable members 157a to 157d and the shafts 141a to 141d, 145a to 145d and 143a to 143d respectively. Also, the terms “elevator board locking mechanism 59”, “shaft 139”, “magnet 155”, “magnet holding member 153” and “elevator board support member 151” are used to generally represent the elevator board locking mechanisms 59a and 59b, the shafts 139a and 139b, the magnets 155a and 155b, the magnet holding members 153a and 153b and the elevator board support members 151a and 151b respectively.

As illustrated in FIG. 10 and also in FIG. 9, on the foreside of the elevator board 55 (toward the front side of the adapter 1), stoppers 131 are formed to project therefrom (refer to FIG. 7). Also, on the opposite side surfaces of the elevator board 55, stoppers 133 are formed corresponding to the guide groove 117 of FIG. 6. In addition, openings 137a and 137b are formed through the elevator board 55 in order to expose the magnets 155a and 155b of the elevator board locking mechanisms 59a and 59b. In the inner surface of the elevator board 55, there are formed semicylindrical shaft abutment portions 129a and 129b along one side edge thereof and semicylindrical shaft abutment portions 129c and 129d along the other side edge thereof. Also, in the inner surface of the elevator board 55, there are formed shaft supporting protrusions 135a on the foreside of the elevator board 55 (the front side of the adapter 1) and shaft supporting protrusions 135b on the rear side of the elevator board 55 (the back side of the adapter 1). As shown in FIG. 7, the decoration plate 4 is attached to the upper surface of the elevator board 55. Incidentally, the terms “the opening 137”, “shaft abutment portion 129” and “shaft supporting protrusion 135” are used to generally represent the openings 137a and 137b, the shaft abutment portions 129a to 129d and the shaft supporting protrusions 135a and 135b.

By the way, the shaft 145a to 145d are non-rotatably affixed to the four elongated corners of the H-shaped shaft support member 149 in order to outwardly project. The pivotable member 157 is pivotally engaged with the shaft 145. The shaft 141 is non-rotatably affixed to the upper end of the pivotable member 157 in order to outwardly project. On the other hand, the lower portion of the pivotable member 157 is two-forked to form a pair of leg portions (refer to FIG. 8). Then, the two leg portions are disposed between the shaft supporting protrusions 111 of FIG. 5 with the torsion spring 147 and the shaft 143, which is inserted through the two leg portions and the torsion spring 147, such that the pivotable member 157 is pivotally supported. In this case, since the shaft 143 is non-rotatably affixed to the shaft supporting protrusion 111, the pivotable member 157 can pivot on the shaft 143. On the other hand, the shaft 141 at the upper end of the pivotable member 157 abuts with the shaft abutment portion 129 formed in the inside of the elevator board 55 and slides on the shaft abutment portion 129 as the elevator board 55 moves up and down (refer to FIG. 7).

While the shaft 141 of the pivotable member 157 urges upward the elevator board 55 by the elastic force of the torsion spring 147, the elevator board 55 is held in a predetermined height by the stoppers 131 and 133. As a result, when the cartridge 500 is not placed on the decoration plate 4 (the elevator board 55), the pivotable member 157 is maintained to make an acute angle with the inner surface of the lower housing 7 as shown in FIG. 7.

Returning to FIG. 10, the magnet holding member 153 holds the magnet 155. The shaft 139 is inserted through the base end of the elevator board support member 151 and the base end of the magnet holding member 153. In this case, the diameter of the holes of the elevator board support member 151 and magnet holding member 153, which are penetrated by the shaft 139, is larger than the diameter of the shaft 139 so that the elevator board support member 151 and the magnet holding member 153 can pivot on the shaft 139.

The both end of the shaft 139 of the elevator board locking mechanism 59 configured as described above are non-rotatably affixed to the shaft supporting protrusion 135 formed in the inner surface of the elevator board 55. Then, when the cartridge 500 is not placed on the decoration plate 4 (the elevator board 55), the elevator board support member 151 stands straight by its own weight to the inner surface of the lower housing 7 as illustrated in FIG. 7. Meanwhile, the magnet holding member 153 makes an acute angle with the elevator board support member 151. The structure of the elevator board locking mechanism 59 will be explained in detail as well as this configuration.

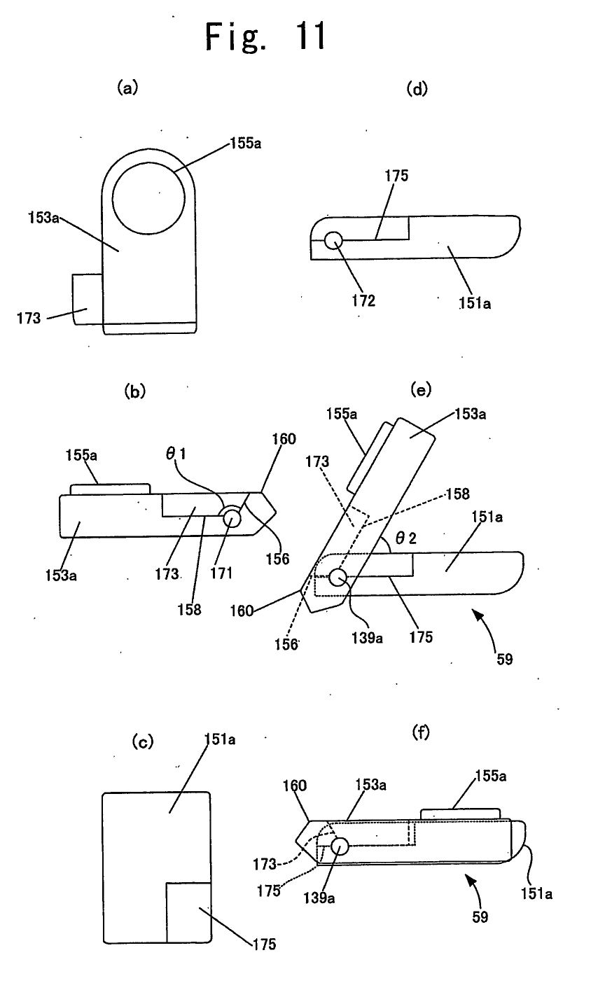

FIG. 11(a) is a plan view showing the magnet holding member 153a of FIG. 10; FIG. 11(b) is a left side view showing the same; FIG. 11(c) is a plan view showing the elevator board support member 151a; FIG. 11(d) is a right side view showing the same; FIG. 11(e) is an explanatory view for showing the elevator board locking mechanism 59a which is fully opened; and FIG. 11(f) is an explanatory view for showing the elevator board locking mechanism 59a which is closed.

As shown in FIG. 11(a), an angle limiting section 173 is formed on one side surface of the magnet holding member 153a in the base end side. As shown in FIG. 11(b), this angle limiting section 173 is shaped in the form of a trapezoid in the side view. Also, on the base end of the magnet holding member 153a, there is formed a shaft support hole 171 through which the shaft 139a is inserted. On the other hand, as shown in FIGS. 11(c) and 11(d), the elevator board support member 151a is partially cut at an upper corner to form a stepped portion which provides a receiving section 175 for receiving the angle limiting section 173 of the magnet holding member 153a. Also, on the base end of the elevator board support member 151a, there are formed the shaft support hole 172 through which the shaft 139a is inserted.

As shown in FIG. 11(e), the magnet holding member 153a and the elevator board support member 151a are configured in order that they cannot be opened beyond a predetermined constant angle θ2 therebetween. That is, they are inhibited from opening beyond the constant angle θ2 therebetween when the inclined surface 156 of the angle limiting section 173 comes in contact with the receiving section 175. This constant angle θ2 is determined by the angle θ1 between the bottom surface 158 and the inclined surface 156 of the angle limiting section 173. In this case, the constant angle θ2 is an acute angle. On the other hand, as shown in FIG. 11(f), the angle limiting section 173 is fitted in the receiving section 175 when the magnet holding member 153a and the elevator board support member 151a are fully closed. The elevator board locking mechanism 59a as constructed above is attached to the shaft supporting protrusion 135a of the elevator board 55 of FIG. 10. In this case, when the cartridge 500 is not placed on the decoration plate 4 as shown in FIG. 7, the corner 160 of the magnet holding member 153a shown in FIG. 11 is in contact with the inner surface of the elevator board 55 so that the magnet holding member 153a and the elevator board support member 151a are not fully closed to keep a certain acute angle therebetween. This angle is no larger than the angle θ2 of FIG. 11(e). Incidentally, the configuration of the elevator board locking mechanism 59b is the same as the configuration of the elevator board locking mechanism 59a.

(Cartridge Locking Structure)

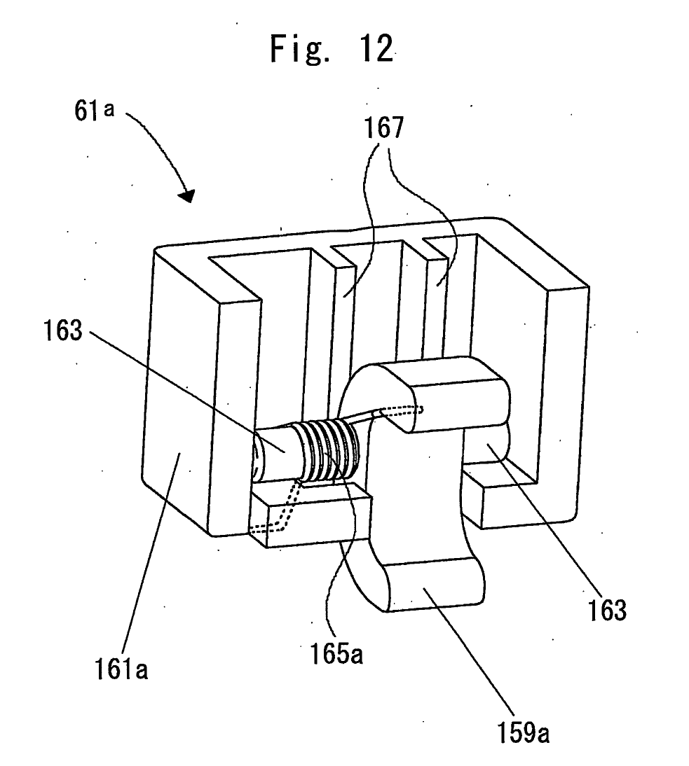

FIG. 12 is a perspective view showing the cartridge locking mechanism 61a of FIG. 4. As shown in FIG. 12, the cartridge locking mechanism 61a includes a shaft support member 161a, a C-shaped member 159a and a torsion spring 165a. Shafts 163 are formed on the side surfaces of the C-shaped member 159a to protrude therefrom. These shafts 163 are supported by the shaft support member 161a. Also, the torsion spring 165a is engaged around one of the shafts 163. The torsion spring 165a has a hook portion at one end hanged to the inner surface of the C-shaped member 159a and a hook portion at the other end hanged to the bottom surface of the shaft support member 161a. Accordingly, the elastic force of the torsion spring 165a is exerted on the C-shaped member 159a in order to turn the C-shaped member 159a toward angle limiting sections 167. However, since the outer surface of the C-shaped member 159a abuts against the angle limiting sections 167 which are formed to protrude from the inner side surface of the shaft support member 161a, the C-shaped member 159a is inhibited from being inclined beyond a predetermined angle. Incidentally, the configuration of the cartridge locking mechanism 61a is the same as the configuration of the cartridge locking mechanism 61b. The cartridge locking mechanisms 61a and 61b as constructed above are installed in the inner surface of the upper housing 3 of FIG. 6. This point will be explained in detail.

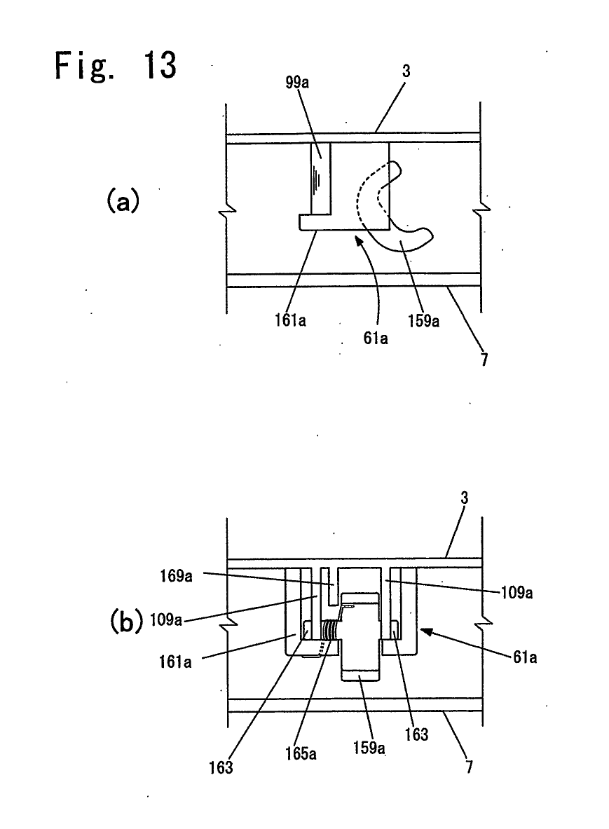

FIG. 13(a) and FIG. 13(b) are explanatory views for showing the cartridge locking mechanism 61a of FIG. 4 as installed in the inner surface of the upper housing 3. In FIG. 13(b), the angle limiting section 167 of FIG. 12 is not illustrated. As shown in FIG. 13(a), the shaft support member 161a of the cartridge locking mechanism 61a is fixed to the cylindrical protrusion 99a protruding from the inside surface of the upper housing 3 with the screw 87a (refer to FIG. 8). The cartridge locking mechanism 61b is fixed to the cylindrical protrusion 99b protruding from the inside surface of the upper housing 3 with the screw 87b in the same manner (refer to FIG. 8). Also, as shown in FIG. 13(b), the shaft 163 of the C-shaped member 159a is pivotally supported by the shaft supporting protrusion 109a protruding from the inside of the upper housing 3 (refer to FIG. 6). Furthermore, not only the shaft supporting protrusions 109a and 109b, but also an upright position supporting section 169a protruding from the inner surface of the upper housing 3 contributes to keeping the upright position of the C-shaped member 159a. Incidentally, the cartridge locking mechanism 61b has the same structure.

(Power Switch Assembly)

FIG. 14 is a schematic diagram showing the push mechanism 73 of FIG. 4. As shown in FIG. 14, the push mechanism 73 includes arms 177, 179 and 181 and a spring 193. A cylindrical protrusion 191 protruding downward from one end of the arm 179 is inserted into an insertion hole 185 formed through one end of the arm 181 while a washer head screw 91a is screwed into the cylindrical protrusion 191. The outer diameter of the cylindrical protrusion 191 is smaller than the inner diameter of the insertion hole 185, while the end of the cylindrical protrusion 191 is projected from the insertion hole 185, and therefore the arm 181 is pivotable around the cylindrical protrusion 191. Also, a cylindrical protrusion 189 protruding downward from the center position of the arm 179 is inserted into an insertion hole 187 formed through one end of the arm 177 while a washer head screw 91b is screwed into the cylindrical protrusion 189. The outer diameter of the cylindrical protrusion 189 is smaller than the inner diameter of the insertion hole 187, while the end of the cylindrical protrusion 189 is projected from the insertion hole 187, and therefore the arm 177 is pivotable around the cylindrical protrusion 189. Also, a cylindrical protrusion 101c protruding from the inner surface of the upper housing 3 is inserted into an insertion hole 183 formed through the other end of the arm 179, while a washer head screw 91c is screwed into the cylindrical protrusion 101c. The outer diameter of the cylindrical protrusion 101c is smaller than the inner diameter of the insertion hole 187, while the end of the cylindrical protrusion 101c is projected from the insertion hole 183, and therefore the arm 179 is pivotable around the cylindrical protrusion 101c.

The key top 41 is attached to the other end of the arm 177 (refer to FIG. 4). Also, the spring 193 is fitted around in the arm 177. On the other hand, an engagement section 197 is formed at the other end of the arm 181 while the end of the power switch unit 53 of FIG. 4 is loosely fitted into this engagement section 197 (refer to FIG. 9). As shown in FIG. 8 and FIG. 9, the push mechanism 73 is supported by the supporting protrusions 107a and 107c and the supporting protrusions 108a and 108b therebetween (refer to FIG. 5 and FIG. 6). Also, as shown in FIG. 8, the spring 193 fitted around the arm 177 is disposed between the stopper 195 (refer to FIG. 14) and the support member 107b.

(Infrared Filter)

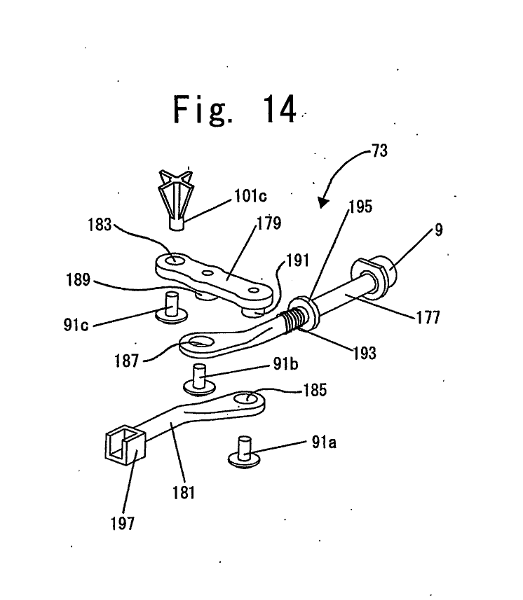

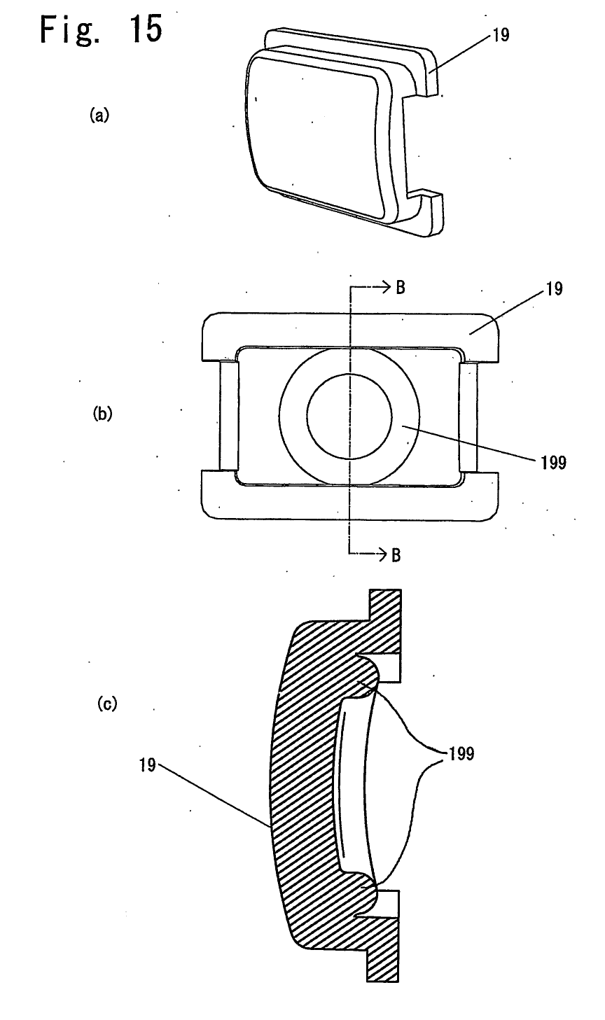

FIG. 15(a) is a perspective view showing the infrared filter 19 of FIG. 4; FIG. 15(b) is a plan view showing the inside of the infrared filter 19; and FIG. 15(c) is a cross sectional view along B-B line of FIG. 15(b). As shown in FIG. 15(b) and FIG. 15(c), a doughnut-shaped lens section 199 is formed in the inner surface of the infrared filter 19. More specifically speaking, this lens section 199 is provided in the form of a doughnut cut in half by a plane perpendicular to the central axis of the ring of the doughnut.

The lens section 199 has a semicircular cross section and an index of refraction larger than that of air. Accordingly, infrared rays incident on the infrared filter 19 from the outside are refracted toward the central axis of the lens section 199 after passing through the lens section 199. Furthermore, because the lens section 199 is ring shaped, incoming infrared rays from directions of 360 degrees can be focused. As a result, it is possible to expand the light receiving range of the infrared sensor 50 (opposed to the lens section 199) which is located behind of the infrared filter 19 (refer to FIG. 9).

Also, the infrared filter 19 is colored in black or another dark color so as to transmit only infrared rays. Because of this, it is possible to avoid the malfunction of the infrared sensor 50 caused by light rays other than infrared rays as much as possible.

Incidentally, any appropriate infrared filter can be used in place of the infrared filter 19 having the doughnut-shaped optical lens section 199 as long as the light receiving range of the infrared is sensor 50 can be expanded. For example, such an alternative infrared filter may be formed with a multitude of small pyramid-shaped protrusions which can redirect light rays incident thereon to the infrared 50 by refraction. In this case, the small pyramid-shaped protrusions are formed in the inner surface of the infrared filter.

With the infrared filter capable of focusing infrared rays incident from a wider range of directions by the use of the doughnut-shaped optical lens section 199 or the small pyramid-shaped protrusions, the adapter 1 can be implemented with an expanded light receiving range of the infrared sensor. In addition to this, the setting of the lens can be performed by installing the infrared filter 19, and therefore it is possible to reduce the number of steps of the manufacturing process.

(Connector)

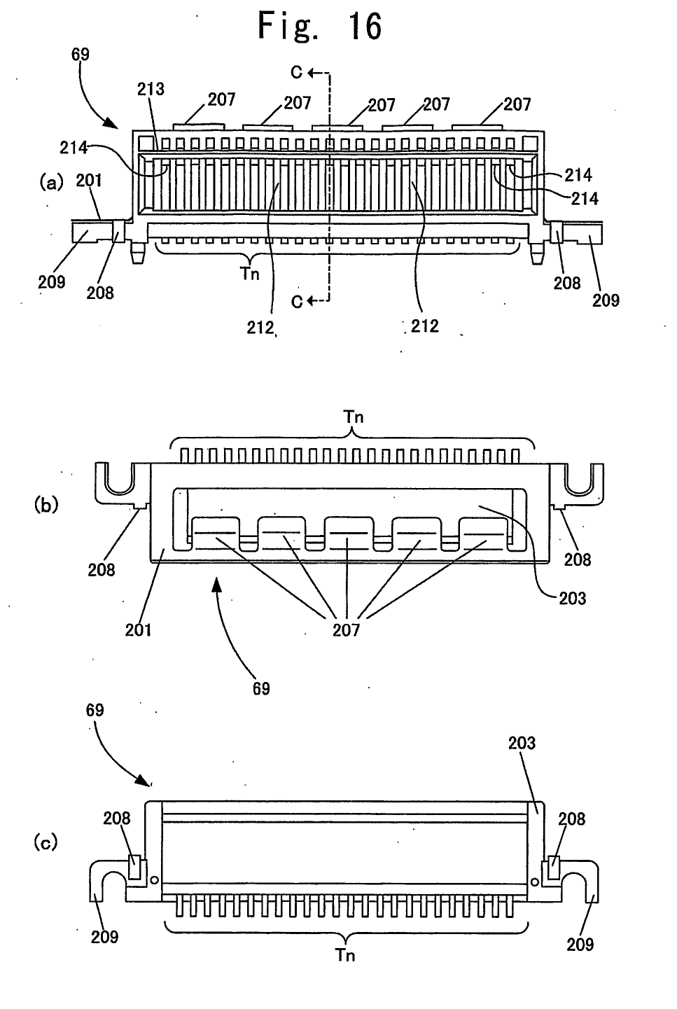

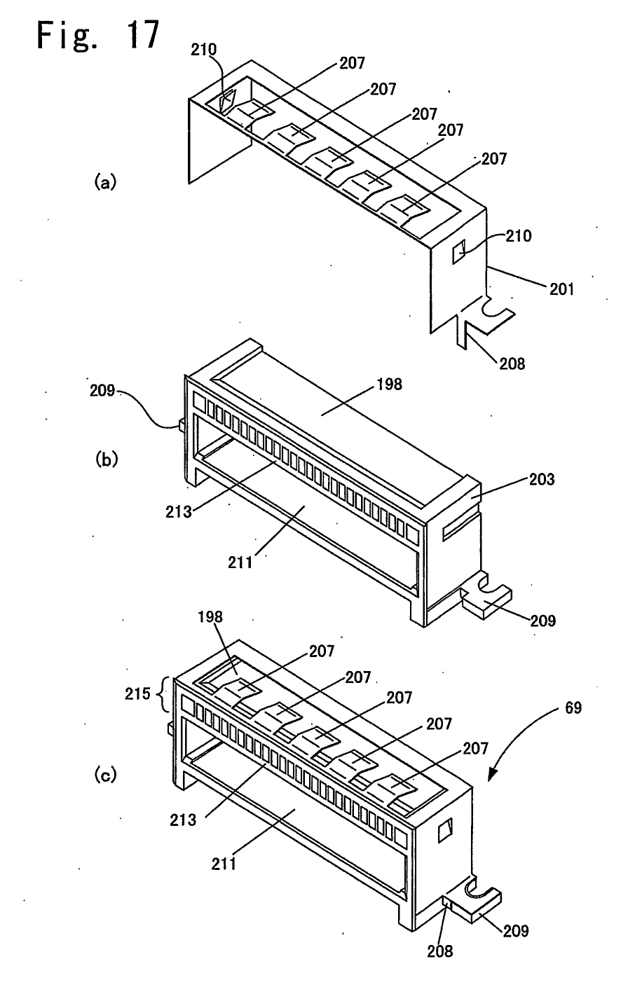

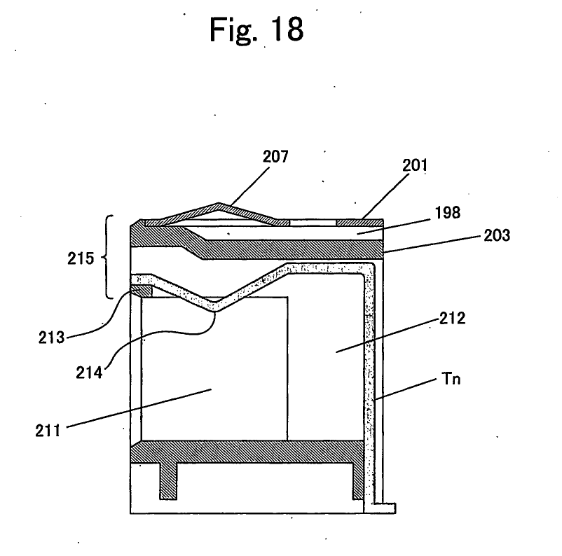

FIG. 16(a) is a front view showing the connector 69 of FIG. 4; FIG. 16(b) is a plan view showing the connector 69 of FIG. 4; and FIG. 16(c) is a bottom view showing the connector 69 of FIG. 4. FIG. 17(a) is a perspective view showing a shield member 201 of FIGS. 16(a) to 16(c); FIG. 17(b) is a perspective view showing a connector unit 203 of FIGS. 16(a) to 16(c); and FIG. 17(c) is a perspective view showing the connector 69 of FIGS. 16(a) to 16(c). FIG. 18 is a cross sectional view along C-C line of FIG. 16(a).

As shown in FIGS. 17(a) to 17(c), the connector unit 203 is made of an insulating material approximately in the form of a rectangular parallelepiped. The shield member 201 is made of a metal and provided in order to cover the upper surface and opposite side surfaces of the connector unit 203. An opening is formed through the upper portion of this shield member 201. The edge of this opening is formed with generally rectangular teeth extending inwardly from the front side of the connector 69 in the plane view (refer to FIG. 16(b)). In this way, as shown in FIG. 17(a), five contact members 207 are formed in the upper surface of the shield member 201. Each contact member 207 has a higher center portion and lower opposite side portions (i.e., in the form of a ridge) as viewed in cross section as shown in FIG. 18. Also, the shield member 201 is provided with a pair of claw portions 208 formed in order to engage with a pair of attachment portions 209 respectively. Furthermore, a pair of claw portions 210 are formed by cutting the opposite side surfaces of the shield member 201. The shield member 201 as formed above is installed on the connector unit 203 to cover it. More specifically, the shield member 201 is attached to the connector unit 203 by folding the claw portion 208 to the bottom surface of the attachment portion 209 of the connector unit 203 (refer to FIG. 17(c) and FIGS. 16(a) to 16(c)), and inwardly folding the claw portions 210 so that they latch onto groove portions formed in the opposite side surfaces of the connector unit 203.

As shown in FIG. 17(b) and FIG. 18, a recess 198 is formed in the upper surface of the connector unit 203. Also, the connector unit 203 is provided with an elongated indented engagement section 211, into which the protruded engagement section 538 of the cartridge 500 (refer to FIG. 1) is fitted, and an elongated protruded engagement section 215, onto which the elongated indented engagement section 539 (refer to FIG. 1) is fitted in the location just above the indented engagement section 211.

In the inside of the connector unit 203, as shown in FIG. 18 and FIG. 16(a), the partitions 212 are formed to define the indented engagement section 211 between the edge of the partitions 212 (refer to FIG. 18) and the inner surface of the bottom portion of the connector unit 203. Furthermore, a terminal support member 213 is formed extending from one side surface to the other side surface of the connector unit 203. Then, 24 terminals T1 to T24 (the term “terminal Tn (n=1 to 24)” is used to generally represent these terminals) are disposed between adjacent ones of the partitions 212 and supported by the terminal support member 213 at one end of the respective terminals Tn. Furthermore, the part of the back side of each partition 212 is melted and bonded to the corresponding terminals Tn. The terminal Tn can be fixed to the connector unit 203 in this manner. Also, as shown in FIG. 18, the terminal Tn is first bent downward from the end supported by the terminal support member 213 toward the indented engagement section 211, and then bent upward toward the upper surface of the connector unit 203. Contacts 214 are formed at the apexes as thus formed. Furthermore, the terminal Tn is extended to the back side along the upper surface, and then bent downward at a right angle.

The connector 69 as constructed above is fixed to the board 63 with screws 83b and 83c as shown in FIG. 8, and reinforced by the connector reinforcement member 71 of FIG. 4 (refer to FIG. 7). The connector reinforcement member 71 is fixed to the cylindrical protrusions 102a (not shown in the figure) and 102b shown in FIG. 6 with the screws 85b (not shown in the figure) and 85a (refer to FIG. 8).

(Elevation Operation)

FIG. 19(a) is an explanatory view for showing the elevator mechanism 57 and the elevator board locking mechanism 59 with the decoration plate 4 of FIG. 7 on which the cartridge 500 is not placed; FIG. 19(b) is an explanatory view for showing the elevator mechanism 57 and the elevator board locking mechanism 59 with the decoration plate 4 on which the cartridge 500 is placed; FIG. 19(c) is an explanatory view for showing the elevator mechanism 57 and the elevator board locking mechanism 59 with the decoration plate 4 on which the cartridge 500 is moved downward to the lowest position; and FIG. 19(d) is an explanatory view for showing the elevator mechanism 57 and the elevator board locking mechanism 59 with the decoration plate 4 on which the cartridge 5.00 is connected to the connector 69.

As shown in FIG. 19(a), when the cartridge 500 is not placed on the decoration plate 4, the elevator board support member 151 stands straight by its own weight. Because of this, when the cartridge 500 is not placed on the decoration plate 4, even if trying to hold the elevator board 55 down, the elevator board 55 does not move down due to the support by the elevator board support member 151. Meanwhile, the magnet holding member 153 makes an acute angle with the elevator board support member 151 by its own weight and the corner 160 (refer to FIG. 11(e)). In this case, while there is a force pushing the elevator board 55 upward by the torsion spring 147, the stoppers 131 formed on the elevator board 55 as shown in FIG. 8 (not illustrated in FIGS. 19(a) to 19(d)) abut onto the inner surface of the upper housing 3 so that the elevator board 55 is stopped at the predetermined height. Also, the stoppers 133 (refer to FIG. 10) formed on the side surfaces of the elevator board 55 abut onto the ends of the guide grooves 117 (refer to FIG. 6) to stop the elevator board 55 at the predetermined height.

As shown in FIG. 19(b), when the cartridge 500 is placed on the decoration plate 4, the magnets 155 are attracted by metal plates 536a and 536b (the term “metal plate 536” is used to generally represent these plates) which are provided on the lower housing 504 of the cartridge 500. As a result, the magnet holding member 153 pivots on the shaft 139 together with the elevator board support member 151. This is because, as explained in FIG. 11(e), the angle between the magnet holding member 153 and the elevator board support member 151 cannot increase beyond the predetermined angle θ2 by virtue ‘of ’ the angle limiting section 173′ and the receiving section 175, and therefore the both members integrally pivot while keeping the predetermined angle θ2. As a result, the elevator board support member 151 no longer serves as the support.

Accordingly, when the cartridge 500 on the decoration plate 4 is pushed down, the elevator board 55 is lowered to the position as illustrated in FIG. 19(c). In this case, while the magnet holding member 153 and the elevator board support member 151 are fully closed (refer to FIG. 11(f)), the height of the decoration plate 4 on which the cartridge 500 is placed is equal to the height of the bottom surface of the indented engagement section 211 of the connector 69.

Accordingly, by sliding the cartridge 500 into the connector 60 as shown in FIG. 19(d), the protruded engagement section 538 and indented engagement section 539 of the cartridge 500 can be fitted respectively to the indented engagement section 211 and protruded engagement section 215 of the connector 69. Needless to say, while the sequence of the above steps is manually performed by the user, the upward elastic force of the torsion spring 147 is applied to the elevator board 55 even in the state as illustrated in FIG. 19(c) so that the user has to slide the cartridge 500 with keeping the pushing force.

The cartridge 500 is connected to the connector 69 by the sequence of the above steps. On the other hand, the cartridge 500 can be detached by the backward process to the above. However, after disconnecting the cartridge 500 from the connector 69, the elevator board 55 is elevated by the elastic force of the torsion spring 147, and therefore the elevator board 55 need not be pulled up by a hand.

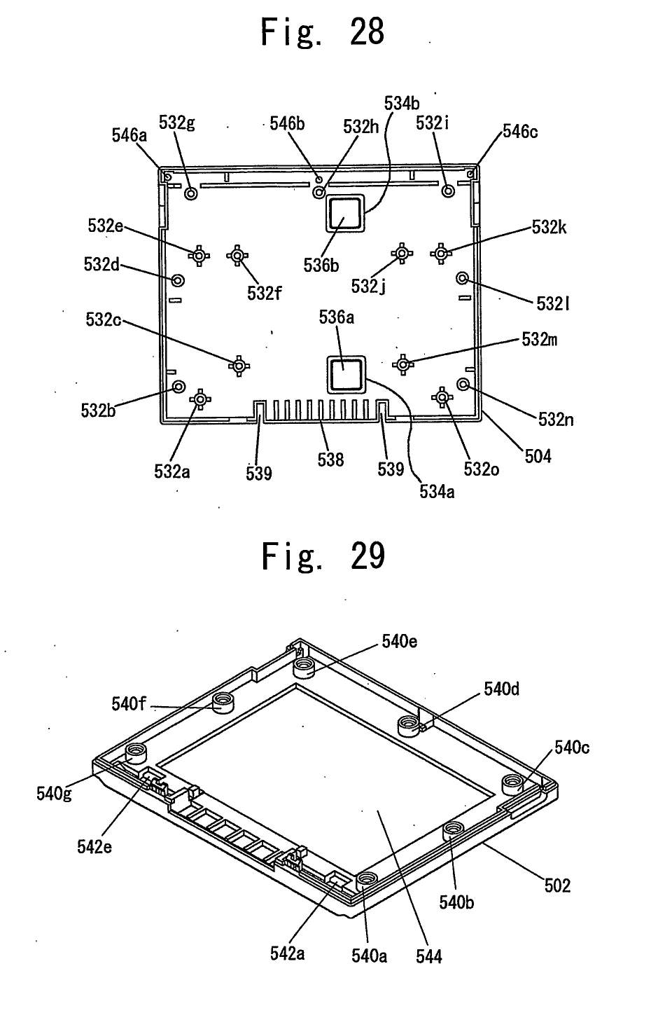

Incidentally, if the cartridge 500 is placed on the decoration plate 4 upside down by oversight, the metal plate 536 is positioned vertically apart from the decoration plate 4 to prevent the magnet 155 from being attracted by the metal plate 536 so that the elevator board locking mechanism is kept locked. Accordingly, it is possible to prevent the cartridge 500 is installed into the adapter 1 upside down by oversight. On the other hand, even if the cartridge 500 is placed backwards on the decoration plate 4 by oversight, the metal plates 536 are provided in the positions displaced to the right from the center in the lateral direction as illustrated in FIG. 28 which is referred to later, rather than the center positions, so that the magnets 155 are not attracted to the metal plates 536, and therefore the elevator board locking mechanism is kept locked. Accordingly, it is possible to prevent the cartridge 500 is installed backwards into the adapter 1 by oversight.

(Cartridge Locking Operation)

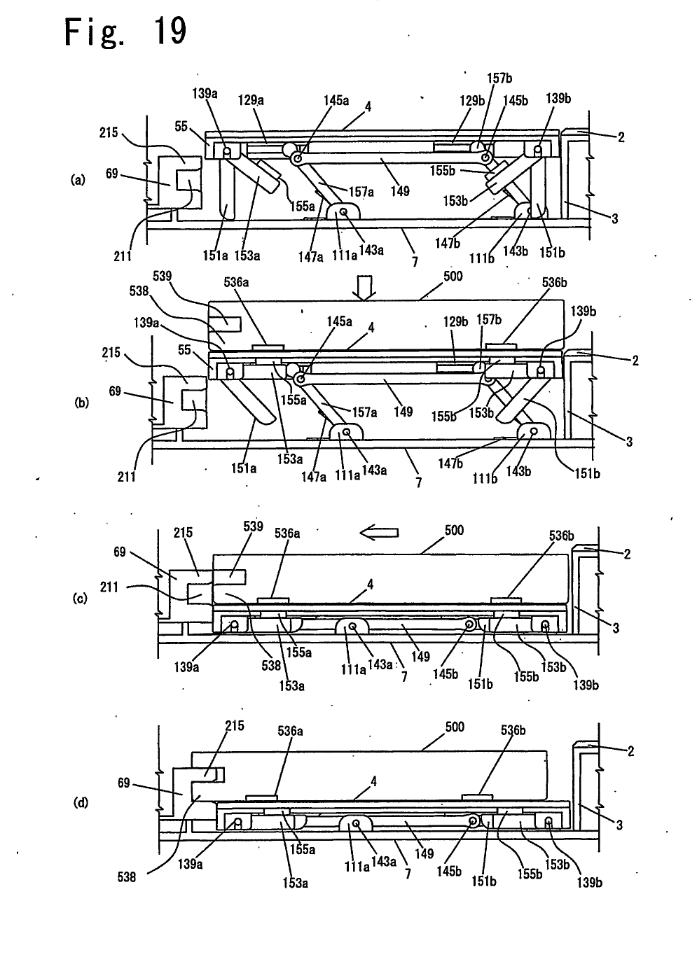

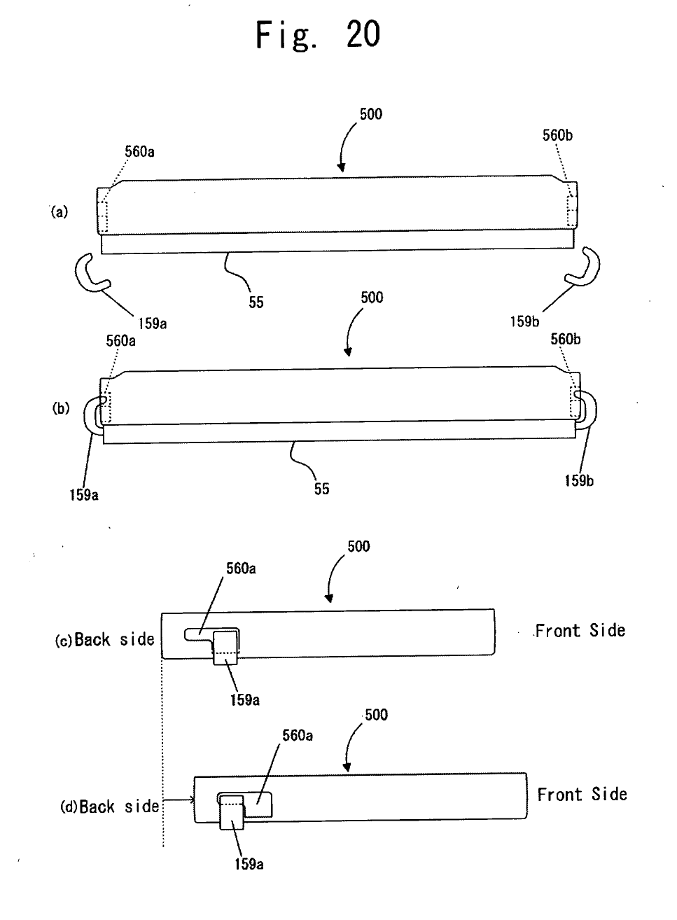

FIG. 20(a) is a view showing the engagement between the cartridge 500 and the C-shaped member 159 of the cartridge locking mechanism 59 in the state of FIG. 19(b); FIG. 20(b) is a view showing the engagement between the cartridge 500 and the C-shaped member 159 of the cartridge locking mechanism 59 in the state of FIG. 19(c); FIG. 20(c) is a right side view showing the state of FIG. 20(b); and FIG. 20(d) is a right side view showing the cartridge 500 which is locked.

As shown in FIG. 20(a), in advance of coming in contact with the elevator board 55, the two C-shaped members 159 are opened out by the elastic force of the torsion springs 165 (refer to FIG. 12) which are attached to the C-shaped members 159. When the cartridge 500 is pushed down so that the bottom surface of the elevator board 55 abuts against the lower ends of the C-shaped members 159, the C-shaped members 159 pivot and abut, at their upper ends, against locking grooves 560a and 560b which are formed on the opposite side surfaces of the cartridge 500 (the term “locking groove 560” is used to generally represent these grooves) as illustrated in FIGS. 20(b) and 20(c). In this case, the lower end of the C-shaped member 159 comes in contact with the side surfaces of the elevator board 55 to keep the state that the upper ends of the C-shaped member 159 is in contact with the locking groove 560.

Then, as shown in FIG. 19(d), the cartridge 500 is connected to the connector 69 by sliding the cartridge 500 toward the front face of the adapter 1 (i.e., toward the connector 69). As thus described, the C-shaped member 159 coming in contact with the locking groove 560 does not hinder the cartridge 500 from sliding because the locking groove 560 is formed to run in the longitudinal direction along the side surface of the cartridge 500. The C-shaped member 159 is located in the end of the locking groove 560 as illustrated in FIG. 20(d) when the cartridge 500 is connected to the connector 69 as described above. Even in this state, the C-shaped member 159 keeps the state of being in contact with the side surface of the elevator board 55, and therefore remains in the state as illustrated in FIG. 20(b). Accordingly, with the elastic force of the torsion spring 147 of FIG. 7 being applied on the elevator board 55, the upper end of the C-shaped member 159 abuts onto the lower edge of the locking groove 560.

The force of the torsion spring 147 to push up the elevator board 55 is applied not only to the protruded engagement section 538 of the cartridge 500 and the connector 69 but also to the lower edge of the locking groove 560 and the C-shaped member 159 to disperse locations where the force is applied, and therefore it is avoided as much as possible that the condition of contact between the cartridge 500 and the connector 69 is deteriorated, that damage becomes likely or that other shortcomings are caused. If it were not for the cartridge locking mechanism 61, the force of the torsion spring 147 would be concentrated to the protruded engagement section 538 and connector 69 of the cartridge 500 so that the above shortcomings would be caused by the long term use.

(Power Switch Push Operation)

As illustrated in FIG. 8 and FIG. 9, when the power supply switch 9 is pushed to turn on the power supply switch 9 of FIG. 1, the arm 177 of the push mechanism 73 is moved toward the power switch unit 53. In response to this, the arm 179 pivots on the cylindrical protrusion 10c (refer to FIG. 14) as a fulcrum toward the power switch unit 53. Furthermore, in response to this, the arm 181 is pushed into the power switch unit 53. By this action, the end of the power switch unit 53 fitted into the engagement section 197 (refer to FIG. 14) of the arm 181 is pushed to turn on the power switch unit 53. When turned on, the power switch unit 53 keeps its state of being pushed down, and therefore the arms 177, 179 and 181 return to their initial positions (default positions) by virtue of the spring 193. Incidentally, the elastic force of the spring 193 is applied even in the default positions, the stopper 195 formed on the arm 177 abuts against the supporting protrusions 107a and 108a to keep the default positions.

As has been discussed above, the pushing operation is implemented by the use of the leverage with the three arms 177, 179 and 181. This configuration is employed for the purpose of securing a sufficient effective pushing distance even if a shorter actual pushing distance is performed by the user.

(Other Structures)

Referring to FIG. 4 and FIG. 6, the frame 5a is fixed to the cylindrical protrusion 93b to 93e of the upper housing 3 with screws 81b to 81e (refer to FIG. 8). The frame 5b is fixed to the cylindrical protrusion 93f to 93i of the upper housing 3 with screws 81f to 81i (refer to FIG. 8). The frame 5c is fixed to the cylindrical protrusion 93a, 93k and 93j of the upper housing 3 with screws 81a, 81k and 81j (refer to FIG. 8).

Referring to FIG. 4, the reset switch unit 45, the line indicator 10, the cancel key unit 47, the arrow key unit 51a to 51d, the enter key unit 49 and the infrared sensor 50 are mounted on the board 63 corresponding to the reset switch 11, the power lamp 10, the cancel key 13, the arrow keys 17a to 17d, the enter key 15 and the infrared filter 19 as shown in FIG. 1. The board 63 is fixed to the cylindrical protrusions 95a and 95d of the upper housing 3 with screws 83a and 83d (refer to FIG. 8).

Referring also to FIG. 8 and FIG. 9, the power switch unit 53, the channel audio jacks 31R and 31L and the video jack 31 V are mounted on the board 65. The board 65 is fixed to the cylindrical protrusions 97a and 97b of the upper housing 3 (refer to FIG. 6) with screws 89a and 89b. The power jacks 27 and AV and the AV jack 25 are mounted on the board 67. The board 67 is fixed to the cylindrical protrusion 97c of the upper housing 3 (refer to FIG. 6) with screws 89c.

Referring to FIG. 4, the decoration plate 2 is mounted on the surface of the upper housing 3. The lower housing 7 is fixed to the upper housing 3 with screws 33a to 33j inserted into the cylindrical protrusions 103a to 103j of the upper housing 3 (refer to FIG. 3(b)) from the outer side of the lower housing 7. In this case, while the cylindrical protrusions 105a to 105c and 105f to 105h (refer to FIG. 5) of the lower housing 7 are fitted into the cylindrical protrusions 103a to 103c and 103f to 103h of the upper housing 3 (refer to FIG. 6), the boards 63, 65 and 67 are supported by the cylindrical protrusions 105i, 105j, 105d and 105e of the lower housing 7 and the cylindrical protrusions 103i, 103j, 103d and 103e of the upper housing 3 therebetween. Also, the jack guard 23 and the infrared filter 19 are supported by the upper housing 3 and the lower housing 7 therebetween.

The key tops 35, 37 and 39a to 39d are arranged to come in contact respectively with the heads of the cancel key unit 51, enter key unit 49 and arrow key units 51a to 51d, while the head surface of the key tops 35, 37 and 39a to 39d are exposed through the insertion holes 75, 77 and 79a to 79d. Also, the key tops 41 and 43 are arranged to come in contact respectively with the end portion of the arm 177 of the push mechanism 73 (refer to FIG. 14) and the end portion of the reset switch unit 45.

Incidentally, the cancel key 13 is constituted by the key top 35 and cancel key unit 47. The enter key 15 is constituted by the key top 37 and enter key unit 49. The arrow keys 17a, 17b, 17c and 17d are constituted respectively by the key top 39a and arrow key unit 51a, the key top 39b and arrow key unit 51b, the key top 39c and arrow key unit 51c, and the key top 39d and arrow key unit 51d. The reset switch 11 is constituted by the key top 43 and reset switch unit 45. The power supply switch 9 is constituted by the key top 41, push mechanism 73 and power switch unit 53.

(B) Structure of Cartridge 500

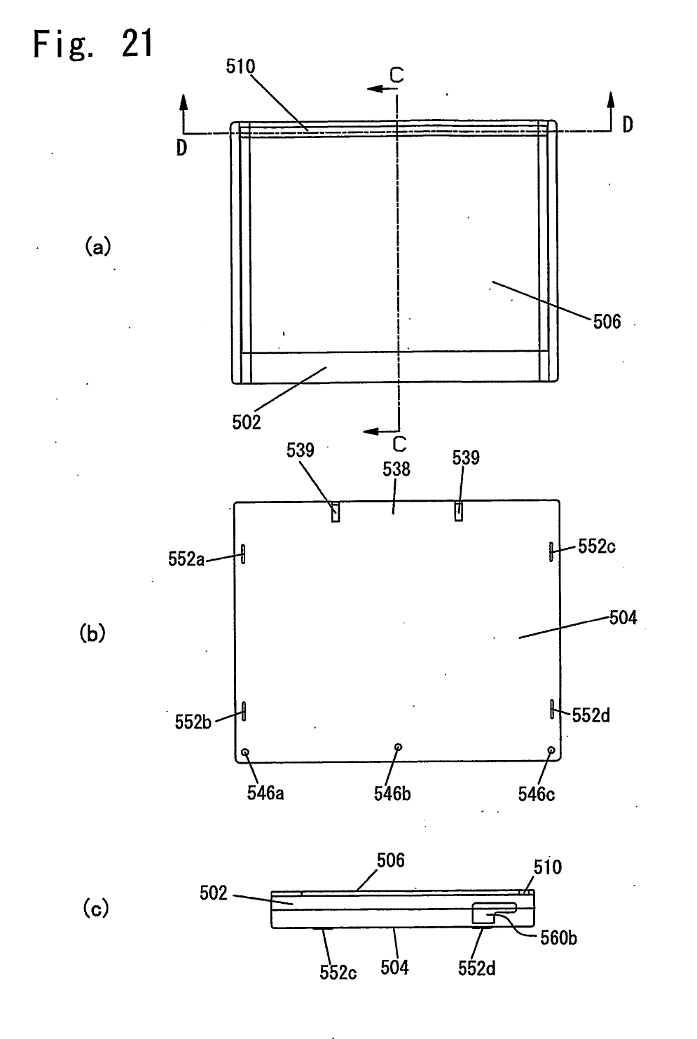

FIG. 21(a) is a plan view showing the cartridge 500 of FIG. 1; FIG. 21(b) is a bottom view showing the cartridge 500; and FIG. 21(c) is a right side view showing the cartridge 500. FIG. 22 is a cross sectional view along C-C line of FIG. 21(a). FIG. 23 is an exploded perspective view showing the cartridge 500 of FIG. 1. As shown in FIG. 23, the cartridge 500 has a flat rectangular parallelepiped shape with an upper face, a lower face, a right and a left side face, a front and a back face, and includes a fixation member 510, a top plate 506, an upper housing 502, a shield member 508, nuts 514a to 514d, cylindrical members 516a to 516d, a dust entry prevention member 512, a board 518, a shield member 520 and the lower housing 504.

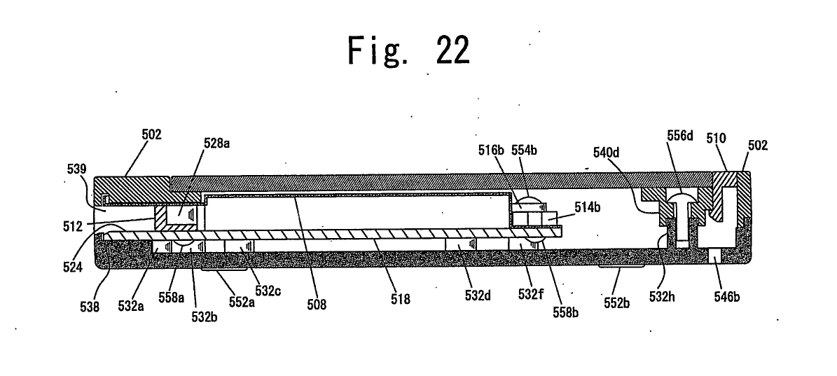

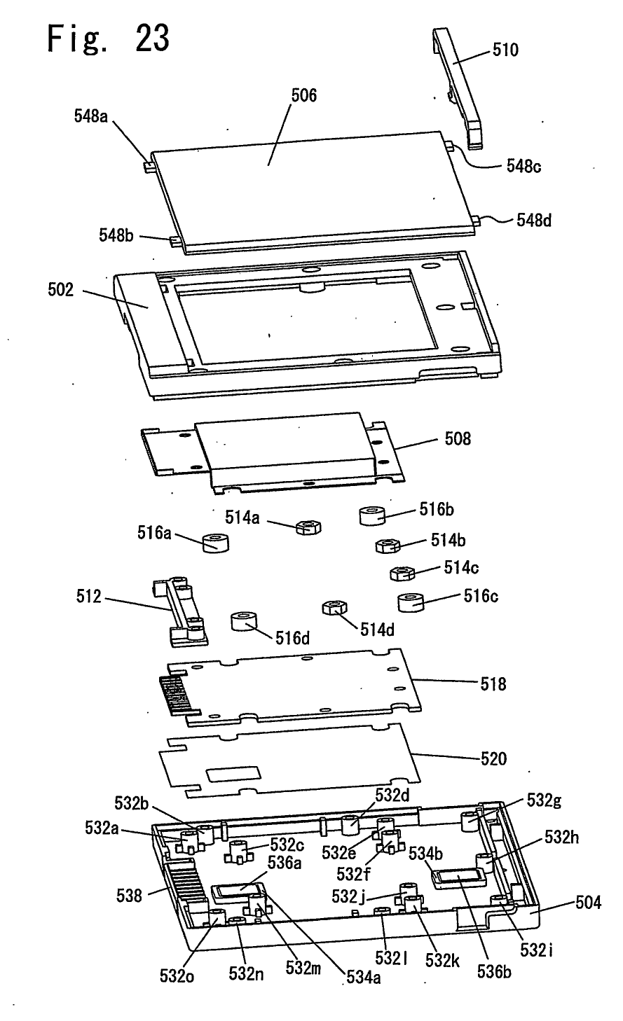

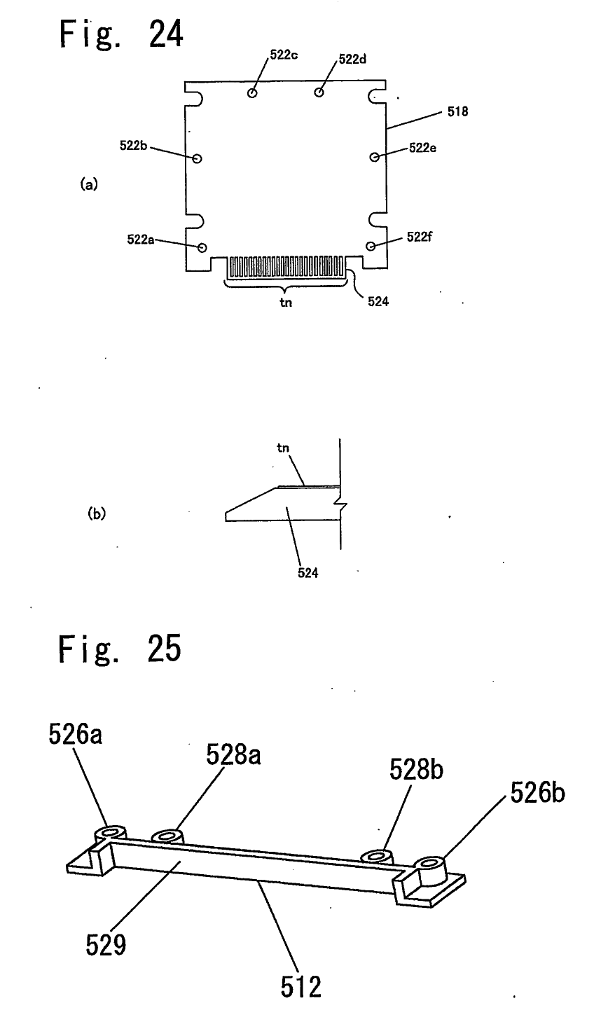

FIG. 24(a) is a plan view showing the board 518 of FIG. 23; and FIG. 24(b) is a right side view showing a connector section 524 of the board 518.

As shown in FIG. 24(a), semicircular cutting sections are formed at opposite side edges of the rectangular board 518 while holes 522a to 522f are formed along the edges except for the front edge. At the front edge of the board 518, there are an indent section, a protruding section continued from the indent section, and another indent section further continued from the protruding section. This protruding section is the connector section 524. 24 terminals t1 to t24 (the term “terminal tn” is used to generally represent these terminals) are formed in the width direction of the connector section 524. As shown in FIG. 24(b), the leading edge of the connector section 524 is formed with a sloped surface downward for making it possible to smoothly insert the cartridge 500 into the connector 69 of FIG. 17(c). For the same reason, as shown in FIG. 18, the edge (opening edge) of the indented engagement section 211 is formed with a sloped surface.

FIG. 25 is a perspective view showing the dust entry prevention member 512 of FIG. 23. As shown in FIG. 25, the dust entry prevention member 512 includes a wall section 529 to prevent external dust from entering the inside through the indented engagement section 539. Also, the surface of the dust entry prevention member 512 is provided with cylindrical protrusions 526a, 526b, 528a and 528b. The cylindrical protrusions 526a and 526b of this dust entry prevention member 512 are aligned respectively with the holes 522a and 522f of the board 518, followed by screwing screws 558a (refer to FIG. 22) and 558f (not shown in the figure) into the cylindrical protrusions 526a and 526b. The dust entry prevention member 512 is attached to the board 518 in this manner.

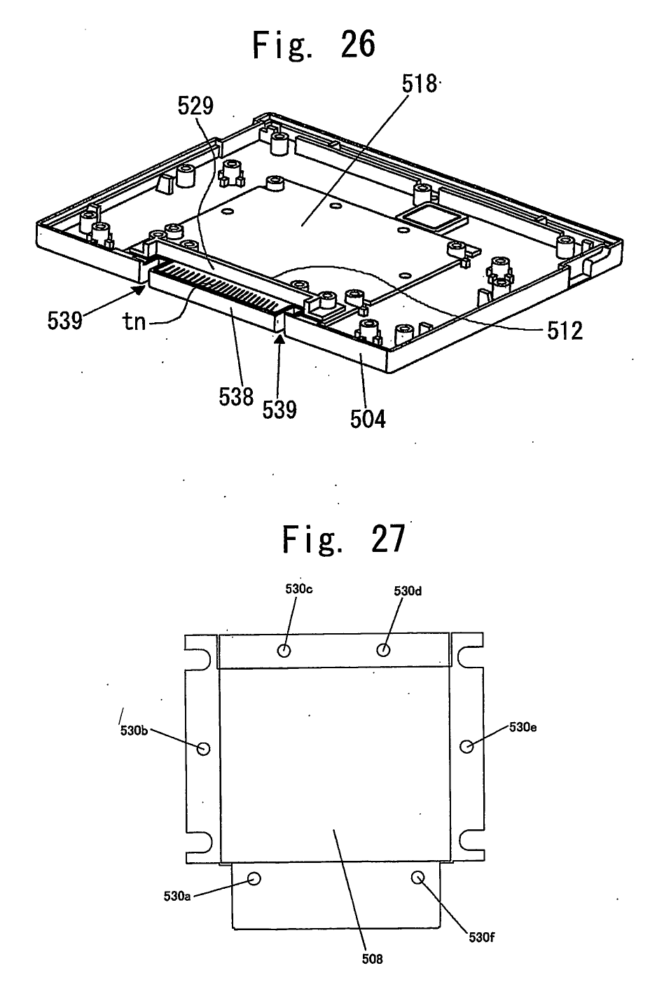

FIG. 26 is a view for explaining the use of the dust entry prevention member 512 of FIG. 25. FIG. 26 shows the lower housing 504 on which the board 518 is placed with the dust entry prevention member 512. As shown in FIG. 26, while the terminals tn are exposed, the wall section 529 of the dust entry prevention member 512 is arranged in parallel to the front edge of the protruded engagement section 538 with its opposite side edges bending at a right angle toward the front side of the lower housing 504 and extending in the vicinity of the front side of the lower housing 504 along the outer side of the indented engagement section 539. As has been discussed above, the dust entry prevention member 512 serves to stop the gap near the indented engagement section 539 of the cartridge 500 after completion (refer to FIG. 22) so that the entry of external dust is prevented.

FIG. 27 is a plan view showing the shield member 508 of FIG. 23. As shown in FIG. 27, the shield member 508 has a shape and a size required for covering the entirety of the board 518 of FIG. 24(a). Semicircular cutting sections are formed at opposite side edges of the shield member 508 while holes 530a to 530f are formed along the outer edges.

The holes 530b to 530e of the shield member 508 are positioned to be aligned with the holes 522b to 522e of the board 518 on which the dust entry prevention member 512 is attached. Then, the screws 558a to 558d (not shown in the figure, except for the screw 558b shown in FIG. 22) are inserted into the holes 522b to 522e and the holes 530b to 530e from the bottom side of the board 518, and screwed into the nuts 514a to 514d respectively. Furthermore, the holes 530a and 530f of the shield member 508 are positioned to be aligned respectively with the cylindrical protrusions 528a and 528b of the dust entry prevention member 512, followed by screwing screws into the cylindrical protrusions 528a and 528b. The shield member 508 is attached to the board 518 in this manner.

As shown in FIG. 22, while the shield member 508 is in contact with the board 518 only by the attachment surfaces (three surfaces (refer to FIG. 27)), there is a space between the upper portion of the shield member 508 and the board 518 so that the shield member 508 shall not come in contact with wirings, an LSI (large scale integrated circuit), electronic parts and the like formed on the board 518.

FIG. 28 is a plan view showing the inside of the lower housing 504 of FIG. 23. As shown in FIG. 28, the cylindrical protrusion 532b, 532d, 532g, 532h, 532i, 5321 and 532n are formed along the edge of the lower housing 504 except for the front edge. Furthermore, in the inside of lower housing 504, the cylindrical protrusion 532c, 532f, 532j and 532m and the cylindrical protrusion 532a, 532e, 532k and 532o are formed. Each of the cylindrical protrusion 532c, 532f, 532j, 532 m, 532a, 532e, 532k and 532o are provided with four support members which are formed around the protrusion and have a flat head. In this case, the length of this support member from its base to its end is smaller than the length of the cylindrical protrusion from its base to its end.

Also, fixation frames 534a and 534b are formed inside of the lower housing 504, and metal plates 536a and 536b are fixedly fitted into the fixation frames 534a and 534b. The fixation frames 534a and 534b are formed in order to be positioned just above the openings 137a and 137b (refer to FIG. 9) of the elevator board 55 when the cartridge 500 is placed on the decoration plate 4 of the adapter 1 of FIG. 1. Referring also to FIG. 21(b), three through-holes 546a to 546c are formed along the back edge of the lower housing 504. There is no through-hole other than the three through-holes 546a to 546c through the lower housing 504 while the holes opened in the cylindrical protrusions 532a to 532o are blind holes which are not formed all the way through the lower housing 504.

Recess sections are formed on the opposite side surfaces of the lower housing 504 near the back face in order to form the locking grooves 560a and 560b. Also, as shown in FIGS. 21(b) and 21(c) and FIG. 22, spacers 552a to 552d are formed on the outer surface of the lower housing 504. With the spacers 552a to 552d, the entire outer surface of the lower housing 504 is prevented from coming in contact with the decoration plate 4 of the adapter 1 to avoid scratching the entire surface of the decoration plate 4 and rubbing off letters, graphics and the like as much as possible.

Returning to FIG. 28, there are a protruding section forming the protruded engagement section 538, an indented section forming the indented engagement section 539 in the front end of the lower housing 504.

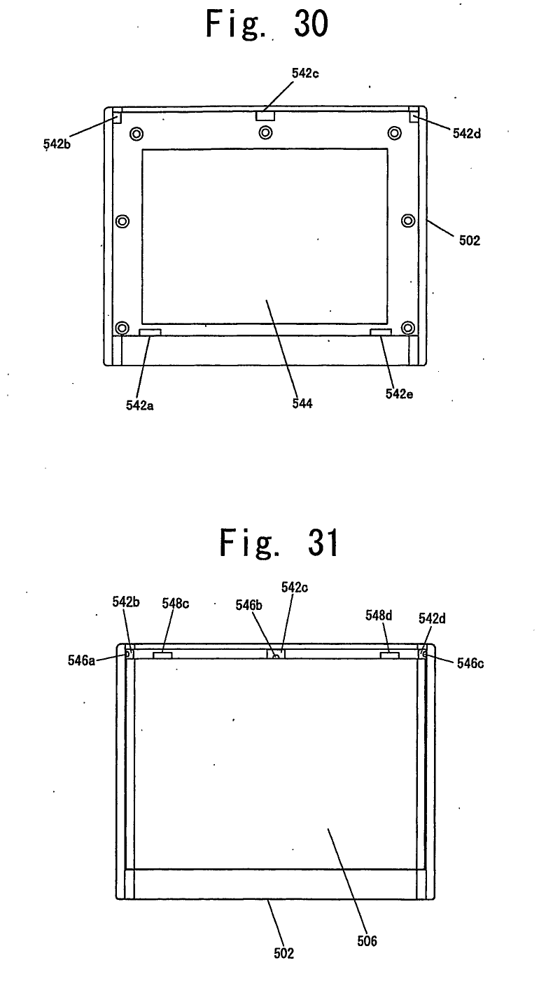

FIG. 29 is a perspective view showing the inside of the upper housing 502 of FIG. 23. FIG. 30 is a plan view showing the upper housing 502 of FIG. 23. As shown in FIG. 29 and FIG. 30, the upper housing 502 is provided with an opening 544 in the form of a rectangle. Also, in the inner surface of the upper housing 502, cylindrical protrusions 540a to 540g are formed along the outer edges except for the front edge. Holes are formed through the insides of the cylindrical protrusions 540a to 540g to the surface of the upper housing 502 in order that a screw can be screwed through the upper housing 502 from the upper face. Also, insertion holes 542a and 542e and insertion holes 542b, 542c and 542d are formed respectively in the front side and back side of the upper housing 502. Meanwhile, the insertion holes are formed all the way through the upper housing 502 from the upper surface to the inner surface. Recess sections are formed on the opposite side surfaces of the upper housing 502 near the back face in order to form the locking grooves 560a and 560b.

By the way, the shield member 520 (refer to FIG. 23) having a shape similar to the board 518 is attached to the inner surface of the lower housing 504. This shield member 520 is made for example of a copper foil. Then, the board 518 is placed on the support members formed around the cylindrical protrusions 532c, 532f, 532j and 532m by fitting the cylindrical protrusions 532c, 532f, 532j and 532m of the lower housing 504 onto the semicircular cutting sections (refer to FIG. 24(a) and FIG. 27) at both side edges of the board 518 on which the dust entry prevention member 512 and the shield member 508 are mounted. The cylindrical members 516a to 516d are fitted onto the respective end portions of the cylindrical protrusions 532c, 532f, 532m and 532j, followed by screwing screws 554a to 554d (not shown in the figure, except for the screw 554b shown in FIG. 22) into the cylindrical protrusions 532c, 532f, 532 m and 532j to fix the board 518 to the lower housing 504.

Next, the cylindrical protrusions 540a to 540g in the inner surface of the upper housing 502 are fitted onto the respective cylindrical protrusions 532b, 532d, 532g, 532h, 532i, 5321 and 532n of the lower housing 504, followed by screwing screws 556a to 556g (not shown in the figure, except for the screw 556d shown in FIG. 22) into the cylindrical protrusions 532b, 532d, 532g, 532h, 532i, 5321 and 532n from the openings in the outer surface of the upper housing 502 to fix the upper housing 502 to the lower housing 504. Then, the top plate 506 is fitted into the surface of the upper housing 502 by inserting insert sections 548a and 548b, which are formed to project from the front edge of the top plate 506, into the insertion holes 542a and 542e of the upper housing 502.

FIG. 31 is a plan view showing the state that the top plate 506 of FIG. 23 is fitted into the surface of the upper housing 502. In this state that the top plate 506 is temporarily secured to the surface of the upper housing 502, the fixation member 510 of FIG. 23 is fitted into the insertion holes 542b, 542c and 542d to complete the cartridge 500. This point will be explained in detail.

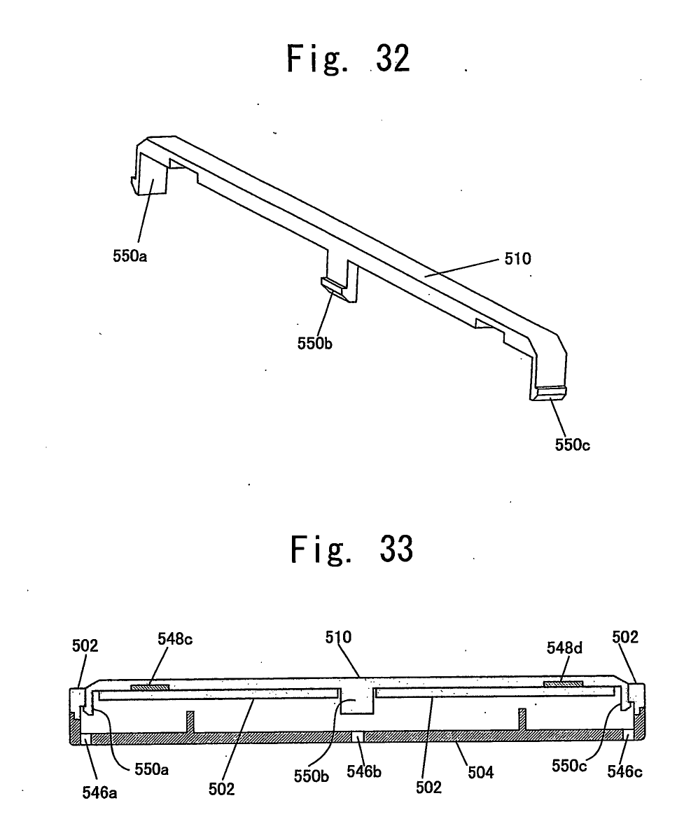

FIG. 32 is a perspective view showing the fixation member 510 of FIG. 23. As shown in FIG. 32, claw portions 550a and 550c are formed outward at the opposite ends of the fixation member 510. Also, a claw portion 550b is formed inward at the central portion of the fixation member 510. The fixation member 510 is placed over insert sections 548c and 548d, which are formed to project from the back corners of the top plate 506 of FIG. 31, with the claw portions 550a to 550c being fitted respectively into the insertion holes 542b to 542d of FIG. 31. By this action, the top plate 506 can be fixed.

FIG. 33 is a cross sectional view along D-D line of FIG. 21(a). As shown in FIG. 33 and FIG. 22, the claw portions 550a to 550c of the fixation member 510 catch the edges of the upper housing 502 to fix the fixation member 510 to the upper housing 502.

Next, with reference to FIG. 22 and FIG. 33, the method of disassembling the cartridge 500. There is no screw head exposed to the external surface of the cartridge 500 as constructed above. Accordingly, when disassembling the cartridge 500 for example for the purpose of maintenance, the following steps are taken. The claw portions 550a to 550c are unhooked from the edges of the upper housing 502 by inserting a long and slim stick through the holes 546a to 546c formed in the lower housing 504. The fixation member 510 is thereby disengaged from the upper housing 502, so that the cartridge 500 can be disassembled by the backward process to the above assembling process.

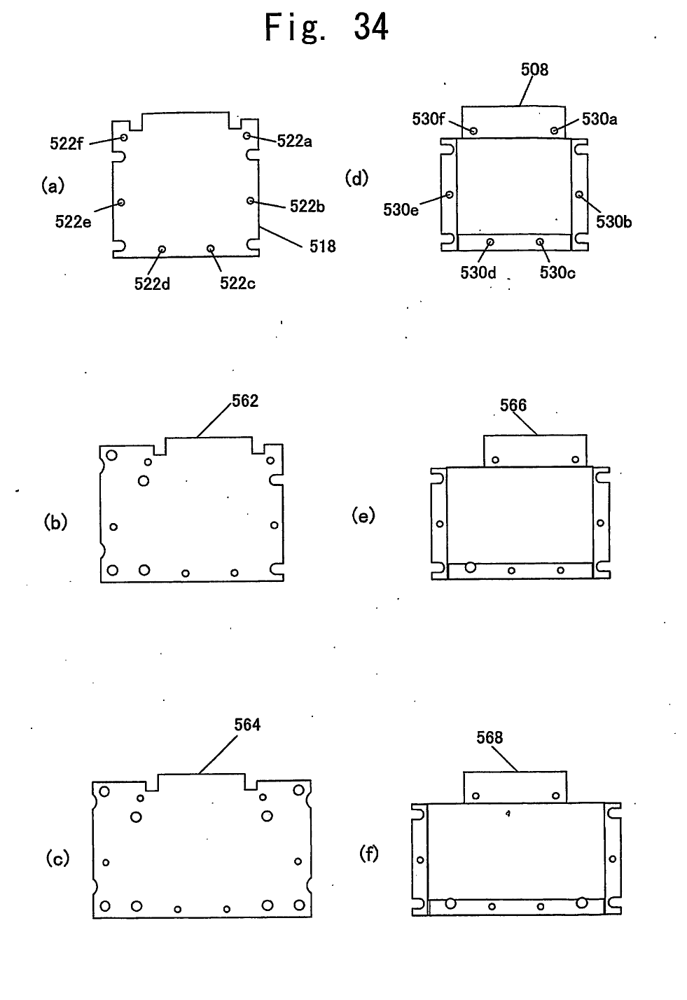

FIG. 34(a) is a plan view showing the board 518 of FIG. 23; FIG. 34(b) is a plan view showing a medium size board 562 which is lager in size than the board 518; FIG. 34(c) is a plan view showing a large size board 564 which is lager in size than the medium size board 562; FIG. 34(d) is a plan view showing the shield member 508 of FIG. 23; FIG. 34(e) is a plan view showing a medium size shield member 566 which is lager in size than the shield member 508; and FIG. 34(f) is a plan view showing a large size shield member 568 which is lager in size than the medium size shield member 566. In the above example, while the board 518 is employed as the board for use, the shield member 508 is employed as the shield member for use. However, it is possible to install the medium size board 562 and medium size shield member 566 which are larger in size than them, or the large size board 564 and large size shield member 568 which are furthermore larger in size than them into the lower housing 504 without modification of the structure thereof. This is because, as illustrated in FIG. 28, the cylindrical protrusions 532a, 532e, 532k and 532o are formed in advance conforming to the size of the large size board 564 in addition to the cylindrical protrusions 532c, 532f, 532j and 532m formed conforming to the size of the board 518.

The large size board 564 and the large size shield member 568 can be installed by fitting them into the cylindrical protrusions 532a, 532e, 532k and 532o, in the same manner as the board 518 and the shield member 508. The medium size board 562 and the medium size shield member 566 can be installed by fitting the medium size board 562 and the medium size shield member 566 into the cylindrical protrusions 532c, 532f, 532k and 532o, in the same manner as the board 518 and the shield member 508.

By the way, with reference to FIG. 18 and FIG. 22, the relation between the cartridge 500 and the connector 69 of the adapter 1, when connecting them, will be explained in detail. The protruded engagement section 538 and indented engagement section 539 of the cartridge 500 are fitted respectively to the indented engagement section 211 and protruded engagement section 215 of the connector 69. Then, the terminals t1 to t24 (refer to FIG. 24(a)) formed on the board 518 of the cartridge 500 come in contact with the contacts 214 of the terminals T1 to T24 of the connector 69 in a one-to-one correspondence. On the other hand, since the shield member 508 of the cartridge 500 is exposed to the indented engagement section 539, the shield member 508 comes in contact with the contact members 207 of the shield member 201 of the connector 69. In this case, the base ends of the contact members 207 of the shield member 201 bend toward the indent section 198 formed in the upper surface of the connector 69, and therefore the ridge profile of the contact members 207 is prevented from deforming to cause bad connection by the long term use.

(C) Another Exemplary Cartridge (Imaging Unit Equipped Cartridge)

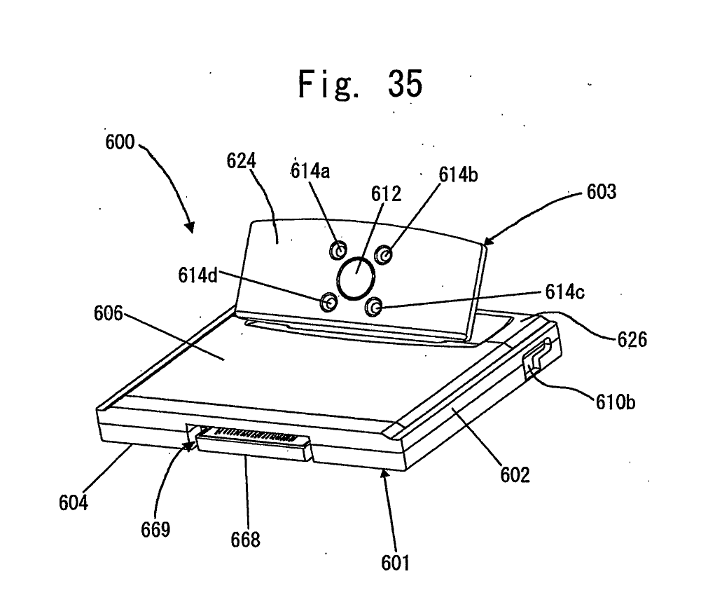

FIG. 35 is a perspective view showing an imaging unit equipped cartridge 600 to be inserted into the adapter 1 of FIG. 1. As shown in FIG. 35, the imaging unit 603 is provided on the upper surface of the main body 601 of this cartridge 600. Also, locking grooves 610a and 610b are formed on the opposite side surfaces of the cartridge main body 601 in the same manner as those of the cartridge 500 of FIG. 1. The functionality thereof is the same as that of the locking grooves 560a and 560b of the cartridge 500. Also, in the same manner as the cartridge 500 of FIG. 1, the cartridge 600 is provided with a protruded engagement section 668 having exposed terminals tn and an indented engagement section 669 having an exposed shield member 508 (not shown in the figure) which are designed to be fitted to the indented engagement section 211 and protruded engagement section 215 of the connector 69 respectively. The procedure of installing the cartridge 600 into the adapter 1 is the same as the procedure of installing the cartridge 500 (refer to FIGS. 19(a) to 19(d)). The mechanism of locking the cartridge 600 as installed is the same as the mechanism of locking the cartridge 500 (refer to FIGS. 20(a) to 20(d)).

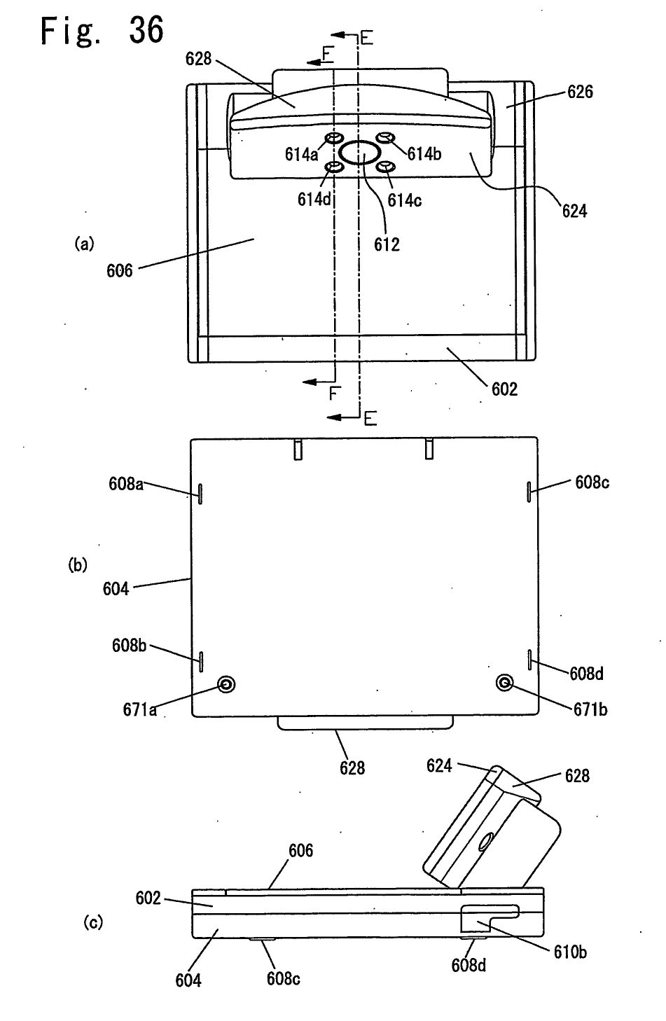

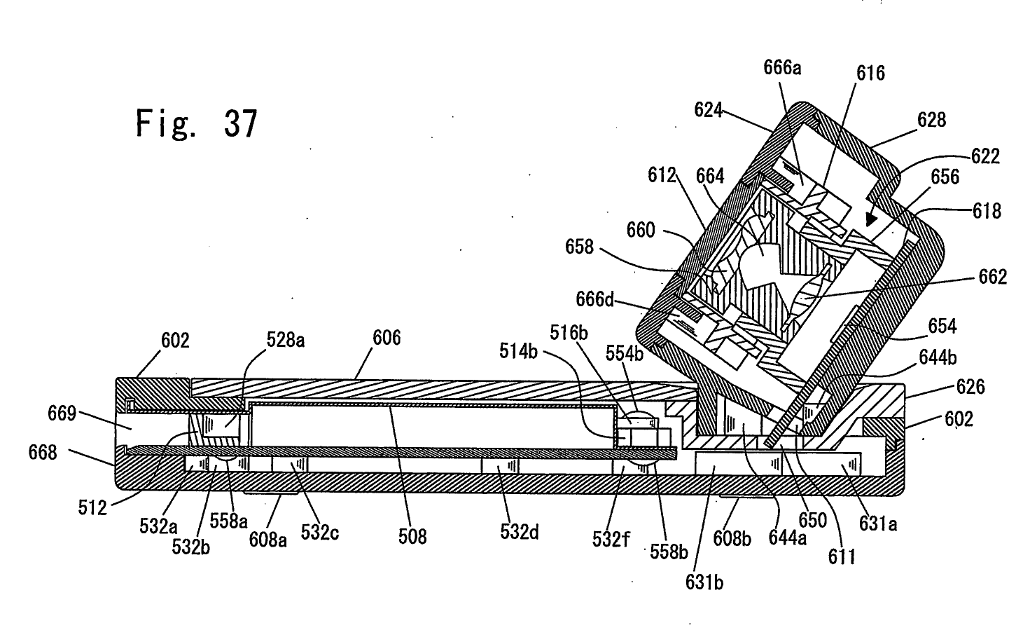

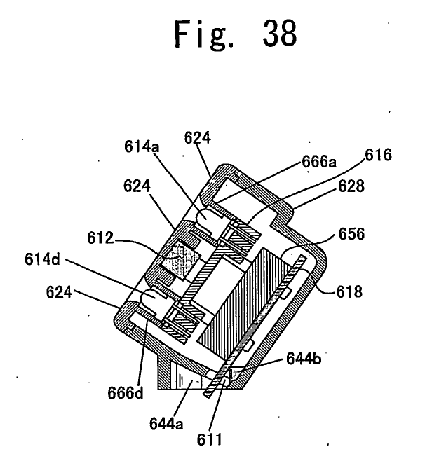

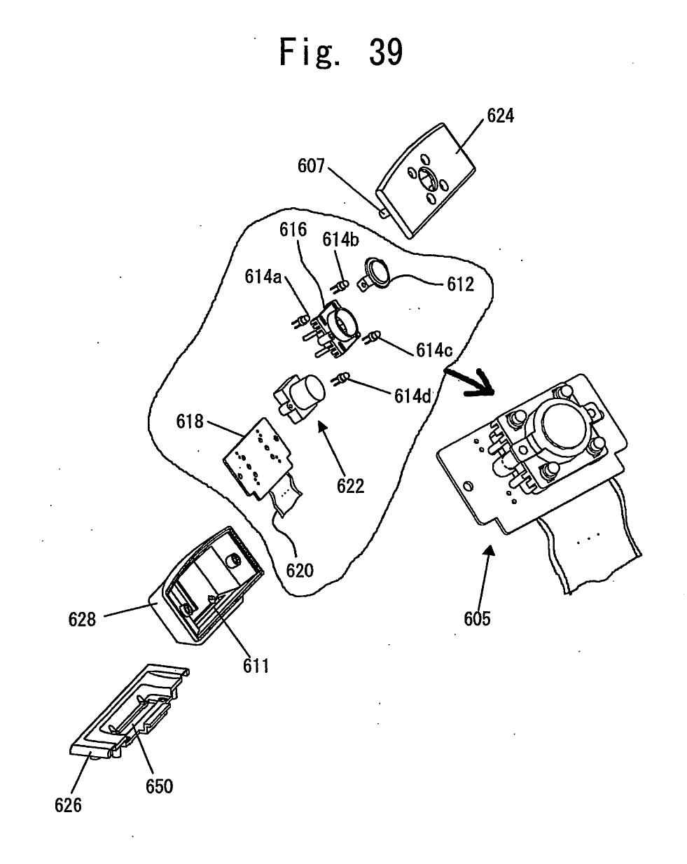

FIG. 36(a) is a plan view showing the cartridge 600 of FIG. 35; FIG. 36(b) is a bottom view showing the cartridge 600; and FIG. 36(c) is a right side view showing the cartridge 600. FIG. 37 is a cross sectional view along E-E line of FIG. 36(a). FIG. 38 is a cross sectional view along F-F line of FIG. 36(a) and showing only the imaging unit 603. FIG. 39 is an exploded perspective view showing the imaging unit 603 of FIG. 35. As shown in FIG. 39, the imaging unit 603 includes a cover plate 624, an infrared filter 612 capable of selectively transmitting only infrared rays, infrared light emitting diodes 614a to 614d, an LED holding member 616, a lens unit 622, a board 618 provided with a coated conductor bundle 620, a housing member 628 and a base plate 626.

The lens unit 622 is mounted on the board 618. Then, the lens unit 622 has a cylindrical section which is fitted into the hole of the cylindrical section of the LED holding member 616. Furthermore, the hole of the cylindrical section of the LED holding member 616 is closed by the infrared filter 612. In this case, the LED holding member 616 and the infrared filter 612 are coupled and located in order that the holes at the opposite sides of both members are aligned with each other in the vertical direction, followed by inserting screws through the holes to join together. Also, two legs of each of the infrared light emitting diodes 614a to 614d are inserted into two holes formed in the vicinity of a corresponding one of the four corners of the LED holding member 616. The imaging unit assembly 605 is constructed in this manner.

The imaging unit assembly 605 is fixed to the cover plate 624 by screwing screws into two cylindrical protrusion 607 protruded from the inner surface of the cover plate 624 through the rear surface of the board 618. Then, the cover plate 624 is fixed to the housing member 628 together with the imaging unit assembly 605 fixed to the cover plate 624. In this case, the edge portion of the board 618 and the conductor bundle 620 are exposed by inserting them into an opening 611 which is formed through the bottom portion of the housing member 628 (refer to FIG. 37 and FIG. 38 in which the illustration of the conductor bundle 620 is dispensed with). Then, the housing member 628 is fixed to the surface of the base plate 626. This point will be explained in detail.

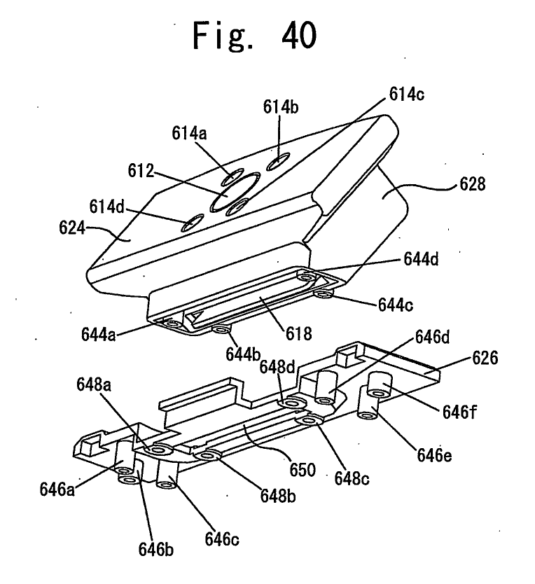

FIG. 40 is a view for explaining the connection between the housing member 628 and the base plate 626 of FIG. 39. As shown in FIG. 40, cylindrical protrusions 644a to 644d formed in the bottom portion of the housing member 628 are aligned respectively with holes 648a to 648d formed through the base plate 626, and then screws are screwed therethrough to fix them. In this case, the edge portion of the board 618 and the conductor bundle 620 are inserted into the opening 650 of the base plate 626 to expose them (refer to FIG. 37).

By the way, as shown in FIG. 38, when the imaging unit assembly 605 is installed to the cover plate 624, the infrared light emitting diodes 614a and 614d are inserted into the holes of the cylindrical sections 666a and 666d protruding from the rear surface of the cover plate 624. The holes of these cylindrical sections 666a and 666d are formed completely through to the surface of the cover plate 624 so that the infrared light emitting diodes 614a and 614d are exposed to the surface of the cover plate 624. This is true also for the infrared light emitting diodes 614b and 614c.

Since the infrared light emitting diodes 614a to 614d are inserted into the cylindrical sections 666a to 666d in this manner, it is possible to prevent infrared rays emitted by the infrared light emitting diodes 614a to 614d from being directly detected by an image sensor 654 (refer to FIG. 37) mounted on the board 618. Furthermore, the cover plate 624 is colored in a frosted black, inclusive of the inner surfaces of the cylindrical sections 666a to 666d into which the infrared light emitting diodes 614a to 614d are inserted. Accordingly, infrared rays emitted by the infrared light emitting diodes 614a to 614d are prevented from transmitting through the cylindrical sections 666a to 666d and from being detected by the image sensor 654 mounted on the surface of the board 618 as much as possible.

Referring to FIG. 37, the lens unit 622 of FIG. 39 is explained in detail. The lens unit 622 includes a unit base 656, a lens holder 658, a concave lens 660 and a convex lens 662. The concave lens 660 is attached to the lens holder 658 in the side facing the infrared filter 612 in parallel with the image sensor 654 mounted on the board 618. Also, the convex lens 662 is attached to the lens holder 658 in the side facing the image sensor 654 in parallel with the image sensor 654. Furthermore, there is a cavity (optical path) 664 between the concave lens 660 and the convex lens 662. The infrared rays as transmitted through the infrared filter 612 are detected by the image sensor 654 after passing through the concave lens 660, the cavity 664 and the convex lens 662. Meanwhile, the lens holder 658 is fixed to the unit base 656.

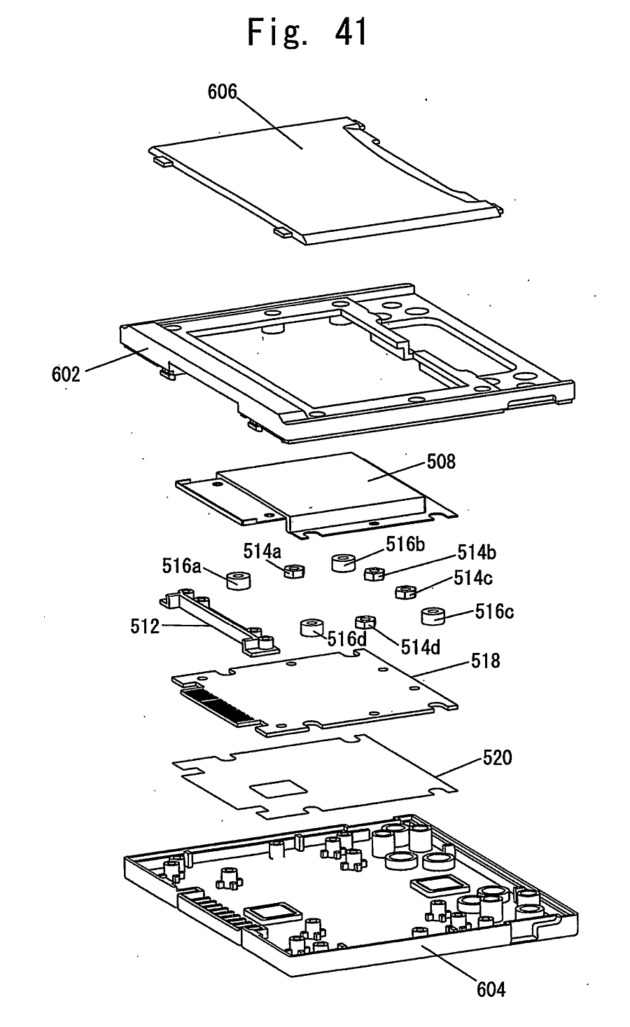

FIG. 41 is an exploded perspective view showing the cartridge unit 601 of FIG. 35. As shown in FIG. 41, the cartridge unit 601 includes a top plate 606, an upper housing 602, a shield member 508, a dust entry prevention member 512, cylindrical members 516a to 516d, nuts 514a to 514d, a board 518, a shield member 520 and a lower housing 604. The shield member 508, the dust entry prevention member 512, the cylindrical members 516a to 516d, the nuts 514a to 514d, the board 518 and the shield, member 520 are the same as those of the cartridge 500 of FIG. 1 as well as the installation process, and therefore no redundant description is repeated.

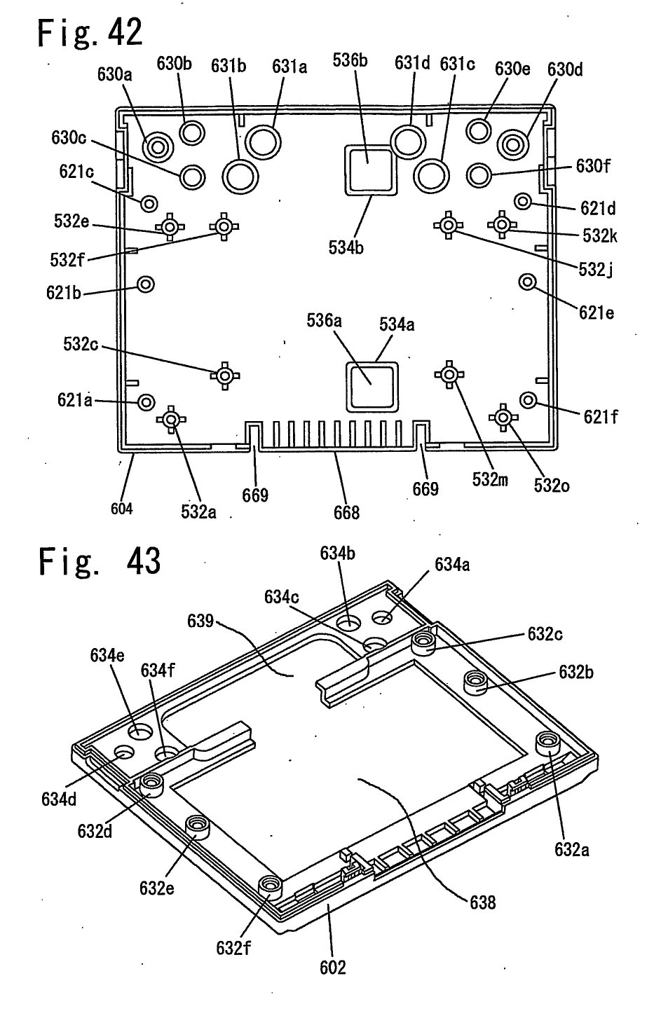

FIG. 42 is a plan view showing the inside surface of the lower housing 604 of FIG. 41. As shown in FIG. 42, the cylindrical protrusions 532c, 532f, 532j and 532m and the cylindrical protrusions 532a, 532e, 532k and 532o are formed in the inside surface of the lower housing 504. These cylindrical protrusions have the same functionality as the cylindrical protrusions 532c, 532f, 532j and 532 m and cylindrical protrusions 532a, 532e, 532k and 532o of the lower housing 504 of the cartridge 500 of FIG. 1, and therefore no redundant description is repeated. Accordingly, needless to say, it is possible that the medium size board 562 and shield member 566, or the large size board 564 and shield member 568 as shown in FIG. 34(c) to 34(f) can be installed into the cartridge 600 without need for modification of the structure of the lower housing 604, in the same manner as the substrate 518 and the shield member 520.

Also, cylindrical protrusions 621a to 621f are formed in the inner surface of the lower housing 604 along the opposite side edges thereof. Furthermore, cylindrical protrusions 630a to 630f are formed in the both corners of the back side of the lower housing 604. Only the holes inside of the cylindrical protrusions 630a and 630d are formed therethrough to the outer surface of the lower housing 604. Also, cylindrical protrusions 631a to 631d are formed near the back side of the lower housing 604.

While fixation frames 534a and 534b are formed in the inner surface of the lower housing 604, metal plates 536a and 536b are fixedly fitted into these fixation frames 534a and 534b. The functionality of the metal plates 536a and 536b are the same as the metal plates 536a and 536b of the cartridge 500 of FIG. 1, and therefore no redundant description is repeated.

Recess sections are formed on the opposite side surfaces of the lower housing 604 near the back face in order to form the locking grooves 610a and 610b. Also, as shown in FIGS. 36(b) and 36(c) and FIG. 37, spacers 608a to 608d are formed on the outer surface of the lower housing 604. The functionality of the spacers 608a to 608d is the same as the functionality of the spacers 552a to 552d of the cartridge 500 of FIG. 1, and therefore no redundant description is repeated. Furthermore, there are a protruding section forming the protruded engagement section 668, and a recess section forming the indented engagement section 669 in the front end of the lower housing 604.

FIG. 43 is a perspective view showing the inside of the upper housing 602 of FIG. 41. As shown in FIG. 43, the upper housing 602 is provided with openings 638 and 639 in the form of a rectangle. Also, the cylindrical protrusions 632a to 632f are formed in the inner surface of the upper housing 602 along the opposite side edges thereof. Holes are formed through the insides of the cylindrical protrusions 632a to 632f to the surface of the upper housing 602 in order that a screw can be screwed through the upper housing 602 from the upper face. Also, holes 634a to 634c and holes 634d to 634f are formed respectively in the both corners near the back side of the upper housing 602. Meanwhile, these holes are formed all the way through the upper housing 602 from the upper surface to the inner surface. Recess sections are formed on the opposite side surfaces of the upper housing 602 near the back face in order to form the locking grooves 610a and 610b.

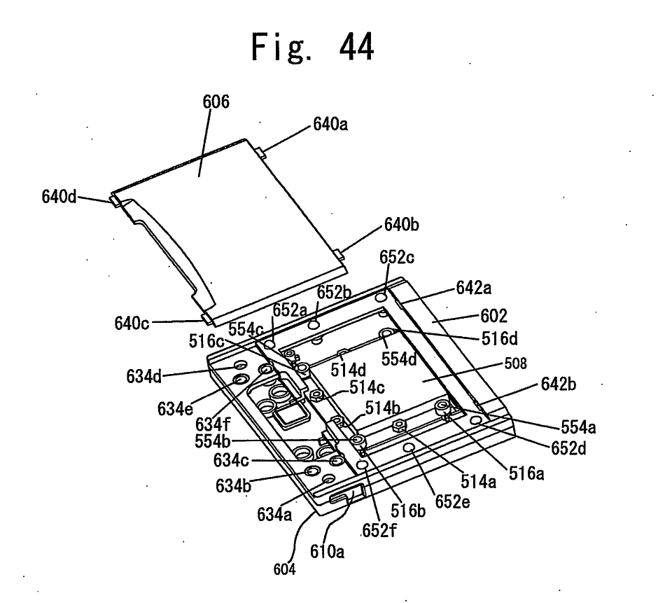

By the way, the cylindrical protrusion 632a to 632f of the upper housing 602 are fitted respectively into the cylindrical protrusions 621a to 621f of the lower housing 604, followed by screwing screws 652a to 652f (refer to FIG. 44 as described below) through the surface of the upper housing 602. In this configuration, the upper housing 602 is fixed to the lower housing 604 on which the board 518 and so forth are fixed.

FIG. 44 is a view for explaining the procedure of attaching the top plate 606 of FIG. 41 to the upper housing 602. As shown in FIG. 44, two insertion holes 642a and 642b are formed in the vicinity of the front edge of the upper housing 602. The top plate 606 is fitted to the upper housing 602 by inserting the insert sections 640a and 640b formed on the front edge of the top plate 606 into the insertion holes 642a and 642b.

Then, the cylindrical protrusions 646a to 646f of the base plate 626 of FIG. 40 are inserted into the holes 634c, 634a, 634b, 634f, 634e and 634d to fit into the cylindrical protrusions 630c, 630a, 630b, 630f, 630e and 630d of the lower housing 604. In this case, the base plate 626 is located over the insert sections 640c and 640d protruded from the rear edge of the top plate 606. Then, the imaging unit 603 is fixed to the cartridge unit 601 by screwing screws 671a and 671b into the cylindrical protrusions 630a and 630d of the lower housing 604 and the cylindrical protrusions 646b and 646f of the base plate 626 through the bottom surface of the lower housing 604.

(D) Exemplary Use 1 of Adapter 1

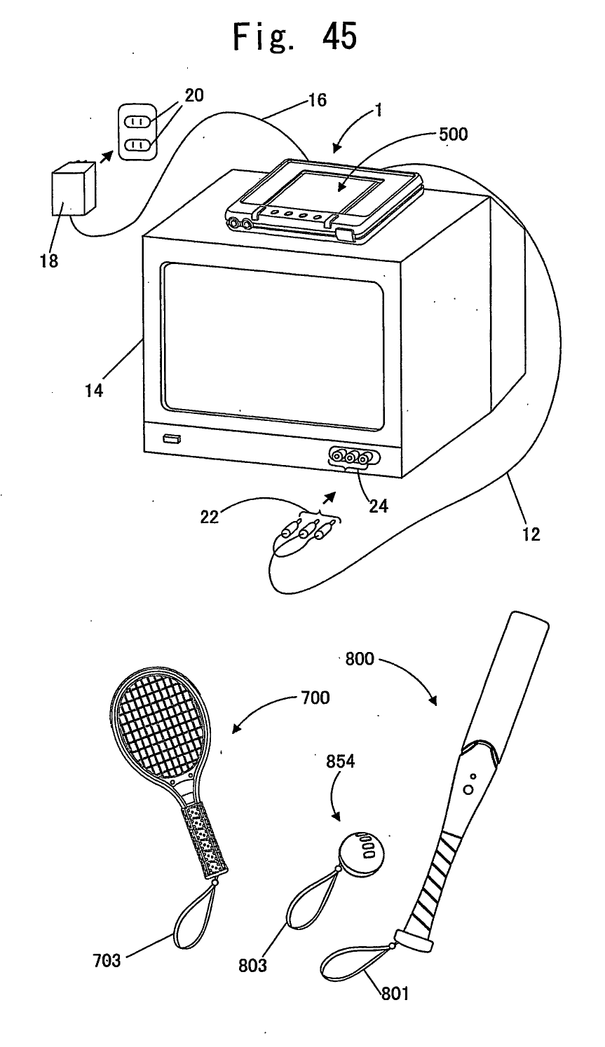

FIG. 45 is an explanatory view for showing an exemplary use 1 of the adapter 1 of FIG. 1. As shown in FIG. 45, while one AV plug (not shown in the figure) of an AV cable 12 is plugged into the AV jack 25 of the adapter 1, the other AV plug 22 is plugged into the AV jack 24 of the television receiver 14. Also, while the plug (not shown in the figure) of a power cable 16 is plugged into the power jack 27 of the adapter 1, the plug of a plug unit 18 is inserted in a plug socket 20. Incidentally, the plug unit 18 comprises a transformer for stepping down the voltage supplied from the plug socket 20 to a certain voltage, and supplies the voltage to the adapter 1 through the power cable 16.

In FIG. 45, the adapter 1 is put on the upper surface of the television receiver 14. In the case of this exemplary use 1, a racket type input device 700 or a bat type input device 800 used in combination with a ball type input device 854 are used. Incidentally, a strap 703 is connected to the end of the grip of the racket type input device 700. In addition, a strap 801 is connected to the knob of the bat type input device 800. Also, a strap 803 is connected to the ball type input device 854. In the following description, the structures of the respective input devices will be explained in turn.

(Racket Type Input Device)

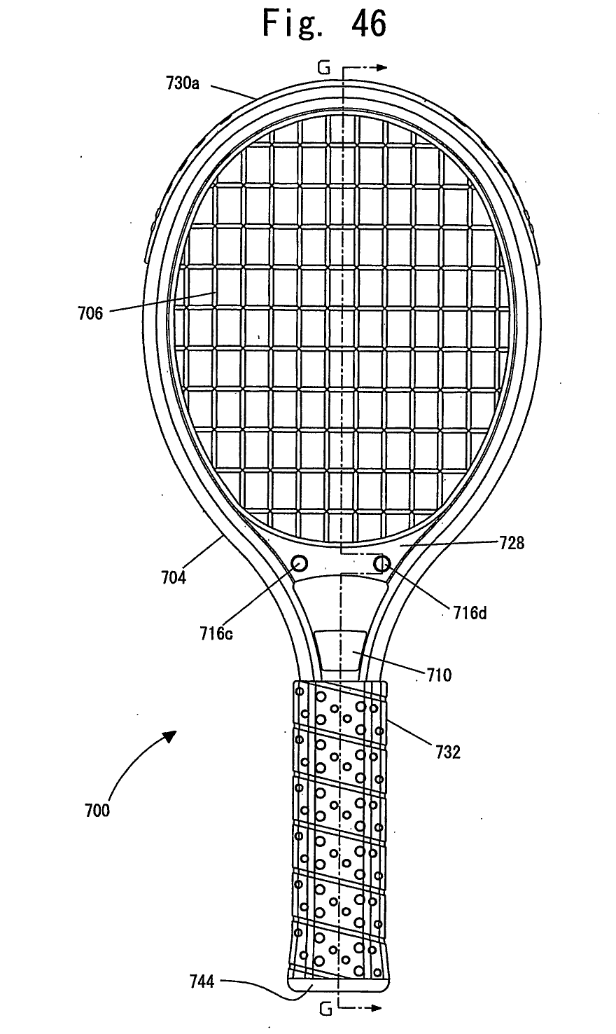

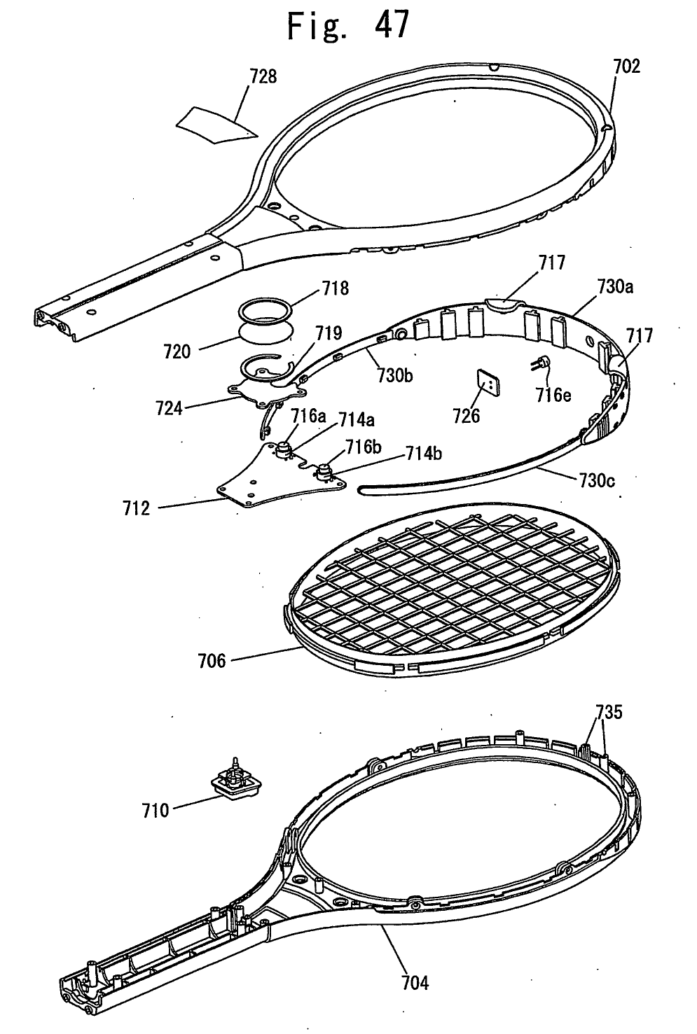

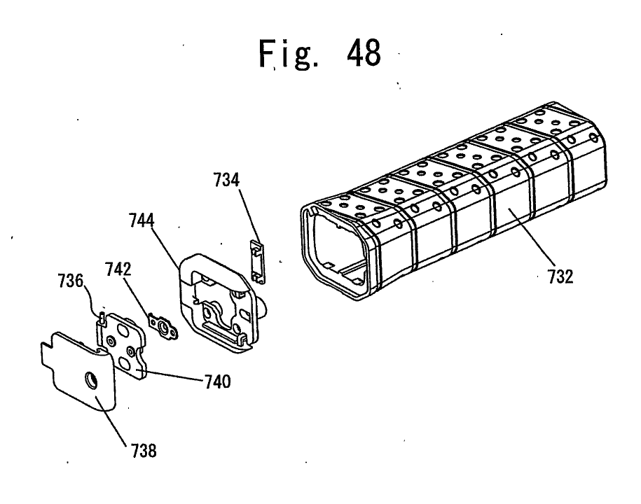

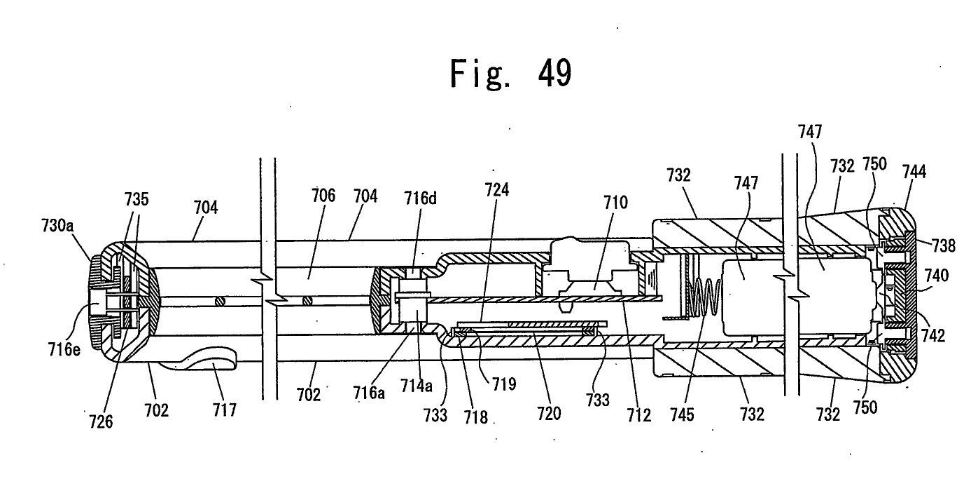

FIG. 46 is a plan view showing the racket type input device 700 of FIG. 45. In this case, the illustration of the strap 703 is omitted. FIG. 47 is an exploded perspective view showing the main body of the racket type input device 700 of FIG. 46. FIG. 48 is an exploded perspective view showing the grip portion of the racket type input device 700 of FIG. 46. FIG. 49 is a cross sectional view along G-G line of FIG. 46.

As shown in FIG. 47 and FIG. 48, the racket type input device 700 is composed of an LED cover 728, a lower housing 702, a rubber ring 718, a piezoelectric element 720, a rubber ring 719, a clipping plate 724, a board 712, LED holders 714a and 714b, infrared light emitting diodes 716a to 716d (the infrared light emitting diodes 716c and 716d are attached in the opposite surface of the board 712 and therefore not illustrated in the figure), a manipulation switch 710, a board 726, an infrared light emitting diode 716e, a side cover 730a provided with screw cover members 717, side covers 730b and 730c, a virtual ball hitting section 706, an upper housing 704, a grip cover 732, a shaft support member 734, a cap frame 744, a battery plate (plus contact) 742, an inner cap 740, a shaft 736, and an outer cap 738.

As shown in FIG. 49, the piezoelectric element 720 is supported between the rubber ring 718 and the rubber ring 719, disposed together in a cylindrical holder 733 having a shallow hole formed in the inner surface of the lower housing 702, and fastened together by the clipping plate 724. Since the rubber rings 718 and 719 are held by the clipping plate 724, the piezoelectric element 720 is fixed in tightly contact with the rubber rings 718 and 719. The piezoelectric element 720 is attached in parallel to the virtual ball hitting surface in this manner.

The LED holders 714a and 714b are attached to the board 712. Each of the LED holders 714a and 714b is designed to receive infrared light emitting diodes from both sides of the lower housing 702 and the upper housing 704. Accordingly, while the infrared light emitting diode 716a is fitted into the LED holder 714a from the side of the lower housing 702, the infrared light emitting diode 716d is fitted into the LED holder 714a from the side of the upper housing 704. Likewise, while the infrared light emitting diode 716b is fitted into the LED holder 714b from the side of the lower housing 702, the infrared light emitting diode 716c is fitted into the LED holder 714b from the side of the upper housing 704. Also, the manipulation switch 710 is attached to the board 712 in the side of the upper housing 704. The board 712 is fixed to the upper housing 704 together with these elements mounted thereon. On the other hand, the infrared light emitting diode 716e is mounted on the board 726. The board 726 on which the infrared light emitting diode 716e is mounted is inserted to the holder 735 which is provided on the end of the upper housing 704.

The virtual ball hitting section 706 and the side cover 730a are supported between the upper housing 704 and the lower housing 702. In regard to the elliptic portion of the racket type input device 700, the upper housing 704 and the lower housing 702 are joined together by screwing screws through the side surfaces thereof in order to fix the side cover 730a and the virtual ball hitting section 706 thereto. Then, the side covers 730b and 730c are attached to the upper housing 704 and the lower housing 702 covering the side surfaces thereof. Also, at two locations of the elliptic portion of the racket type input device 700 near the leading edge thereof, screws are screwed into the upper housing 704 from the surface of the lower housing 702 after pulling up the screw cover members 717 covering the two locations, and thereafter the screw cover members 717 are returned in the initial position to hide the heads of the screws. On the other hand, in regard to the grip portion of the racket type input device 700, the upper housing 704 and the lower housing 702 are joined together by screwing screws from the lower housing 702 to the upper housing 704. Then, the grip cover 732 is fitted onto the grip portions of the upper housing 704 and lower housing 702.

As described above, with the side covers 730a to 730c and the grip cover 732, the head of the screws are not exposed. Meanwhile, the side cover 730a and the grip cover 732 are made, for example, of a non-phthalic base vinyl chloride. Because of this, they are relatively soft.

On the other hand, the infrared light emitting diodes 716e are exposed from the end of the racket type input device 700, the infrared light emitting diodes 716a and 716b are exposed from the surface of the lower housing 702, and the infrared light emitting diodes 716c and 716d are exposed from the surface of the upper housing 704 (refer to FIG. 49). Meanwhile, the LED covers 728 which are transparent are attached in order to cover the infrared light emitting diodes 716a to 716d for the purpose of protecting them (refer to FIG. 46 and FIG. 47).

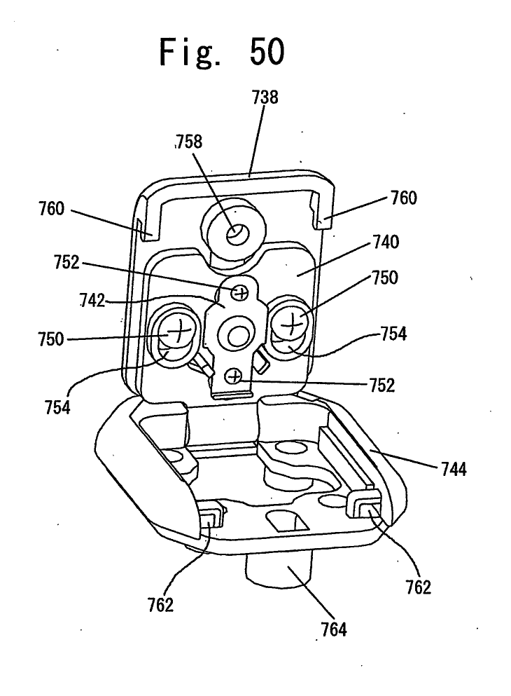

By the way, as shown in FIG. 49, the cap frame 744 is attached to the bottom portion of the grip of the racket type input device 700. The inner cap 740, into which the shaft 736 is inserted, and the shaft support member 734 are attached to this cap frame 744. Also, while the battery plate (plus contact) 742 is attached to the surface of the inner cap 740 with a screw 752 (refer to FIG. 50 as described below), the outer cap 738 is slidably attached to the opposite surface of the inner cap 740 with a screw 750. On the other hand, a battery plate (minus contact) 745 is attached to the back end inside of the grip. In this configuration, after opening the outer cap 738 and the inner cap 740, two size AA batteries 747 are inserted into the inside of the grip followed by closing the outer cap 738 and the inner cap 740, and the outer cap 738 is fixed by screwing a screw from the outer surface of the outer cap 738. Next, the opening and closing mechanism of the outer cap 738 and inner cap 740 will be explained in detail.

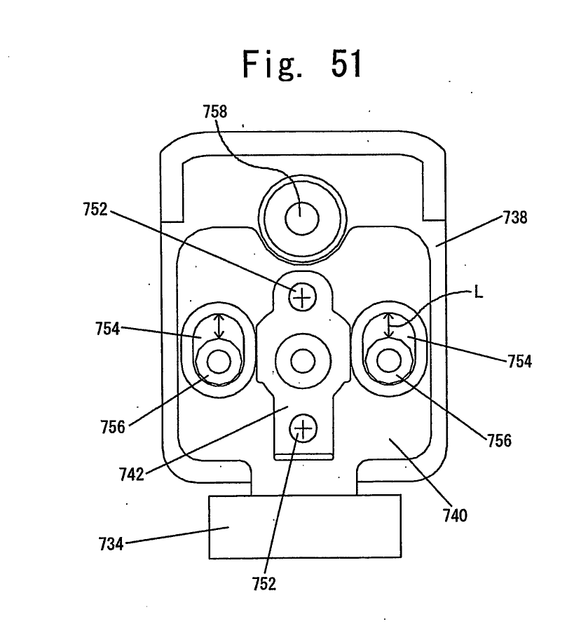

FIG. 50 is a perspective view showing the outer cap 738 and the inner cap 740 of FIG. 49 which are opened. FIG. 51 is a plan view showing the outer cap 738 and the inner cap 740 of FIG. 49 which are closed. FIG. 52 is a side view showing the outer cap 738 and the inner cap 740 of FIG. 49 which are opened and closed. Incidentally, in FIG. 51 and FIG. 52, the illustration of the screw 750 of FIG. 50 is omitted for the sake of clarity in explanation.

As shown in FIG. 50, hook shaped fitting claw portions 760 are formed at the both corners near the leading edge of the outer cap 738. On the other hand, corresponding to the fitting claw portion 760 of the outer cap 738, fitting holes 762 are formed at the both corners near the leading edge of the cap frame 744. Also, as discussed above, the outer cap 738 is slidably attached to the back surface of the inner cap 740 with a screw 750. This point will be explained in detail.

As shown in FIG. 51, two long holes 754 are formed through the inner cap 740. Two cylindrical protrusions 756 formed in the inner surface of the outer cap 738 are inserted into the two long holes 754. In this case, as shown in FIG. 52, the ends of this cylindrical protrusions 756 are projected from the long holes 754 of the inner cap 740. Accordingly, even with the screws 750 screwed into the cylindrical protrusion 756, the outer cap 738 is not fixed to the inner cap 740. Because of this, the outer cap 738 can moved along the long holes 754 of the inner cap 740 for a distance L at a maximum (refer to FIG. 51).

As shown in FIG. 52, the cylindrical protrusions 756 of the outer cap 738 are located in one ends of the long holes 754 of the inner cap 740 (i.e., the ends near the base end of the inner cap 740) when the outer cap 738 and the inner cap 740 are closed. Accordingly, in this case, the fitting claw portions 760 of the outer cap 738 are inserted into the fitting holes 762 of the cap frame 744. Also, in this case, a screw which is inserted through the screw hole 758 formed in the outer cap 738 is screwed into a nut (not shown in the figure) which is fixed to the inside of the cylindrical protrusion 764 (refer to FIG. 50) formed on the cap frame 744 in order to lock the outer cap 738 and the inner cap 740.

On the other hand, when the outer cap 738 and the inner cap 740 are opened, the screw locking the outer cap 738 and the inner cap 740 is removed. Then, the fitting claw portions 760 of the outer cap 738 are got out from the fitting holes 762 of the cap frame 744 by sliding the outer cap 738. Then, the outer cap 738 and the inner cap 740 are opened. As shown in FIG. 52, with the outer cap 738 and the inner cap 740 being opened, the cylindrical protrusions 756 of the outer cap 738 are located in the other ends of the long holes 754 of the inner cap 740 (i.e., the ends near the leading edge of the inner cap 740). When the outer cap 738 and the inner cap 740 are opened in this manner, the outer cap 738 is moved to slide in the backward direction to the direction when closing. Incidentally, the outer cap 738 and the inner cap 740 can be closed by the backward procedure to the opening procedure.

(Bat Type Input Device)

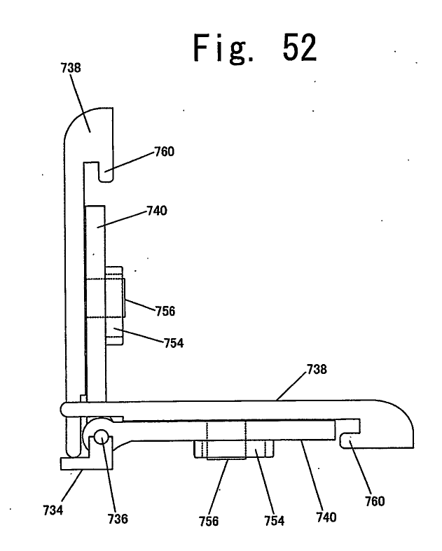

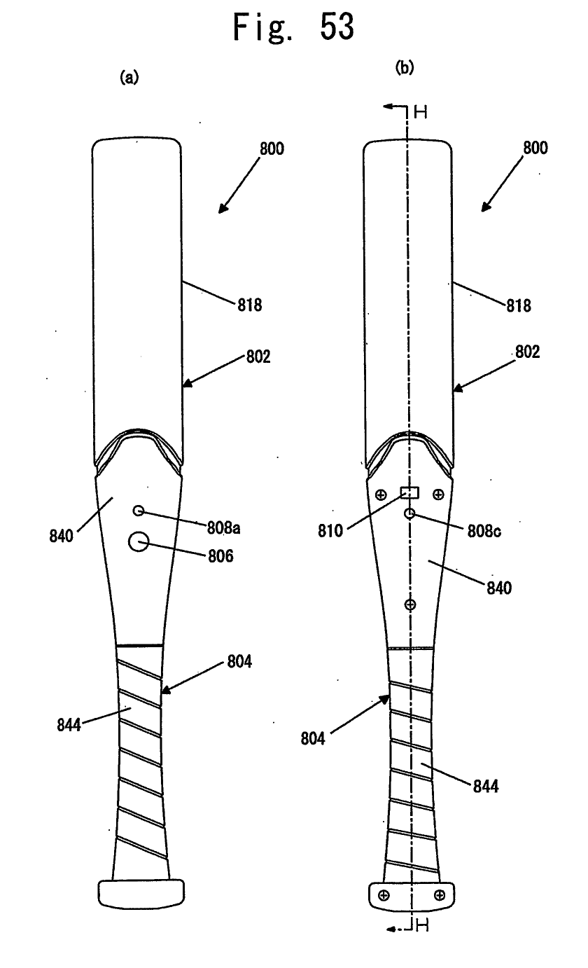

FIG. 53(a) is a plan view showing the bat type input device 800 of FIG. 45; and FIG. 53(b) is a bottom view showing the bat type input device 800. In this case, the illustration of the strap 801 is omitted. As shown in FIG. 53(a) and FIG. 53(b), this bat type input device 800 comprises a head 802 and a main body 804. The main body 804 is composed of an upper half as a control unit 840 and a lower half as a grip section 844.

The control unit 840 of the main body 804 is provided with a manipulation switch 806 as shown in FIG. 53(a), and a separation button 810 located opposite the manipulation switch 806 as shown in FIG. 53(b). Also, four infrared light emitting diodes 808a to 808d are provided on the peripheral surface of the control unit 840 to be exposed at even intervals.

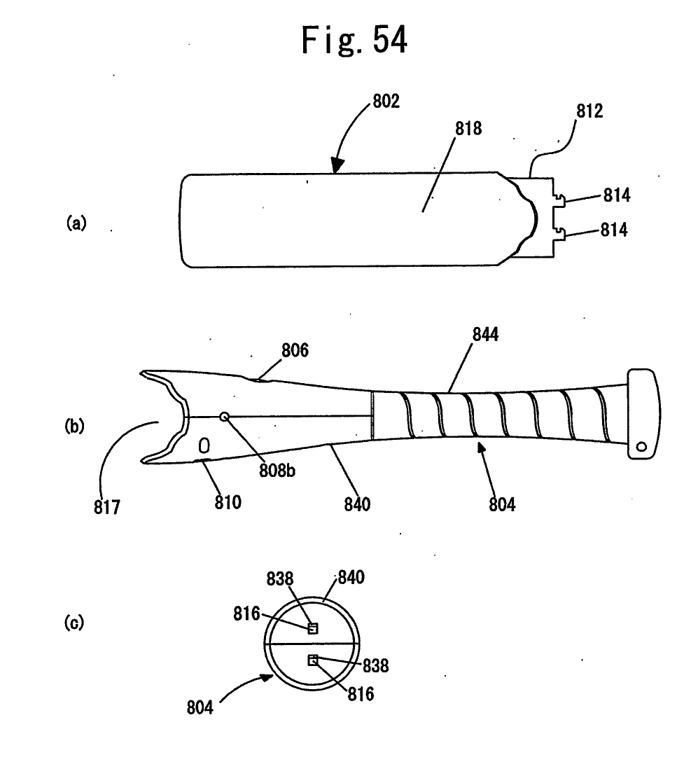

FIG. 54(a) to FIG. 54(c) are explanatory views for showing the bat type input device 800 of FIG. 45 after separation. As shown in FIGS. 54(a) and 54(b), the bat type input device 800 can be divided into the head 802 and the main body 804. As shown in FIG. 54(a), the base end of the head 802 is provided with a connecting member 812 having hooked claw portions 814. On the other hand, on the bottom portion of an opening 817 of the control unit 840, two connecting holes 816 are formed corresponding to the two claw portions 814 of the connecting elements 812 as illustrated in FIG. 54(c). The head 802 and the control unit 840 can be connected by engaging the claw portions 814 with the connecting holes 816. This point will be explained in detail later.

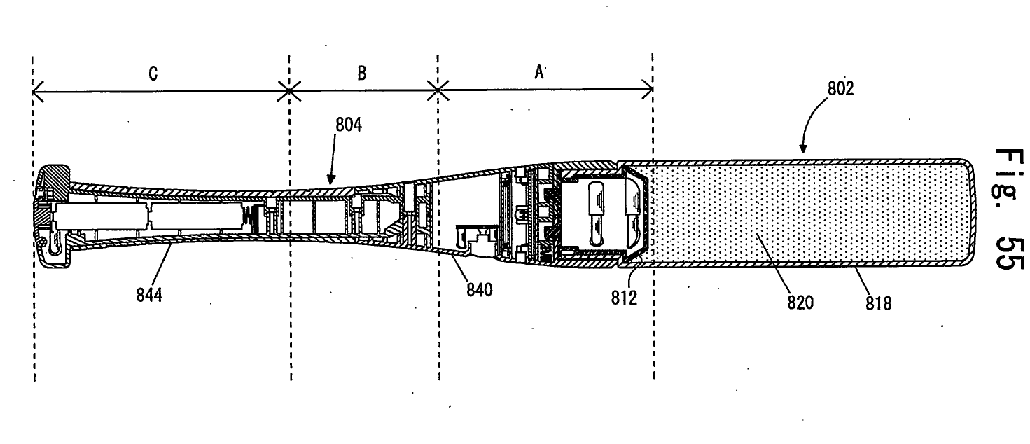

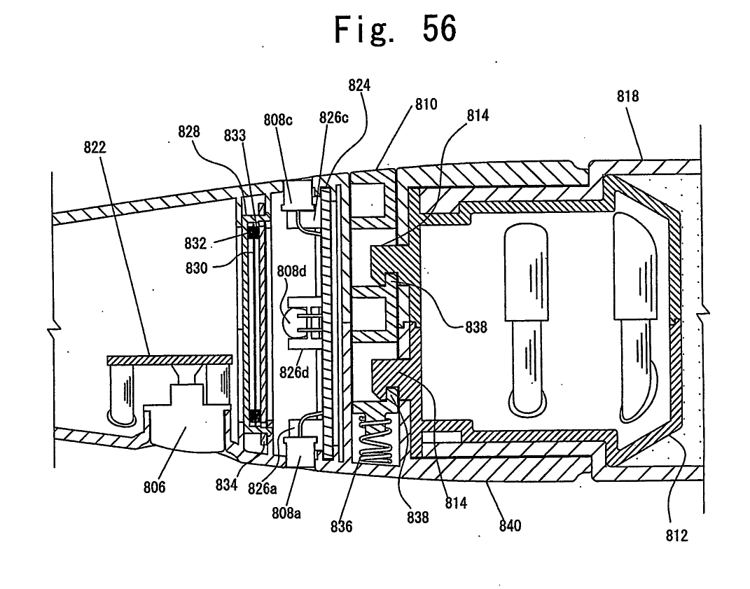

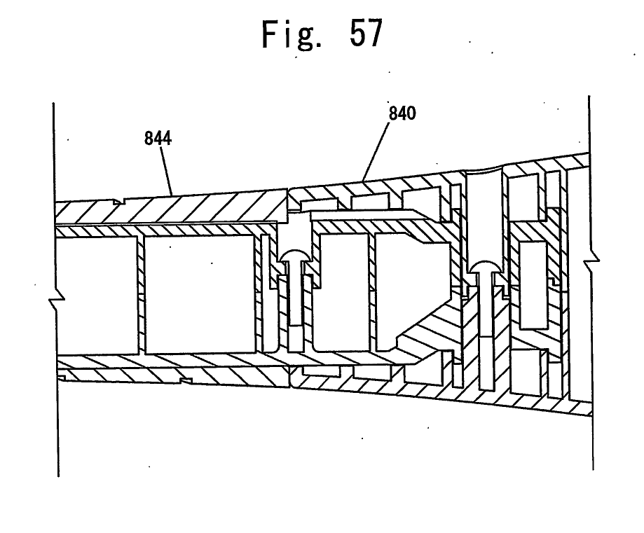

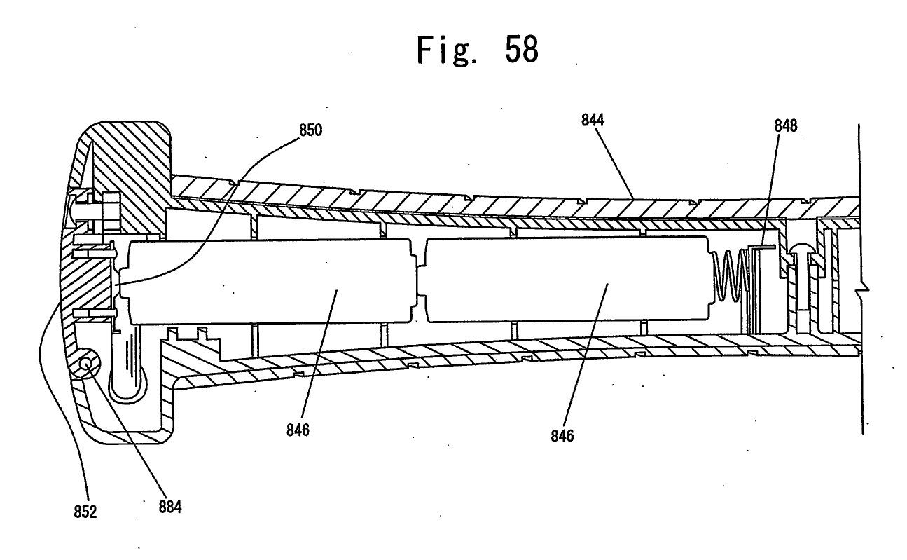

FIG. 55 is a cross sectional view along H-H line of FIG. 53(b). FIG. 56 is an expanded view showing area A of FIG. 55. FIG. 57 is an expanded view showing area B of FIG. 55. FIG. 58 is an expanded view showing area C of FIG. 55.

As shown in FIG. 55, the head 802 comprises a container section 818, sponge 820 and the connecting member 812. The container section 818 is loaded with the sponge 820 in the form of a cylinder, and the connecting member 812 is fixedly inserted into it. Incidentally, the container section 818 and the grip section 844 are made, for example, of a non-phthalic base vinyl chloride.

By the way, the separation button 810 of FIG. 53(b) is shaped in the form of a rectangular parallelepiped and has a cross section as illustrated in FIG. 56. As shown in FIG. 56, a protruding section is formed at the inner end of the separation button 810. Then, while one end of a spring 836 is fitted onto this protruding section, the other end of the spring 836 comes in contact with the inner wall of the control unit 840. Two rectangular openings are formed on the upper surface of the separation button 810 corresponding to the connecting holes 816 of FIG. 54. Then, the claw portions 814 of the connecting member 812 are inserted into the rectangular openings formed on the upper surface of the separation button 810 through the connecting holes 816, and engaged with hooking sections 838 of the separation button 810. The head 802 is connected to the main body 804 in this manner. On the other hand, the following steps are taken for separation.

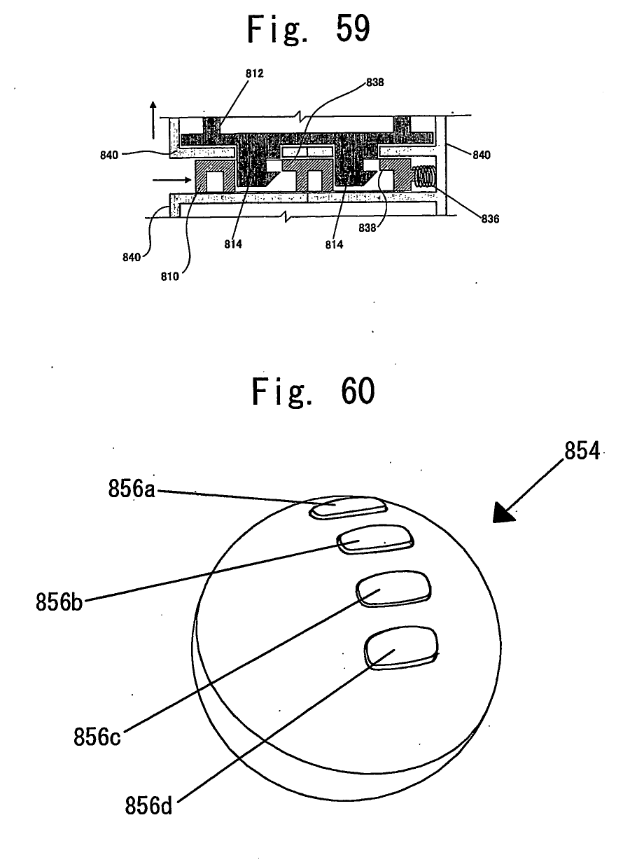

FIG. 59 is an explanatory view for showing the separation mechanism of the bat type input device 800 of FIG. 45. When the separation button 810 is pushed down as shown in FIG. 59, the claw portions 814 are unhooked from the hooking sections 838. Accordingly, the head 802 can be easily pulled out in this state.

By the way, referring to FIG. 56, a board 824 is installed in the inside of the control unit 840 parallel to the central axis of the bat type input device 800. Then, infrared light emitting diodes 808a to 808d fitted into LED holders 826a to 826d are mounted on this board 824 (the LED holder 826b and the infrared light emitting diode 808b is not shown in the figure). Also, a rubber ring 833 and a rubber ring 832 are held in a holder 828 with a piezoelectric element 830 supported therebetween. Then, the piezoelectric element 830 between the rubber rings 833 and 832 is disposed between the holder 828 and a clipping plate 834. Since the rubber rings 833 and 832 are held by the clipping plate 834, the piezoelectric element 830 is fixed in tightly contact with the rubber rings 833 and 832. As described above, the holder 828 holding the piezoelectric element 830 is fixed into the control unit 840. In this case, the holder 828 is arranged in order that the piezoelectric element 830 is oriented perpendicular to the central axis of the bat type input device 800.

Also, the board 822 is fixed to the inside of the control unit 840 in order that it is perpendicular to the central axis of the bat type input device 800. Then, the manipulation switch 806 is mounted on this board 822.

As illustrated in FIG. 58, two size AA batteries 846 are set in the inside of the grip section 844. The negative terminal of the batteries 846 comes in contact with a battery plate 848 (minus contact) provided in the inside of the grip section 844 while the positive terminal of the batteries 846 comes in contact with a battery plate 850 (plus contact) provided in the inside of a lid member 852. Meanwhile, the lid member 852 is pivoted about a shaft 884 in order to make it possible to replace the batteries 846 by opening the lid member 852.

(Ball Type Input Device)

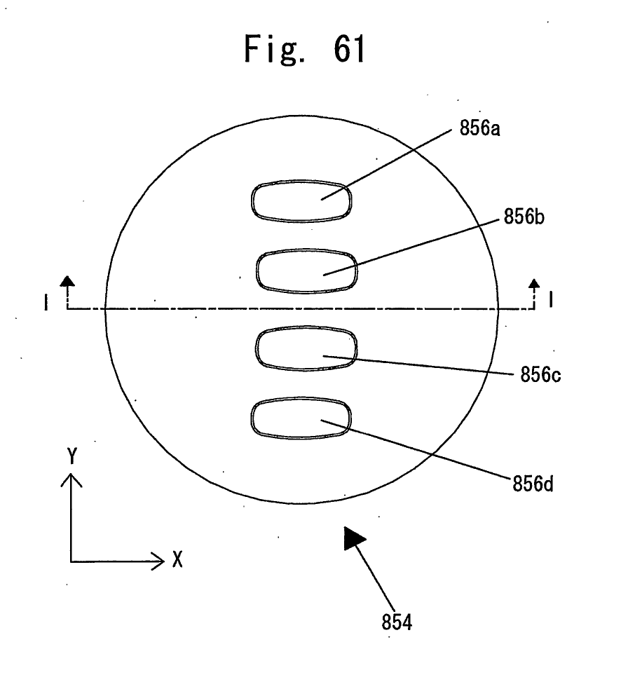

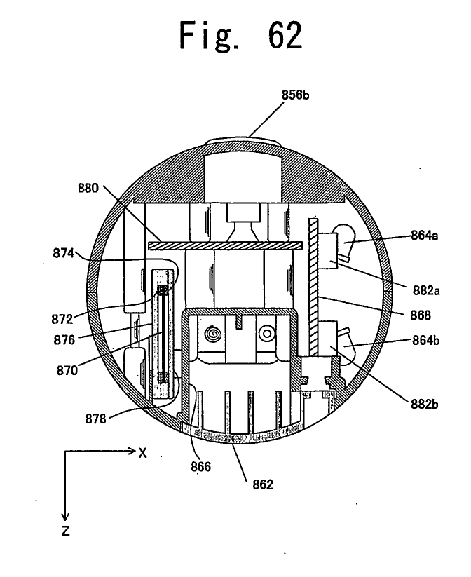

FIG. 60 is a perspective view showing the ball type input device 854 of FIG. 45. FIG. 61 is a plan view showing the ball type input device 854 of FIG. 45. FIG. 62 is a cross sectional view along I-I line of FIG. 61. In this case, the illustration of the strap 803 is omitted. Also, FIG. 61 and FIG. 62 are illustrated with the left-handed three dimensional coordinate system. As shown in FIG. 62, a board 880 is fixed inside of the ball type input device 854 in parallel with the XY plane. Then, manipulation keys 856a to 856d are mounted on this board 880. Also, a rubber ring 872 and a rubber ring 874 are housed in a holder 876 together with a piezoelectric element 870 therebetween. Then, the piezoelectric element 870 between the rubber rings 872 and 874 is disposed between the holder 876 and a clipping plate 878. Since the rubber rings 872 and 874 are held by the clipping plate 878, the piezoelectric element 870 is fixed in tightly contact with the rubber rings 872 and 874. As described above, the holder 876 holding the piezoelectric element 870 is fixed into the inside of the ball type input device 854. In this case, the holder 876 is installed in order that the piezoelectric element 870 is oriented in parallel with the YZ plane.

In addition, a board 868 is installed in the inside of the ball type input device 854 in parallel with the YZ plane while infrared light emitting diodes 864a and 864b fitted into LED holders 882a and 882b are mounted on this board 868. Furthermore, a battery holder 866 is installed in the inside of the ball type input device 854 to accommodate two size AA batteries therein. Incidentally, while the infrared light emitting diodes 864a and 864b are not exposed to the outside in the case of the present embodiment, they can be arranged to be exposed to the surface of the outer shell. Also, while these diodes are arranged in the vertical direction of the figure, they can be arranged in the lateral direction of the figure.

(E) Exemplary Use 2 of Adapter 1

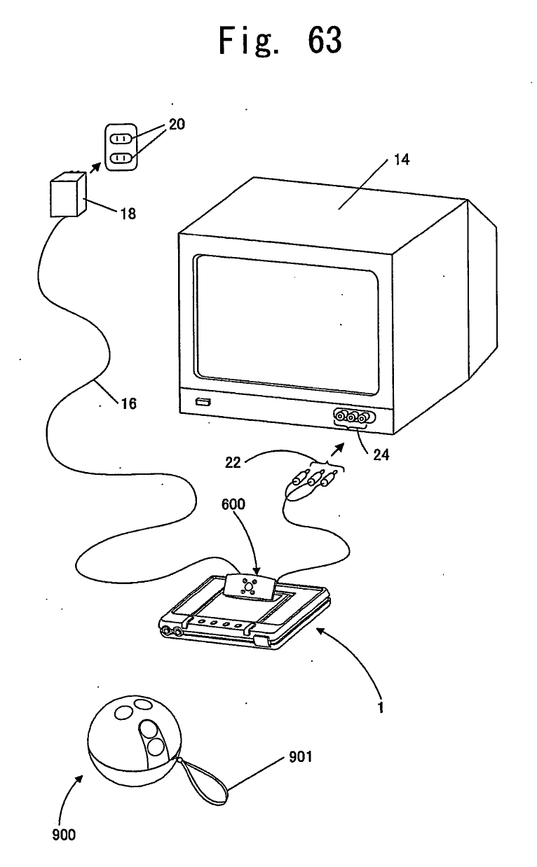

FIG. 63 is an explanatory view for showing an exemplary use 2 of the adapter 1 of FIG. 1. In FIG. 63, the adapter 1 is put on the floor. In the case of this exemplary use 2, a bowling ball type input device 900 is used. A strap 901 is attached to the bowling ball type input device 900. Incidentally, the power cables 16 and the AV cable 12 are used for connection in the same manner as in FIG. 45, and therefore no redundant description is repeated.

(Bowling Ball Type Input Device)

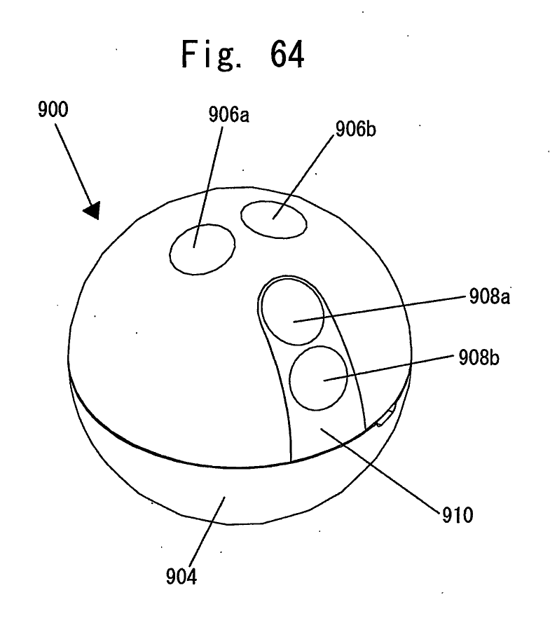

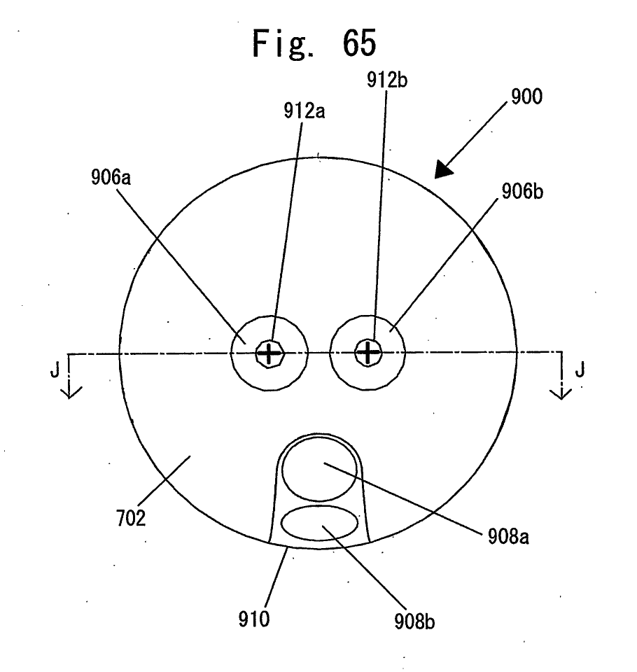

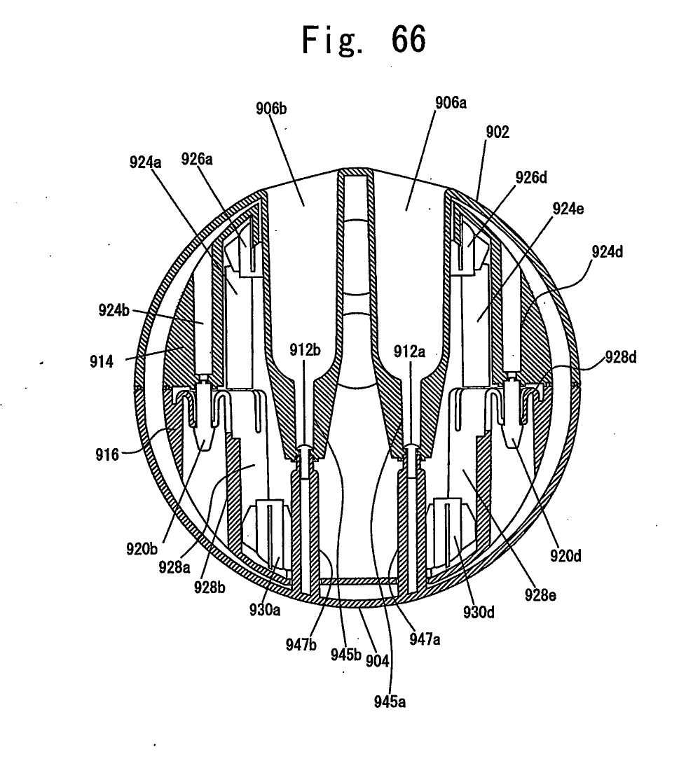

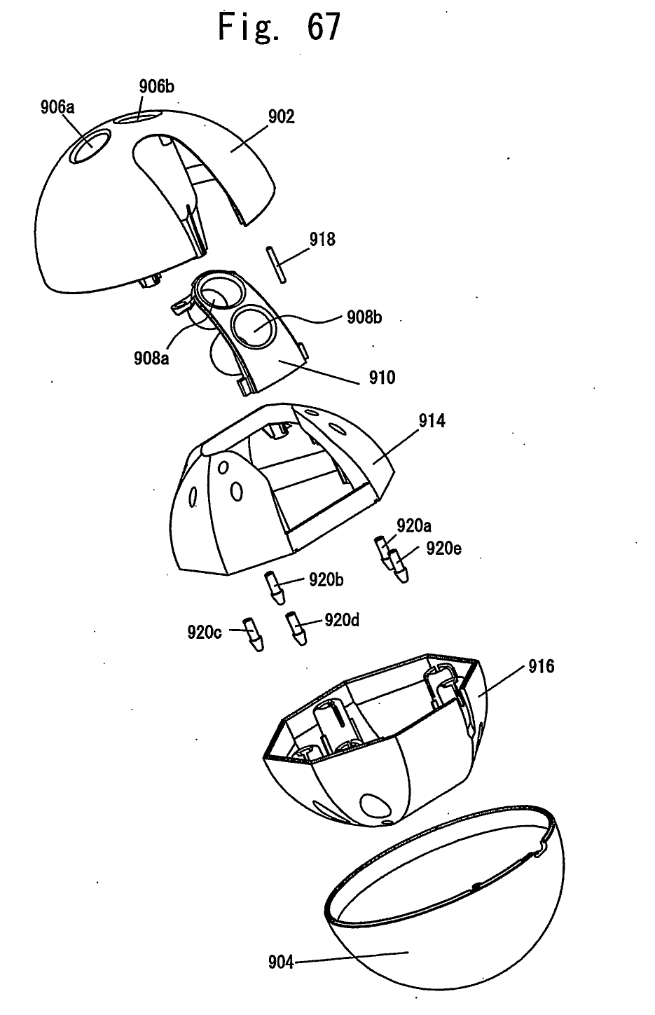

FIG. 64 is a perspective view showing the bowling ball type input device 900 of FIG. 63. FIG. 65 is a plan view showing the bowling ball type input device 900 of FIG. 63. FIG. 66 is a cross sectional view along J-J line of FIG. 65. FIG. 67 is an exploded perspective view showing the bowling ball type input device 900 of FIG. 63.

As shown in FIG. 64 and FIG. 65, finger holes 906a and 906b and the finger holes 908a and 908b are formed in the surface of the bowling ball type input device 900. Also, as shown in FIG. 67, this bowling ball type input device 900 includes an outer shell upper housing 902 formed with the finger holes 906a and 906b, an outer shell lower housing 904, a finger hole formation member 910 formed with the finger holes 908a and 908b, an inner shell upper housing 914, an inner shell lower housing 916, a pin 918 and connecting pins 920a to 920e. Each of the connecting pins 920a to 920e has a frustum-conical end (in the form of a cone with the point cut off). Incidentally, the outer shell upper housing 902 and the outer shell lower housing 904 are semitransparent or transparent.

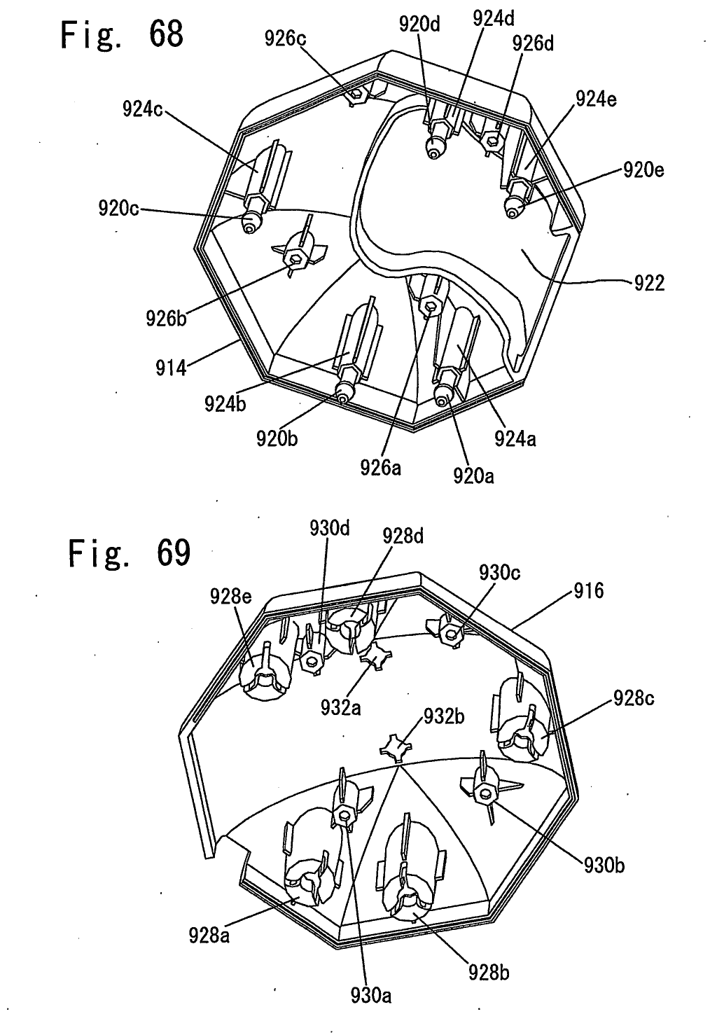

FIG. 68 is a perspective view showing the inside of the inner shell upper housing 914 of FIG. 67. FIG. 69 is a perspective view showing the inside of the inner shell lower housing 916 of FIG. 67. As shown in FIG. 68, the base ends of the connecting pins 920a to 920e are fixedly fitted respectively into cylindrical protrusions 924a to 924e which are protruded from the inner surface of the inner shell upper housing 914. Then, the leading ends of the connecting pins 920a to 920e fixed to the cylindrical protrusions 924a to 924e are fitted into engagement sections 928a to 928e which are protruded from the inner surface of the inner shell lower housing 916 shown in FIG. 69. The inner shell upper housing 914 and the inner shell lower housing 916 are joined in this manner (refer to FIG. 66).

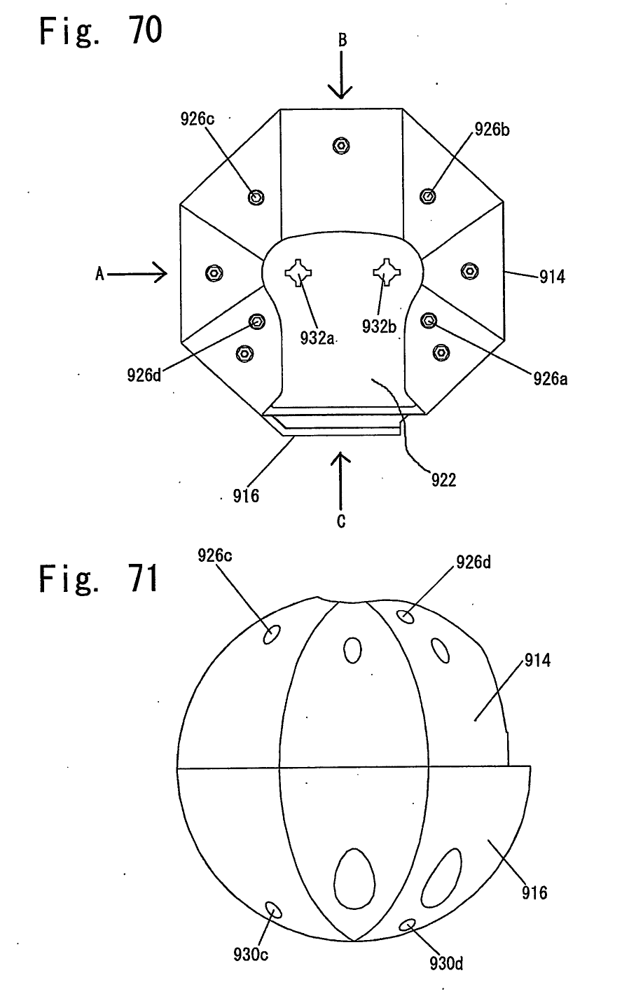

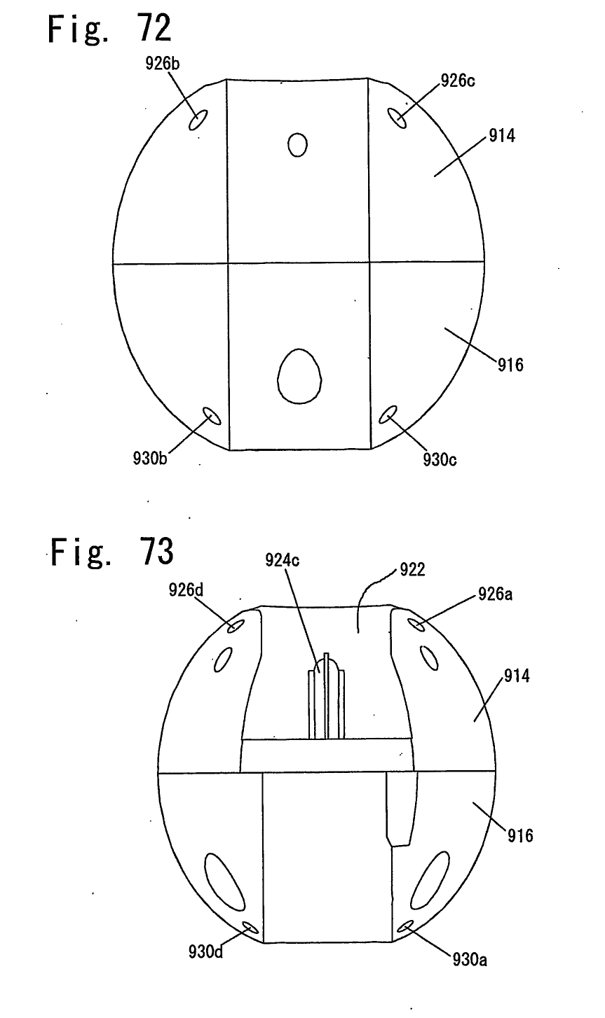

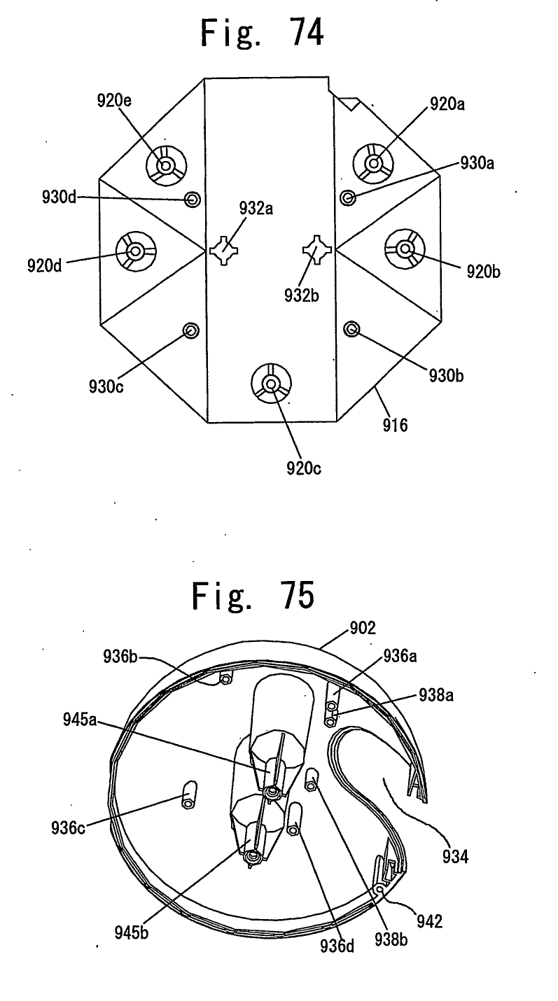

FIG. 70 is a plan view showing the inner shell upper housing 914 and the inner shell lower housing 916 as joined together (referred to below as “inner shell” in combination). FIG. 71 is a side view of the inner shell as viewed from arrow A of FIG. 70. FIG. 72 is a side view of the inner shell as viewed from arrow B of FIG. 70. FIG. 73 is a side view of the inner shell as viewed from arrow C of FIG. 70. FIG. 74 is a bottom view showing the inner shell of FIG. 70. A reflective sheets (for example, retroreflective sheets) are attached to the surface of the inner shell as constructed above.

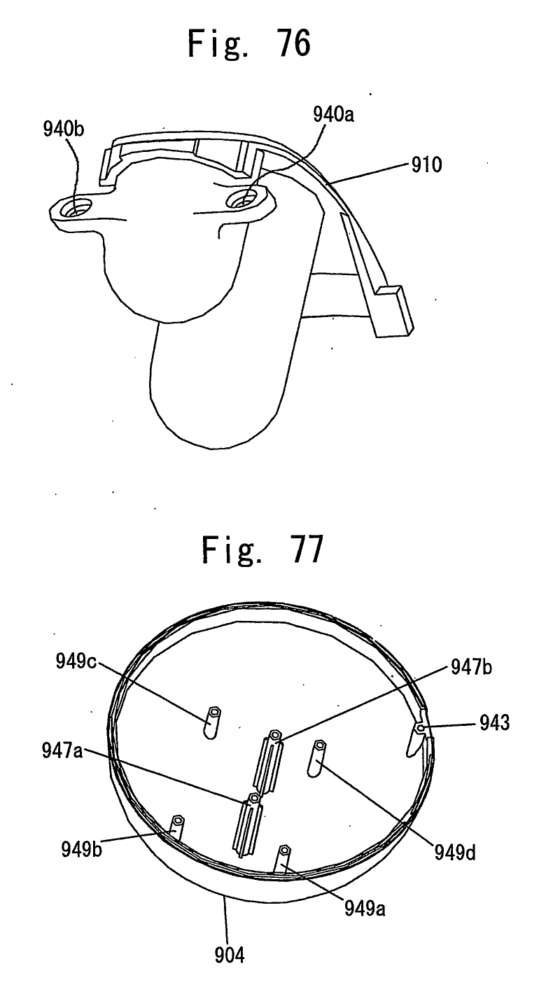

FIG. 75 is a perspective view showing the inside of the outer shell upper housing 902 of FIG. 67. FIG. 76 is a schematic diagram showing the finger hole formation member 910 of FIG. 67. FIG. 77 is a perspective view showing the inside of the outer shell lower housing 904 of FIG. 67.

The finger hole formation member 910 of FIG. 76 is attached to an opening 934 formed in the outer shell upper housing 902 of FIG. 75. In this case, fitting holes 940a and 940b formed in the finger hole formation member 910 are fitted onto cylindrical protrusions 938a and 938b which are protruded from the inner surface of the outer shell upper housing 902, and fixed with screws.

As shown in FIG. 70 and FIG. 68, indent sections 926a to 926d are formed in cylindrical protrusions inwardly protruded from the surface of the inner shell upper housing 914. In addition, an opening 922 is formed in the inner shell upper housing 914. On the other hand, as shown in FIG. 69 and FIG. 74, indent sections 930a to 930d are formed in cylindrical protrusions inwardly protruded from the surface of the inner shell lower housing 916. Also, two insertion holes 932a, 932b are formed near the top point of the inner shell upper housing 914.

As shown in FIG. 77, cylindrical protrusions 949a to 949d and cylindrical protrusions 947a and 947b protruded from the inner surface of the outer shell lower housing 904 are inserted into the indent sections 930a to 930d and the insertion holes 932a and 932b of the inner shell lower housing 916 of FIG. 74; as shown in FIG. 75, cylindrical protrusions 936a to 936d protruded from the inner surface of the outer shell upper housing 902 are inserted into the indent sections 926a to 926d of the inner shell upper housing 914 of FIG. 70; and cylindrical protrusions 945a and 945b protruded from the bottoms of the finger holes 906a and 906b are inserted into the cylindrical protrusions 947a and 947b protruded from the insertion holes 932a and 932b of the inner shell lower housing 916. By this configuration, it is possible to fix the inner shell to the outer shell (the outer shell upper housing 902 and the outer shell lower housing 904) without need for screws. In this case, the cylindrical protrusions 949a to 949d of the outer shell lower housing 904, the indent sections 930a to 930d of the inner shell lower housing 916, the cylindrical protrusions 936a to 936d of the outer shell upper housing 902 and the indent sections 926a to 926d of the inner shell upper housing 914 contribute to the fixation of the inner shell.

Then, as shown in FIG. 66, screws 912a and 912b are screwed into the cylindrical protrusions 945a and 945b of the outer shell upper housing 902 and the cylindrical protrusions 947a and 947b of the outer shell lower housing 904 through the bottoms of the finger holes 906a and 906b of the outer shell upper housing 902 to join the outer shell upper housing 902 and the outer shell lower housing 904 together. Incidentally, the pin 918 of FIG. 67 is inserted into a hole 942 of the outer shell upper housing 902 and a hole 943 of the outer shell lower housing 904 for attaching the strap 901.

In this case, the finger holes 906a, 906b and 908b of the bowling ball type input device 900 of FIG. 64 are holes into which three fingers of the user, i.e., a long finger, an annular finger and a thumb are inserted respectively. Incidentally, even for a user (for example, child) whose hand is small, the bowling ball type input device 900 can be easily used by inserting a long finger, an annular finger and a thumb are inserted respectively into the finger holes 906a, 906b and 908a. In this manner, there are provided the finger hole 908a and the finger hole 908b which are located respectively near and distant from the finger holes 906a and 906b for the purpose of enhancing the convenience of many users. Meanwhile, the provision of finger holes in different positions for users having hands of different sizes is applicable not only to the bowling ball type input device 900 but also to a bowling ball which can be used for real bowling games.

(F) Electric Configuration of Adapter 1

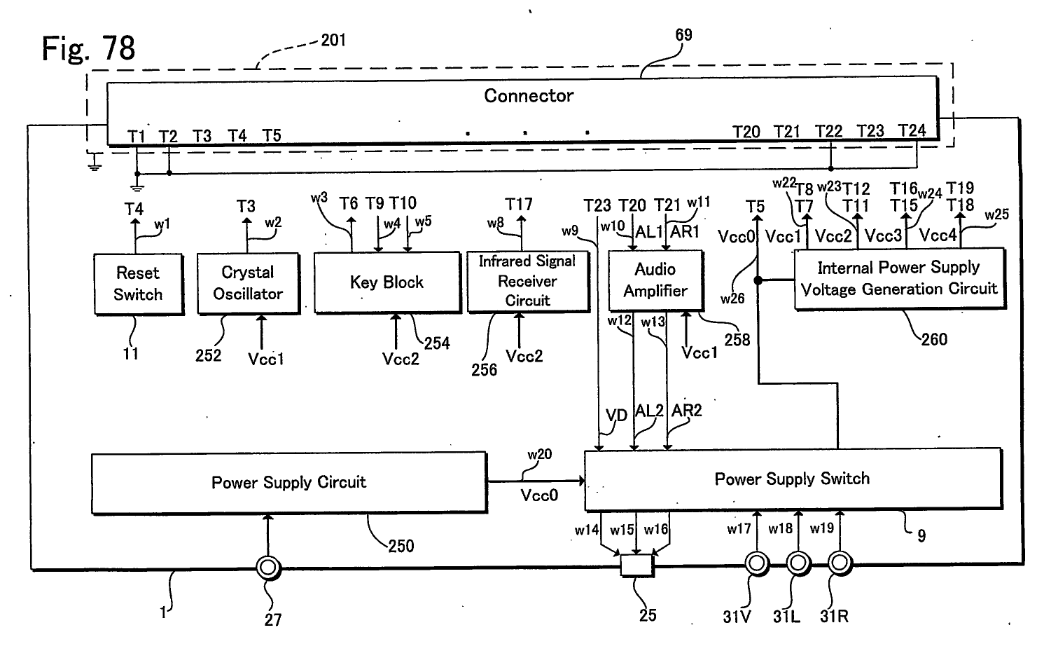

FIG. 78 is a view showing the electric configuration of the adapter 1 of FIG. 1. As shown in FIG. 78, this adapter 1 includes the connector 69, the reset switch 11, a crystal oscillator circuit 252, a key block 254, an infrared signal receiver circuit (IR receiver circuit) 256, an audio amplifier 258, an internal power supply voltage generation circuit 260, a power supply circuit 250 comprising an A/D converter and the like, the power supply switch 9, the power jack 27, the AV jack 25, the video jack 31 V, the L channel audio jack 31L, and the R channel audio jack 31R. The connector 69 has 24 terminals T1 to T24 and is covered by the shield member 201 which is grounded (refer to FIG. 17(c)). Also, the terminals T1, T2, T22 and T24 of the connector 69 are grounded. Incidentally, the connector 69, the reset switch 11, the crystal oscillator circuit 252, the key block 254, the IR receiver circuit 256, the audio amplifier 258 and the internal power supply voltage generation circuit 260 are mounted on the board 63 of FIG. 4 (refer to FIG. 9). On the other hand, the power supply circuit 250, the power supply switch 9, the video jack 31 V and the channel audio jacks 31L and 31R are mounted on the board 65 of FIG. 4 (refer to FIG. 9). Also, the power jacks 27 and AV and the AV jack 25 are mounted on the board 67 of FIG. 4 (refer to FIG. 9). The above configuration will be briefly explained.

The AC voltage as supplied from the power cable 16 (refer to FIG. 45 and FIG. 63) is given to the power supply circuit 250 through the power jack 27. The power supply circuit 250 converts the AC voltage as given to a DC voltage, which is then output to a line w20 as a power supply voltage Vcc0. When turned on, the power supply switch 9 connects the line w20 and a line w26 to supply the internal power supply voltage generation circuit 260 with the power supply voltage Vcc0, and gives the AV jack 25 a video signal VD from a line w9 and audio signals AL2 and AR2 from the lines w12 and w13 respectively through the lines w14, w15 and w16. Accordingly, the video signal VD and the audio signals AL2 and AR2 are given to the television receiver 14 through the AV cable 12 (refer to FIG. 45 and FIG. 63), while the television receiver 14 displays images and outputs sounds output from a speaker (not shown in the figure) in accordance with these signals.

On the other hand, when turned off, the power switch 9 connects lines w17, w18 and w19 to lines w14, w15 and w16. By this configuration, a video signal as input from the video jack 31 V, an L channel audio signal as input from the L channel audio jack 31L and an R channel audio signal as input from the L channel audio jack 31R are given to the AV jack 25. Accordingly, the video signal and the audio signals as input from the jacks 31 V, 31L and 31R are transferred to the television receiver 14 from the AV jack 25 through the AV cable 12. As thus described, when the power supply switch 9 is turned off, it is possible to output the video signal and the audio signal as input from an external device (for example, a DVD player) through the jacks 31 V, 31L and 31R to the television receiver 14.

The internal power supply voltage generation circuit 260 generates, by the use of the power supply voltage Vcc0 supplied from the power supply switch 9, a power supply voltage Vcc1 (for example, 5.0 V), a power supply voltage Vcc2 (for example, 3.3 V), a power supply voltage Vcc3 (for example, 2.5 V) and a power supply voltage Vcc4 (for example, 1.5 V) and outputs the respective power supply voltages to a line w22, a line w23, a line w24, and a line w25 The line w22 is connected to the terminals T7 and T8 of the connector 69; the line w23 is connected to the terminals T11 and T12 of the connector 69; the line w24 is connected to the terminals T15 and T16 of the connector 69; and the line w25 is connected to the terminals T18 and T19 of the connector 69. The line w26 from the power supply switch 9 is connected to the terminal T5 of the connector 69. In this case, the respective power supply voltages are determined in order that Vcc0>Vcc1>Vcc2>Vcc3>Vcc4.

The audio amplifier 258 amplifies the R channel audio signal AR1 as input through the line w11 which is connected to the terminal T21 and the L channel audio signal AL1 as input through the line w10 which is connected to the terminal T20, and outputs the R channel audio signal AR2 and L channel audio signal AL2 as amplified to the lines w13 and w12. This audio amplifier 258 is supplied with the power supply voltage Vcc1.

The line w9 for inputting the video signal VD to the power supply switch 9 is connected to the terminal T23 of the connector 69.

The IR receiver circuit 256 digital demodulates the digital modulated infrared signal as received, and outputs the digital demodulated signal to the line w8. The line w8 is connected to the terminal T17 of the connector 69. Incidentally, the IR receiver circuit 256 is supplied with the power supply voltage Vcc2.

The key block 254 includes the cancel key 13, the arrow keys 17a to 17d and the enter key 15 (refer to FIG. 1), converts the parallel signals from these keys into corresponding serial signals, and outputs the converted signals to the line w3. This line w3 is connected to the terminal T6 of the connector 69. In addition, the key block 254 is given a clock signal through the line w5 which is connected to the terminal T10 and a control signal through the line w4 which is connected to the terminal T9. Furthermore, the key block 254 is connected to the lines w6 and w7, which are connected to the terminals T13 and T14. This point is explained in detail later. Incidentally, the key block 254 is supplied with the power supply voltage Vcc2.

The crystal oscillator circuit 252 oscillates a clock signal at a predetermined frequency (for example, 3.579545 MHz), and supplies the clock signal to the line w2. The line w2 is connected to the terminal T3 of the connector 69. Incidentally, the crystal oscillator circuit 252 is supplied with the power supply voltage Vcc1, which is the highest voltage among the inner power supply voltages.

The reset switch 11 outputs a reset switch, which is used for resetting the system, to the line w1. The line w1 is connected to the terminal T4 of the connector 69.

(Power Supply Circuit 250 and Power Switch 9)

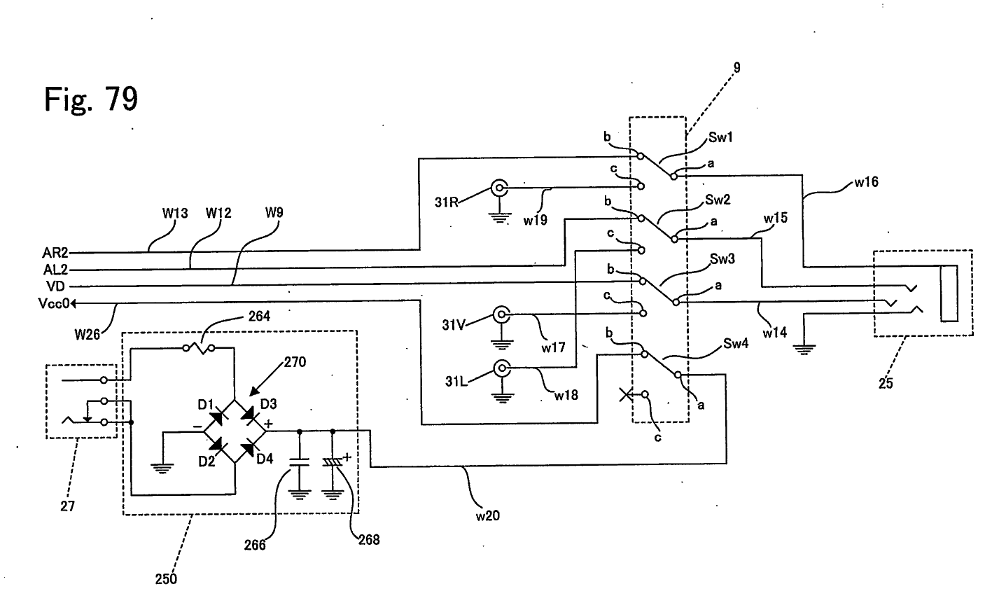

FIG. 79 is a circuit diagram showing the power supply circuit 250 and the power supply switch 9 of FIG. 78. As shown in FIG. 79, the power supply circuit 250 includes a full wave rectifier 270 consisting of four diodes D1 to D4 connected in the form of a bridge, a capacitor 266, an electrolytic capacitor 268 for smoothing the output voltage and a fuse 264. The cathode of the diode D1 and the anode of the diode D3 are connected to one terminal of the power jack 27 through the fuse 264. The anode of the diode D4 and the cathode of the diode D2 are connected to the other terminal of the power jack 27. The anode of the diode D1 and the anode of the diode D2 are grounded. The cathode of the diode D3 and the cathode of the diode D4 are connected to the line w20, which is in turn connected to one terminal of the capacitor 266 and the positive terminal of the electrolytic capacitor 268. The other terminal of the capacitor 266 and the negative terminal of the electrolytic capacitor 268 are grounded.

The AC voltage as input from the power jack 27 is full wave rectified by the full wave rectifier 270, smoothed by the electrolytic capacitor 268 and then output to the line w20 as the DC power supply voltage Vcc0.

By the way, the power supply switch 9 is a four pole double throw type switch composed of four switching circuits sw1 to sw4. The contacts “a”, “b” and “c” of the switching circuit sw1 are connected respectively to the lines w16, w13 and w19. The contacts “a”, “b” and “c” of the switching circuit sw2 are connected respectively to the lines w15, w12 and w18. The contacts “a”, “b” and “c” of the switching circuit sw3 are connected respectively to the lines w14, w9 and w17. The contacts “a” and “b” of the switching circuit sw4 as connected respectively to the lines w20 and w26. Also, the contact “c” of the switching circuit sw4 is kept in its high impedance state.

When the power supply switch 9 is turned on, each of the switching circuits sw1 to sw4 makes the contact “a” and the contact “b” connected to each other. Accordingly, in this case, the video signal VD from the line w9 and the audio signals AL2 and AR2 from the lines w12 and w13 are given to the AV jack 25. Also, the power supply voltage Vcc0 from the line w20 is output to the line w26. As thus described, when the power supply switch 9 is turned on, the video signal and audio signals input through the connector 69 (i.e., the video signal and audio signals output from the cartridge 500 or 600) are given to the AV jack 25 and output to the television receiver 14.

On the other hand, when the power supply switch 9 is turned off, each of the switching circuits sw1 to sw4 make the contact “a” and the contact “c” connected to each other. Accordingly, in this case, the lines w16 and w19, the lines w15 and w18 and the lines w14 and w17 are connected respectively. Also, the line w20 is kept in its high impedance state. Accordingly, the power supply voltage Vcc0 is not supplied to the circuitry of the adapter 1 which is thereby not operated. Furthermore, since the jacks 31L, 31R and 31 V are connected to the AV jack 25, the audio signals and the video signals as output from the jacks 31L, 31R and 31 V are output to the television receiver 14 through the AV jack 25. As thus described, when the power supply switch 9 is turned off, the adapter 1 merely relays the audio signal and the video signals from an external device.

(Internal Power Supply Voltage Generation Circuit 260)

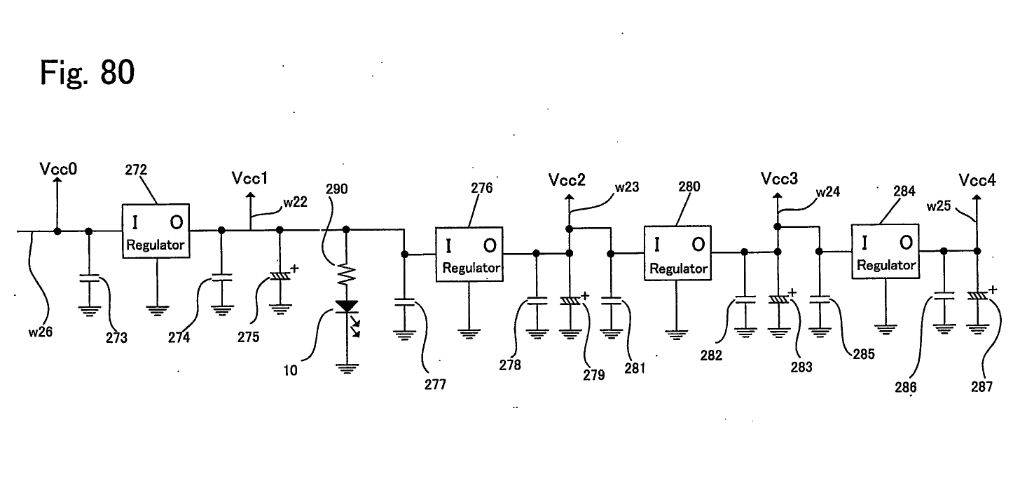

FIG. 80 is a circuit diagram showing the internal power supply voltage generation circuit 260 of FIG. 78. As shown in FIG. 80, this internal power supply voltage generation circuit 260 comprises: a Vcc1 generating circuit having capacitors 273 and 274, an electrolytic capacitor 275 and a regulator 272; a Vcc2 generating circuit having capacitors 277 and 278, an electrolytic capacitor 279 and a regulator 276; a Vcc3 generating circuit having capacitors 281 and 282, an electrolytic capacitor 283 and a regulator 280; a Vcc4 generating circuit having capacitors 285 and 286, an electrolytic capacitor 287 and a regulator 284; a resistor 290; and an LED 10.

The regulators 272, 276, 280 and 289 are connected respectively to the lines w26, w22, w23 and w24 at their respective input terminals, and respectively to the lines w22, w23, w24 and w25 at their respective output terminals. The line w26 is connected to one terminal of the capacitor 273 of which the other terminal is grounded. The line w22 are connected to one terminals of the capacitors 274 and 277 and the positive terminal of the electrolytic capacitor 275. The other terminals of the capacitors 274 and 277 and the negative terminal of the electrolytic capacitor 275 are grounded. Also, the line w22 is connected to one terminal of the resistor 290 of which the other terminal is connected to the anode of the LED 10 whose cathode is grounded. The line w23 is connected to one terminals of the capacitors 278 and 281 and the positive terminal of the electrolytic capacitor 279. The other terminals of the capacitors 278 and 281 and the negative terminal of the electrolytic capacitor 279 are grounded. The line w24 is connected to one terminals of the capacitors 282 and 285 and the positive terminal of the electrolytic capacitor 283. The other end of the capacitors 282 and 285 and the negative terminal of the electrolytic capacitor 283 are grounded. The line w25 is connected to one terminals of the capacitor 286 and the positive terminal of the electrolytic capacitor 287. The other end of the capacitor 286 and the negative terminal of the electrolytic capacitor 287 are grounded.

The regulator 272 serves to generate the power supply voltage Vcc1 lower than the power supply voltage Vcc0 by the use of the power supply voltage Vcc0 of the line w26, and output the power supply voltage Vcc1 to the line w22. In this case, the output voltage of the regulator 272 is smoothed by the electrolytic capacitor 275, and output to the line w22 as the power supply voltage Vcc1. The regulator 276 generates the power supply voltage Vcc2 which is lower than the power supply voltage Vcc1 by the use of the power supply voltage Vcc1, and outputs the power supply voltage Vcc2 to the line w23. Also in this case, the power supply voltage Vcc2 is smoothed by the electrolytic capacitor 279. The regulator 280 generate the power supply voltage Vcc3 which is lower than the power supply voltage Vcc2 by the use of the power supply voltage Vcc2, and outputs the power supply voltage Vcc3 to the line w24. Also in this case, the power supply voltage Vcc3 is smoothed by the electrolytic capacitor 283. The regulator 284 generate the power supply voltage Vcc4 which is lower than the power supply voltage Vcc3 by the use of the power supply voltage Vcc3, and outputs the power supply voltage Vcc4 to the line w25. Also in this case, the power supply voltage Vcc4 is smoothed by the electrolytic capacitor 287. Incidentally, when the power supply switch 9 of FIG. 78 is turned on, the power supply voltage Vcc0 is supplied to the line w26, and the regulator 272 outputs the power supply voltage Vcc1 to the line w22, so that the LED 10, i.e., the power lamp 10 is lighted (refer to FIG. 1).

(Audio Amplifier 258)

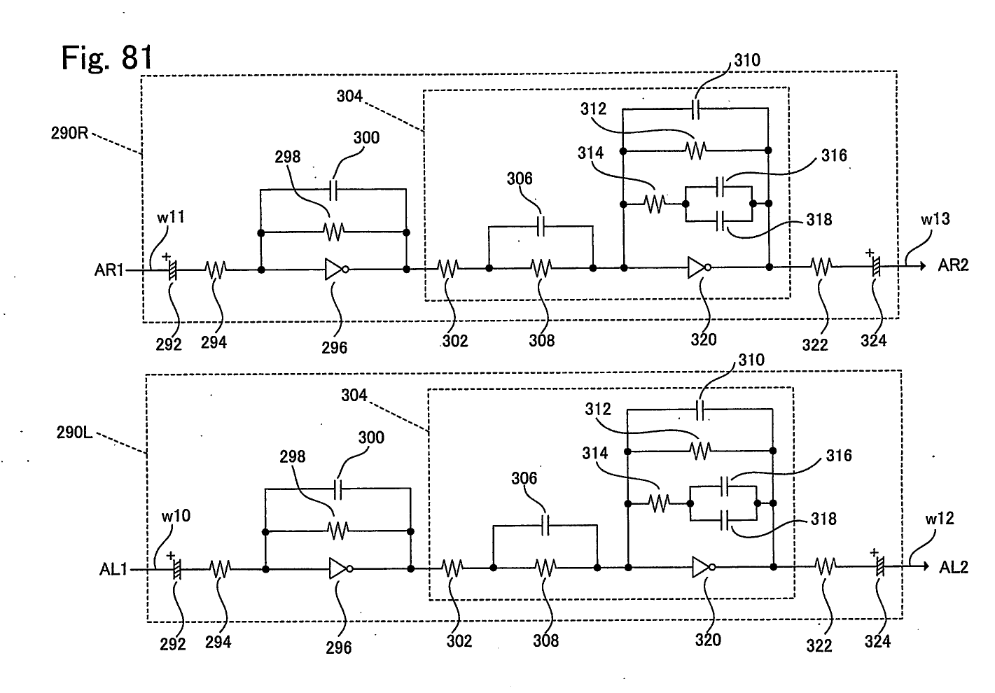

FIG. 81 is a circuit diagram showing the audio amplifier 258 of FIG. 78. As shown in FIG. 81; the audio amplifier 258 includes an R channel amplifier 290R which amplifies the R channel audio signal AR1 as input from the line w11 and output the amplified signal to the line w13 as a signal AR2, and an L channel amplifier 290L which amplifies the L channel audio signal AL1 as input from the line w10 and output the amplified signal to the line w12 as a signal AL2.

The R channel amplifier 290R includes an electrolytic capacitor 292, a resistor 294, a capacitor 300, a resistor 298, an inverter 296, a loudness circuit 304, a resistor 322, and an electrolytic capacitor 324. The loudness circuit 304 includes a resistor 302, a capacitor 306, a resistor 308, a capacitor 310, resistors 312 and 314, capacitors 316 and 318, and an inverter 320.

The electrolytic capacitor 292 and the resistor 294 are connected in series between the input terminal of the inverter 296 and the line w11. The capacitor 300 and the resistor 298 are connected in parallel between the input terminal and output terminal of the inverter 296. The capacitor 306 and the resistor 308 are connected in parallel between the input terminal of the inverter 320 and the other terminal of the resistor 302 of which one terminal is connected to the output terminal of the inverter 296. The input terminal of the inverter 320 is connected to one terminal of the capacitor 310 and one terminals of the resistors 312 and 314. The input terminal of the inverter 320 is connected to the other terminal of the capacitor 310, the other terminal of the resistor 312 and one terminals of the capacitors 316 and 318. The other terminal of the resistor 314 is connected to the other terminals of the capacitors 316 and 318. The resistor 322 and the electrolytic capacitor 324 are connected in series between the output terminal of the inverter 320 and the line w13.

The resistor 294, the capacitor 300, the resistor 298 and the inverter 296 serve in combination as a negative feedback amplifier and a lowpass filter. Namely, these circuits serves as an amplifier having a gain determined by the ratio of the resistor 298 to the resistor 294 at frequencies lower than the cutoff frequency f1, which is determined by the capacitance value of the capacitor 300 and the resistance value of the resistor 298. On the other hand, since the impedance of the capacitor 300 is small at frequencies higher than the cutoff frequency f1, negative feed-back is substantially applied to the signal to lessen the signal transmission.

The loudness circuit 304 is a circuit for enhancing signals at low frequencies and high frequencies which are determined by the resistance values of the resistors 302, 308, 312 and 314 and the capacitance values of the capacitors 306, 310, 316 and 318. This will be explained in accordance with specific examples. The resistance values of the resistors 302, 308, 312 and 314 are assumed, for example, respectively to be r1 (for example, 470 kΩ), r2 (for example, 3 kΩ) r3 (for example, 39 kΩ) and r4 (for example, 1.5 kΩ) so that r3>r2>r4>r1. Also, the capacitance values of the capacitors 306, 310, 316 and 318 are assumed, for example, respectively to be c1, c2, c3 and c4 wherein c1=c3=c4 (for example, 10×10@s4@s pF)>c2 (for example, 10×10@s3@s pF). The impedance of the capacitor 306 is small at frequencies higher than a specific frequency f2 which is determined by the capacitor 306 and the resistor 308. On the other hand, the specific frequency determined by the capacitors 316 and 318 and the resistor 314 is the same as the specific frequency f2. Accordingly, at frequencies higher than a specific frequency f2, the gain of the loudness circuit 304 is approximately determined by the ratio of the combined resistance value of the resistor 312 and the resistor 314 to the resistance value of the resistor 302 while the gain of signals is high at frequencies higher than a specific frequency f2. Incidentally, the capacitance value of the capacitor 310 is small, and therefore can be neglected in calculation of the specific frequency f2.

However, at frequencies higher than the specific frequency f3 determined by the capacitor 310 and the resistor 314, the impedance of the capacitor 310 is large so that the gain becomes small. In this case, the resistor 312 having a large resistance value is neglected. The capacitance value c2 of the capacitor 310 is smaller than the capacitance value c1 of the capacitor 306, and the resistance value r4 of the resistor 314 is smaller than the resistance value r2 of the resistor 308 in this example, so that f3>f2.

Also, at frequencies lower than the specific frequency f4 determined by the resistor 312 and the capacitors 316 and 318, the gain of the loudness circuit 304 is determined by the ratio of the resistor 312 to the combined resistance value of the resistor 302 and the resistor 308 and becomes large. Meanwhile, in this case, the resistance value r4 of the resistor 314 is small and therefore neglected. The combined capacitance value of the capacitors 316 and 318 (2×c1) is larger than the capacitance value c1 of the capacitor 306 and the resistance value r3 of the resistor 312 is larger than the resistance value r2 of the resistor 308 in this example, so that f2>f4.

Therefore, the above approximate calculation results in f3>f2>f4. Accordingly, the loudness circuit 304 serves to enhance signals at frequencies higher than the specific frequency f2 and signals at frequencies lower than the specific frequency f4. Incidentally, the values of the resistor 298 and capacitor 300 are selected in order that the cutoff frequency f1 is higher than the specific frequency f3.

Meanwhile, the circuit configuration of the L channel amplifier 290L is the same as that of the R channel amplifier 290R, and therefore no redundant description is repeated.

(IR Receiver Circuit 256)

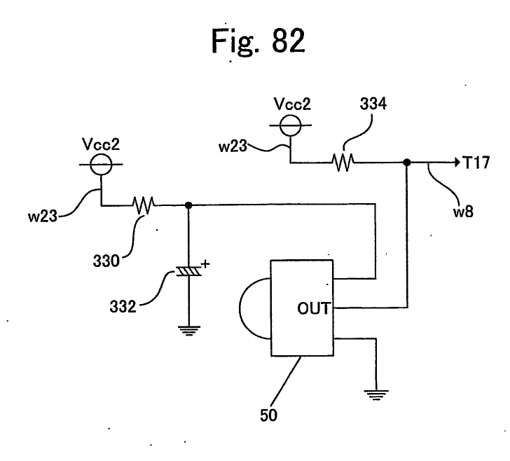

FIG. 82 is a circuit diagram showing the IR receiver circuit 256 of FIG. 78. As shown in FIG. 82, the IR receiver circuit 256 includes resistors 330 and 334, an electrolytic capacitor 332 and an infrared sensor 50 (refer to FIG. 4). The infrared sensor 50 is supplied with the power supply voltage Vcc2 through the resistor 330. Also, the output terminal OUT of the infrared sensor 50 is connected to the line w8. Accordingly, the infrared sensor 50 digital demodulates the digital modulated infrared signal as received, and outputs the digital demodulated signal to the line w8. Incidentally, since the infrared sensor 50 has an open collector output, a pull-up resistor 334 is connected to the line w8.

(Key Block 254)

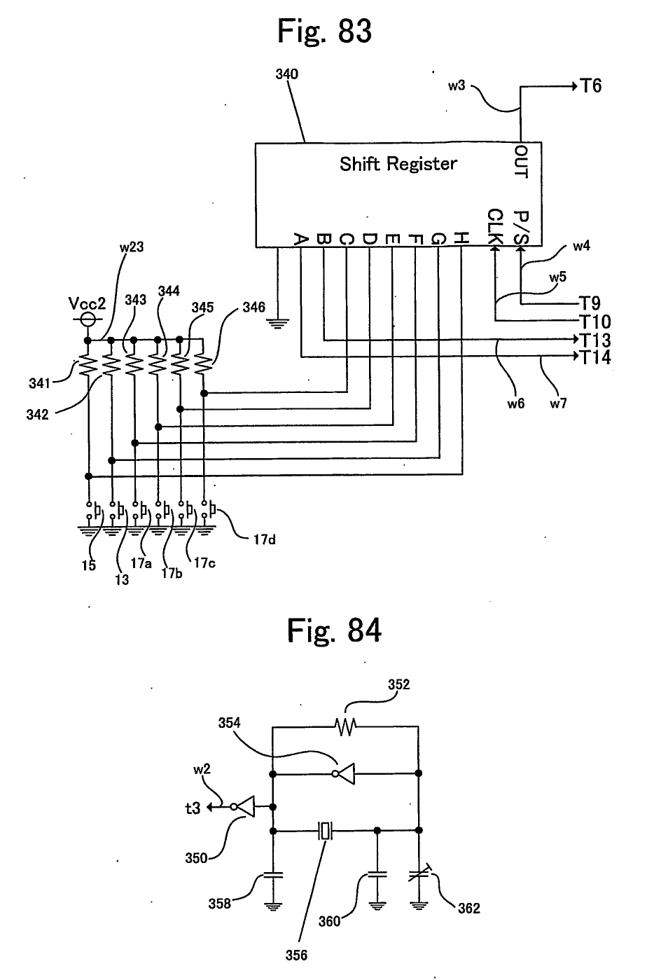

FIG. 83 is a circuit diagram showing the key block 254 of FIG. 78. As shown in FIG. 83, the key block 254 includes the cancel key 13, the enter key 15, the arrow keys 17a to 17d, resistors 341 to 346 and a shift register 340. The enter key 15 is connected to one terminal of the resistor 341 and a terminal H of the shift register 340 at one contact of the enter key 15, and grounded at the other contact. The cancel key 13 is connected to one terminal of the resistor 342 and a terminal G of the shift register 340 at one contact of the cancel key 13, and grounded at the other contact. The arrow keys 17a to 17d are connected respectively to one terminals of the resistors 343 to 346 and the terminals F to C of the shift register 340 at their respective one contacts of the arrow keys 17a to 17d and grounded at the other contacts thereof respectively. Also, the other terminals of the resistors 341 to 346 are connected to the line w23 for receiving the power supply voltage Vcc2.

The shift register 340 includes a terminal OUT connected to the line w3, a clock input terminal CLK connected to the line w5, and a control terminal P/S connected to the line w4. Also, the terminals A and B of the shift register 340 are connected to the lines w7, w6 respectively.

The shift register 340 converts parallel signals input through the terminals A to H into corresponding serial signals, which are sequentially output to the line w3. In other words, the on/off signals input through the keys 15, 13 and 17a to 17d, parallel/serial converted, and output to the line w3. In this case, the terminals A and B of the shift register 340 are reserved for future use so that two additional input signals can be added if necessary for some purpose. The additional input signals may be given from the inside of the adapter 1, or from the outside through the connector 69. Meanwhile, while an operating clock is input to the clock input terminal CLK through the line w5, a control signal is input to the control terminal P/S through the line w4. When this control signal is in L level, the shift register 340 loads parallel data in response to this control signal of L level, and when this control signal is in H level, the shift register 340 outputs serial data.

In accordance with the adapter 1, the number of the input terminals of the shift register 340 is larger than the number of the on/off signals of the keys 15, 13 and 17a to 17d. In this configuration, since the remaining input terminals can be used, it is possible to provide additional inputs, and therefore the extensibility is improved.

(Crystal Oscillator 252)

FIG. 84 is a circuit diagram showing the crystal oscillator circuit 252 of FIG. 78. As shown in FIG. 84, the crystal oscillator circuit 252 includes a quartz oscillator 356, inverters 350 and 354, a resistor 352, capacitors 358 and 360 and a semi-variable capacitor 362. One terminal of the quartz oscillator 356 is connected to one terminal of the capacitor 358, the input terminal of the inverter 350, the output terminal of the inverter 354 and one terminal of the resistor 352. The other terminal of the quartz oscillator 356 is connected to one terminal of the capacitor 360, one terminal of the semi-variable capacitor 362, the input terminal of the inverter 354 and other terminal of the resistor 352. The other terminals of the capacitors 358 and 360 and semi-variable capacitor 362 are grounded. Also, the output terminal of the inverter 350 is connected to the line w2.

The phases at opposite sides of the quartz oscillator 356 become opposite to each other by connecting the opposite terminals of the quartz oscillator 356 respectively to the capacitors 358 and 360 which are grounded at the other terminals. On the other hand, since the output of the inverter 354 has the phase opposite its input, a positive feedback circuit is formed in combination with the quartz oscillator 356 to pull down the output terminal with the input being pulled up and pull up the output terminal with the input being pulled down, resulting in oscillation. The resistor 352 is a bias resistor serving to maintain the potential at the input terminal of the inverter 354 to the threshold voltage. The inverter 350 is a buffer for preventing the parasitic capacitance and noise on the line w2 from adversely affecting the oscillation. In addition, the oscillating frequency can be finely adjusted by adjusting the capacitance value of the semi-variable capacitor 362.

(G) Electric Configuration of Cartridge 500

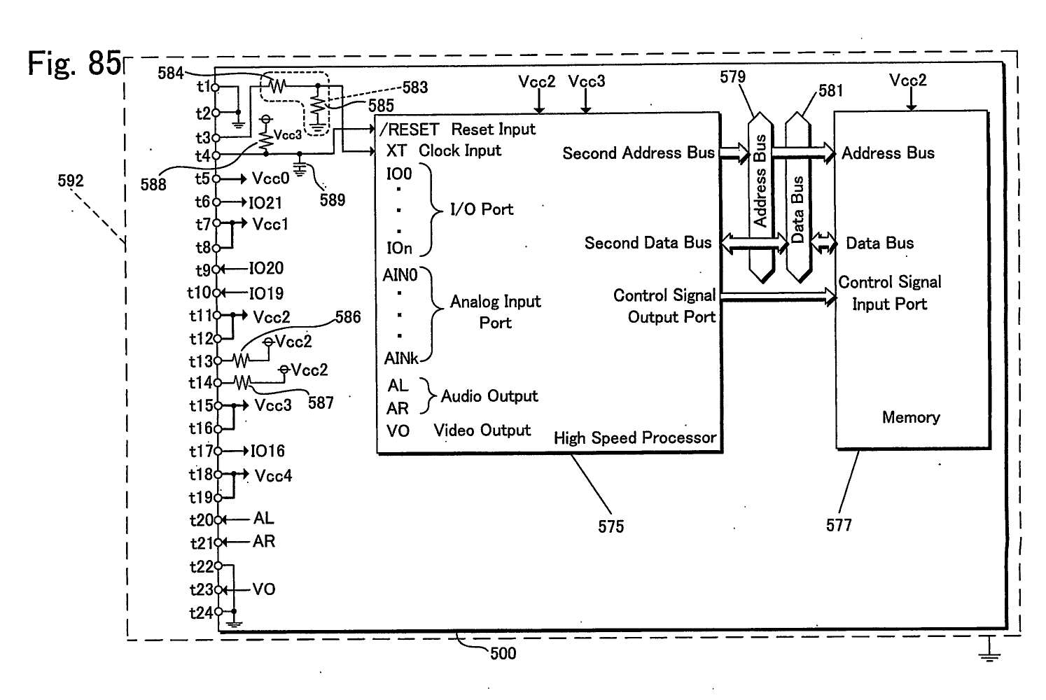

FIG. 85 is a schematic diagram showing the electric configuration of the cartridge 500 of FIG. 1. As shown in FIG. 85, the cartridge 500 includes a high speed processor 575, a memory 577, terminals t1 to t24, an address bus 579, a data bus 581, an amplitude setting circuit 583 and resistors 586 and 587. The amplitude setting circuit 583 includes a resistor 584, and a resistor 585. The high speed processor 575 includes a reset input port /RESET for inputting a reset signal, a clock input port XT for inputting a clock signal SCLK2, an input/output ports (I/O ports) IO0 to IOn (“n” is a natural number, for example, n=24) for inputting/outputting data, analog input ports AIN0 to AINk (“k” is a natural number, for example, k=6), audio output ports AL and AR for outputting audio signals AL1 and AR1, a video output port for outputting a video signal VD, control signal output ports for outputting control signals (for example, a chip enable signal, an output enable signal, a write enable signal), a second data bus, and a second address bus. The memory 577 may be, for example, a ROM (read only memory), a flash memory, or any appropriate memory.

The control signal output ports of the high speed processor 575 are connected to the control signal input ports of the memory 577. The second address bus of the high speed processor 575 and the address bus of the memory 577 are connected to the address bus 579. The second data bus of the high speed processor 575 and the data bus of the memory 577 are connected to the data bus 581. In this case, the control signal output ports of the high speed processor 575 include an OE output port for outputting an output enable signal, a CE output port for outputting a chip enable signal, a WE output port for outputting a write enable signal, and the like. Also, the control signal input ports of the memory 577 include an OE input port connected to the OE output port of the high speed processor 575, a CE input port connected to the CE output port of the high speed processor 575, a WE input port connected to the WE output port of the high speed processor 575, and so forth.

When receiving the chip enable signal, the memory 577 responds to the signal as the destination thereof to output a data signal in accordance with an address signal and the output enable signal which are given substantially at the same time as the chip enable signal. The address signal is input to the memory 577 through the address bus 579 while the data signal is input to the high speed processor 575 through the data bus 581. Also, when receiving the chip enable signal, the memory 577 responds to the signal as the destination thereof to write a data signal in accordance with an address signal and the write enable signal which are given substantially at the same time as the chip enable signal. The address signal is input to the memory 577 through the address bus 579 while the data signal is input to the memory 577 from the high speed processor 575 through the data bus 581.

When the cartridge 500 is installed into the adapter 1, the terminals t1 to t24 are connected to the terminals T1 to T24 of the connector 69 of the adapter 1 in a one-to-one correspondence. Also, the terminals t1, t2, t22 and t24 are grounded. The terminal t3 is connected to the amplitude setting circuit 583. The terminal t4 is connected to the reset input port /RESET of the high speed processor 575. Also, one terminal of the resistor 588 and one terminal of the capacitor 589 are connected to the line through which the reset input port /RESET is connected to the terminal t4. Also, the other terminal of the resistor 588 is supplied with the power supply voltage Vcc3 while the other terminal of the capacitor 589 is grounded.

The power supply voltage Vcc0 is supplied from the terminal t5. The power supply voltage Vcc1 is supplied from the terminals t7 and t8. The power supply voltage Vcc2 is supplied from the terminals t11 and t12. The power supply voltage Vcc3 is supplied from the terminals t15 and t16. The power supply voltage Vcc4 is supplied from the terminals t18 and t19. The terminals t6, t9, t10 and t17 are connected respectively to the I/O ports IO21, IO20, IO19 and IO16 of the high speed processor 575. The terminals t13 and t14 are connected respectively to one terminals of the resistors 586 and 587, while the other terminals of the resistors 586 and 587 are supplied with the power supply voltage Vcc2. The terminals t20 and t21 are connected respectively to the audio output ports AL and AR of the high speed processor 575. The terminal t23 is connected to the video output port VO of the high speed processor 575.

The resistor 584 of the amplitude setting circuit 583 is connected to the terminal t3 at one terminal thereof, and connected to the clock input port XT of the high speed processor 575 and one terminal of the resistor 585 at the other terminal thereof. The other terminal of the resistor 585 is grounded. In other words, the amplitude setting circuit 583 is a resistor divider network.

The clock signal SCLK1 generated by oscillation of the crystal oscillator circuit 252 of the adapter 1 is input through the terminal t3 to the amplitude setting circuit 583 which then generates a clock signal SCLK2 having an amplitude smaller than the clock signal SCLK1 and outputs the clock signal SCLK2 to the clock input port XT. Namely, the amplitude of the clock signal SCLK2 is set to a value which is determined by the ratio between the resistor 584 and the resistor 585.

The power supply voltage Vcc2 is supplied to the analog circuitry of the high speed processor 575 while the power supply voltage Vcc3 is supplied to the digital circuitry of the high speed processor 575.

Incidentally, the cartridge 500 is provided with a shield member 592. The respective circuits shown in FIG. 85 are mounted on the board 518 of FIG. 23 which is disposed between the grounded shield member 508 and the grounded shield member 520. Accordingly, the shield member 592 of FIG. 85 is composed of the shield members 508 and 520. By virtue of the shield member 592, electromagnetic waves can be prevented, as much as possible, from leaking from the high speed processor 575 and the like as external radiation.

In accordance with the present embodiment as described above, since the amplitude setting circuit 583 is provided, the cartridge 500 can be operated even with the clock signal SCLK1 as input from the adapter 1, even if the amplitude of the clock signal SCLK1 is different from that required of the inside of the cartridge 500.

(Electric Configuration of High Speed Processor 575)

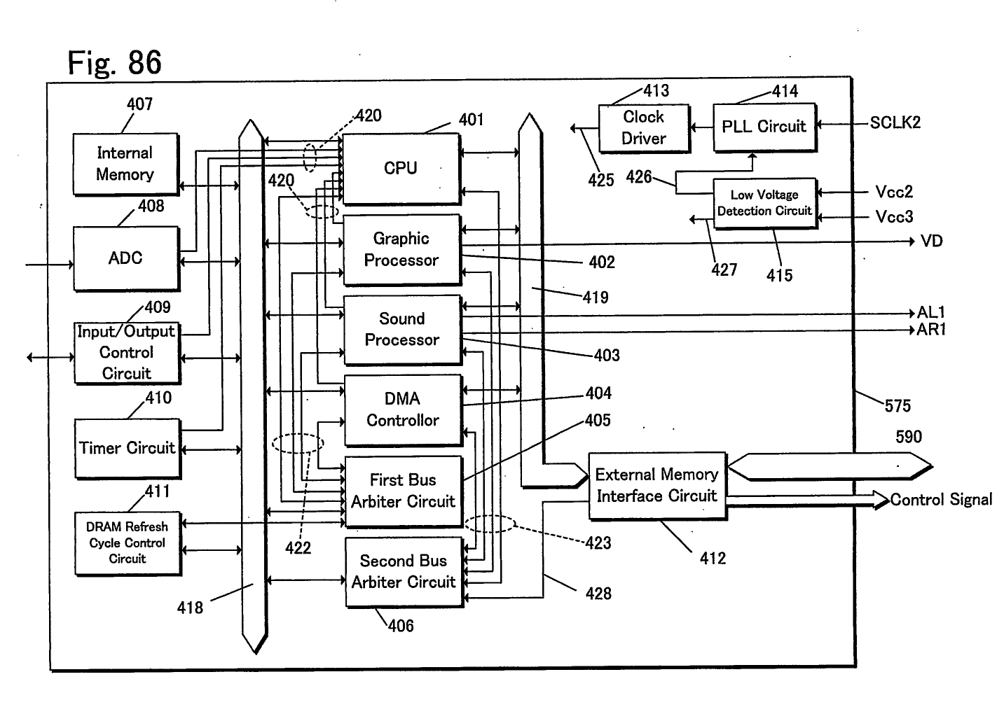

FIG. 86 is a block diagram showing the high speed processor 575 of FIG. 85. As shown in FIG. 86, this high speed processor 575 includes a central processing unit (CPU) 401, a graphics processor 402, a sound processor 403, a DMA (direct memory access) controller 404, a first bus arbiter circuit 405, a second bus arbiter circuit 406, an inner memory 407, an A/D converter (ADC: analog to digital converter) 408, an input/output control circuit 409, a timer circuit 410, a DRAM (dynamic random access memory) refresh cycle control circuit 411, an external memory interface circuit 412, a clock driver 413, a PLL (phase-locked loop) circuitry 414, a low voltage detection circuit 415, a first bus 418, and the second bus 419. The first bus 418 includes an address bus and a data bus. The second bus 419 includes an address bus and a data bus. Incidentally, the bus 590 comprises the address bus 579 and the data bus 581 of FIG. 85.

The CPU 401 performs various operations and controls the overall system in accordance with a program stored in a memory (the inside memory 407, or the memory 577). The CPU 401 is a bus master of the first bus 418 and the second bus 419, and can access the resources connected to the respective buses.

The graphic processor 402 is also a bus master of the first bus 418 and the second bus 419, generates a video signal VD on the basis of the data as stored in the inner memory 407 or the memory 577, and outputs the video signal VD through the video output port VO. The graphic processor 402 is controlled by the CPU 401 through the first bus 418. Also, the graphic processor 402 has the functionality of outputting an interrupt request signal 420 to the CPU 401. In this case, the video signal VD as output from the graphics processor 402 is, for example, a composite signal. However, this video signal is not limited to the composite signal but may be any other type of video signal such as the S-Video signal as long as it can be processed by the television receiver for displaying images.

For example, in terms of the standard of analog television system, the video signal may be generated in conformity with any one of NTSC, NTSC 4.43, PAL, PAL 60, PAL-M, PAL-N and SECAM and so forth. Also, in terms of the analog video signal format, any one of the Y/C video signal (also known as S-Video signal), the YCbCr component video signal and so forth can be used in place of the composite video signal. Furthermore, in terms of the digital video signal format, the video signal may be output in accordance with any one of the Dn (D1 to D5) video interfaces (in conformity with JEITA CP-4120 standard for digital image broadcasting), the iLink interface, the DV interface and so forth. Furthermore, in terms of the digital interface standard, the HDMI (High Definition Multimedia Interface) may be used for this purpose. Also, it is possible to design the above system capable of outputting either or both digital video signals and analog video signals.

The sound processor 403 is also a bus master of the first bus 418 and the second bus 419, and generates the audio signals AL1 and AR1 as analog signals on the basis of the data as stored in the inner memory 407′ or the memory 577, and output the audio signals AL1 and AR1 through the audio output ports AL and AR. The sound processor 403 is controlled by the CPU 401 through the first bus 418. Also, the sound processor 403 has the functionality of outputting an interrupt request signal 420 to the CPU 401.

The DMA controller 404 serves to transfer data from the memory 577 to the inner memory 407. Also, the DMA controller 404 has the functionality of outputting, to the CPU 401, an interrupt request signal 420 indicative of the completion of the data transfer. The DMA controller 404 is also a bus master of the first bus 418 and the second bus 419. The DMA controller 404 is controlled by the CPU 401 through the first bus 418.

The inner memory 407 may be implemented with one or any necessary combination of a mask ROM, an SRAM (static random access memory) and a DRAM in accordance with the system requirements. In the case where a DRAM is used, the so called refresh cycle is periodically performed to maintain the data contained therein.

The first bus arbiter circuit 405 accepts a first bus use request signal from the respective bus masters of the first bus 418, performs bus arbitration among the requests for the first bus 418, and issue a first bus use permission signal to one of the respective bus masters. Each bus master is permitted to access the first bus 418 after receiving the first bus use permission signal. In FIG. 86, the first bus use request signal and the first bus use permission signal are illustrated as first bus arbitration signals 422.

The second bus arbiter circuit 406 accepts a second bus use request signal from the respective bus masters of the second bus 419, performs bus arbitration among the requests for the second bus 419, and issue a second bus use permission signal to one of the respective bus masters. Each bus master is permitted to access the second bus 419 after receiving the second bus use permission signal. In FIG. 86, the second bus use request signal and the second bus use permission signal are illustrated as second bus arbitration signals 423.

The input/output control circuit 409 serves to perform input and output operations of input/output signals to enable the communication with external input/output devices and/or external semiconductor devices through the I/O ports IO0 to IOn of FIG. 85. The input/output signals from the I/O ports IO0 to IOn are input and output from the CPU 401 through the first bus 418. Also, the input/output control circuit 409 has the functionality of outputting an interrupt request signal 420 to the CPU 401.

The timer circuit 410 has the functionality of periodically outputting an interrupt request signal 420 to the CPU 401 with a time interval as preset. The setting of the timer circuit 410 such as the time interval is performed by the CPU 401 through the first bus 418.

The ADC 408 converts analog input signals, which are input from the analog input ports AIN0 to AINk of FIG. 85, into digital signals. The digital signals are read by the CPU 401 through the first bus 418. Also, the ADC 408 has the functionality of outputting an interrupt request signal 420 to the CPU 401.

The PLL circuit 414 generates a high frequency clock signal by multiplication of the high frequency clock signal SCLK2 as input from the clock input port XT.

The clock driver 413 amplifies the high frequency clock signal as received from the PLL circuit 414 to a sufficient signal level to supply the respective blocks with the clock signal 425.

While there are provided predetermined threshold voltages respectively for the power supply voltages Vcc2 and Vcc3, the low voltage detection circuit 415 monitors the power supply voltages Vcc2 and Vcc3, and issues the reset signal 426 of the PLL circuit 414 and the reset signal 427 to the other circuit elements of the entire system when either the power supply voltage Vcc2 or Vcc3 falls below the threshold voltage corresponding thereto.

The external memory interface circuit 412 has the functionality of connecting the second bus 419 to the external bus 590 and issuing a bus cycle completion signal 428 of the second bus 419 to control the length of the bus cycle of the second bus 419. Also, the external memory interface circuit 412 outputs the control signal of the memory 577 from the control signal output ports.

The DRAM refresh cycle control circuit 411 periodically and unconditionally gets the ownership of the first bus 418 to perform the refresh cycle of the DRAM at a certain interval. Needless to say, the DRAM refresh cycle control circuit 411 is provided in the case where the inner memory 407 includes a DRAM.

(H) Electric Configuration of Cartridge 600

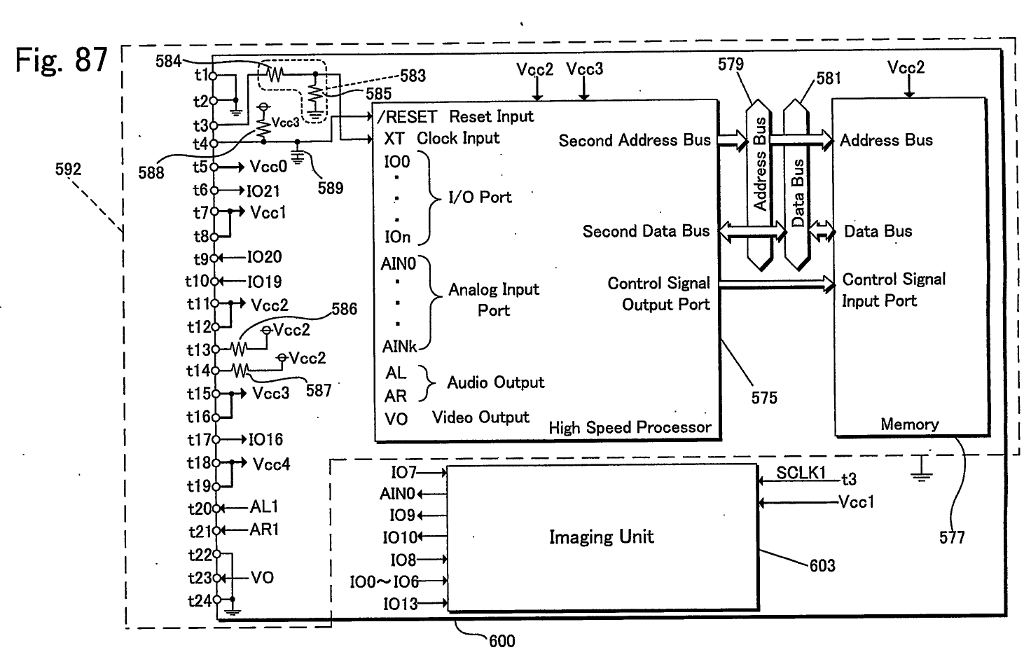

FIG. 87 is a view showing the electric configuration of the cartridge 600 of FIG. 35. As shown in FIG. 87, while this cartridge 600 includes the imaging unit 603 in addition to the configuration of FIG. 85, the other elements are the same as those of the cartridge 500, and therefore no redundant description is repeated.

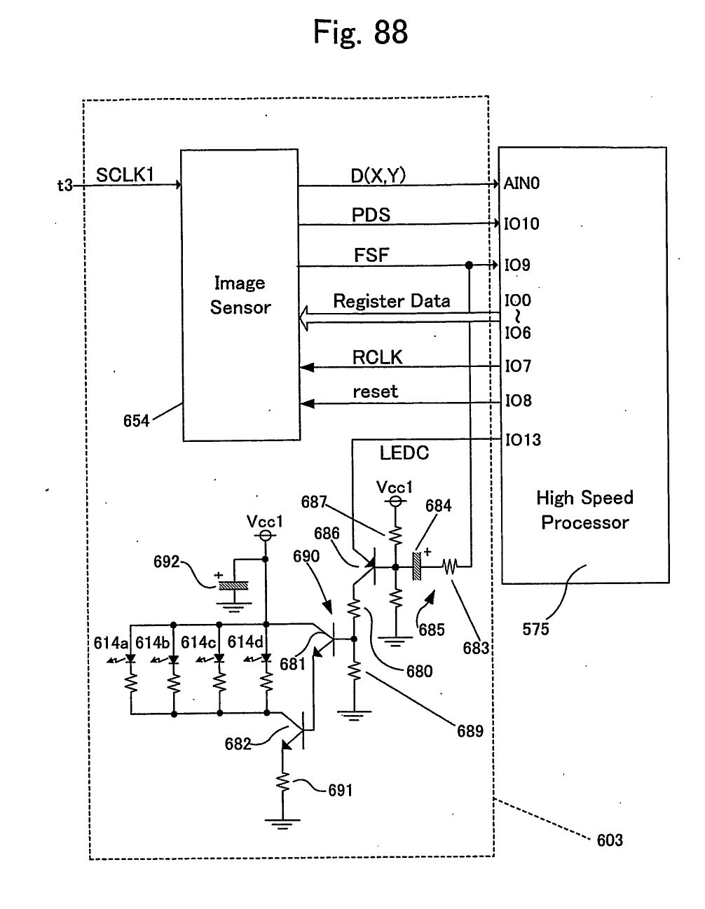

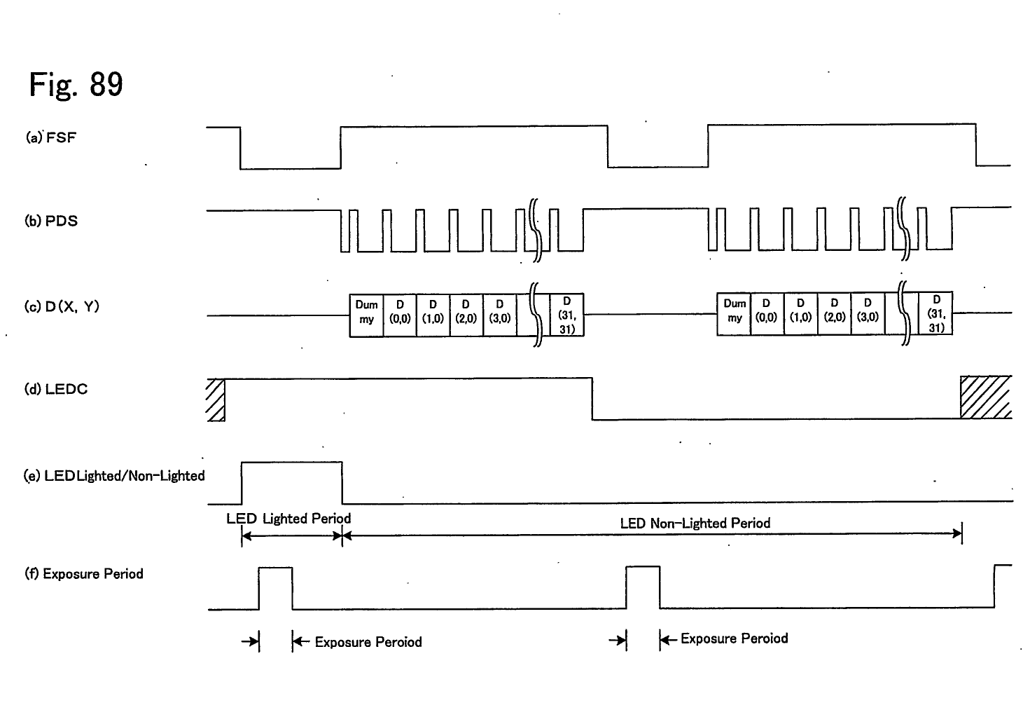

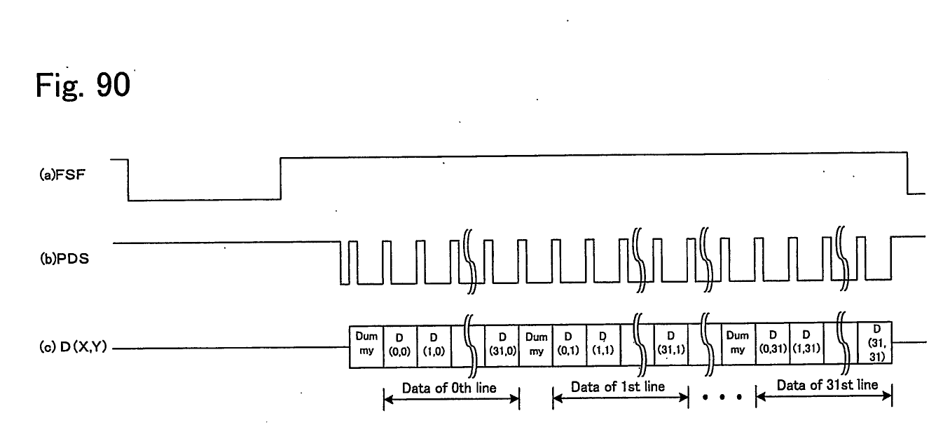

FIG. 88 is a view showing the electric configuration of the imaging unit 603 of FIG. 87. FIG. 89 is a timing diagram showing the operation of the high speed processor 575 which receives pixel data from the image sensor 654 of FIG. 88. FIG. 90 is an expanded timing diagram showing part of FIG. 89.

Referring to FIG. 88, since the image sensor 654 (refer to FIG. 37) is a sensor which outputs pixel data D (X, Y) in the form of an analog signal, this pixel data D (X, Y) is input to the analog input port AIN0 of the high speed processor 575. The analog input port AIN0 is internally connected to the ADC 408 in this high speed processor 575, and therefore the high speed processor 575 acquires the pixel data in the form of a digital signal.

The center point of the above analog pixel data D (X, Y) is determined by the reference voltage which is internally generated by the image sensor 654. Through the I/O ports of the high speed processor 575, the respective digital signals are output from the high speed processor 575 for controlling the image sensor 654 and input to the high speed processor 575 for receiving image signals. These I/O ports are digital ports capable of controlling input and output operations and connected to the input/output control circuit 409 inside of this high speed processor 575.

More specifically speaking, a reset signal “reset” is output to the image sensor 654 from the I/O port IO8 of the high speed processor 575 for resetting the image sensor 654. On the other hand, a pixel data strobe signal PDS and a frame status flag signal FSF are output from the image sensor 654 and input to the I/O ports IO10 and IO9 of the high speed processor 575.

The pixel data strobe signal PDS is a strobe signal for reading the respective pixel signals D (X, Y) as illustrated in FIG. 89(b). The frame status flag signal FSF is a flag signal which indicates the state of the image sensor 654 and used for defining the exposure period of this image sensor 654 as illustrated in FIG. 89(a). In other words, while the exposure period is defined by the low level period of the frame status flag signal FSF as illustrated in FIG. 89(a), the non-exposure period is defined by the high level period of the frame status flag signal FSF as illustrated in FIG. 89(a).

Also, the high speed processor 575 outputs, from the I/O ports IO0 to IO6, a command (or command associated with data) to be set in a control register (not shown in the figure) of the image sensor 654, and supplies the image sensor 654 with a register setting clock RCLK which periodically and alternatively takes high and low levels.

The four infrared light emitting diodes 614a, 614b, 614c and 614d (refer to FIG. 35) are connected in parallel each other. These infrared light emitting diodes 614a to 614d are lighted or non-lighted (lighted out) by an LED drive circuit 690. The LED drive circuit 690 receives the frame status flag signal FSF as described above from the image sensor 654, and this frame status flag signal FSF is passed through a differentiating circuit 685 comprising a resistor 683 and a capacitor 684 and given to the base of the PNP transistor 686. The base of this PNP transistor 686 is connected further to a pull-up resistor 687 which pulls up the base to a high level. Then, when the frame status flag signal FSF is pulled down to a low level, the low level signal is input to the base through the differentiating circuit 685 so that the PNP transistor 686 is turned on only for the low level period of the frame status flag signal FSF.

The emitter of the PNP transistor 686 is grounded through resistors 680 and 689. On the other hand, the connecting point between the emitter resistors 680 and 689 is connected to the base of an NPN transistor 681. The collector of this NPN transistor 681 is connected commonly to the anodes of the respective infrared light emitting diodes 614a to 614d. The emitter of the NPN transistor 681 is connected directly to the base of another NPN transistor 682. The collector of the NPN transistor 682 is connected commonly to the cathodes of the respective infrared light emitting diodes 614a to 614d, while the emitter of the NPN transistor 682 is grounded through a resistor 691.

This LED drive circuit 690 turns on the infrared light emitting diodes 614a to 614d only the period when an LED control signal LEDC output from the I/O port IO13 of the high speed processor 575 is activated (in a high level) while the frame status flag signal FSF outputs from the image sensor 654 is in a low level.

When the frame status flag signal FSF is pulled down to the low level as shown in FIG. 89(a), the PNP transistor 686 is turned on for the low level period (actually inclusive of the delay time corresponding to the time constant of the differentiating circuit 685). Accordingly, when the LED control signal LEDC shown in FIG. 89(d) is output from the high speed processor 575 as a high level signal, the base of the NPN transistor 681 is pulled up to a high level and turned on. When the transistor 681 is turned on, the transistor 682 is also turned on. Accordingly, a current flows from the power supply Vcc1 through the respective infrared light emitting diodes 614a to 614d and the transistor 682, and in response to this, the respective infrared light emitting diodes 614a to 614d are lighted as shown in FIG. 89(e).

The LED drive circuit 690 turns on the infrared light emitting diodes 614a to 614d only the period when the LED control signal LEDC is activated as shown in FIG. 89(d) while the frame status flag signal FSF is in a low level as shown in FIG. 89(a), and therefore the infrared light emitting diodes 614a to 614d are turned on only in the exposure period (refer to FIG. 89(f)) of the image sensor 654.

Accordingly, useless power consumption can be restricted. Furthermore, since the frame status flag signal FSF is given also to the coupling capacitor 684, the transistor 686 is necessarily turned off after a certain period even if the frame status flag signal FSF is fixed to a low level due to the runaway of the image sensor 654 or the like trouble, so that the infrared light emitting diodes 614a to 614d are also necessarily turned off after the certain period.

It is therefore possible to arbitrarily and freely change the exposure period of the image sensor 654 by adjusting the mark duration of the frame status flag signal FSF.

Furthermore, the lighting period, non-lighting period, cycles of lighting/non-lighting period and so forth of the infrared light emitting diodes 614a to 614d, i.e., of the stroboscope can be arbitrarily and freely set and changed by adjusting the mark durations and the frequencies of the frame status flag signal FSF and LED control signal LEDC.

Meanwhile, the image sensor 654 is connected to the terminal t3 and operates in synchronism with the clock signal SCLK1 generated by the crystal oscillator circuit 252.

In accordance with this cartridge 600, while the memory thereof can be used to store a program handling the image of the object as taken, a wider variety of applications can be implemented in the cartridge 600.

(I) Electric Configuration of Racket Type Input Device 700

As illustrated in FIG. 49, the racket type input device 700 is implemented with the piezoelectric element 720 which is fixed as part of an acceleration sensor circuit 766 (to be described below). As is well known, the piezoelectric element 720 is composed of a ceramic plate attached to a metal plate and serves as an acceleration sensor. Namely, the ceramic plate of the piezoelectric element 720 is made of a piezoelectric ceramic which generates an electrical signal when subjected to mechanical stress, as is well known in the field. Thus, the electrical signal generated by the piezoelectric element 720 is detected as a signal indicative of the motion of the piezoelectric element 720, i.e., the motion of the racket type input device 700.

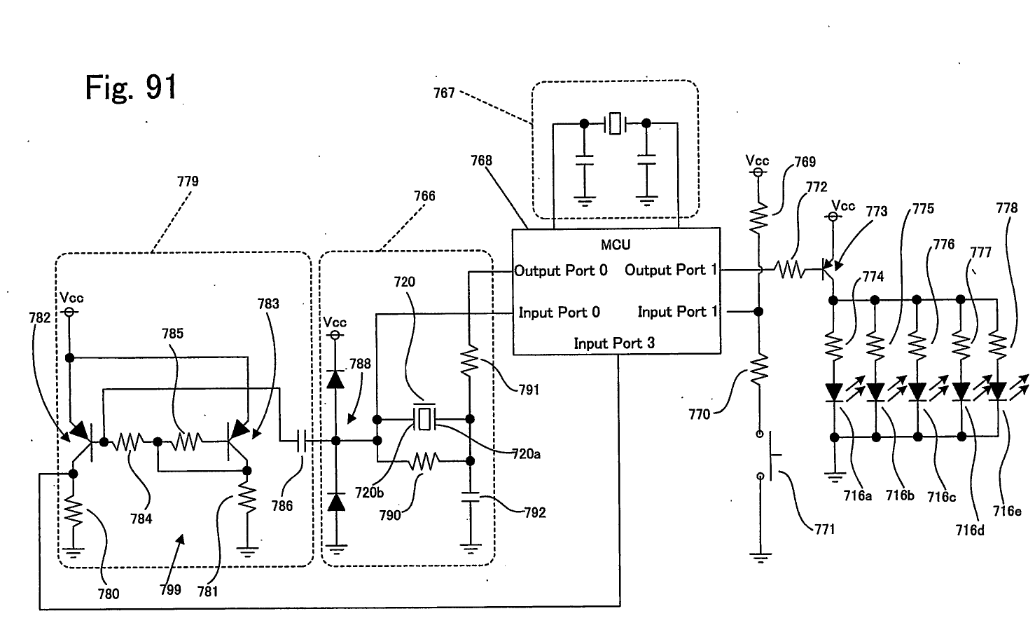

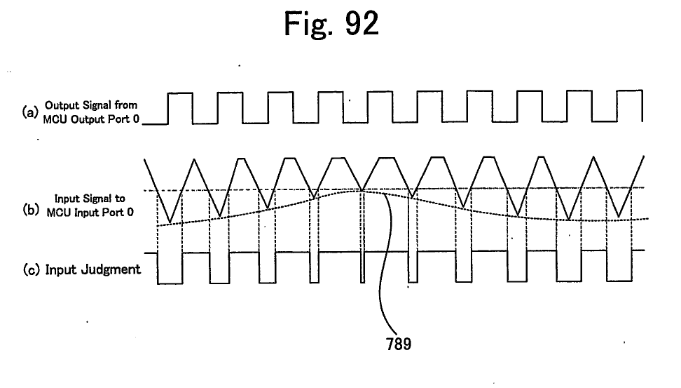

FIG. 91 is a view showing the electric configuration of the racket type input device 700 of FIG. 45. FIG. 92(a) is a waveform diagram of the output signal from the output port 0 of the MCU 768 of FIG. 91; FIG. 92(b) is a waveform diagram of the input signal to the input port 0 of the MCU 768; and FIG. 92(c) is an explanatory view for illustrating the input judgment by the MCU 768.

Referring to FIG. 91, the piezoelectric element 720 is included in the acceleration sensor circuit 766. Also, the MCU 768 is provided with an external crystal oscillator circuit 767 and operates in response to the clock signal generated by this crystal oscillator circuit 767. Then, the MCU 768 outputs a square wave signal from the output port 0, and applies the square wave signal to one electrode 720a of the piezoelectric element 720 through the resistor 791. The electrode 720a of the piezoelectric element 720 is grounded through a capacitor 792.

The other electrode 720b of the piezoelectric element 720 is connected to the input port 0 of the MCU 768 through a resistor 793 and connected to a diode circuit 788, so that the fluctuation of voltage is maintained within a constant range. Meanwhile, the two electrodes 720a and 720b of the piezoelectric element 720 are electrically separated from each other with a relatively high resistor 790.

The input port 1 of the MCU 768 is connected to the node between the resistor 769 and the resistor 770. The other terminal of the resistor 769 is connected to the power supply Vcc. The other terminal of the resistor 770 is connected to one terminal of the switch 771 while the other terminal of the switch 771 is grounded. If the switch 771 is opened, the node connected to the input port 1 is equal to the potential of the power supply Vcc. If the switch 771 is closed, a current flows from the power supply Vcc to the ground to pull down the potential of the node connected to the input port 1 to the potential determined by the voltage division between the resistor 769 and the resistor 770. With reference to the change in this potential, the MCU 768 can determine whether or not the switch 771 is conducting.

The output port 1 of the MCU 768 is connected to the base of the PNP transistor 773 through a resistor 772. The emitter of the transistor 773 is connected to the power supply Vcc while the collector thereof is connected to one terminals of resistors 774, 775, 776, 777 and 778. The other terminals of these resistor 774, 775, 776, 777 and 778 are connected to the respective infrared light emitting diode 716a to 716e (refer to FIG. 47) as described above. It is possible to control the lighting of the infrared light emitting diodes 716a to 716e by the output from the output port 1.

When the square wave signal as shown in FIG. 92(a) is applied to the electrode 720a of the piezoelectric element 720, a triangular wave signal as shown in FIG. 92(b) is input to the input port 0 of the MCU 768 during the charging and discharging of the capacitor 792. However, the amplitude of the triangular wave signal (peak to peak) is determined by the diode circuit 788.

When the racket type input device 700 is in a stationary condition, i.e., not moved, the potential of the triangular wave signal does not change in its lowest level (minus) as illustrated in the left end of FIG. 92(b). However, if the player moves the racket type input device 700 in the three-dimensional space, a voltage is induced within the piezoelectric element 720 by piezoelectric effect associated with the motion. This acceleration correlated voltage biases the triangular wave signal in the minus side. Accordingly, when the racket type input device 700 is moved, the acceleration correlated voltage is generated in the piezoelectric element 720 in accordance with the magnitude of the displacement acceleration, and therefore the lowest level of the triangular wave signal as input to the input port 0 of the MCU 768 varies in accordance with the level of the acceleration correlated voltage 789 as illustrated in FIG. 92(b).

The MCU 768 converts the deviation of the lowest level of the triangular wave signal into acceleration data, in accordance with which the infrared light emitting diodes 716a to 716e are controlled.

By the way, a start-up circuit 779 is composed of a current mirror circuit 799 and a capacitor 786. This capacitor 786 has one terminal connected to the electrode 720b of the piezoelectric element 720 and the other terminal connected to the base of a PNP transistor 782. The emitters of PNP transistors 782 and 783 are connected to the power supply Vcc. The collectors of the PNP transistors 782 and 783 are connected to one terminals of resistors 780 and 781. The other terminals of the resistors 780 and 781 are grounded. Resistors 784 and 785 are connected between the base of the PNP transistor 782 and the base of the PNP transistor 783 in series. The connecting point between the resistor 784 and the resistor 785 is connected to the collector of the PNP transistor 783. Also, the collector of the PNP transistor 782 is connected to the input port 3 of the MCU 768.

In this case, for example, it is assumed that the resistors 784 and 785 have a resistance value of 1 MΩ, that the resistor 780 has a resistance value of 100 kΩand that the resistor 781 has a resistance value of 1 MΩ. The resistance values of the resistors 784 and 785 are set to be large in this manner. Also, the resistance value of the resistor 781 is larger than the resistance value of the resistor 780.

First, when the racket type input device 700 is not moved so that the piezoelectric element 720 generates no voltage, the MCU 768 does not output a square wave signal from the output port 0. In this case, the collector current of the PNP transistor 782 is equal to the collector current of the PNP transistor 783 while the resistance value of the resistor 780 is smaller than the resistance value of the resistor 781, and therefore the potential at the collector of the PNP transistor 782 is smaller than the potential at the collector of the PNP transistor 783 ( 1/10 in this example). Because of this, the input port 3 of the MCU 768 is given a low level signal, and therefore the MCU 768 stops outputting the square wave signal.

Then, when the racket type input device 700 is moved, the piezoelectric element 720 is oscillated so that a voltage is generated in response to the oscillation. In this case, when this voltage is generated in the minus direction, the base current of the PNP transistor 782 flows into the capacitor 786, and therefore the base current of the PNP transistor 782 increases as compared to the case where the racket type input device 700 is not moved Thereafter, the collector current of the PNP transistor 782 increases to pull up the potential of the collector terminal, so that a high level voltage is given to the input port 3 of the MCU 768. By this process, the MCU 768 starts outputting the square wave signal from the output port 0.

Meanwhile, the electric configuration of the bat type input device 800 and the ball type input device 854 is the same as the racket type input device 700, and therefore no redundant description is repeated. However, in the case of the bat type input device 800, the four infrared light emitting diodes 808a to 808d are employed. Also, in the case of the ball type input device 854, the two infrared light emitting diodes 864a and 864b are employed.

(J) Processing of MCU 768 of Racket Type Input Device 700

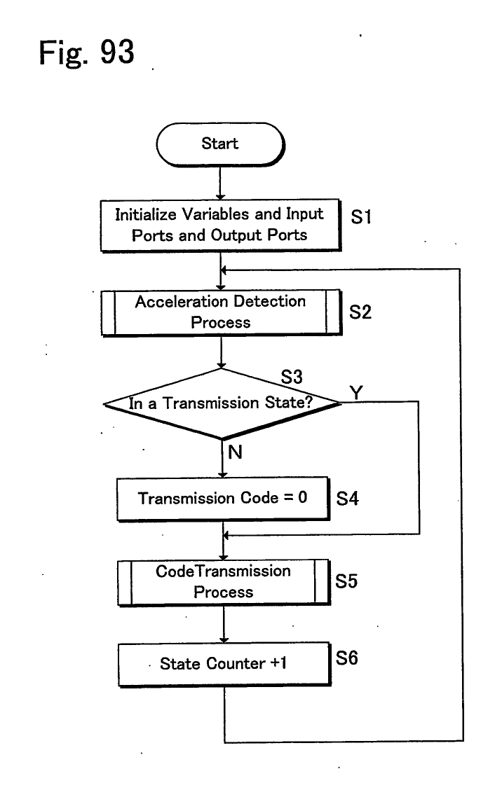

FIG. 93 is a flowchart showing the processing of the MCU 768 of FIG. 91. Referring to FIG. 93, in the first step S1, the MCU 768 initializes variables, to be described below and handled by the MCU 768, such as a detection offset value and an offset counter as well as the input ports and the output ports (FIG. 91).

Then, after the acceleration detection process (to be described below in detail) in step S2, the MCU 768 judges whether or not it is in a transmission state in step S3. Not shown in the figure, the MCU 768 is provided with a state counter as a software counter and takes the transmission state when the state counter reaches a predetermined value. Accordingly, in step S3, it is judged whether or not this state counter reaches the predetermined value. If it is “NO” in step S3, the transmission code is set to “0” in step S4, or if it is “YES” in step S3, the process proceeds to the code transmission process in step S5 (to be described below in detail) skipping the step S4. After performing the code transmission process in step S5, the state counter (not shown in the figure) is incremented by one (+1) in step S6, followed by returning to step S2. Incidentally, as described below, while the code transmission process is performed with a serial bit sequence, the required time thereof is extremely short in the order of micro seconds.

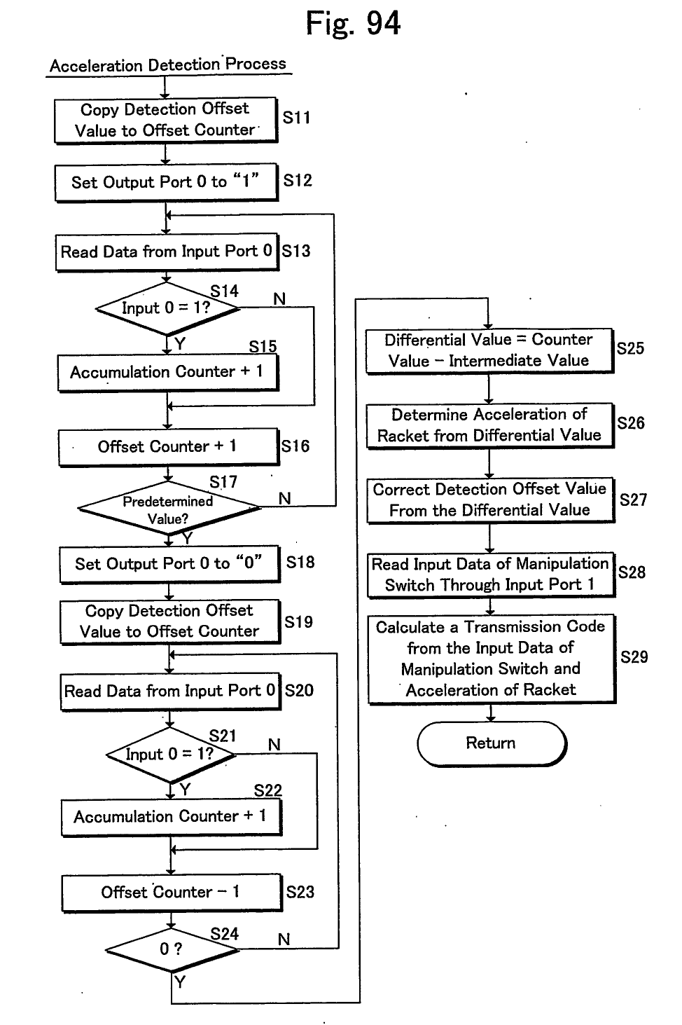

FIG. 94 is a flowchart showing the acceleration detection process in step S2 of FIG. 93. Referring to FIG. 94, in the first step S11 of this acceleration detection process, the MCU 768 copies the detection offset value saved in a register (not shown in the figure) to an offset counter (not shown in the figure). The “detection offset value” is a value to be adjusted to input the high level duration and low level duration of the square wave signal as illustrated in FIG. 92(a), which are equal to each other when the piezoelectric element 720 generates no voltage, and just after starting the system this detection offset value is set to an arbitrary default value.

In step S12 subsequent to step S11, the MCU 768 sets the output port 0 to “1”. In other words, the MCU 768 outputs “1”, i.e., a high level. Next, in step S13, the MCU 768 reads data from the input port 0.

In step S14, it is judged whether or not the data read from the input port 0 in step S13 is “1”. If it is “YES”, in the next step S15, the MCU 768 increments an accumulation counter (not shown in the figure) by one (+1). The “accumulation counter” is a counter for calculating the period during which the input port 0 continues taking a high level, such that it is incremented if the input port 0 is “1” or a high level and not incremented if the input port 0 is “0”.

In the case where the accumulation counter is incremented in step S15 or “NO” is judged in step S14, the MCU 768 increments the offset counter in the next step S16 and judges whether or not the counter value of the offset counter reaches a predetermined value in step S17. This predetermined value is the number “N/2” as explained in the following description. In other words, after the output port 0 is set to “1” in step S12, the MCU 768 continues outputting “1” from the output port 0 as long as “NO” is judged in step S17.

Then, when it is determined in step S17 that the counter value of this offset counter reaches the predetermined value, the MCU 768 sets “0”, i.e., a low level to the output port 0 in the next step S18. In the next step S19, the MCU 768 copies the detection offset value set in the register to the offset counter.

In the next step S20, the MCU 768 reads data from the input port 0. In step S21, it is judged whether or not the data of the input port 0 as read in step S20. If it is “YES”, in the next step S12, the MCU 768 increments the accumulation counter.

After the accumulation counter is incremented in step S22 or after “NO” is judged in step S21, the MCU 768 decrements the offset counter by one (−1) in the next step S23 and judges whether or not the counter value of the offset counter reaches “0” in step S24. In other words, after the output port 0 is set to “0” in step S18, the MCU 768 continues the output of “0” from the output port 0 as long as “NO” is judged in step S24.

Then, when “YES” is judged in step S24, i.e., when the offset counter becomes zero (0), the MCU 768 calculates a differential value by subtracting an intermediate value from the counter value of the accumulation counter in the next step S25. In this case, the “intermediate value” is “N/2” where “N” is the total number of times of repeating the process between step S17 and step S13 for detecting the high level duration and repeating the process between step S20 and step S24 for detecting the high level duration. The default value of the detection offset value is “N/2” in the usual case. The reason for calculating the differential value on the basis of the intermediate value in this step S25 is to use, as a reference of detecting the acceleration, the ratio between the high level duration and the low level duration under the condition that no acceleration correlated voltage is generated from a piezoelectric element which is an ideal piezoelectric element (i.e., duty ratio=50%).

More specifically speaking, while the accumulation counter indicates the number of times of reading “1” or a high level from the input port 0, the differential value, i.e., “the accumulation counter—the intermediate value” must be zero in step S25 as long as the piezoelectric element is an ideal piezoelectric element and no voltage is generated. Therefore, if the piezoelectric element 720 generates a certain voltage, the differential value becomes a significant non-zoro value. For this reason, the displacement acceleration of the racket type input device 700 is determined in accordance with this differential value in step S26. Basically, the differential value is multiplied by a predetermined coefficient to obtain desired acceleration data.

Thereafter, in step S27, the detection offset value is corrected on the basis of the differential value obtained in step S25. Namely, because the player does not swing the racket type input device 700 in the initial state, no acceleration correlated voltage is generated from the piezoelectric element 720. If there is a non-zero differential value detected in step S25 irrespective of the above fact, it means that the detection offset value as set in step S11 is not appropriate in view of the characteristics of the piezoelectric element used in the racket type input device. In other words, this means that the piezoelectric element is not ideal. For this reason, in such a case, the detection offset value is corrected by the use of the differential value in step S27 in order to compensate the difference in characteristics between the piezoelectric element for use and the ideal piezoelectric element.

On the other hand, in the case where the detection offset value is changed or corrected always in step S27, the detection offset value is modified even if the differential value is calculated with the acceleration correlated voltage actually generated by the piezoelectric element. However, the voltage generation period of the piezoelectric element is significantly short as compared to other periods. Because of this, there is no problem in practice even if step S27 is performed each time the differential value is detected. This will simplifies the algorithm.

The MCU 768 reads the input data, “1” or “0”, from the manipulation switch 710 through the input port 1 in the next step S28, prepares a transmission code with an additional parity bit in step S29 indicative of the input data read from the switch 710 and the displacement acceleration or the motion acceleration of the racket type input device 700 determined in the previous step S26, followed by returning to the step S3 of the main routine.

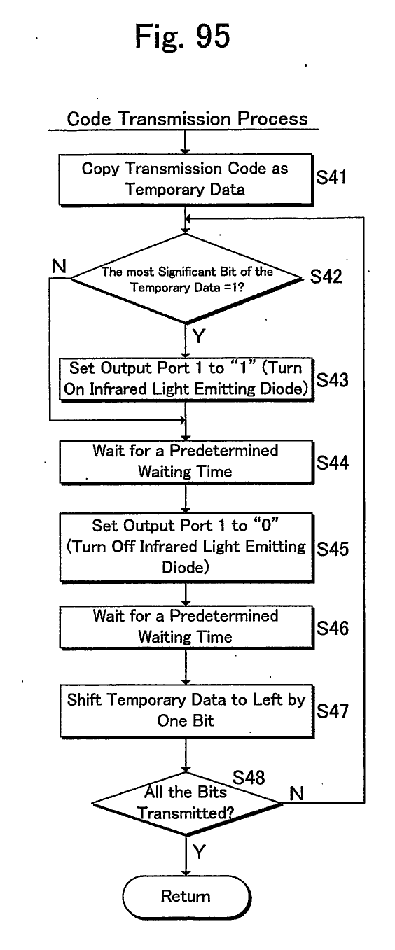

FIG. 95 is a flowchart showing the code transmission process of step S5 of FIG. 93. Referring to FIG. 95, in the first step S41, the MCU 768 copies the transmission code prepared in step S2 or S4 to a temporary data register (not shown in the figure). Then, it is judged whether or not the most significant bit is “1”. If the most significant bit is “1”, “YES” is judged in step S42 and, in the next step S43 the MCU 768 set the output port 1 to “1” in order to turn on the infrared light emitting diodes 716a to 716e. Thereafter, the MCU 768 waits for a predetermined waiting time in step S44. However, if it is “NO” in step S42, i.e., if the most significant bit is “0”, the process proceeds to step S44, skipping the step S43.

After the predetermined waiting time elapses in step S44, the MCU 768 set the output port 1 to “0” and turns off the infrared light emitting diodes 716a to 716e in step S45. Thereafter, the MCU 768 waits for a predetermined waiting time in step S46.

Then, after the predetermined waiting time elapses in step S46, the MCU 768 shifts the temporary data to the left by one bit, and the transmitted bit is moved to the least significant bit in step S47. In other words, the transmission bit is successively replaced for serial bit transmission. Then, in step S48, it is judged whether or not all the bits have been transmitted. If it is “NO”, the process returns to step S42, and if it is “YES” this process is completed and proceeds to step S6 of FIG. 93.

Meanwhile, the process of the MCU installed in the bat type input device 800 and the ball type input device 854 of FIG. 45 is the same as the process of the MCU 768 installed in the racket type input device 700, and therefore no redundant description is repeated.

(K) Virtual Reality Experience by the Use of Racket Type Input Device 700 of FIG. 45.

In the case where the television receiver 14 is used as part of a virtual reality system for playing tennis, as illustrated in FIG. 45 for example, the adapter 1 is set with the cartridge 500 having the built-in memory 577 (refer to FIG. 85) in which are stored a program and data required for implementing the virtual reality system for playing tennis. Then, the television receiver 14 is turned on, and the power supply switch 9 of the adapter 1 is turned on.

In the virtual reality system for playing tennis, the high speed processor 575 of the cartridge 500 generates the video signal VD for displaying on the television receiver 14 a ball, player characters, a net character, and a court character, and outputs to the video output port VO. The video signal VD is transmitted to the television receiver 14 through the terminal t23 of the cartridge 500, the terminal T23 of the adapter 1 and the AV jack 25. In this configuration, the television receiver 14 displays images such as a ball. Also, the high speed processor 575 generates audio signals AL1 and AR1 for outputting music, sound effects and the like to be output to the speaker of the television receiver 14, and outputs them to the audio output ports AL and AR. The audio signals AL1 and AR1 are transmitted to the television receiver 14 through the terminals t20 and t21 of the cartridge 500, the terminals T20 and T21 of the adapter 1, the audio amplifier 258, and the AV jack 25. In this configuration, the television receiver 14 outputs music and the like from the speaker.

In the case of this virtual reality system for playing tennis, when the player swings the racket type input device 700 in the real space, the infrared light emitting diodes 716a to 716e output an infrared signal to the IR receiver circuit 256 of the adapter 1 in accordance with the acceleration correlated signal as output from the piezoelectric element 720 of the racket type input device 700. After receiving the infrared signal, the IR receiver circuit 256 digital demodulates the infrared signal as received and outputs it to the terminal t17 of the cartridge 500 through the terminal T17. The high speed processor 575 inputs these signals from the I/O port IO16 and performs processing in accordance with the program stored in the memory 577.

For example, if the player swings the racket type input device 700 in the real space in synchronism with the motion timing of the ball as displayed in the screen, the high speed processor 575 detects the swing with reference to the infrared signal corresponding to the acceleration correlated signal of the piezoelectric element 720 transmitted from the infrared light emitting diodes 716a to 716e to the IR receiver circuit 256, and then moves the ball displayed in the screen toward the opponent over the court, as if the ball were actually returned with the racket, in accordance with the timing when the racket type input device 700 is swung at a predetermined moving speed and the position of the ball in the screen. Depending on the position in which the ball moves, it is judged whether the ball is out or in the court. However, if there is disagreement between the timing of swinging the racket type input device 700 and the position of the ball on the screen, it is judged that the player swings and misses (lets the ball pass).

FIG. 96 is a flowchart showing the process flow of the virtual reality system for playing tennis by the use of the racket type input device 700 of FIG. 45. The high speed processor 575 shown in FIG. 85 first performs the initialization process in step S101. Specifically, the system and the respective variables are initialized.

Thereafter, the high speed processor 575 updates the video signal VD in step S102, and updates the image displayed on the television receiver 14. However, the process of updating the display image is performed for each frame (television frame or video frame).

Then, the high speed processor 575 performs the process in accordance with the state. However, the process to be performed first is the selection of the mode. In this mode selection, the player manipulates the arrow keys 17a to 17d of the adapter 1, selects a single player mode or a two player mode, and a singles mode or a doubles mode, and sets the difficulty level of the game in step S103.

While the real tennis starts from a serve and enters a rally, the ball of this game must be tossed for the serve in the screen. In this situation, the high speed processor 575 performs a preparation process of tossing in step S104 and then performs a tossing process in step S105. Namely, if the manipulation switch 710 is pressed in the preparation process of tossing, the process proceeds to the tossing process in which, if the racket type input device 700 is not swung, the process returns to the preparation process. On the other hand, if the racket type input device 700 is swung in the tossing process, the process proceeds to a rally process in step S106. Then, if a point is got in the rally process, the process proceeds to the process of handling the point in the next step S107. Also, depending upon whether or not a termination condition is satisfied with the point in the point handling process, the process returns to the mode selection (S103) or the preparation process of tossing (S104).

Thereafter, if there is an interrupt by a video system synchronous signal, the process of updating the display image is performed in step S102. Also, the sound process in step S108 is performed when an audio interrupt is issued for outputting sound effects such as music, hitting sound. When receiving an infrared signal (code), the IR receiver circuit 256 of the adapter 1 outputs an interrupt request signal to the high speed processor 575, which then starts the following code reception process as an interrupt handler in step S109 after accepting the interrupt request or timer interrupt.

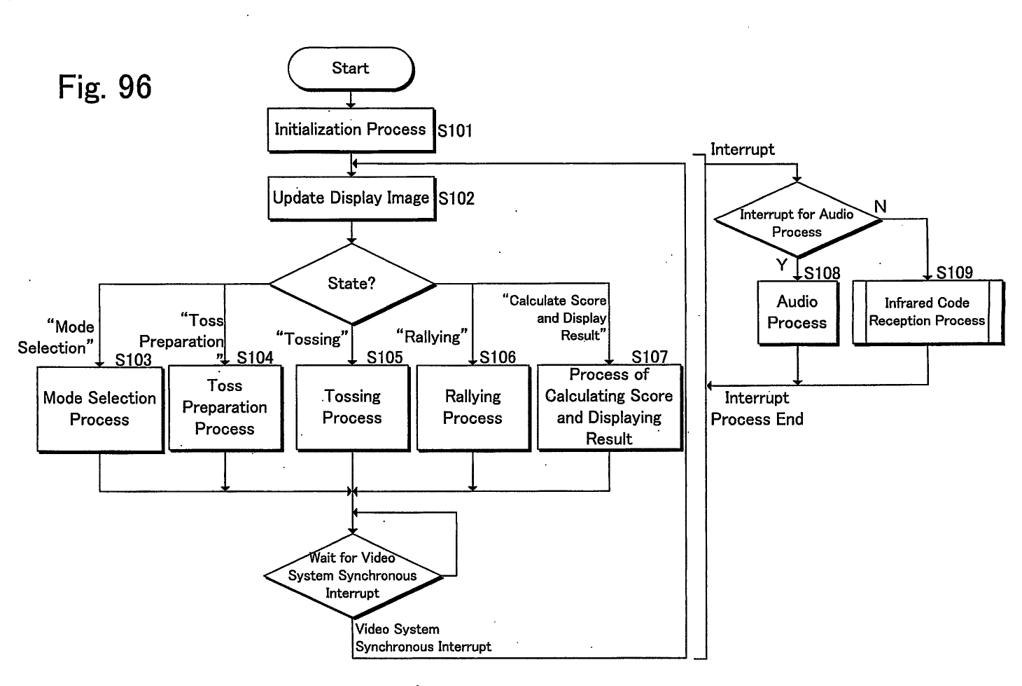

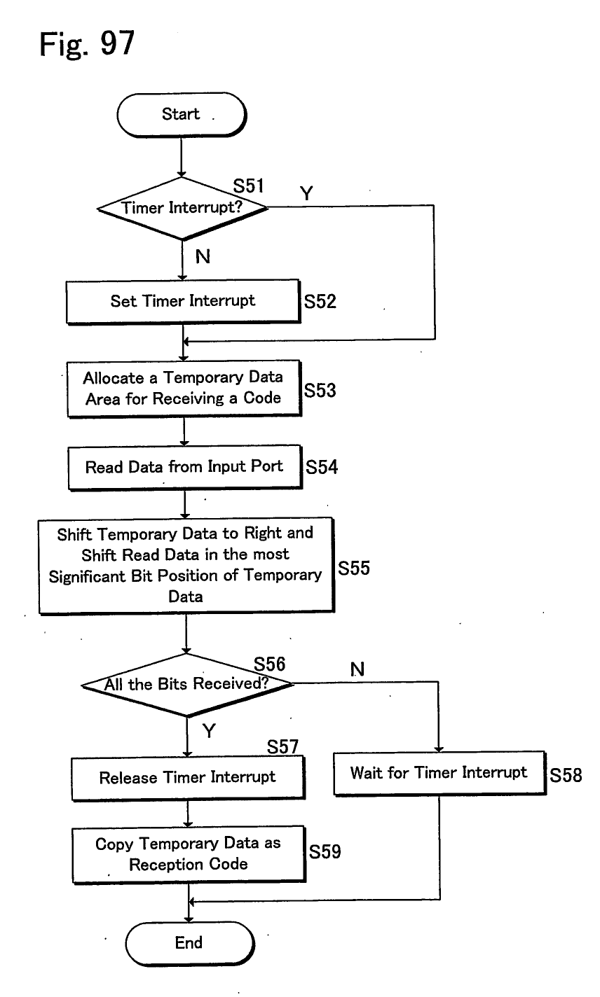

FIG. 97 is a flowchart showing the code reception process in step S109 of FIG. 96. This code reception process is invoked by the timer interrupt signal, so that the high speed processor 575 judges in the first step S51 whether or not the timer interrupt is set. If it is “NO”, the timer interrupt is set in step S52, and if it is “YES” the process proceeds to step S53, skipping the step S52.

In step S53, the high speed processor 575 allocates a temporary data area for receiving the code in the memory 407 (FIG. 86). Then, in the next step S54, the high speed processor 575 reads data from the input port IO16 to which the output signal from the IR receiver circuit 256 (FIG. 78) is input. In the next step S55, the high speed processor 575 shifts the temporary data to the right, and places the data read in step S54 on the most significant bit position of the temporary data.

Thereafter, it is judged whether or not all the bits have been received in step S56, and if it is “NO” the high speed processor 575 waits for the next timer interrupt in step S57. If it is “YES”, the timer interrupt setting is released in step S58, the temporary data is copied as a reception code in step S59. The high speed processor 575 performs the process of FIG. 96 by the use of this reception code.

By the way, in the case where the television receiver 14 is used as part of a virtual reality system for playing baseball by the use of the bat type input device 800 and the ball type input device 854 as illustrated in FIG. 45, for example, the adapter 1 is set with the cartridge 500 having the built-in memory 577 (refer to FIG. 85) in which are stored a program and data required for implementing the virtual reality system for playing baseball. Then, when turning on the television receiver 14 and the power supply switch 9 of the adapter 1, the high speed processor 575 generates a video signal VD and audio signals AL1 and AR1 according to the program stored in the memory 577 and outputs these signals to the television receiver 14 through the adapter 1.

In the case of this virtual reality system for playing baseball, if the player swings the bat type input device 800 in the real space, an infrared signals is transmitted from the infrared light emitting diodes 808a to 808d to the IR receiver circuit 256 of the adapter 1 in accordance with the acceleration correlated signal from the piezoelectric element 830 of the bat type input device 800. After receiving the infrared signal, the IR receiver circuit 256 digital demodulates the infrared signal as received and outputs it to the terminal t17 of the cartridge 500 through the terminal T17. The high speed processor 575 inputs these signals from the I/O port IO16 and performs in accordance with the program stored in the memory 577. Incidentally, the similar process is performed also when the player holds the ball type input device 854 and gestures a throwing motion in the real space.

Meanwhile, the player puts his wrist through the strap 703 of the racket type input device 700, the strap 801 of the bat type input device 800 or the strap 803 of the ball type input device 854 in advance of playing the game. The safety is improved with such a wrist strap.

(L) Virtual Reality Experience by the Use of Bowling Ball Type Input Device 900 of FIG. 63.

In the case where the television receiver 14 is used as part of a virtual reality system for playing bowling, as illustrated in FIG. 63 for example, the adapter 1 is set with the cartridge 600 having the built-in memory 577 (refer to FIG. 85) in which are stored a program and data required for implementing the virtual reality system for playing bowling. Then, the television receiver 14 is turned on, and the power supply switch 9 of the adapter 1 is turned on.

In the virtual reality system for playing bowling, the high speed processor 575 of the cartridge 600 generates video signal VD for displaying on the television receiver 14 a bowling lane, pins and so forth, and outputs it to the video output port VO. The video signal VD is transmitted to the television receiver 14 through the terminal t23 of the cartridge 600, the terminal T23 of the adapter 1 and the AV jack 25. In this configuration, the television receiver 14 displays images such as a bowling lane. Also, music, sound effects and the like are output to the speaker of the television receiver 14 in the same manner as in the virtual reality system for playing tennis.

In the case of this virtual reality system for playing bowling, when the player gestures a throwing motion with the bowling ball type input device 900 in the real space, the high speed processor 575 turns on and off the infrared light emitting diodes 614a to 614d of FIG. 35 to intermittently output infrared signals and analyzes and process the images of the image sensor 654 each time when turning on and off in order to intermittently detect the location of the bowling ball type input device 900. Then, the high speed processor 575 controls the motion of the bowling ball displayed on the screen in accordance with the position (coordinates) of the bowling ball type input device 900 and knocks down no pin or one or more pins in accordance with the motion of the bowling ball. Incidentally, the player puts his wrist through the strap 901 in advance of gesturing a throwing motion. The safety is improved with such a wrist strap.

Meanwhile, the reflective sheets attached to the inner shell of the bowling ball type input device 900 are exposed to the infrared light of the infrared light emitting diodes 614a to 614d, and reflects the infrared light. The image sensor 654 takes the image of the reflective sheets with the infrared light as reflected by these reflective sheets to output the image signal of the reflective sheets.

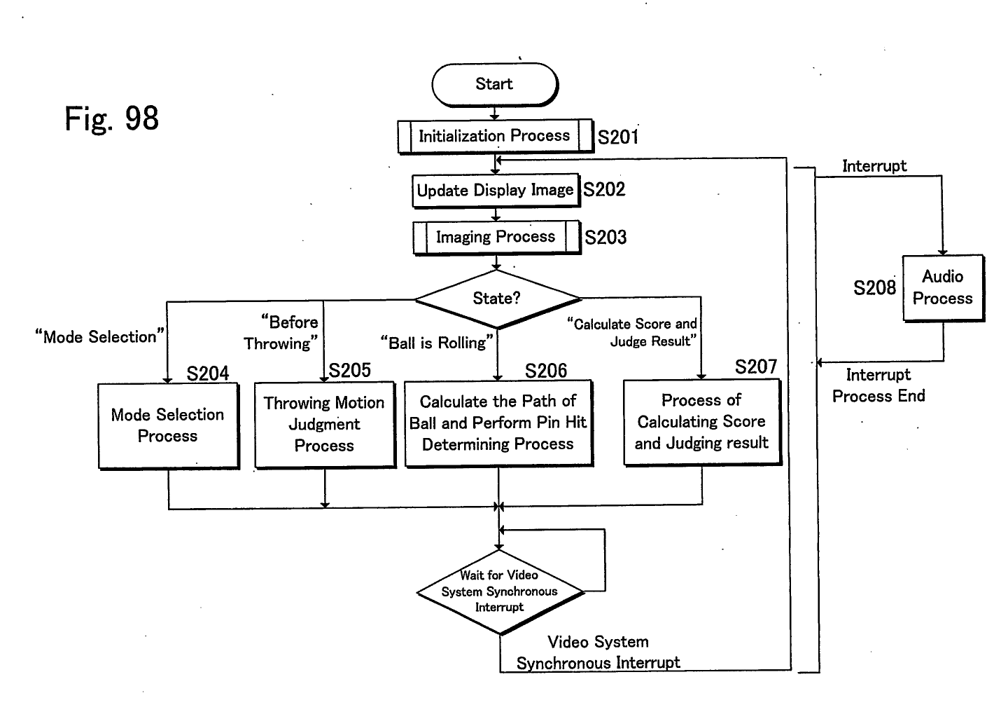

FIG. 98 is a flowchart showing the process flow of the virtual reality system for playing bowling by the use of the bowling ball type input device 900 of FIG. 63. The high speed processor 575 first performs the initialization process in step S201. Specifically, the system and the respective variables are initialized.

After step S201, the high speed processor 575 updates the video signal VD in step S202, and updates the image displayed on the television receiver 14. However, the process of updating the display image is performed for each frame (television frame or video frame).

In step S203, the high speed processor 575 performs the imaging process. Then, the high speed processor 575 performs the process in accordance with the state. However, the process to be performed first is the selection of the mode. In this mode selection, the player manipulates the arrow keys 17a to 17d, selects a single player mode or a two player mode, and sets the difficulty level of the game in step S204.

While the ball is let roll in the case of the real bowling game, the player of this game gestures a throwing motion with the bowling ball type input device 900. In this situation, the high speed processor 575 performs a judgment process of the throwing motion in step S205 and then judges whether or not a throwing motion is actually gestured. Then, if a throwing motion is actually gestured, the ball is displayed to move on the lane while calculating the path of the ball, followed by performing the hit determining process of determining the collision of the ball with pins in step S206. Then, when the ball reaches the end of the lane, in step S207, the process of judging the outcome and score calculation is performed as the result of the hit determining process in step S206.

Thereafter, if there is an interrupt by a video system synchronous signal, the process of updating the display image is performed in step S202. Also, the sound process in step S208 is performed when an audio interrupt is issued for outputting sound effects such as music, the rolling sound of the bowling ball.

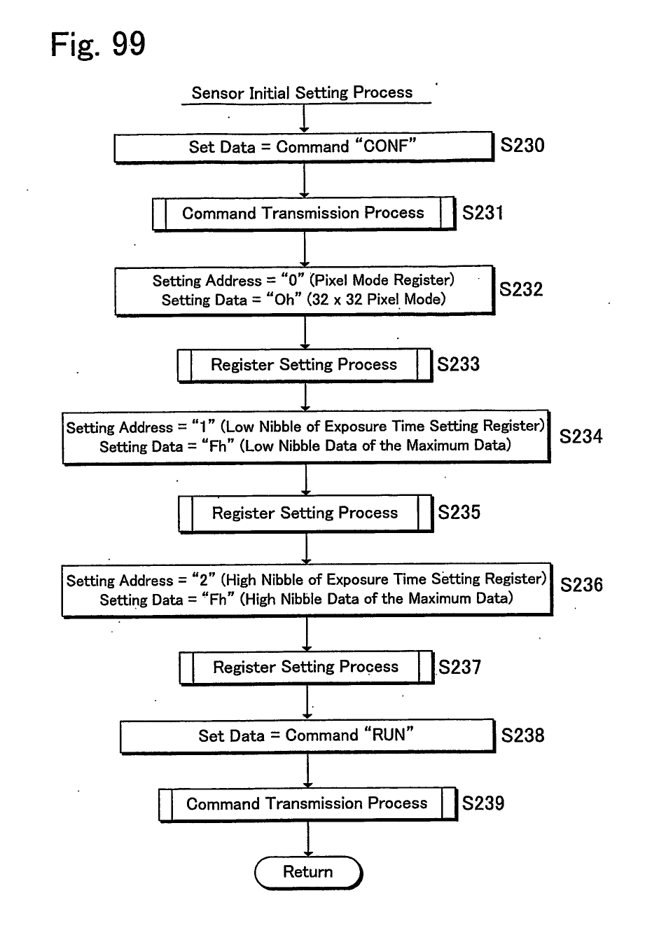

FIG. 99 is a flowchart showing an example of the sensor initial setting process which is performed as a process of the initialization process performed in step S201 of FIG. 98. As shown in FIG. 99, in the first step S230, the high speed processor 575 prepares a command “CONF” as data to be set. In this case, this command “CONF” is a command used to inform the image sensor 654 that the high speed processor 575 is ready to transmit a command to the image sensor 654 in a configuration mode. Then, in the next step S231, a command transmission process is performed.

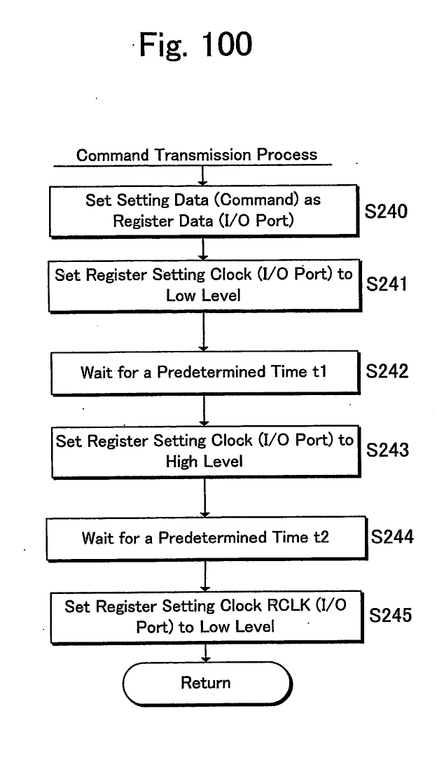

FIG. 100 is a flowchart showing one example of the command transmission process in step S231 of FIG. 99. As shown in FIG. 100, the high speed processor 575 sets the setting data (the command “CONF” in step S231) as register data (I/O ports IO0 to IO6) in the first step S240, and sets the register setting clock RCLK (I/O port IO7) to a low level in the next step S241. Then, after waiting for a predetermined time in step S242, the register setting clock RCLK is set to a high level in step S243. Then, after further waiting for the predetermined time in step S244, the register setting clock RCLK is set to a low level again in step S245.

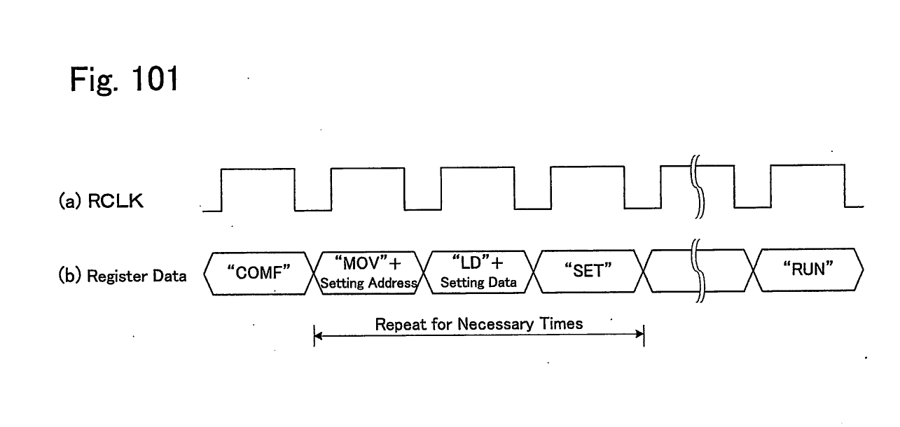

In this manner, as illustrated in FIG. 101, the process of transmitting a command (or command associated with data) can be performed by changing the level of the register setting clock RCLK between a low level and a high level while waiting for the predetermined time before each change.

Returning to FIG. 99, the explanation continues. The pixel mode is set in step S232. In the case where the image sensor 654 is a CMOS image sensor of 32 pixels×32 pixels, “0h” indicative of 32 pixels×32 pixels is loaded into the pixel mode register in setting address “0”. In the next step S233, the high speed processor 575 performs a register setting process.

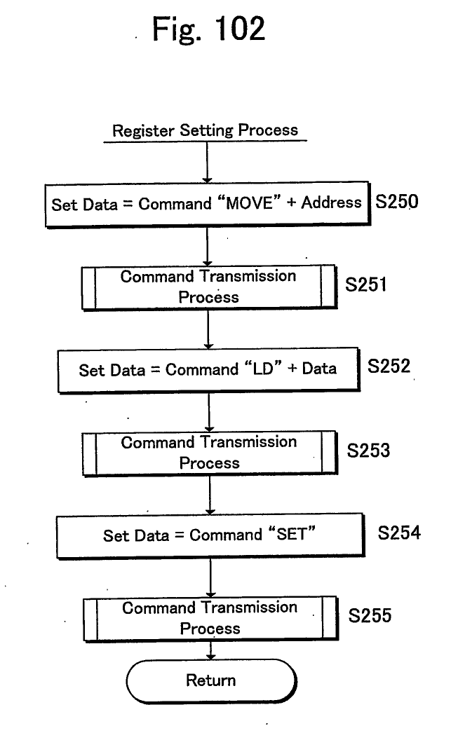

FIG. 102 is a flowchart showing one example of the register setting process in step S233 of FIG. 99. As shown in FIG. 102, the high speed processor 575 sets the command “MOV” associated with an address as setting data in the first step S250, and then performs the command transmission process in the next step S251 as explained above with reference to FIG. 100 to transmit the command. Next, the high speed processor 575 sets the command “LD” associated with data as setting data in the next step S252, and then performs the command transmission process in the next step S253 to transmit the command. Then, the high speed processor 575 sets the command “SET” as setting data in step S254, and transmits the command in the next step S255. Incidentally, the command “MOV” is a command for transmitting the address of a control register; the command “LD” is a command for transmitting data; and the command “SET” is a command for actually loading the data into the address. Incidentally, the above process is repeated if there are a plurality of control registers to be set.

Returning to FIG. 99, the explanation continues. In step S234, the setting address is set to “1” (the address of the low nibble of an exposure time setting register), and “Fh” is loaded into the low nibble of the exposure time setting register as the low nibble data of “FFh” indicative of the maximum exposure time. Then, in step S235, the register setting process of FIG. 102 is performed. In the same manner, in step S236, the setting address is set to “2” (the address of the high nibble of the exposure time setting register), and “Fh” is loaded into the high nibble of the exposure time setting register as the high nibble data of “FFh” indicative of the maximum exposure time, followed by performing the register setting process in step S237.

Thereafter, a command “RUN” is set in step S238 for indicating the completion of initialization and letting the image sensor 654 start outputting data, followed by step S239 in which the command “RUN” is transmitted. The sensor initialization process is performed in this manner. However, the specific examples as illustrated in FIGS. 99 to 102 may be modified in accordance with the specification of the image sensor 654 actually employed.

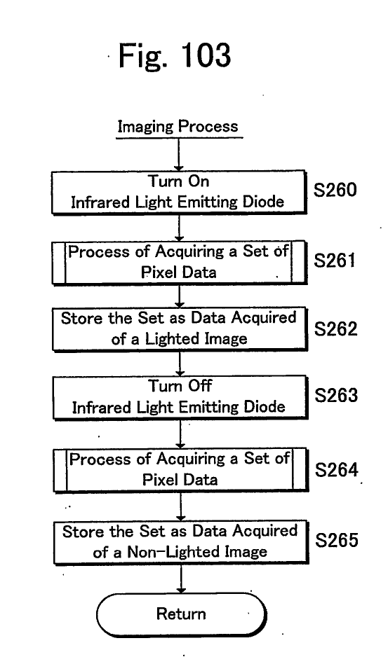

FIG. 103 is a flowchart showing the imaging process of step S203 of FIG. 98. As shown in FIG. 103, in step S260, the high speed processor 575 turns on the infrared light emitting diodes 614a to 614d for stroboscope imaging. More specifically speaking, the LED control signal shown in FIG. 88 is pulled up to a high level. Thereafter, in step S261, the high speed processor 575 performs the process of acquiring a set of pixel data.

In step S262, a pixel data array is stored, for example, in a working area of the inner memory 407 as data acquired of an lighted image. In step S263, the high speed processor 575 turns off the infrared light emitting diodes 614a to 614d by pulling down the LED control signal to a low level and so forth. Thereafter, in the same manner as in step S261, a pixel data array is acquired with the diodes 614a to 614d being turned off in step S264, and in the same manner as in step S262 the pixel data array is stored in a working area of the inner memory 407 in step S265.

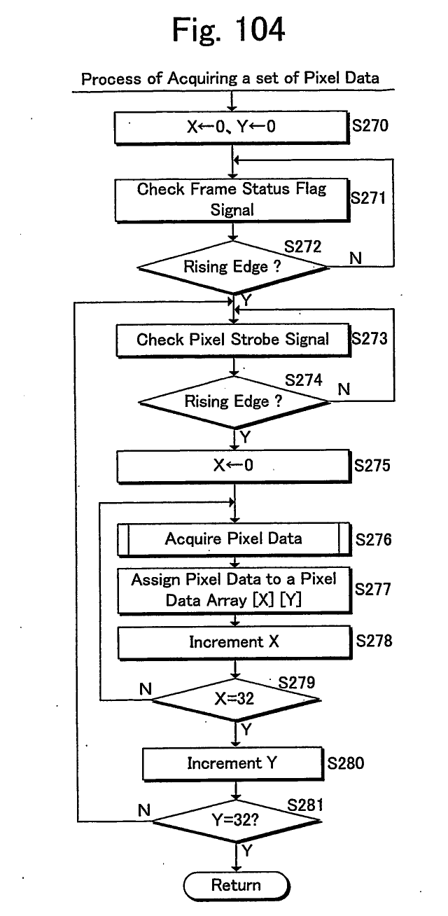

FIG. 104 is a flowchart showing one example of the process of acquiring a set of pixel data in step S261 of FIG. 103. As shown in FIG. 104, in the first step S270, the high speed processor 575 assigns “0” to both the X index and Y index of the pixel data array. The high speed processor 575 then checks the frame status flag signal FSF as input from the image sensor 654 in step S271, and judges whether or not the rising edge thereof (from a low level to a high level) is detected in step S272. If the rising edge of the frame status flag signal FSF is detected in step S272, the process proceeds to step S273. On the other hand, if the rising edge of the frame status flag signal FSF is not detected, the process proceeds to step S271.

The high speed processor 575 checks the pixel strobe signal PDS as output from the image sensor 654 in step S273, and judges whether or not the rising edge of the pixel strobe signal PDS from a low level to a high level is detected in step S274. If “NO” is judged in step S274, the high speed processor 575 proceeds to step S273. On the other hand, if “YES” is judged in step S274, the high speed processor 575 assigns “0” to the X index in step S275. In the next step S276, the process of acquiring pixel data.

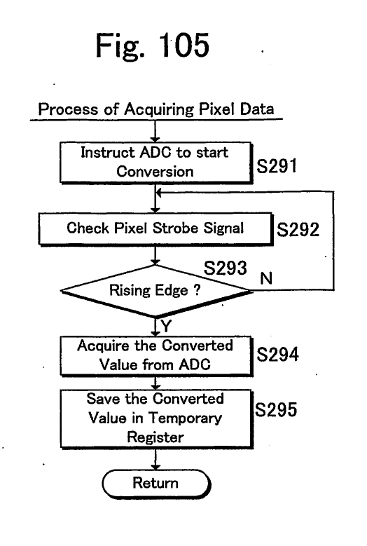

FIG. 105 is a flowchart showing one example of the process of acquiring pixel data shown in step S276 of FIG. 104. As shown in FIG. 105, in the first step S291, the high speed processor 575 instructs the ADC 408 to start the conversion of the analog pixel data into digital data. Thereafter, the high speed processor 575 checks the pixel strobe signal PDS as input from the image sensor 654 in step S292, and judges whether or not the rising edge of the pixel strobe signal PDS from a low level to a high level is detected in step S293.

If “NO” is judged in step S293, the process proceeds to step S292, while if YES” is judged in step S293, the process proceeds step S294. In step S294, the high speed processor 575 acquires digital pixel data (converted values) from the ADC 408. Then, in step S295, the pixel data as acquired is saved in a temporary register (not shown in the figure). Thereafter, the process proceeds to step S277 of FIG. 104.

In step S277, the high speed processor 575 assigns the pixel data as saved in the temporary register to the pixel data array P[Y] [X]. In the next step S278, the index X is incremented. If X is less than 32, the above process from step S276 to step S278 is repeatedly performed. If X is equal to 32, i.e., if the acquisition process of pixel data reaches the end of the current line, Y is incremented in step S280 and the acquisition process of pixel data is repeated from the top of the next line. If Y is equal to 32 in step S281, i.e., if the acquisition process of pixel data reaches the end of the pixel data array P[Y][X], the process proceeds to step S262 of FIG. 103.

By the way, in accordance with the adapter 1 of the present embodiment, it is possible to transmit the video signals and the audio signals generated by a computer (the high speed processor 575) to the television receiver 14 simply by connecting the AV jack 25 (the video signal output terminal and the audio signal output terminal) of the adapter 1 to the AV jack 24 (the video signal input terminal and the audio signal input terminal) of the television receiver 14 while the cartridge 500 or 600 is inserted into the adapter 1. Accordingly, the television receiver 14 can display screen images by the use of video signals generated by the computer (the high speed processor 575), and output sounds by the use of the audio signals generated by the computer (the high speed processor 575).

In this manner, by the use of the adapter 1, the computer (the high speed processor 575) can easily be connected to the television receiver 14. Accordingly, the television receiver 14 can be easily adapted for the purpose of the program stored in the memory 577 inside of the cartridge 500 or 600. In addition to this, the television receiver 14 can be easily adapted for a variety of purposes simply by changing the cartridge 500 or 600 inserted into the adapter 1.

Also, by the use of the adapter 1, the computer (the high speed processor 575) can be easily connected to the television receiver 14 which is widely distributed and used by any person, and therefore it is possible to alleviate the economic burden on the user while the user can use the computer (the high speed processor 575) without circumstance.

Incidentally, since a personal computer cannot be used alone without peripherals such as a monitor, the user has to provide a set of a personal computer with all the necessary peripherals, and therefore a computer can not necessarily be used without circumstance even with the recent price plummet of personal computers. Also, while it is troublesome to use a monitor connected to a personal computer by installing an exclusive device driver, which is usually indispensable for operating the monitor, such troublesome installation can be dispensed with by the use of the above adapter 1 since the adapter 1 is connected to the television receiver 14 to improve the convenience of the user. Furthermore, in the usual case, a variety of functions are installed in a personal computer to have the versatility with many unnecessary functions which are burdensome for the user and boost the price. Contrary to this, the user of the present system possessing the adapter 1 can adapt the television receiver 14 for his purpose only by purchasing the corresponding cartridge 500 or 600, while few unnecessary functions for the user are installed to remove botheration.

Furthermore, since the computer (the high speed processor 575) outputs the video signal and the audio signals in such signal formats that the television receiver 14 receives the video and audio signals, displays an image and outputs a sound respectively corresponding to the video and audio signals, the user can continue using the adapter 1 without extension or modification even when the functionality of the computer (the high speed processor 575, the memory 577) is upgraded or modified. In other words, even when the functionality of the computer (the high speed processor 575, the memory 577) is upgraded or modified, the user can continue using the existing adapter 1 in the way as it is without awareness of the extension and modification of hardware and software simply by inserting into the adapter 1 the cartridge 500 or 600 equipped with the built-in computer (the high speed processor 575, the memory 577) which is upgraded or modified. As a result, it is possible to improve user-friendliness and alleviate the economic burden on the user, and therefore to promote the spread of the cartridges 500 and 600.

Incidentally, in the case of the game machine disclosed in Patent document 1, the VDG having an ability of generating video signals is implemented within the game console itself, and therefore, when the CPU in a game cartridge is upgraded or modified, the game console must be upgraded or modified in functionality corresponding to the upgrade or modification of the game cartridge. As a result, in the case of the game machine of Patent document 1, the user has to purchase a new game cartridge together with a new game console so that a substantial economic burden is imposed on and botheration is caused to the user while the specification and operation procedure of the game console may be changed. This is true for the personal computer disclosed in Patent document 2. The reason is because the display control circuit for generating video signals is implemented within a docking station.

Also, since the adapter 1 of the present embodiment is designed to receive the video signal and the audio signals in such signal formats that the television receiver 14 can receive the video and audio signals, displays an image corresponding to the video signal, and outputs a sound corresponding to the audio signals, the computer (for example, the high speed processor 575) can be employed for use in combination with the adapter 1 as long as it is capable of outputting such signals. Accordingly, the developer of the cartridge 500 or 600 can be freely and arbitrarily design the hardware and software configuration of the computer (the high speed processor 575) in accordance with a variety of purposes. As has been discussed above, unlike the existing personal computers and the game machines, the restraints on hardware and software by the platform can be removed, as much as possible, when designing the cartridge 500 or 600.

By the way, in the case of the existing personal computers, an application program must be designed for each of different platforms to be supported (for example, different operating systems) to increase the development cost. Also, in the case of the existing game machines, a game program must be designed for each of different platforms to be supported (for example, different game consoles).

Furthermore, the adapter 1 of the present embodiment is used with the cartridge 500 or 600 in which a program is installed for a particular purpose. Because of this, unlike the personal processor module of Patent document 2 requiring the versatility, there is no need for a hard disk and it is possible to reduce the performance required of the computer. As a result, it is possible to reduce the cost of the cartridge 500 or 600 to be inserted into the adapter 1 as compared with the personal processor module having the versatility.

Furthermore, in accordance with the adapter 1 of the present embodiment, the power supply voltages required for operating the computer and peripheral circuits inside of the cartridge 500 or 600 can be supplied from the adapter 1 so that there is no need for a power supply circuit in the cartridge 500 or 600. Therefore, the cost of the cartridge 500 or 600 can be reduce. On the other hand, while the cost of the adapter 1 tends to increase in this configuration, it is outweighed by the economic effect of the cost reduction of the cartridges 500 and 600 which are frequently purchased in accordance with different purposes since the adapter 1 can be commonly used for the cartridges. In addition, in the case of the adapter 1 of this embodiment, since the cartridges 500 and 600 can be designed to operate with various power supply voltages, the design freedom can be increased.

Furthermore, the adapter 1 of the present embodiment, when it is not needed to supply a power supply voltage to the cartridge 500 or 600, i.e., when the cartridge 500 or 600 is not used, the contact “c” and contact “a” of the switching circuit sw4 are connected to each other so that the line w20 for supplying the external power supply voltage assumes a high impedance state. On the other hand, the contact “c” and contact “a” of the switching circuit sw3 are connected to each other so that the AV jack 25 is connected to the jack 31 V, while the contact “c” and contact “a” of each of the switching circuits sw1 and sw2 are connected to each other so that the AV jack 25 is connected to the jacks 31R and 31L. Accordingly, when the cartridge is not used, it is possible to relay the video signal and the audio signals as input from the external device to the television receiver. Therefore, the adapter 1 can be applied for wider purposes. Also, while there may be users who have the adapter 1 always connected to the television receiver, a shortage of the input terminals of the television receiver can be avoided by this configuration. In other words, since the adapter 1 is provided with the jacks 31R, 31L and 31 V, the number of available input terminals is not decreased even if the adapter is connected to the input terminal of the television receiver.

The adapter 1 in accordance with the embodiment as described above is provided with the power supply button push mechanism 73. Taking into consideration the user's convenience and the external appearance, it seems reasonable that the power supply button which is manipulated by the user is located in the front face of the adapter 1 while the respective terminals are located in the back face of the adapter. Then, the power switch unit 53 serves not only to turn on and off the power supply but also connect and disconnect the respective terminals therebetween. Accordingly, if the power switch unit 53 is located in the front face side of the adapter, many wirings must be arranged from the back face side of the adapter 1 to the front face side. However, while the power switch unit 53 is located in the back face of the adapter 1, it is possible to control the opening and closing of the power switch unit 53 in the front face side by making rod-like members, such as the arms 177, 179 and 181 of FIG. 8, come in contact with the power switch unit 53 from the front face side. Therefore, complicated wirings can be dispensed with. Eventually, it is possible to inhibit noise or the like from affecting the system.

Also, since an AC power supply voltage is internally converted to a DC power supply voltage in accordance with this adapter 1, unlike in the case where an AC power supply voltage is supplied from an external AC adapter, it is avoided that the user connects an inappropriate AC adapter having a different specification with the adapter 1 by oversight, and therefore the reliability can be improved.

Furthermore, in accordance with this adapter, the adapter 1 serves to supply the clock signal SCLK1 which is required for operating the computer and other circuitry implemented within the cartridge 500 or 600 connected to the adapter 1, and therefore a clock oscillator circuit need not be provided in the cartridge 500 or 600. Accordingly, the cost of the cartridge 500 or 600 can be reduced. On the other hand, while the cost of the adapter 1 tends to increase in this configuration, it is outweighed by the economic effect of the cost reduction of the cartridges 500 and 600 which are frequently purchased in accordance with different purposes since the adapter 1 can be commonly used for the cartridges.

Also, since in accordance with this adapter 1, the clock signal SCLK1 is generated from the internal power supply voltage Vcc1 which has the maximum level, the cartridge 500 or 600 can be designed to operate with a clock signal having a large amplitude so that the design freedom can be increased. On the other hand, the cartridge 500 or 600 can be designed to operate with a clock signal having a smaller amplitude by providing the cartridge 500 or 600 with the circuit 583 for changing the amplitude of the clock signal SCLK1.

In accordance with this adapter 1, the frequency characteristics of audio signals AL1 and AR1 as input from the computer (the high speed processor 575) of the cartridge 500 or 600 are improved in the adapter 1 so that it is possible to output high quality audio signals AD1 and AR1 to the television receiver. In addition to this, the frequency characteristic adjustment functionality need not be provided in the cartridge 500 or 600, so that the cost of the cartridge 500 or 600 can be reduced. On the other hand, while the cost of the adapter 1 tends to increase in this configuration, it is outweighed by the economic effect of the cost reduction of the cartridges 500 and 600 which are frequently purchased in accordance with different purposes since the adapter 1 can be commonly used for the cartridges.

Furthermore, in accordance with the adapter 1 of the present embodiment, the infrared signals received by the adapter 1 can be transferred to the cartridge 500 or 600. Accordingly, the program stored in the cartridge 500 or 600 can be designed in order to use the information of the infrared signals so that a wider variety of applications can be implemented in the cartridge 500 or 600.

Also, in accordance with the adapter 1 of the present embodiment, the transmission of signals from the cartridge 500 or 600 to an external device (a television receiver in the case of the present embodiment) can be relayed through the connection terminals T20, T21 and T23 of the connector 69 and the output terminal 25. In this simple configuration, the signals from the cartridge 500 or 600 can be transmitted for any purpose to an external device, so that the destination of the processing result of the cartridge 500 or 600 can be easily changed.

Also, in accordance with the cartridge 500 or 600, the cartridge 500 or 600 is placed on the decoration plate 4 and the elevator mechanism 57, and pushed down to the position in which the cartridge 500 or 600 is restrained against further moving and the connector of the cartridge 500 or 600 can be inserted into the connector 69 of the adapter 1. Accordingly, the cartridge 500 or 600 can be easily inserted into the adapter 1.

Since the decoration plate 4 in the form of a rectangular plate is used to form a cartridge support member, the cartridge 500 or 600 in the form of a plate can be stably supported by the cartridge support member. Also, the handling of the cartridge 500 or 600 and the pushing down operation of the cartridge 500 or 600 are easy, so that the cartridge 500 or 600 can be easily inserted.

In addition, in accordance with the cartridge 500 or 600 of the above embodiment, the cartridge 500 or 600 can be connected to the connector 69 of the adapter 1 only by simple steps of placing the cartridge 500 or 600 on the decoration plate 4, pushing down the cartridge 500 or 600 and then sliding the cartridge 500 or 600 on the decoration plate 4 toward the connector 69 of the adapter 1.

Since the decoration plate 4 on which the cartridge 500 or 600 is placed is located in the upper surface of the housing of the adapter 1, the cartridge 500 or 600 can be inserted into the adapter 1 only by placing on the decoration plate 4, pushing down and then sliding it. The pushing down operation of the cartridge 500 or 600 can be performed in a stable and reliable manner as compared with the manipulation of pushing in the lateral direction. For this reason, it is possible to stably and surely perform the insertion operation of the cartridge 500 or 600. Also, in the case where the cartridge 500 or 600 is inserted into the connector 69 simply by sliding the cartridge 500 or 600 in the longitudinal direction, generally speaking, a certain type of mechanism must be provided for disconnecting the cartridge 500 or 600. However, when the cartridge 500 or 600 is slid after pushing down in such a manner as in accordance with the present embodiment, such a disconnecting mechanism is not needed. Also, in the configuration that the cartridge 500 or 600 is pushed inwardly from the upper surface of the adapter 1, the top plate 506 or 606 of the cartridge 500 or 600 being used is exposed to the upper surface of the adapter 1 during operation. Accordingly, it is possible to provide a variety of accessories such as an image sensor (for example, the imaging unit 603) or the connector for connecting an additional cartridge on the top plate 506 or 606. As a result, there are a wider variety of applications which are feasible with the cartridge 500 or 600.

Also, the decoration plate 4 as described above is usually supported by the elevator mechanism 57 in order to be flush with the upper surface of the adapter 1, so that the external design of the adapter 1 becomes neat from the aesthetic viewpoint. Furthermore, since the decoration plate 4 is urged by the elevator mechanism 57 in the upward direction, the cartridge 500 or 600 is automatically elevated together with the decoration plate 4 after the cartridge 500 or 600 is slid in order to disconnect the cartridge 500 or 600. Therefore, the cartridge 500 or 600 can be easily removed.

Also, the sliding direction of the cartridge 500 or 600 for inserting it into the adapter 1 is the direction toward the front face of the housing of the adapter 1. The user is usually considered to insert the cartridge 500 or 600 before the front face of the adapter 1, so that he can easily confirm the correct direction of the cartridge 500 or 600 by placing the cartridge 500 or 600 in order that the connector section 524 thereof faces forward. There is a small possibility that the cartridge 500 or 600 is placed in a wrong direction.

Also, in accordance with the adapter 1 of the present embodiment, when the cartridge 500 or 600 is installed, i.e., when the decoration plate 4 is located in a position where it is restrained by the elevator mechanism 57, one ends of the C-shaped members 159a and 159b of the cartridge locking mechanisms 61a and 61b enter the locking grooves 560a and 560b of the side surfaces of the cartridge 500 or 600 by the cartridge locking mechanisms 61a and 61b. The cartridge 500 or 600 is restrained against vertical movement by the C-shaped members 159a and 159b. Because of this, the cartridge 500 or 600 is prevented from being pushed up by the bias force of the elevator mechanism 57 to lower the risk that the cartridge 500 or 600 is disconnected from the adapter 1 when not desired. Also, the locking grooves 560a and 560a are formed in a shape such that the C-shaped members 159a and 159b do not hinder the motion of the cartridge when the cartridge 500 or 600 is horizontally slid. Accordingly, there is no obstacle for intentionally inserting and pulling the cartridge 500 or 600.

The locking grooves 560a and 560a are formed in the opposite side surfaces of the cartridge 500 or 600 such that the cartridge 500 or 600 can be securely fixed to the adapter 1 by engaging the opposite side surfaces of the cartridge 500 or 600 with the C-shaped members 159a and 159b.

Also, the elevator mechanism 57 is composed of the elevator board 55 and a plurality of members urging the elevator board 55 in the upward direction, and therefore it is possible to urge the decoration plate 4 in the upward direction while the decoration plate 4 is stably supported allowing the movement in the upward and downward directions.

Of the members urging the elevator board 55 in the upward direction, the pivotable member 157 is provided with an upper end which is pivotally connected to the elevator board 55 and a lower end which is pivotally connected to the shaft supporting protrusion 111 formed on the housing bottom of the adapter 1, so that it is possible to stably support the decoration plate 4 by the elevator mechanism 57.

When the cartridge 500 or 600 is placed on the decoration plate 4 and pulled down in the downward direction, the height of the elevator board 55 is lowered toward the bottom surface of the housing of the adapter 1, and when the pivotable member 157 comes in contact with the bottom surface of the housing the cartridge 500 or 600 no longer moves in the downward direction. When there is no force in the downward direction, the upper end of the pivotable member 157 moves in the upward direction by the resilient force of the spring 147 to urge the elevator board 55 in the upward direction. In this manner, the decoration plate 4 is stably supported with a bias force exerted in the upward direction, and when pulled down in the downward direction while being stably supported, the decoration plate 4 is restrained against movement in the position in which the elevator board 4 comes in contact with the bottom surface of the housing of the adapter 1.

Furthermore, when the cartridge 500 or 600 in accordance with the present embodiment is inserted into the adapter 1, the contact members 207 of the shield member 201 fixed to the upper surface of the connector unit 203 of the adapter 1 are in contact with the shield member 508 covering the inner circuitry of the cartridge 500 or 600 at the portion located on the inner upper surface of the indented engagement section 539 so that the connection therebetween is established over a wide area. By this connection, it is possible to stabilize the electric connection between the adapter 1 and the cartridge 500 or 600 and avoid trouble in the transmission and reception of signals. Also, in the case where the connection is made only by lines through the terminal t1, t2, t22 and t24, a differential potential may be generated between the ground potential of the cartridge 500 or 600 and the ground potential of the adapter 1 (which is relatively stable) so that the ground potential of the cartridge 500 or 600 is not stable. If the ground potential of the cartridge 500 or 600 is not stable, there is the possibility that the transmission and reception of signals becomes unstable between the cartridge 500 or 600 and the adapter 1. Also, there is the possibility that the potential of the shield member 508 itself fluctuates during the operation of the inner circuit of the cartridge 500 or 600 to radiate electromagnetic waves. By virtue of the connection established over a wide area between the cartridge 500 or 600 and the connector 69 of the adapter 1, it is possible to maximally reduce the differential potential between the ground potential of the cartridge 500 or 600 and the ground potential of the adapter 1, i.e., to stabilize the ground potential of the cartridge 500 or 600.

The shield member 201 of the connector 69 of the adapter 1 is urged in the downward direction by coming in contact with the shield member 508 of the cartridge 500 or 600 at the portion located on the inner upper surface of the indented engagement section 539. The shield member 201 of the connector 69 can move in the downward direction above the indent section 198 of the upper surface of the connector unit 203 and is prevented from coming in strong contact with the shield member 508 of the cartridge 500 or 600 and suffering from physical failure which would be caused by the strong contact.

Furthermore, in accordance with the adapter 1 of the above embodiment, each contact member 207 of the connector 69 is formed to have a predetermined point which is remotest from the upper surface of the connector unit 203 between one end and the other end (i.e., in the form of a ridge). In this configuration, the shield member 201 of the connector 69 can surely be in contact with the shield member 508 of the cartridge 500 or 600 at the contact members 207. Also, while a portion of the shield member 201 of the connector 69 extending over the contact member 207 moves in the downward direction, physical failure of the shield member 201 of the connector 69 is avoided also in this case because a portion (the indent section 198) of the upper surface of the connector unit 203 is formed lower.

Furthermore, in accordance with the cartridge 500 or 600 of the present embodiment, it is possible to supply the external device, through the adapter 1 with video signals and audio signals as generated by the high speed processor 575 in accordance with data and a program stored in the inner memory 577. The result of the program running in the cartridge 500 or 600 can be used by transferring the signals generated by the cartridge 500 or 600 having no display device to an external device, such as the television receiver or an intermediary device. The memory 577 is installed, as well as a program, in the cartridge 500 or 600 which outputs the video signals and the audio signals in such signal formats that the television receiver can display an image and output a sound respectively corresponding to the video and audio signals, so that the cartridge 500 or 600 can be used irrespective of the configuration of the television mode receiver. Furthermore, in the case where an intermediary device is used, since the memory 577 and the high speed processor 575 are installed in the cartridge 500 or 600, the same intermediary device can be used to implement substantially different functions. Still further, when the performance of the high speed processor 575 in the cartridge 500 or 600 is improved, the functionality of the improved computer can be fully available irrespective of the configuration of the intermediary device.

Still further, the dust entry prevention member 512 serves to prevent external dust from entering the inside of the cartridge 500 or 600 through the indented engagement section 539 or 669. The cartridge 500 or 600 includes several components such as the memory 577 and the high speed processor 575 which are relatively susceptible to external dust, and therefore this member 512 is effective to lower the risk of causing failure due to external dust.

Also, the cartridge 500 in accordance with the present embodiment is constructed without the use of screws and the like which spoil the appearance of the cartridge 500 by fitting the claw portions 550 of the fixation member 510 into the insertion holes 542 of the housing 502 over the top plate 506, and hooking the claw portions 550 at the edge of the housing 502 in order to fix the top plate 506 to the housing 502. Furthermore, since the fixation member 510 is fixed to the housing 502 by hooking the claw portions 550, this fixation member 510 can be easily removed and therefore the top plate 506 can be also easily removed so that the maintenance of the cartridge 500 is facilitated.

The lower housing 504 is provided with the holes 546 into which a stick can be inserted to unhook the claw portions 550 of the fixation member 510 from the edge of the upper housing 502 after the fixation member 510 is fixed to the upper housing 502 by hooking the claw portions 550 to the edge of the upper housing 502. The fixation member 510 and the top plate 506 can be easily removed from the upper housing 502 by inserting a pointed member into the holes 546 to unhook the claw portions 550 from the edge of the upper housing 502.

Also, in accordance with the cartridge 500 or 600 of the present embodiment, since the cylindrical protrusions 532 are formed to receive any one of a plurality of boards and shield members having different sizes, it is possible to use the same housings 502 and 504 for manufacturing a variety of products with boards, shield members and the like respectively having different size. As a result, it is possible to simplify the manufacturing process and quickly launch the production without need for redesigning the housings 502 and 504 for the respective products.

Furthermore, the bowling ball type input device 900 in accordance with the present embodiment is provided with a plurality of the finger holes 906a, 906b and 908b corresponding to a predetermined hand size, and therefore it is possible for the user having hands of an average size to easily gesture a throwing motion of the bowling ball by the use of the finger holes 906a, 906b and 908b. On the other hand, for the user having smaller hands than the average, for example, for a child, it is possible to easily gesture a throwing motion of the bowling ball by the use of the additional finger hole 908a in addition to the finger holes 906a and 906b of the above plurality of the finger holes 906a, 906b and 908b. Therefore, the user can enjoy the bowling game by selecting appropriate finger holes for his hand size.

Also, in accordance with the bowling ball type input device 900 of the present embodiment, the outer shell of the bowling ball type input device 900 is formed with the inner shell held inside thereof by fixing the cylindrical protrusions 945a and 945b at the ends of the finger holes 906a and 906b of the outer shell upper housing 902 to the cylindrical protrusions 947a and 947b, provided for fixation, of the outer shell lower housing 904 with the screws 912a and 912b. The screws 912a and 912b are located in the bottom portion of the finger holes 906a and 906b and therefore cannot be viewed from the outside. Besides the screws 912a and 912b, any other such member is not used at least for fixing the outer shell. Because of this, a smart design of the bowling ball type input device 900 can be realized.

By making transparent the outer shell housings 902 and 904, it is possible to externally control optical members such as a reflective sheet (for example, a retroreflective member such as a retroreflective sheet) provided on the inner shell housings 914 and 916 by external light. On the other hand, the input device 900 looks interesting in design since the inner shell housings 914 and 916 appear through the outer shell housings 902 and 904. With the retroreflective sheet attached to the outer surface of the inner shell housings 914 and 916, it is possible for the high speed processor 575 to obtain the position, velocity and acceleration of the input device 900 by the light reflected from this member and make use of the information for the game. Also, there is no need for particular electric circuits in the bowling ball type input device 900 itself so that the configuration can be simplified.

Furthermore, in accordance with the racket type input device 700 of the above embodiment, when acceleration is not detected, the start-up circuit 779 and the MCU 768 shut off supply of the square wave signals to the acceleration sensor circuit 766, and once acceleration is detected, the supply of the square wave signal is started so that it is possible to output the information about acceleration. It is therefore possible to provide the racket type input device 700 of which the power consumption is saved when not operated while, once operated, the system is activated without delay.

Also, in accordance with the bowling game program installed in the cartridge 600 of the present embodiment, the acquisition of the pixel data corresponding to one frame is started when the frame status flag signal takes a predetermined value (i.e., Y in step S272 of FIG. 104). In steps S273 to S281, while incrementing the Y coordinate (index) from a predetermined initial value to a maximum value by a predetermined amount, the pixel data for one line designated by each Y coordinate is acquired in succession. At first, the process waits until the pixel strobe signal takes the predetermined value (“Y” in step S274), and when the pixel strobe signal takes the predetermined value, the value of the X coordinate (index) is initialized (S275). At this time, the pixel data is not stored yet. Thereafter, the pixel data is acquired while incrementing the X coordinate to a maximum value (S276 to S279). When completing the acquisition of the pixel data for one line (“Y” in S279), the value of the Y coordinate is incremented by the predetermined amount (S280). As a result, if the value of the Y coordinate reaches the maximum value (“Y” in S281), the step of sequentially acquiring is completed. When the pixel strobe signal takes the predetermined value (“Y” in S274) for the first time, there is no effective pixel data so that this pixel strobe signal is skipped. Namely, while pixel data is not acquired when the pixel strobe signal takes the predetermined value (“Y” in step S274) for the first time, the actual acquisition of pixel data is started in the next time the pixel strobe signal takes the predetermined value (“Y” in step S274). In the repeating process (S276) subsequent thereto for actually storing pixel data, the pixel data can be successively stored without initialization of the X coordinate since the value of the X coordinate has already been initialized (S275). In the prior art technique, the X coordinate is initialized after the pixel data for one line is acquired (“Y” in S279) and before the pixel strobe signal takes the predetermined value at the beginning of the next line. In the case of such a prior art technique, since a certain time is required for initializing the value of the X coordinate, when the pixel strobe signal takes the predetermined value at the beginning of the next line, this signal transition is sometimes missed. As a result, it often fails to acquire the first pixel data of each line. In accordance with the method of the present invention, the X coordinate is not initialized just after completing the acquisition of the pixel data for one line (“Y” in S279) while waiting for the pixel strobe signal (“Y” in S274) to take the predetermined value indicative of the start of the acquisition of the pixel data of the next line, and then the initialization of the value of the X coordinate is performed only just after the pixel strobe signal takes the predetermined value (S275). Because of this, it is not missed when the pixel strobe signal takes the predetermined value, and therefore it rarely fails to acquire the pixel data.

Meanwhile, the present invention is not limited to the above embodiments, and a variety of variations and modifications may be effected without departing from the spirit and scope thereof, as described in the following exemplary modifications.

(M) Exemplary Modifications of Adapter and Cartridge

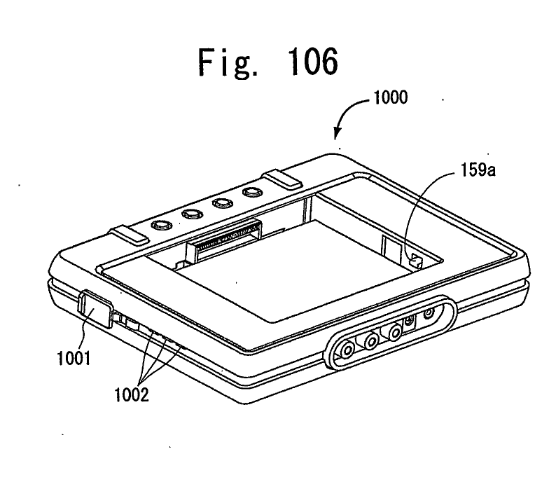

The configurations of the adapter 1 and the cartridges 500 and 600 as have been discussed above are only illustrative examples, and there are a variety of modifications can be contemplated. FIG. 106 is a view showing an adapter 1000 in accordance with an exemplary modification. FIG. 107(a) is a side view showing the adapter 1000; FIG. 107(b) is a back side view thereof; and FIG. 107(c) is a bottom view thereof. This adapter 1000 has a configuration substantially equivalent to that of the adapter 1 shown in FIG. 1, but differs therefrom in various specifications, for example, in providing of an extension connector to which an external device can be connected in addition to the configuration of the adapter 1. Meanwhile, in the following drawings, elements the same as the adapter 1 of the embodiments of FIG. 1 to FIG. 105 retain the same reference numerals. The names and functionality thereof are also the same. Accordingly, redundant detailed description is not repeated.

(Configuration of Housing)

Referring to FIG. 106 and FIG. 107, this adapter 1000 includes an extension connector 1003 (illustrated only in FIG. 107) formed on the side of the housing and covered by a cap 1001 (illustrated only in FIG. 106), and inner circuitry for this extension connector 1003 (not illustrated in FIG. 106 and FIG. 107) Also, as illustrated in FIG. 106 and FIG. 107, the housing of this adapter 1000 is provided with a plurality of openings 1002 for releasing heat inside of the housing. The plurality of openings 1002 are closed by a felt paper inside of the housing for the purpose of preventing powder dust and the like from entering the inside.

Incidentally, of the elevator mechanism 57 as shown in FIG. 10 and FIG. 11, particularly, the elevator board locking mechanism 59 as shown in FIG. 11 is not formed in this adapter 1000. Namely, the adapter 1000 is provided only with an elevator mechanism which simply urges the decoration plate 4 (refer to FIG. 1) in the upward direction. This is because the cost may be reduced, as well as the possibility of causing failure, by making use of a smaller number of parts. Needless to say, it is decided in accordance with the tradeoff made between a variety of requirements whether or not the elevator board locking mechanism 59 is employed, and the decision depends on the design concept.

(Configuration of Cartridge)

Incidentally, in the case where the elevator board locking mechanism 59 is not implemented, the decoration plate 4 shown in FIG. 1 can freely be moved up and down. Namely, even if the cartridge 500 is placed upside down on the decoration plate 4, the elevator board can be moved up and down. Accordingly, it is possible that the user installs the cartridge 500 into the adapter 1000 upside down by oversight. In this case, when the cartridge 500 is pulled down, the lower ends of the C-shaped members 159 shown also in FIG. 106 are pushed by the elevator board 55, and therefore the upper ends thereof are projected to the inside of the opening. However, in the case of the side grooves 560 of the cartridge 500 (refer to FIG. 1), if the cartridge 500 is placed upside down, there are no grooves in the location where the C-shaped members 159 are projected. As a result, of the side surfaces of the cartridge 500, the surface portions apart from the grooves 560 are strongly pinched by the C-shaped members 159 to fix the cartridge 500 so that the elevator board 55 also cannot be moved, resulting in the risk that the cartridge 500 can no longer be pulled out from the adapter 1000.

Similarly, in the case where the cartridge 500 is placed backwards on the adapter 1000, of the side surfaces of the cartridge 500, the surface portions apart from the grooves 560b are strongly pinched by the C-shaped members 159 to fix the cartridge 500 so that the elevator board 55 also cannot be moved, resulting in the risk that the cartridge 500 can no longer be pulled out from the adapter 1000.

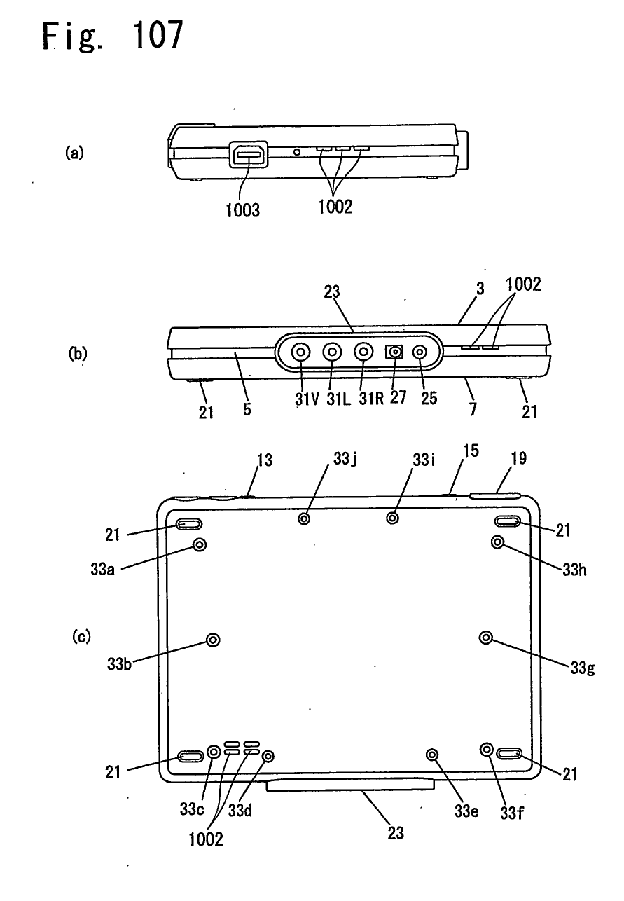

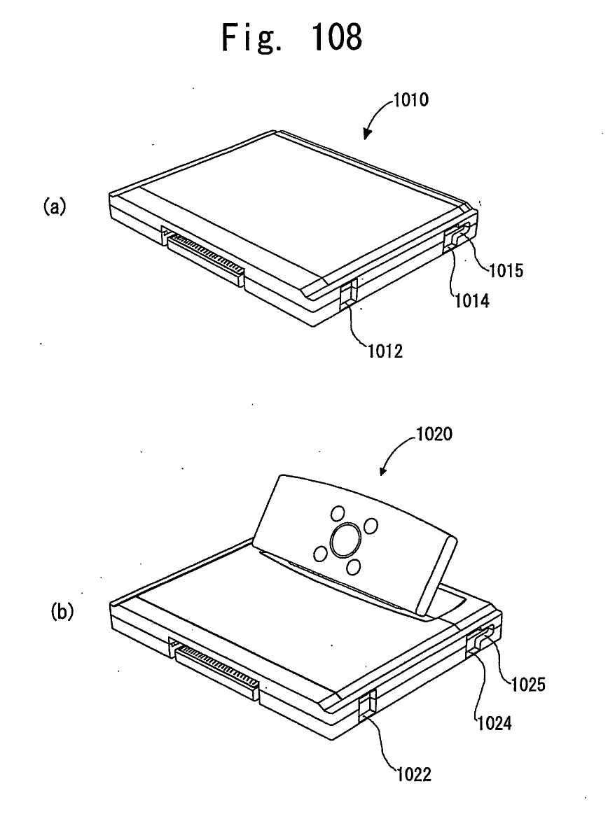

Because of this, in the case of the cartridges 1010 and 1020 of the present embodiment as illustrated in FIG. 108, additional grooves 1012 and 1022 are provided also on the opposite side surfaces near the front face and located opposite the grooves 560b as described above symmetrically with respect to the center line perpendicular to the opposite sides, while the grooves 560b shown in FIG. 1 are reshaped as grooves 1014 and 1024 on the opposite sides near the back face in the present embodiment. The grooves 1012 and 1022 are shaped and located in order that, even if the cartridges 1010 and 1020 are placed backwards into the adapter 1000, the C-shaped members 159 enter the grooves 1012 and 1022. Also, the height thereof in the vertical direction is determined in order that the upper ends of the C-shaped members 159 enter the grooves even when the cartridge 500 is inserted in the correct direction and also upside down. As a result, even if the cartridge is inserted backwards into the adapter 1000, the C-shaped members 159 enter the grooves so that it is avoided that the cartridge is fixed, that the elevator board 55 cannot be moved, and that the cartridge can no longer be pulled out from the adapter 1000. Also, while the geometry of the grooves 1014 and 1024 on the side surfaces near the back face is similar to some extent as the geometry of the grooves 560b of the cartridge 500 shown in FIG. 1, the front portion of the grooves 1014 and 1024 are wider than that as illustrated in FIG. 1 in the vertical direction so that even if the cartridge is inserted upside down the upper ends of the C-shaped members 159 enter the grooves 1014 and 1024 in the same manner as in the case of the groove portions 1012 and 1022. As a result, even if the cartridge is inserted upside down into the adapter 1000, the C-shaped members 159 enter the grooves 1014 and 1024 so that it is avoided that the cartridge is fixed, that the elevator board 55 cannot be moved, and that the cartridge can no longer be pulled out from the adapter 1000. The grooves 1014 and 1024 are formed to have a smaller height near the back face as grooves 1015 and 1025. The height of the grooves 1015 and 1025 is slightly larger than that of the upper ends of the C-shaped member 159.

Also, in accordance with the cartridges 1010 and 1020, if the cartridges 1010 and 1020 are inserted in the correct direction, the cartridges 1010 and 1020 can be surely restrained against movement in the vertical direction by, after the upper ends of the C-shaped members 159 of the cartridge locking mechanism 61 enter the grooves 1014 and 1024 from the right and left sides, sliding the cartridges 1010 and 1020 toward the front face in order that the upper ends of the C-shaped members 159 enter the inside of the grooves 1015 and 1025. This is true for the cartridges 500 and 600 as has been discussed above.

Also, the grooves 1012 and 1022 are provided respectively on the opposite side surfaces near the front face and located opposite the grooves 1014 and 1024 symmetrically with respect to the center line perpendicular to the opposite sides in order to receive the ends of the C-shaped member 159 for fixing the cartridge in a predetermined location, while the height and position of the grooves 1012 and 1022 are selected in order that even if the cartridges 1010 and 1020 are fixed backwards or upside down to the predetermined position, the C-shaped members 159 enter the grooves 1012 and 1022. Also, while the geometry of the grooves 1014 and 1024 on the side surfaces near the back face is similar as the geometry of the grooves 560b of the cartridge 500 shown in FIG. 1, the front portion of the grooves 1014 and 1024 are wider than that as illustrated in FIG. 1 in the vertical direction so that even if the cartridge is inserted upside down the upper ends of the C-shaped members 159 enter the grooves 1014 and 1024 in the same manner as in the case of the groove portions 1012 and 1022. In this configuration, even if the cartridges 1010 and 1020 are inserted upside down or backwards into the adapter 1000, it is avoided that the C-shaped members 159 hold the cartridges 1010 and 1020 in the location apart from the grooves 1012, 1014, 1022 and 1024, and that the cartridges 1010 and 1020 can no longer be pulled out from the adapter 1000.

(Power Switch Assembly)

FIG. 109 is a schematic diagram showing the power switch assembly inside of this adapter 1000. Referring to FIG. 109, in place of the configuration as illustrated in FIG. 9, the power switch assembly of the adapter 1000 includes a single rod 1032 which is supported by a supporting protrusion 1038 and the like and has one end formed with an engagement section 1034 and the other end coming in contact with the key top 41 of the a power supply switch 9. The end of the power switch unit 53 is loosely fitted into the engagement section 1034. A stopper 1040 is formed on the end of the powerswitch unit 53 while a spring 1036 is fitted between the power switch unit 53 and this stopper 1040.

In this configuration, the key top 41 is always urged in the downward direction as viewed in FIG. 109 by the spring 1036, and pushed in the upward direction at power up to push the switch of the power switch unit 53 to the pushed position in which the rod 1032 is stopped. When the user pushes again the key top 41, the rod 1032 is released to freely move and then moves again in the downward direction as viewed in the figure to return the initial position by the resilient force of the spring 1036.

As compared to the case where the plurality of arms 177, 179 and 181 are combined as illustrated in FIG. 9, while the pushing distance required for pushing the key top 41 might increase, it is possible to realize the push mechanism of the power supply switch 9 in a simplified structure.

(Internal Circuitry Configuration)

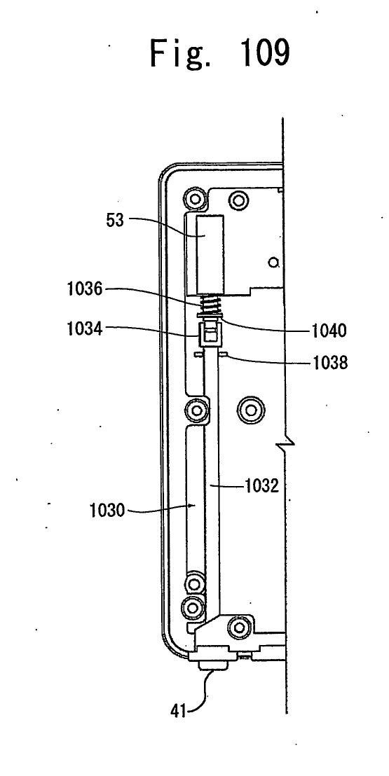

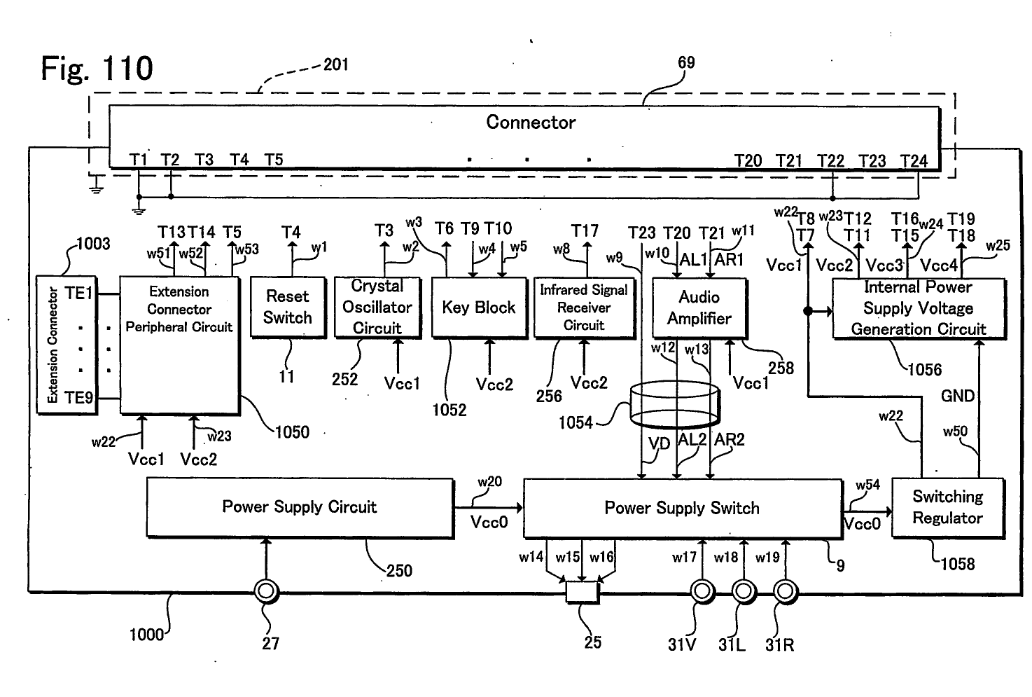

FIG. 110 is a view showing the electric configuration of the adapter 1000. While the electric configuration of this adapter 1000 is similar as the electric configuration of the adapter 1 shown in FIG. 78, it differs from that shown in FIG. 78 in that an extension connector peripheral circuit 1050 is provided for the extension connector 1003. This adapter 1000 includes, in place of the internal power supply voltage generation circuit 260 shown in FIG. 78, a switching regulator 1058 for receiving the power supply voltage Vcc0 from the power supply circuit 250 through the power supply switch 9 and generating a ground potential GND on the line w50 and a power supply voltage Vcc1 on the line w22, and an internal power supply voltage generation circuit 1056 for generating the power supply voltage Vcc1, Vcc2, Vcc3 and Vcc4 respectively on the line w22, w23, w24 and w25 from the ground potential GND and the power supply voltage Vcc1 supplied from the switching regulator 1058. Incidentally, the switching regulator 1058 and the internal power supply voltage generation circuit 1056 form an internal power supply voltage generation unit in combination. The adapter 1000 further includes, in place of the key block 254 shown in FIG. 78, a key block 1052 connectable to the extension connector peripheral circuit 1050. The connection between the key block 1052 and the extension connector peripheral circuit 1050 will be described later.

Also, unlike the adapter 1 shown in FIG. 78, this adapter 1000 includes a cylindrical ferrite 1054 which covers the lines w9, w12 and w13 in order to prevent electromagnetic waves from leaking from these lines.

(Circuit Configuration of Switching Regulator)

FIG. 111 is a view showing the circuit configuration of the switching regulator 1058 shown in FIG. 110 as well as the circuit configuration of the peripheral circuitry thereof (the switch 9 and the power supply circuit 250). Referring to FIG. 111, the power supply switch 9 includes a switch having a contact 1102 connected to the power supply circuit 250 and two contacts 1100 and 1104 connected respectively to the switching regulator 1058, and is configured to connect the contact 1100 to the contact 1102 when powered on and connect the contact 1100 to the contact 1104 when powered off, in response to the manipulation of the power supply switch.

The switching regulator 1058 includes a capacitor 1060 connected between the contact 1100 and the ground potential, an electrolytic capacitor 1062 for smoothing voltage signals connected between the contact 1100 and the contact 1104, a PNP transistor 1066 and the NPN transistors 1072 and 1084.

The transistor 1066 is connected to the contact 1100 at the emitter, while the transistors 1072 and 1084 are connected to the ground potential respectively at their emitters.

The switching regulator 1058 further includes a resistor 1064 connected between the emitter and base of the transistor 1066, a resistor 1070 connected between the base of the transistor 1066 and the collector of the transistor 1072, a resistor 1068 connected between the contact 1104 and the base of the transistor 1072, a capacitor 1074 connected between the collector of the transistor 1066 and the base of the transistor 1072, and a schottky diode 1078 connected between the collector of the transistor 1066 and the ground potential.

The switching regulator 1058 further includes a coil 1079 having one end connected to the collector of the transistor 1066 and the other end an output node 1081, a diode 1080 and a resistor 1082 connected in series between the output node 1081 and the base of the transistor 1084, and a capacitor 1086 between the output node 1081 and the base of the transistor 1084.

The switching regulator 1058 further includes a zener diode 1088 and a resistor 1090 connected in series between the output node 1081 and the ground potential for generating a reference voltage Vz, an electrolytic capacitor 1092 connected between the output node 1081 and the ground potential a capacitor 1094 connected between the output node 1081 and the ground potential, a coil 1096 having one end connected to the output node 1081 and the other end connected to the line w22 for removing noise, and a coil 1098 connected between the line w50 and the ground potential for removing noise. The contact between the zener diode 1088 and the resistor 1090 is further connected to the base of the transistor 1084.

The equation, Vcc1=Vz+Vbe, is satisfied by the reference voltage Vz generated by the zener diode 1088, the base-emitter voltage Vbe of the transistor 1084 and the output voltage Vcc1 on the output node 1081. Accordingly, when the output voltage Vcc1 drops, the base-emitter voltage Vbe of the transistor 1084 drops to turn off the transistor 1084. Because of this, the transistor 1072 is turned on to turn on the transistor 1066. Then, a current is passed through the transistor 1066 from the power supply circuit 250 so that the current is supplied to the coil 1079 and the output node 1081.

When the power supply voltage Vcc1 rises, the base-emitter voltage Vbe of the transistor 1084 is pulled up to turn on the transistor 1084. Because of this, the transistor 1072 is turned off and then the transistor 1066 is turned off. As a result, the current supply from the transistor 1066 is stopped. In response to this, the coil 1079 serves to supply a current to the output node 1081 from the schottky diode 1078. It is possible to maintain the power supply voltage Vcc1 in this way.

(Circuit Configuration of Extension Connector Peripheral Circuit 1050 and Key Block 1052)

FIG. 112 is a circuit block diagram showing the circuit configurations of the expansion connector 1003, extension connector peripheral circuit 1050 and key block 1052 shown in FIG. 110. Referring to FIG. 112, the extension connector 1003 is provided with the first to ninth terminals (referred to as terminals TE1 to TE9 in the following description). The key block 1052 has a similar configuration as the key block 254 shown in FIG. 83. Namely, the key block 1052 includes a cancel key 13, an enter key 15, arrow keys 17a to 17d, resistors 341 to 346, and a shift register 340.

Each pair of the resistor 341 and the enter key 15, the resistor 342 and the cancel key 13, the resistor 343 and the arrow key 17a, the resistor 344 and the arrow key 17b, the resistor 345, the arrow key 17c, and the resistor 346 and the arrow key 17d are connected in series between the power supply voltage Vcc2 and the ground potential respectively in this order. Also, the contact between the resistor 341 and the enter key 15, the contact between the resistor 342 and the cancel key 13, the contact between the resistor 343 and the arrow key 17a, the contact between the resistor 344 and the arrow key 17b, the contact between the resistor 345 and the arrow key 17c, and the contact between the resistor 346 and the arrow key 17d are connected respectively to the terminal F, E, D, C, B and A of the shift register 340.

The output terminal OUT of the shift register 340 is connected to the terminal T6 through the line w3; the clock input terminal CLK is connected to the line w5; and the control terminal P/S is connected to the line w4. Also, the terminal SER of the shift register 340 is connected to the line w55.

The shift register 340 converts the parallel signals as input through the terminals A to H into serial signals, and outputs them to the line w3. In other words, the on/off signals as output from the key tops 15, 13 and 17a to 17d are parallel/serial converted and output to the line w3. Incidentally, the terminals G and H of the shift register 340 are provided for future use so that two additional input signals can be added if necessary for some purpose. The additional input signals may be given from the inside of the adapter 1000, or from the outside through the connector 69 or the extension connector 1003. Also, while an operating clock is input to the clock input terminal CLK through the line w5, a control signal is input to the control terminal P/S through the line w4. When this control signal is in L level, the shift register 340 loads parallel data in response to this control signal of L level, and when this control signal is in H level, the shift register 340 outputs serial data. In addition, the line w55 connected to the terminal SER is connected to the extension connector 1003 as described later in order to supply serial data to the shift register 340 from the extension connector 1003. In the case of the present embodiment, it is assumed that the external device connectable to the extension connector 1003 is provided with a shift register which is the same as the shift register 340. Since the shift register of the external device can convert 8 bit parallel input data into serial data and output the serial data in the same manner as the shift register 340, the shift register 340 serves to output 14 bit serial data in total to the line w3 when the serial data is input to the terminal SER of the shift register 340. Incidentally, the shift register of the external device may not be identical to the shift register 340 while the bit length handled by the shift register is not limited to 8 bits.

The extension connector peripheral circuit 1050 includes a line 1121 connecting the terminal TE1 of the extension connector 1003 to the ground potential, resistors 1110, 1112 and 1114 connected respectively between the terminals TE9, TE2 and TE8 and the lines w4, w51 and w5, a resistor 1122 connected between the terminal TE3 and the power supply voltage Vcc1, resistors 1116, 1118 and 1120 connected respectively between the terminals TE7, TE4 and TE6 and the lines w55, w52 and w53, and a resistor 1124 between the terminal TE5 and the power supply voltage Vcc2.

The extension connector peripheral circuit 1050 further includes an electrolytic capacitor 1126 and a capacitor 1128 connected in series between the terminal TE5 and the terminal TE9, and a capacitor 1130 between the terminal TE2 and the contact between the electrolytic capacitor 1126 and the capacitor 1128. The contact between the electrolytic capacitor 1126 and the capacitor 1128 is grounded. The extension connector peripheral circuit 1050 further includes capacitors 1132, 1134, 1136 and 1138 connected respectively between the terminals TE8, TE7, TE4 and TE6 and the line 1121.

In accordance with the extension connector peripheral circuit 1050 as constructed above, it is possible to supply the power supply voltages Vcc1 and Vcc2 to an external device which is connected to the extension connector 1003 through the terminals TE3 and TE5. Also, the terminals TE2, TE4 and TE6 are used to exchange signals with the external device. The same clock signal can be supplied to the external device through the terminal TE8 as supplied to the shift register 340. The same control signal can be supplied to the external device through the terminal TE9 as supplied to the shift register 340.

(Circuit Configuration of Power Supply Voltage Generation Circuit 1056)

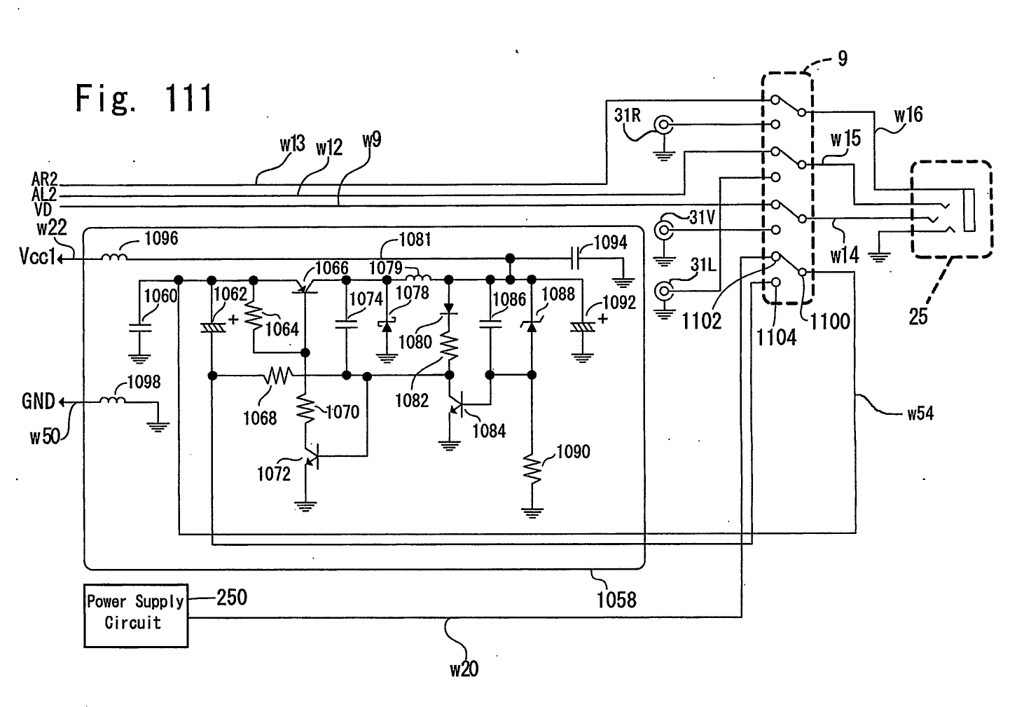

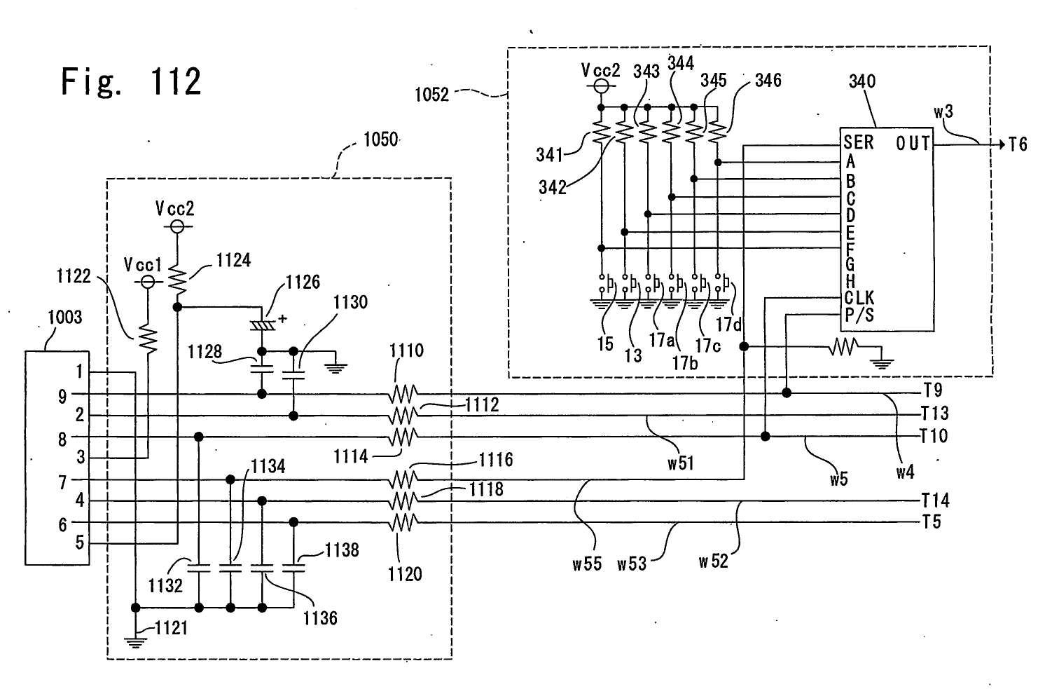

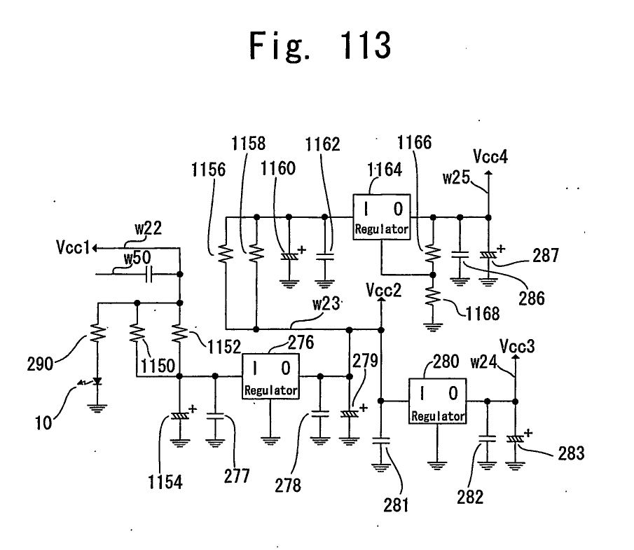

FIG. 113 shows the circuit configuration of the internal power supply voltage generation circuit 1056 as shown in FIG. 110. Referring to FIG. 113, in this internal power supply voltage generation circuit 1056, the number of regulators is one less than the number of regulators in the internal power supply voltage generation circuit 260 shown in FIG. 80. Referring to FIG. 113, this internal power supply voltage generation circuit 1056 includes three regulators 276, 280 and 1164, a resistor 290 and a power lamp (LED) 10 connected in series between the power supply voltage Vcc1 and the ground potential, resistors 1150 and 1152 connected in parallel between the power supply voltage Vcc1 and the input terminal of the regulator 276, an electrolytic capacitor 1154 connected between the ground potential and the contact between the resistor 1150 and the regulator 276, and a capacitor 277 connected between the input terminal of the regulator 276 and the ground potential. Incidentally, the regulator 276 is provided with a heat sink which is not shown in the figure. The regulator 276 outputs the power supply voltage Vcc2 at its output terminal which is connected to the input terminal of the regulator 280.

The internal power supply voltage generation circuit 1056 further includes capacitors 278 and 281 and an electrolytic capacitor 279 connected respectively between the output terminal of the regulator 276 and the ground potential. The regulator 280 outputs the power supply voltage Vcc3. The internal power supply voltage generation circuit 1056 further includes a capacitor 282 and an electrolytic capacitor 283 connected in parallel between the output terminal of the regulator 280 and the ground potential.

The internal power supply voltage generation circuit 1056 further includes resistors 1156 and 1158 connected in parallel between the output terminal of the regulator 276 and the input terminal of the regulator 1164, and an electrolytic capacitor 1160 and a capacitor 1162 connected in parallel between the input terminal of the regulator 1164 and the ground potential. The regulator 1164 outputs the power supply voltage Vcc4.

The internal power supply voltage generation circuit 1056 further includes resistors 1166 and 1168 connected in series between the output terminal of the regulator 1164 and the ground potential, and a capacitor 286 and an electrolytic capacitor 287 provided between the output terminal of the regulator 1164 and the ground potential.

While the ground terminals of the regulator 276 and the regulator 280 are connected respectively to the ground potential, the ground terminal of the regulator 1164 is connected to the contact between the resistor 1166 and the resistor 1168.

As has been discussed above, the number of the regulators used in the internal power supply voltage generation circuit 1056 of the present embodiment is one less than that used in the internal power supply voltage generation circuit 260 shown in FIG. 80. Because of this, the cost of the system is reduced while heat generation can be decreased.

Incidentally, in FIG. 110, the lines w51, w52 and w53 extending from the extension connector peripheral circuit 1050 are connected respectively to the terminals T13, T14 and T5 of the connector 69. The lines w3, w4 and w5, connected to the key block 1052 are connected respectively to the terminal T6, T9 and T10 of the connector 69 in the same manner as those shown in FIG. 78.

(Electric Configuration Of Cartridges 1010 and 1020)

While the electric configurations of the cartridges 1010 and 1020 are similar as the electric configurations of the cartridge 500 shown in FIG. 85 and the cartridge 600 shown in FIG. 78, they differ therefrom in the connection of the terminals t5, t13 and t14. Namely, the terminals t5, t13 and t14 are connected respectively to the corresponding I/O ports of the high speed processor 575.

(N) Exemplary Modifications of Bat Type Input Device

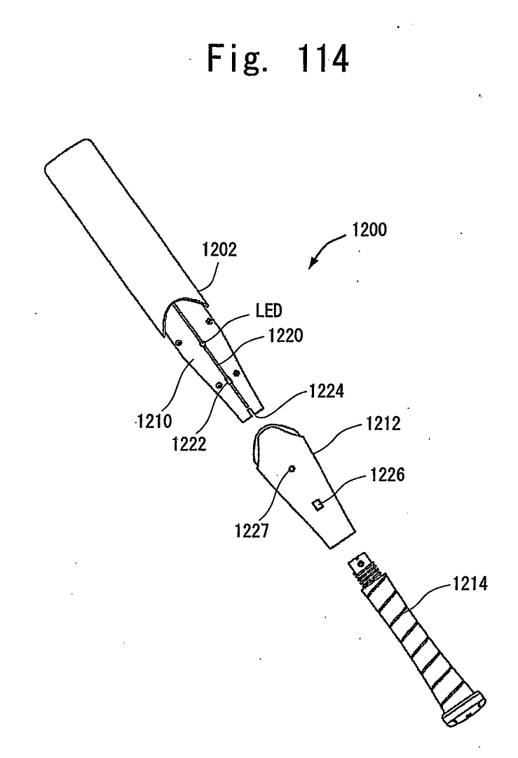

In the case of the bat type input device 800 as illustrated in FIG. 45 and FIG. 53 to FIG. 59, screws and the like for fixing the respective elements (for example, refer to FIG. 53(b)) are exposed to the outside. However, there is no such screws exposed on a real bat. In fact, such screws may cause disfigurement from the aesthetic viewpoint. Thereby, it is preferred to provide a bat type input device in which screws are invisibly located. The bat type input device 1200 as shown in FIG. 114 to FIG. 124 is constructed with screws which are not visible externally.

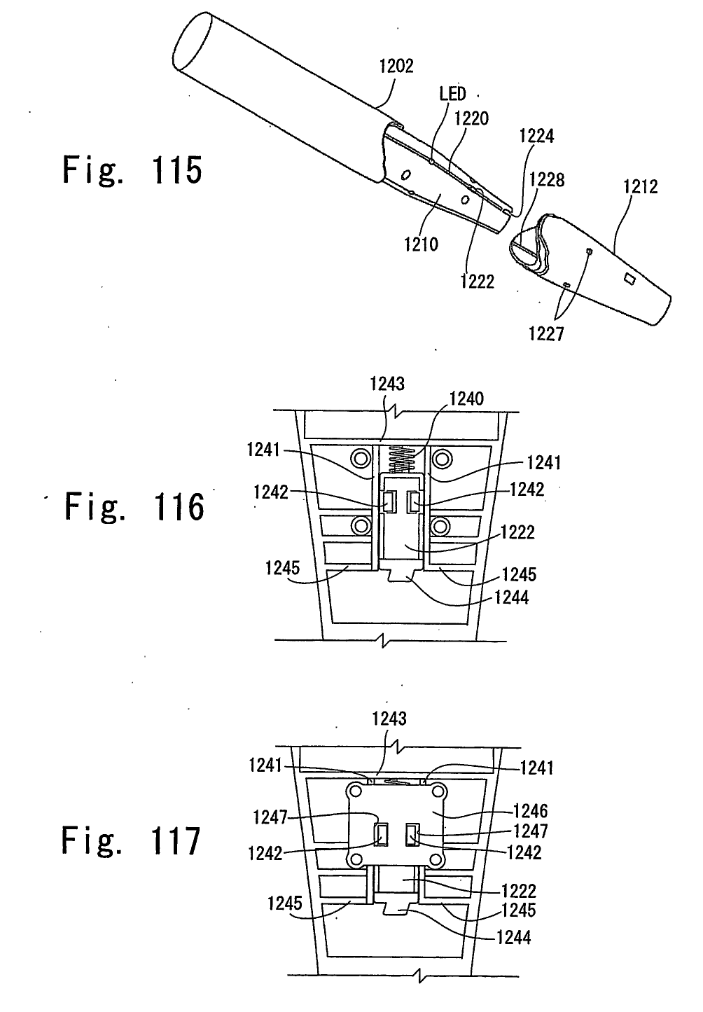

Referring to FIG. 114 and FIG. 115, the bat type input device 1200 is generally composed of three sections, i.e., a head 1202, a cap 1212 and a grip section 1214.

The head 1202 is shaped in the same manner as the head of a real bat, but provided with a control unit 1210 having LEDs, a button and the like in its lower part. The control unit 1210 is provided with a plurality of LEDs (only one is illustrated in FIG. 114). The cap 1212 is hollow inside and formed in order that the control unit 1210 can be fitted into the inside thereof as described below. The control unit 1210 is provided with a button 1222 on a position of the surface thereof for engaging the grip section 1214 with the head 1202 and the cap 1212. Meanwhile, it is also possible to separate the grip section 1214 from the head 1202 and the cap 1212 by manipulating the button 1222 as described below.

In the predetermined locations of the cap 1212, there are an opening 1226 through which the button 1222 is partially exposed when the control unit 1210 is engaged with the cap 1212, a plurality of openings 1227 through which the LEDs of the control unit 1210 are exposed, and an opening (not shown in the figure) through which a manipulation switch (the manipulation switch 806 of FIG. 53(a)) is exposed. The size of the opening 1226 is selected to allow a small movement of the button 1222 in the axial direction of the bat type input device 1200. In order to accurately fit the cap 1212 to the control unit 1210 with the button 1222 aligned with the opening 1226, protruding sections 1220 are formed on the surface of the control unit 1210 while indent sections 1228 are formed on the inside surface of the cap 1212 in order to loosely fit into the protruding sections 1220. Cutting sections 1224 are formed at the ends of the protruding sections 1220 of the control unit 1210 while protruding sections 1264 are formed on the inside surface of the cap 1212 at the locations corresponding to the cutting sections 1224 when the control unit 1210 is fitted into the cap 1212.

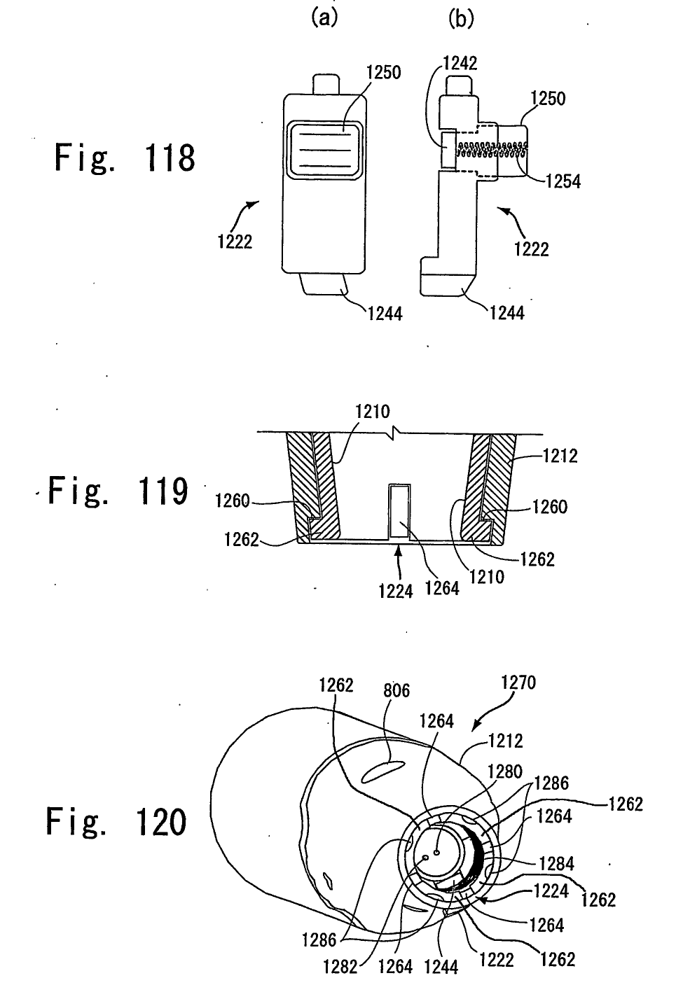

FIG. 116 is an inside view of the control unit 1210 showing the button 1222 as illustrated in FIG. 114 and FIG. 115. In the figure, the button 1222 is viewed from its rear side as well as the internal structure of the control unit 1210 around the button 1222. Referring to FIG. 116, in the control unit 1210, there are formed a pair of wall sections 1241 formed in parallel with in the axial direction of the control unit 1210, a stopper 1243 formed perpendicular to in the axial direction of the control unit 1210, and a pair of wall sections 1245 formed perpendicular to in the axial direction of the control unit 1210 with a spacing therebetween. The button 1222 is inserted between the pair of wall sections 1241 in order to allow sliding movement in the vertical direction as viewed in the figure. A spring 1240 is interposed between the button 1222 and the stopper 1243, and therefore the button 1222 is urged in the downward direction as viewed in FIG. 116. In the location of the control unit 1210 where the button 1222 is provided, there is an opening which is not shown in the figure and into which a manipulation member 1250 of the button 1222 is inserted (refer to FIG. 118). The button 1222 is always urged in the downward direction as viewed in the figure by the stopper 1243 and the spring 1240, and a claw portion 1244 of the button 1222 is projected downward from the wall section 1245 in this state. When the button 1222 is moved in the upward direction, the claw portion 1244 goes up beyond the wall section 1245.

FIG. 117 is a view showing the button 1222, shown in FIG. 116, which is prevented from falling away from the control unit 1210 by attaching a holding tool 1246 to the button 1222. In this case, openings 1247 are formed through the holding tool 1246 in a position corresponding to claw portions 1242. The openings 1247 is provided in order not to hinder the movement of the claw portions 1242 of the button 1222 in the direction normal to the drawing sheet of FIG. 117 as described below. In other words, when the control unit 1210 is inserted and fitted into the cap 1212, the button 1222 is urged toward the center of the control unit 1210 by the inside surface of the cap 1212 so that the claw portions 1242 moves in the front direction normal to the drawing sheet. If such openings 1247 are not formed, the claw portions 1242 comes in contact with the holding tool 1246 so that the button 1222 can not sufficiently enter inside of the control unit 1210, making it impossible to fitting the control unit 1210 into the inside of the cap 1210. For this reason, the openings 1247 must be formed. Incidentally, after fitting the control unit 1210 into the inside of the cap 1210, the button 122 is manipulated only when the grip section 1214 is separated from the head 1202 and the cap 1212. In this case, the button 1222 is slid in the upward direction in FIG. 117. Since the holding tool 1246 is located in a position in front of the claw portions 1242, the button 1222 can be slid, as it is, without interference between the claw portions 1242 and the holding tool 1246.

FIG. 118(a) is a front view showing the button 1222; and FIG. 118(b) is a left side view thereof. Referring to FIG. 118, the button 1222 has the manipulation member 1250 which can be slid in the direction perpendicular to the drawing sheet in (a) and in the direction from side to side of the drawing sheet in (b). A spring 1254 is provided in the manipulation member 1250 which is then urged in the right direction in FIG. 118(b). The rear end of the manipulation member 1250 is provided with the above claw portions 1242, which are engaged with the main body of the button 1222 to prevent the manipulation member 1250 from being detached from the main body of the button 1222. The manipulation member 1250 can be pushed down in the direction perpendicular to the drawing sheet toward the rear side in FIG. 118(a). In this case, the manipulation member 1250 moves in the left direction of the drawing sheet in FIG. 118(b).

FIG. 119 is a cross sectional view showing the lower portions of the control unit 1210 and cap 1212 when the control unit 1210 is inserted into the cap 1212. Referring to FIG. 119, claw portions 1262 are formed at the lower end of the control unit 1210. On the other hand, a stepped portion 1260 is formed on the lower end of the cap 1212. When inserting the control unit 1210 into the inside of the cap 1212 from the above in the figure, the control unit 1210 and the cap 1212 can be slightly deformed due to their elasticity so that the control unit 1210 can be fitted into the cap 1212 by engaging the claw portion 1262 with the stepped portion 1260 in the final stage of the fitting. With the claw portion 1262 engaged with the stepped portion 1260, it is difficult to pull out the control unit 1210 from the cap 1212.

Incidentally, in the state that the control unit 1210 is fully engaged with the inside of the cap 1212, the protruding sections 1264 formed on the inside surface of the cap 1212 are engaged with the cutting sections 1224 formed at the lower end of the control unit 1210. As a result, the control unit 1210 is prevented from rotating with respect to the cap 1212.

In the above configuration, by inserting the control unit 1210 into the hollow space of the cap 1212 with the protruding sections 1220 of the control unit 1210 as a guiding means in order to fit the protruding sections 1264 into the cutting sections 1224, it is possible to attach the cap 1212 to the control unit 1210 in an accurate position where the button 1222 is exposed through the opening 1226 and the LEDs are exposed through the openings 1227. Also, the manipulation switch 806 is also exposed through a corresponding opening (not shown in the figure) and therefore can be manipulated.

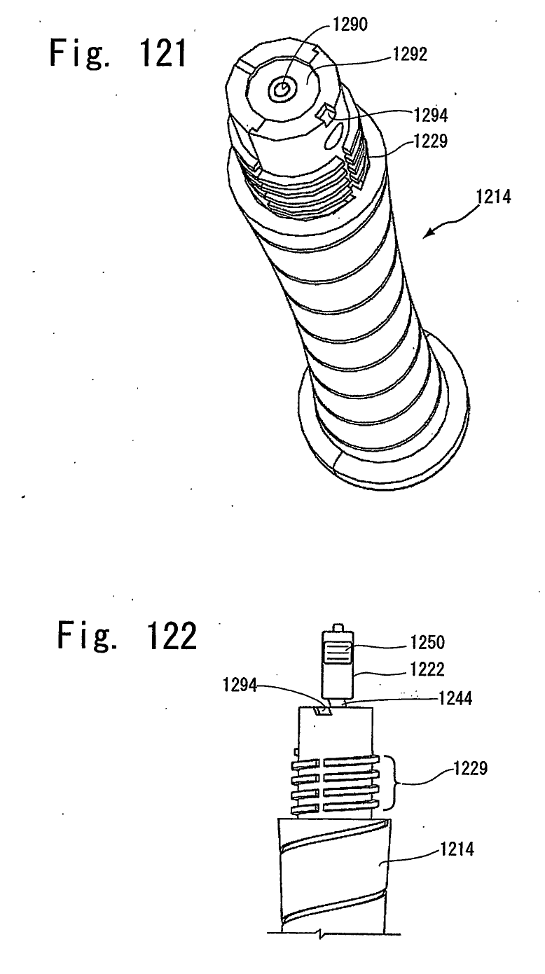

FIG. 120 is a view showing a head assembly 1270 which is formed by combining the cap 1212 and the head 1202 as viewed from the lower end direction. In FIG. 120, the bat type input device 1200 is placed in order that the button 1222 is located in the lower surface. Referring to FIG. 120, the head assembly 1270 includes a positive terminal 1280 and a negative terminal 1282 which are formed for inner circuitry in a position visible through the bottom opening. The inside surface of the bottom opening of the control unit 1210 is provided with a threaded portion 1284 (refer to FIG. 124) to be engaged with the threaded portion 1229 (refer to FIG. 121 to FIG. 123) of the grip section 1214. The grip section 1214 can be attached to the head 1202 and cap 1212 by threading the threaded portion 1229 into the threaded portion 1284 formed on the inside surface of the control unit 1210. Also, arched cutting sections 1286 are formed on four positions of the control unit 1210 at the lower end thereof. The cap 1212 can be pulled out from the control unit 1210 by inserting the ends of a tool provided for removing cap 1212 into these four cutting sections 1286 and inwardly pushing these ends at the same time in order to inwardly deform the lower end of the control unit 1210.

FIG. 121 is a view showing the grip section 1214 to be attached to this head assembly 1270 as viewed from an obliquely upward direction. Referring to FIG. 121, a threaded portion 1229 is formed around the outside surface of an end of the grip section 1214. The end of the grip section 1214 is provided with a positive terminal 1290 in its center position and a negative terminal 1292 around the positive terminal 1290. Also, a cutting section 1294 is formed in a position of the peripheral edge of the grip section 1214 in order to engage with the claw portion 1244 of the above button 1222 (refer to FIG. 118).

FIG. 122 is a view showing the positional relationship between the button 1222 and the grip section 1214 just before the grip section 1214 is completely threaded into the control unit 1210. Referring to FIG. 122, the button 1222 can be moved in the vertical direction. As illustrated in FIG. 122, the end of the grip section 1214 comes in contact with the end of the claw portion 1244 to move the button 1222 in the upward direction just before the grip section 1214 is completely threaded into the control unit 1210.

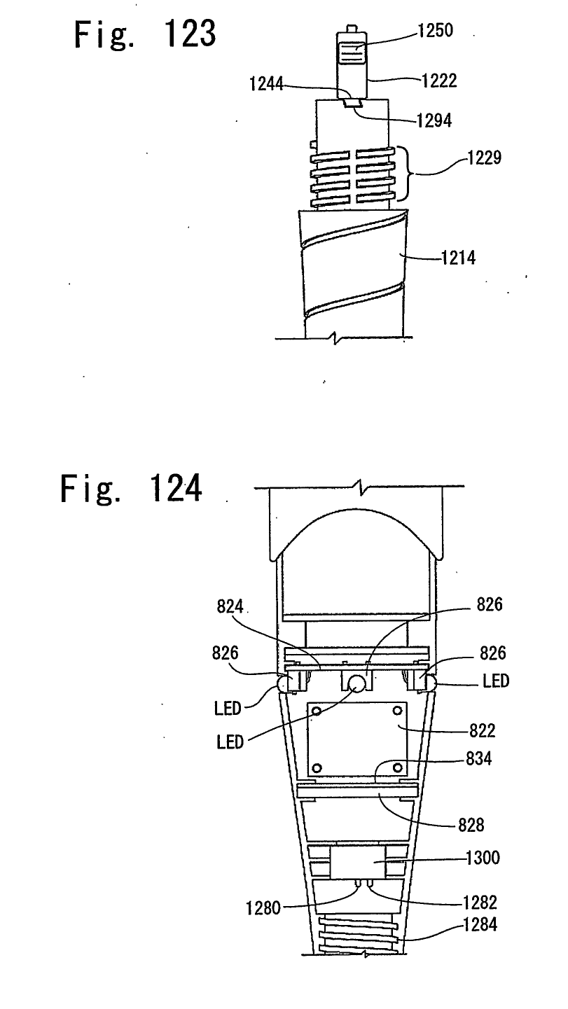

FIG. 123 is a view showing the grip section 1214 completely threaded into the control unit 1210. In this state, as illustrated in FIG. 123, the claw portion 1244 of the button 1222 is fitted into the cutting section 1294 of the upper end of the grip section 1214. Accordingly, in this state, the grip section 1214 cannot be moved relative to the control unit 1210, even if trying to twist the grip section 1214, and therefore the grip section 1214 is integrated with the control unit 1210. The manipulation member 1250 of the button 1222 is exposed through the opening 1226 as shown in FIG. 114 and FIG. 115, while the size of the opening 1226 is selected to allow a sliding movement of the manipulation member 1250, and therefore it is possible to remove the grip section 1214 from the control unit 1210 by sliding the manipulation member 1250 in the upward direction as viewed in FIG. 123 and then twisting the grip section 1214 around the control unit 1210.

FIG. 124 is a view showing the inner structure of the control unit 1210 shown in FIG. 114. Referring to FIG. 114, the board 824 is installed in the control unit 1210 perpendicular to the central axis of the bat type input device 1200. Then, on this board 824, there are mounted the four LED holders 826 around the central axis of the control unit 1210 angularly spaced from each other by 90 degrees with the LEDs attached respectively thereto as illustrated, for example, in FIG. 114.

Furthermore, inside of the control unit 1210, there are the holder 828 and clipping plate 834 for holding therebetween an acceleration sensor (piezoelectric element) not shown in the figure. In this case, the holder 828 is located in the control unit 1210 in order that the piezoelectric element is located perpendicular to the central axis of the bat type input device 1200. Furthermore, inside of the control unit 1210, there is the manipulation switch which is not shown in this figure but mounted on the board 822, which is fixed in parallel with the central axis of the bat type input device 800.

Still further, inside of the control unit 1210, there is a unit 1300 provided with the positive terminal 1280, the negative terminal 1282, a spring supporting and urging these terminals in the downward direction to allow the movement in the vertical direction as viewed in the figure, and a board which is not shown in the figure and serves to provide wirings for electric connection thereof. In this configuration, in the state that the grip section 1214 is attached to the control unit 1210, the positive terminal 1280 and negative terminal 1282 are urged against the positive terminal 1290 and negative terminal 1292 of the grip section 1214 as shown in FIG. 121 to make good electric contact therebetween.

The operation of the bat type input device 1200 as explained in the above is similar to that as explained with reference to FIG. 53 to FIG. 59. However, in the case of this bat type input device 1200, since the control unit 1210 is covered by the cap 1212 which is integrally molded, screws and the like are not exposed to the surface of the bat type input device 1200. Because of this, the external appearance is so good from the aesthetic viewpoint to provide a realistic item much like a real bat which is effective to uplift the interest in the game.

Incidentally, while the above explanation is provided with reference to the bat type input device, it is possible to design any other type of input device in accordance with this technique that a control unit is covered by an integrally molded cover in order to hide screws and the like. For example, such other types of input device include the above described types, i.e., the racket type, the ball type and the bowling ball type.

In accordance with the bat type input device 1200 of the above embodiment, a plurality of fastening members used in assembling the control unit 1210 become invisible by fitting the cap 1212 onto the control unit 1210. Also, the grip section 1214 is fixed to the head assembly 1270 by the threaded portions 1229 and 1284 which are also invisible externally. Accordingly, it is possible to provide the bat type input device 1200 which is so good from the aesthetic viewpoint without externally visible fastening members such as screws.

Meanwhile, the present invention is not limited to the above embodiment, and the following modifications are possible.

(1) In the above exemplary examples, the adapter 1 or 1000 is used to adapt the television receiver 14 for the virtual reality system for playing tennis, the virtual reality system for playing baseball, and the virtual reality system for playing bowling. However, while the applications are not limited thereto, the adapter 1 or 1000 can be used to adapt the television receiver 14 for a variety of other purposes. For example, it is possible to adapt the television receiver for a variety of purposes in the field of education, a variety of purposes in the field of entertainment, a variety of purposes in the field of healthcare, a variety of purposes in the field of finance, a variety of purposes in the field of medicine, and a variety of purposes in any other field.

(2) While any appropriate processor can be used as the high speed processor 575 of FIG. 85, it is preferred to use the high speed processor in relation to which the applicant has been filed patent applications. The details of this high speed processor are disclosed, for example, in Jpn. unexamined patent publication No. 10-307790 and U.S. Pat. No. 6,070,205 corresponding thereto.

While the embodiments disclosed herein are provided only for illustrative purposes, the present invention is not limited to these disclosed embodiments.

(3) In the above examples, the adapter 1 or 1000 is configured to be connected with the television receiver 14 which is an analog television. However, while the applications of the present invention are not limited thereto, the adapter can be configured to be connected with a digital television receiver. For example, in the case where the digital television receiver is provided with an HDMI interface, the adapter can be configured to be connected with this digital television receiver by providing an analog-to-digital conversion circuit therein which can convert an analog composite video signal and analog audio signals as output from the cartridge into digital elementary color signals (YUV signals) and digital audio signals (PCM signals), which are received by the digital television receiver through the HDMI interface.

On the other hand, in the case where the television receiver is not provided with an HDMI interface but only provided with an IEEE1394 interface, the adapter can be configured to be connected with this digital television receiver by providing an encoder therein which can encode an analog composite video signal and analog audio signals into an MPEG-TS, which are received by the digital television receiver through the IEEE1394 interface. In these cases, the adapter configured to be connected with the digital television receiver as described above can be used with the above cartridge 500 or 600 connectable to the adapter 1 or 1000 for the analog television receiver 14.

However, in the case where analog television receivers are not considered but only digital television receivers are taken into consideration, it seems natural to design an adapter and a cartridge for digital television receiver in accordance with the present invention in the following manner. Namely, the cartridge is configured to generate digital elementary color signals (YUV signals) and digital audio signals (PCM signals) and output these signals without conversion between digital and analog signals. On the other hand, the adapter for digital television receiver is configured to simply transfer these digital signals from the cartridge to the digital television receiver provided with an HDMI interface, in the similar manner as the adapter 1 or 1000 simply transfers analog signals from the above cartridge 500 or 600 to the analog television receiver 14.

The scope of the present invention is defined by the respective patent claims taking into consideration the detailed description of the invention, and includes any type of modifications within the scope in view of the description therein under the doctrine of equivalents.

1. An adapter connectable to a television receiver and a cartridge which contains a memory storing a program and data, and a computer capable of performing an arithmetic operation by the use of said program with said data, generating a video signal in such a signal format that said television receiver receives said video signal and displays an image corresponding to said video signal and generating an audio signal in such a signal format that television receiver receives said audio signal and outputs a sound corresponding to said audio signal, said adapter comprising:
a first video signal input terminal through which said video signal is received from said computer;
a first audio signal input terminal through which said audio signal is received from said computer;
a video signal output terminal through which said video signal input from said computer is output to said television receiver;
an audio signal output terminal through which said audio signal input from said computer is output to said television receiver;
a first inner circuit operable to receive said video signal from said first video signal input terminal and output said video signal to said video signal output terminal;
a second inner circuit operable to receive said audio signal from said first audio signal input terminal and output said audio signal to said audio signal output terminal.

2. The adapter as claimed in claim 1 further comprising:
an internal power supply voltage generation circuit operable to generate an internal power supply voltage on the basis of an external power supply voltage as supplied from an external source; and
a power supply voltage output terminal through which the computer is supplied with said inner power supply voltage as generated by said internal power supply voltage generation circuit.

3. The adapter as claimed in claim 1 further comprising:
an internal power supply voltage generation circuit operable to generate a plurality of internal power supply voltages having different output levels on the basis of an external power supply voltage as supplied from an external source; and
a plurality of output terminals operable to supply said computer with said plurality of internal power supply voltages.

4. The adapter as claimed in claim 2 further comprising:
a second video signal input terminal through which a video signal is externally received;
a second audio signal input terminal through which an audio signal is externally received;
a first switching circuit having a first contact, a second contact and a third contact;
a second switching circuit having a fourth contact, a fifth contact, and a sixth contact; and
a third switching circuit having a seventh contact, an eighth contact, and a ninth contact, wherein
said first contact is connected to said video signal output terminal; said fourth contact is connected to said audio signal output terminal; and said seventh contact is connected to a first line through which said external power supply voltage is supplied, and wherein
said second contact is connected to a second line which is connected to said first video signal input terminal; said fifth contact is connected to a third line which is connected to said first audio signal input terminal; and said eighth contact is connected to a fourth line which is connected to said internal power supply voltage generation circuit, and wherein
said third contact is connected to said second video signal input terminal; said sixth contact is connected to said second audio signal input terminal; and said ninth contact is in a high impedance state, and wherein
when said seventh contact is connected to said eighth contact, then said first contact is connected to said second contact, and said fourth contact is connected to said fifth contact, and wherein
when said seventh contact is connected to said ninth contact, then said first contact is connected to said third contact, and said fourth contact is connected to said sixth contact.

5. The adapter as claimed in claim 4 further comprising a rod-like member, wherein
said first switching circuit, said second switching circuit and said third switching circuit are combined to form a switch unit, and wherein
said switch unit is opened and closed by abutting said rod-like member against said switch unit.

6. The adapter as claimed in claim 2 further comprising an AC/DC converter operable to convert an AC power supply voltage into a DC power supply voltage, and outputs the DC power supply voltage to said internal power supply voltage generation circuit.

7. The adapter as claimed in claim 1 further comprising:
a clock oscillator circuit operable to generate a clock signal at a predetermined frequency; and
a clock signal output terminal through which said clock signal is supplied to said computer.

8. The adapter as claimed in claim 1 further comprising:
an internal power supply voltage generation circuit operable to generate a plurality of internal power supply voltages having different output levels on the basis of an external power supply voltage as supplied from an external source;
a clock oscillator circuit operable to generate a clock signal at a predetermined frequency; and
a clock signal output terminal through which said clock signal is supplied to said computer, wherein
said internal power supply voltage generation circuit supplies
said clock oscillator circuit with an inner power supply voltage having a maximum output level from among said plurality of internal power supply voltages having different output levels.

9. The adapter as claimed in claim 1 wherein said second inner circuit is provided with a frequency characteristic adjustment circuit operable to adjust or modify the frequency characteristics of said audio signal as input from said computer and outputs said audio signal as adjusted to said audio signal output terminal.

10. The adapter as claimed in claim 1 further comprising:
an infrared signal receiver circuit operable to externally receive an infrared signal and convert the infrared signal into an electrical signal; and
a terminal through which the electrical signal from said infrared signal receiver circuit is output to said computer.

11. The adapter as claimed in claim 10 further comprising a doughnut-shaped optical lens, wherein
said lens is located to face a light receiving section of said infrared signal receiver circuit.

12. The adapter as claimed in claim 11 wherein said lens is integrally formed with an infrared filter which is located on a light path toward said light receiving section of said infrared signal receiver circuit.

13. The adapter as claimed in claim 1 further comprising:
a predetermined number of switching circuits;
a parallel/serial conversion circuit operable to convert on/off signals as input in parallel from said predetermined number of switching circuits to serial signals, wherein
the number of the input terminals of said parallel/serial conversion circuit is more than said predetermined number.

14. A cartridge connectable to the adapter as recited in claim 1, comprising:
a memory storing a program and data; and
a computer capable of performing an arithmetic operation by the use of said program with said data in order to generate a video signal in such a signal format that said television receiver receives said video signal and displays an image corresponding to said video signal and generate an audio signal in such a signal format that television receiver receives said audio signal and outputs a sound corresponding to said audio signal.

15. The cartridge as claimed in claim 14 further comprising an imaging unit operable to take an image of an object and output the video signal as taken to said computer.

16. A cartridge connectable to the adapter as recited in claim 7, comprising:
a memory storing a program and data;
a computer capable of performing an arithmetic operation by the use of said program with said data in order to generate a video signal in such a signal format that said television receiver receives said video signal and displays an image corresponding to said video signal and generate an audio signal in such a signal format that the television receiver receives said audio signal and outputs a sound corresponding to said audio signal; and
a clock amplitude changing circuit operable to change the amplitude of said clock signal as output from said clock oscillator circuit.

17. A computer system comprising:
a cartridge which contains a memory storing a program and data, and a computer capable of performing an arithmetic operation by the use of said program with said data, generating a video signal in such a signal format that said television receiver receives said video signal and displays an image corresponding to said video signal and generating an audio signal in such a signal format that television receiver receives said audio signal and outputs a sound corresponding to said audio signal; and
an adapter into which said cartridge can be installed and which can be connected to said television receiver,
said adapter comprising:
a video signal input terminal through which said video signal is received from said computer;
an audio signal input terminal through which said audio signal is received from said computer;
a video signal output terminal through which said video signal input from said computer is output to said television receiver;
an audio signal output terminal through which said audio signal input from said computer is output to said television receiver; and
an inner circuit operable to receive said video signal from said video signal input terminal and output said video signal to said video signal output terminal, and receive said audio signal from said audio signal input terminal and output said audio signal to said audio signal output terminal.

18. An adapter comprising:
a cartridge installation interface provided with a connector section which is composed of a plurality of connection terminals including a first connection terminal and a second connection terminal, and connectable to a cartridge which serves a predetermined function and has a connector designed in a predetermined configuration;
a first and a second signal output terminal each of which can be connected to a plug designed in a predetermined configuration;
a first inner circuit by which said first connection terminal and said first signal output terminal are connected to each other; and
a second inner circuit by which said second connection terminal and said second signal output terminal are connected to each other, wherein
signals as input from said cartridge through said connector and said connector section are output to an external device through said first connection terminal and said first signal output terminal and through said second connection terminal and said second signal output terminal.

19. The adapter as claimed in claim 18 wherein said cartridge installation interface includes:
a cartridge support member operable to stably support the cartridge; and
an urging mechanism operable to urge said cartridge support member in a predetermined direction and restrict the amount of the movement of said cartridge support member in the direction opposed to said predetermined direction;
said connector section is located in a position such that it can be connected to the connector of said cartridge when said cartridge support member supporting the cartridge is pushed in the direction opposed to said predetermined direction to a position in which the movement of said cartridge support member is restricted by said urging mechanism.

20. The adapter as claimed in claim 19 wherein said cartridge support member includes a plate-like member in a predetermined shape.

21. The adapter as claimed in claim 19 wherein the connector of said cartridge is connected to said connector section of said cartridge installation interface by sliding the cartridge supported by said cartridge support member toward said connector section after said cartridge support member is pushed to a position in which the movement is restricted by said urging mechanism.

22. The adapter as claimed in claim 18 wherein said adapter is provided with a housing in the form of a flat rectangular parallelepiped having an upper surface, a bottom surface, left and right side surfaces, a front surface, and a back surface, wherein an opening is formed on said upper surface for receiving said cartridge, and wherein
said cartridge installation interface is located in said opening of said upper surface.

23. The adapter as claimed in claim 22 wherein said cartridge installation interface includes:
a top plate located in said opening of said upper surface and having a principal surface on which the cartridge is placed; and
an urging mechanism operable to support said top plate in order that said principal surface of said top plate is flush with said upper surface of said housing while urging said top plate in the upward direction and restricting the amount of the movement of said top plate in the downward direction, wherein
said connector section is located in a position such that it can be connected to the connector of said cartridge by pushing down the cartridge placed with said connector oriented in the predetermined direction toward said bottom surface to a position in which the movement of said cartridge support member is restricted by said urging mechanism, and sliding the cartridge in said predetermined direction.

24. The adapter as claimed in claim 23 wherein said predetermined direction is the direction toward said front surface of said housing.

25. The adapter as claimed in claim 23 wherein said cartridge is provided with a housing in the form of a flat rectangular parallelepiped which can be installed into said opening of said adapter and provided with an upper surface, a lower surface, opposite side surfaces, a front surface, and a back surface, wherein an indent section in a predetermined shape is formed on at least one of said opposite side surfaces, wherein
said adapter further comprises:
an engagement member which can enter into said indent section of the predetermined shape and fix said cartridge by fitting into said indent section; and
an engagement member support mechanism operable to support said engagement member in said adapter in order that, when said top plate of said cartridge installation interface is located in the position in which the movement thereof is restricted by said urging mechanism said engagement member is protruded into said opening of said housing of
said adapter, and when said top plate of said cartridge installation interface is located in elsewhere than the position said engagement member moves out of said opening, wherein
said indent section is formed in such a geometry that said engagement member does not interfere with any other portion of said cartridge during sliding said cartridge in the front-back direction when said cartridge is installed into said cartridge installation interface of said adapter.

26. The adapter as claimed in claim 25 wherein said indent section is formed in both the opposite sides of said cartridge, and wherein
said engagement member comprises a plurality of members which can enter into said indent sections of the respective opposite sides of said cartridge.

27. The adapter as claimed in claim 23 wherein said urging mechanism includes:
a plurality of urging members each of which has a first and a second end portion; and
a support member having a plurality of connection sections to which said first end portions of said plurality of the urging members are respectively connected for supporting said top plate from the bottom.

28. The adapter as claimed in claim 27 wherein a plurality of bottom connection sections, to which said second end portions of said plurality of the urging members are respectively connected, are formed on the bottom surface of said housing of said adapter.

29. The adapter as claimed in claim 28 wherein each of said plurality of the urging members includes:
a pivotable member which is pivotally attached to one of said plurality of the connection sections at said first end portion on the axis in parallel with the upper surface of said top plate, and pivotally attached to one of said plurality of the bottom connection sections at said second end portion on the axis in parallel with the above axis on which said pivotable member is pivotally attached at said first end portion; and
a resilient member operable to urge said pivotable member in the upward direction at said second end portion.

30. The adapter as claimed in claim 29 wherein said resilient member includes a spring fitted onto the pivotable axis of said second end portion of said pivotable member in order to urge said pivotable member in the direction that it moves away from said bottom surface of said housing of said adapter.

31. The adapter as claimed in claim 18 wherein said connector section comprising:
a connector unit in the form of a rectangular parallelepiped having an indented engagement section opened toward the front face of said rectangular parallelepiped in order to fit onto a protruded engagement section formed on said cartridge;
a shield member fixed to said connector unit in order to cover at least part of the upper surface of said connector unit; and
a plurality of said connection terminals located in said indented engagement section, wherein
said cartridge is provided with said protruded engagement section which can be fitted into said indented engagement section with a plurality of connection terminals to be in electric contact with the plurality of the connection terminals of said connector section, an indented engagement section which can be fitted onto a protruding section of said connector section formed between said upper surface and indented engagement section of said connector section, and a conductive shield member provided to cover the inner circuit of said cartridge while part of said shield member of said cartridge is attached to the inner upper surface of said indented engagement section of said cartridge, and wherein
said shield member of said connector section is configured to come in contact with said shield member of said cartridge when said cartridge is installed into said connector section.

32. The adapter as claimed in claim 31 wherein the back portion of said upper surface of said connector unit is formed lower than the front portion of said upper surface, wherein
said shield member of said connector unit is provided with an opening in order to form a contact member having one end fixed to said front portion of said upper surface and the other end located in said lower portion of said upper surface of said connector unit.

33. The adapter as claimed in claim 32 wherein said contact member is formed to have a predetermined point which is remotest from the upper surface of said connector unit between said one end and said the other end.

34. A cartridge comprising:
a memory storing a program and data;
a computer capable of performing an arithmetic operation by the use of said program with said data, generating a video signal in such a signal format that a television receiver receives said video signal and displays an image corresponding to said video signal and generating an audio signal in such a signal format that said television receiver receives said audio signal and outputs a sound corresponding to said audio signal; and
a connector that is connected to said computer and operable to supply an external device with said video signal and audio signal as output from said computer; and
a housing containing said memory and said computer and provided with said connector attached thereto.

35. The cartridge as claimed in claim 34 further comprising a dust entry prevention member located in an opening in which connection terminals are provided and operable to prevent external dust from entering the inside of said cartridge through said opening.

36. The cartridge as claimed in claim 34 wherein said housing comprising:
a housing main body having an inside space with an opening in one side thereof;
a top plate that is formed in such a shape as to cover the most part of said opening of said housing, and can be temporarily fixed to a position to cover said opening.
a fixation member having a claw portion protruded in order that it is fixedly hooked to a predetermined inner portion of said housing through a portion of said opening of said housing which is not covered by said top plate for fixing said temporarily fixed top plate to said housing main body.

37. The cartridge as claimed in claim 36 wherein said housing main body is provided with an opening through which a tool can be inserted in order to detach said claw portion from said predetermined portion after said claw portion of said fixation member is fixedly hooked to the predetermined inner portion of said housing.

38. The cartridge as claimed in claim 34 wherein fixation sections are provided on the inside of said housing in a plurality of positions in order that any one of constituent elements, which are functionally corresponding to each other but have different sizes, can be installed by selecting one or more of said fixation sections.

39. The cartridge as claimed in claim 34 wherein
a first locking groove is formed on each of the opposite side surfaces of said housing in a position displaced toward the back face of said housing from the center of said each of the opposite side surfaces in order that part of a locking member for use in fixing said cartridge in a predetermined position is inserted into said first locking groove, and wherein
said first locking groove comprises a first groove in the form of a rectangle having a predetermined height and a predetermined width respectively larger than the height and width of said part of the locking member, and a second groove in the form of a rectangle adjoining said first groove and having a height larger than the height of said part of the locking member and smaller than said predetermined height of said first groove and a predetermined width.

40. The cartridge as claimed in claim 39 wherein
a second locking groove is formed on each of the opposite side surfaces of said housing in a position opposite said first locking groove symmetrically with respect to the center line perpendicular to the opposite sides in order that said part of the locking member for use in fixing said cartridge in the predetermined position is inserted into said second locking groove, and wherein said second locking groove has a height and a width which are selected in order that said part of the locking member is inserted into said second locking groove even if said cartridge is placed backwards in said predetermined position.

41. The cartridge as claimed in claim 40 wherein
the height and width of said first locking groove and the height and width of said second locking groove are selected respectively in order that said part of the locking member is inserted into said first locking groove or said second locking groove even if said cartridge is placed upside down in said predetermined position.
